(19) United States
(12) Patent Application Publication
(10) Pub. No.: US 2014/0009671 A1
(43) Pub. Date: Jan. 9, 2014

(54) ACCESSORY, CAMERA, ACCESSORY CONTROL METHOD, ACCESSORY CONTROL PROGRAM, AND CAMERA CONTROL PROGRAM

(71) Applicant: Nikon Corporation, (US)

(72) Inventors: Akihiro OZONE, Yokohama-shi (JP); Kazuharu IMAFUJI, Kawasaki-shi (JP); Keiko MURAMATSU, Niiza-shi (JP); Izumi KUMAZAWA, Tokyo (JP); Yusuke IDE, Yokohama-shi (JP)

(73) Assignee: NIKON CORPORATION, Tokyo (JP)

(21) Appl. No.: 13/739,683

(22) Filed: Jan. 11, 2013

Related U.S. Application Data
(63) Continuation of application No. PCT/JP2012/068136, filed on Jul. 17, 2012.
(60) Provisional application No. 61/589,600, filed on Jan. 23, 2012.
(60) Provisional application No. 61/589,593, filed on Jan. 23, 2012.
(60) Provisional application No. 61/589,530, filed on Jan. 23, 2012.

(30) Foreign Application Priority Data
Jul. 20, 2011 (JP) 2011-158870
Jul. 20, 2011 (JP) 2011-158872
Jul. 22, 2011 (JP) 2011-161358
Sep. 16, 2011 (JP) 2011-203702

(51) Int. Cl. H04N 5/225

(52) U.S. Cl. CPC H04N 5/2256
USPC 348/371; 348/370; 348/372

(57) ABSTRACT

Provided is an accessory which is capable of communicating with a camera, including an illumination light emitting section that emits illumination light, a nonvolatile memory that stores light-emittable time information indicating the longest time for which the illumination light emitting section is capable of continuously emitting the illumination light, and an accessory control section that transmits the light-emittable time information stored in the nonvolatile memory to the camera.

### CROSS-REFERENCE TO RELATED APPLICATION

This is a Continuation Application of International Application No. PCT/JP2012/068136, filed on Jul. 17, 2012, which claims priority to Japanese Patent Application No. 2011-158870, filed Jul. 20, 2011, Japanese Patent Application No. 2011-158872, filed Jul. 20, 2011, Japanese Patent Application No. 2011-161358, filed Jul. 22, 2011, Japanese Patent Application No. 2011-203702, filed Sep. 16, 2011, U.S. Provisional Application No. 61/589,530, filed Jan. 23, 2012, U.S. Provisional Application No. 61/589,600, filed Jan. 23, 2012, and U.S. Provisional Application No. 61/589,593, filed Jan. 23, 2012, the contents of which are incorporated herein by reference.

### BACKGROUND

1. Field of the Invention

The present invention relates to an accessory, a camera, an accessory control method, an accessory control program, and a camera control program.

2. Description of the Related Art

Cameras are often used with an accessory such as a flash unit (see, for example, U.S. Patent Application Publication No. 2010/0329302). The accessory is used in a state where it is connected to an accessory shoe (also called a shoe seat, a hot shoe, or the like) of the camera. The accessory shoe has terminals that output a control signal for controlling the accessory to the accessory. The camera can transmit the control signal to the accessory through the terminals of the accessory shoe, and control the accessory.

### SUMMARY

In a camera system including the camera and the accessory, satisfactory usability (high convenience) is expected. When the camera system, for example, does not respond to a user operation or causes a response delay, usability of the system is deteriorated.

In addition, since the accessory has a battery built-in or is supplied with power from the camera through a cable, convenience deteriorates.

In addition, there is an accessory including an illumination light emitting section (for example, LED). When a moving image is captured, the camera controls the illumination light emitting section included in the accessory in a case of low illuminance, and emits light for a time longer than the image capture time of a still image. In such a case, the turn-on possible time of the illumination light emitting section is required to be set, but it is difficult to appropriately set the turn-on possible time.

An aspect of the present invention is aimed at providing an accessory, a camera, an accessory control program, and a camera control program which have a high degree of convenience.

In addition, an aspect of the present invention is aimed at providing an accessory, an accessory control method and an accessory control program which are capable of appropriately setting the turn-on possible time of an illumination light emitting section.

According to an aspect of the present invention, there is provided an accessory which is capable of communicating with a camera, including: a light-emitting section that emits illumination light; a nonvolatile storage section that stores light-emittable time information which is a time for which the light-emitting section is capable of continuously emitting the illumination light and a predetermined time indicating an upper limit of the continuous light-emitting time; and an accessory control section that transmits the light-emittable time information stored in the storage section to the camera.

According to an aspect of the present invention, there is provided a camera which is capable of communicating with an accessory including a light-emitting section that emits illumination light and a nonvolatile storage section that stores light-emittable time information which is a time for which the light-emitting section is capable of continuously emitting the illumination light and a predetermined time indicating an upper limit of the continuous light-emitting time, the camera including: a camera control section that receives the light-emittable time information transmitted from the accessory.

According to an aspect of the present invention, there is provided an accessory control program for controlling an operation of an accessory control section included in an accessory, capable of communicating with a camera, which includes a light-emitting section that emits illumination light and a nonvolatile storage section that stores light-emittable time information which is a time for which the light-emitting section is capable of continuously emitting the illumination light and a predetermined time indicating an upper limit of the continuous light-emitting time, the program including: a step of transmitting the light-emittable time information stored in the storage section to the camera.

According to an aspect of the present invention, there is provided a camera control program for controlling an operation of a camera control section included in a camera which is capable of communicating with an accessory including a light-emitting section that emits illumination light and a nonvolatile storage section that stores light-emittable time information which is a time for which the light-emitting section is capable of continuously emitting the illumination light and a predetermined time indicating an upper limit of the continuous light-emitting time, the program including: a step of receiving the light-emittable time information transmitted from the accessory.

According to an aspect of the present invention, there is provided an accessory which is capable of communicating with a camera, including: an accessory terminal section which is capable of being electrically connected to a camera terminal section provided in the camera; and a nonvolatile storage section that stores type information on the accessory side indicating a type of the accessory terminal section.

According to an aspect of the present invention, there is provided a camera which is capable of communicating with an accessory, including: a camera terminal section which is capable of being electrically connected to an accessory terminal section provided in the accessory; and a nonvolatile storage section that stores type information on the camera side indicating a type of the camera terminal section.

According to an aspect of the present invention, there is provided an accessory control program for controlling an operation of an accessory control section included in an accessory, capable of communicating with a camera, which includes an accessory terminal section which is capable of being electrically connected to a camera terminal section provided in the camera and a nonvolatile storage section that stores type information on the accessory side indicating a type of the accessory terminal section, the program including: a step of reading out the type information on the accessory side stored in the storage section; and a step of transmitting the type information on the accessory side which is read out in the step to the camera.

According to an aspect of the present invention, there is provided a camera control program for controlling an operation of a camera control section included in a camera, capable of communicating with an accessory, which includes a camera terminal section capable of being electrically connected to an accessory terminal section provided in the accessory and a nonvolatile storage section that stores type information on the camera side indicating a type of the camera terminal section, the program including: a step of reading out the type information on the camera side stored in the storage section; and a step of transmitting the type information on the camera side which is read out in the step to the accessory.

According to an aspect of the present invention, there is provided an accessory which is capable of being attached and detached to and from a camera, including: a terminal section that receives a supply of power from the camera; and an accessory control section that outputs power supply continuation information, to the camera, which requests, from the camera, the continuation of the supply of power even when the camera is set to be in a predetermined state different from a startup state in which the camera is capable of being operated.

According to an aspect of the present invention, there is provided a camera to and from which an accessory is capable of being attached and detached, including: a communication terminal section which communicates with the attached accessory; a power supply terminal section that supplies power to the attached accessory; and a camera control section that controls the camera, wherein the camera control section is able to receive power supply continuation information, from the accessory through the communication terminal section, which requests, from the camera, the continuation of the supply of power even when the camera is set to be in a predetermined state different from a startup state in which the camera is capable of being operated, and continues a supply of power to the accessory through the power supply terminal section even when the camera is set to be in the predetermined state at the time of receiving the power supply continuation information.

According to an aspect of the present invention, there is provided an accessory control program causing a computer to execute control of an operation of an accessory control section provided in an accessory which is capable of being attached and detached to and from a camera, the program causing the computer to execute: a procedure of outputting power supply continuation information, to the camera, which requests, from the camera, the continuation of the supply of power even when the camera is set to be in a predetermined state different from a startup state in which the camera is capable of being operated.

According to an aspect of the present invention, there is provided a camera control program causing a computer to execute control of an operation of a camera control section provided in a camera to and from which an accessory is capable of being attached and detached, the program causing the computer to execute: a procedure of receiving power supply continuation information, from the accessory, which requests, from the camera, the continuation of the supply of power even when the camera is set to be in a predetermined state different from a startup state in which the camera is capable of being operated; and a procedure of continuing a supply of power to the accessory even when the camera is set to be in the predetermined state at the time of receiving the power supply continuation information.

According to an aspect of the present invention, there is provided an accessory which is capable of communicating with a camera, including: a light-emitting section that emits illumination light; a temperature detection section that detects a temperature; and an accessory control section that creates light-emittable time information indicating a time for which the light-emitting section is capable of continuously emitting the illumination light, based on the temperature detected by the temperature detection section, and transmits the created light-emittable time information to the camera.

According to an aspect of the present invention, there is provided an accessory control method of controlling an operation of an accessory, capable of communicating with a camera, which includes a light-emitting section that emits illumination light and a temperature detection section that detects a temperature, the method including: executing a procedure of creating a light-emittable time indicating a time for which the light-emitting section is capable of continuously emitting the illumination light, based on the temperature detected by the temperature detection section, and transmitting light-emittable time information indicating the created light-emittable time to the camera.

According to an aspect of the present invention, there is provided an accessory control program for controlling an operation of an accessory, capable of communicating with a camera, which includes a light-emitting section that emits illumination light and a temperature detection section that detects a temperature, the program causing a computer to execute, a step of creating light-emittable time information indicating a time for which the light-emitting section is capable of continuously emitting the illumination light, based on the temperature detected by the temperature detection section, and transmitting the created light-emittable time information to the camera.

According to an aspect of the present invention, there is provided an accessory which is capable of communicating with a camera, including: an accessory terminal section which is capable of being electrically connected to a camera terminal section provided in the camera; a nonvolatile storage section that stores accessory initial state information including accessory type information; and an accessory control section that transmits the accessory initial state information stored in the storage section to the camera, at the time of initial communication with the camera, wherein the accessory type information includes battery presence or absence information indicating whether a battery is mounted in the accessory, function type information including information indicating the presence or absence of the flash light emitting function, information indicating the presence or absence of an illumination light emitting function, and information indicating the presence or absence of an extended function, different from the flash light emitting function and the illumination light emitting function, in the accessory, characteristic information indicating a characteristic of each of the functions included in the accessory, and type information on the accessory side indicating a type of the accessory terminal section.

According to an aspect of the present invention, it is possible to provide an accessory, a camera, an accessory control program, and a camera control program which are capable of improving convenience.

According to an aspect of the present invention, it is possible to appropriately set the turn-on possible time of an illumination light emitting section.

### BRIEF DESCRIPTION OF DRAWINGS

FIG. 1 is a diagram illustrating an appearance of a camera system according to a first embodiment.

FIG. 2 is a diagram when the camera system according to the present embodiment is viewed from the side opposite to FIG. 1.

FIG. 3 is a diagram illustrating appearance of an accessory shoe according to the present embodiment.

FIG. 4 is a diagram illustrating an accessory according to the present embodiment.

FIG. 5 is a diagram illustrating appearance of a connector according to the present embodiment.

FIG. 6 is a block diagram illustrating a functional configuration of the camera system according to the present embodiment.

FIG. 7 is a diagram illustrating a configuration of the accessory according to the present embodiment and a connection relationship between the accessory and the camera.

FIG. 8 is a diagram illustrating a timing of performing each process in a charging control.

FIG. 9A is a diagram schematically illustrating a connection relationship between a startup detection level and a camera control section.

FIG. 9B is a diagram schematically illustrating a configuration of a level switching section.

FIG. 10 is a diagram illustrating a procedure of processes of the camera system according to the present embodiment.

FIG. 11 is a diagram illustrating a procedure of processes in a communication preparation sequence.

FIG. 12 is a diagram illustrating a procedure of processes in an initial communication sequence.

FIG. 13 is a diagram illustrating a procedure of processes subsequent to FIG. 12.

FIG. 14 is a diagram illustrating a procedure of processes in a control of supplying power to the accessory.

FIG. 15 is a diagram illustrating a procedure of processes in a steady communication sequence.

FIG. 16 is a diagram illustrating a procedure of processes subsequent to FIG. 15.

FIG. 17 is a diagram illustrating a procedure of setting processes of making each light-emitting function effective or ineffective.

FIG. 18 is a diagram illustrating a procedure of processes of the charging control.

FIG. 19 is a diagram illustrating a procedure of processes in the charging control in the initial communication sequence.

FIG. 20 is a diagram illustrating a procedure of processes of the charging control in the steady communication sequence.

FIG. 21 is a diagram illustrating a procedure of processes in an image capturing sequence.

FIG. 22 is a diagram illustrating a procedure of processes in the image capturing sequence for causing an illumination light emitting function to function.

FIG. 23A is a diagram illustrating a timing of executing each process of a control prolonging the turn-on time.

FIG. 23B is a diagram illustrating a timing of executing each process of a control prolonging the turn-on time.

FIG. 24 is a diagram illustrating a procedure of processes of terminating the process in the accessory.

FIG. 25 is a diagram illustrating a procedure of processes in an initial communication sequence of Modified. Example 1.

FIG. 26 is a diagram illustrating a procedure of processes in a power supply control of Modified Example 2.

FIG. 27 is a diagram illustrating a procedure of processes of a charging control of Modified Example 3.

FIG. 28 is a block diagram illustrating a portion of the functional configuration of the camera and the accessory which are the present embodiment.

FIG. 29 is a flow diagram illustrating a procedure of turn-on start processes of an illumination light emitting section executed by the camera control section and an accessory control section in the present embodiment.

FIG. 30 is a flow diagram illustrating a procedure of turn-on termination processes of the illumination light emitting section executed by the camera control section and the accessory control section in the present embodiment.

FIG. 31 is a diagram illustrating an appearance of a camera system 1a according to the present embodiment.

FIG. 32 is a diagram when the camera system 1a according to the present embodiment is viewed from the side opposite to FIG. 31.

FIG. 33 is a diagram illustrating a second connector 620 according to the present embodiment.

FIG. 34 is a block diagram illustrating a configuration of an accessory 600 according to the present embodiment.

FIG. 35 is a configuration diagram illustrating a connection relationship between the camera 10a and the accessory 600 according to the present embodiment.

FIG. 36 is a diagram illustrating a configuration of a navigation message.

FIG. 37 is an example of NMEA data (first GPS information).

FIG. 38 is a diagram illustrating a configuration of data included in second GPS information according to the present embodiment.

FIG. 39 is a flow diagram illustrating a procedure of processes in the camera system 1a according to the present embodiment.

FIG. 40 is a diagram illustrating a procedure of processes in an initial communication sequence in the accessory 600 according to the present embodiment.

FIG. 41 is a diagram illustrating a procedure of processes in a second steady communication sequence in the accessory 600 according to the present embodiment.

FIG. 42 is a diagram illustrating a procedure of update processes of GPS data within the camera 10a according to the present embodiment.

FIG. 43 is a diagram illustrating a procedure of processes of the camera 10a and the accessory 600 in still image capture according to the present embodiment.

FIG. 44 is a diagram illustrating a procedure of processes of the camera 10a and the accessory 600 in moving image capture according to the present embodiment.

FIG. 45 is a diagram illustrating processes in a power source control of the accessory 600 using the camera 10a according to the present embodiment.

FIG. 46 is a diagram illustrating a procedure of detachment processes (power-off processes) of the accessory 600 according to the present embodiment.

FIG. 47 is a diagram illustrating an example of an operation when a connection cable is connected to a data terminal 640 according to the present embodiment.

FIG. 48 is a diagram illustrating an appearance of a camera system 1b according to the present embodiment.

FIG. 49 is a diagram when the camera system 1b according to the present embodiment is viewed from the side opposite to FIG. 48.

FIG. 50 is a configuration diagram illustrating a connection relationship between a camera 10b and a GPS section 600b according to the present embodiment.

FIG. 51 is a diagram illustrating the appearance of a camera system according to a second embodiment.

FIG. 52 is a diagram when the camera system according to the second embodiment is viewed from the opposite side to FIG. 51.

FIG. 53 is a block diagram illustrating a functional configuration of the camera system according to the second embodiment.

FIG. 54 is a diagram illustrating a configuration of an accessory according to the second embodiment and a connection relationship between the accessory and a camera.

FIG. 55 is an example of table T1 in which outside air temperature information and light-emittable time information which are stored in a storage section according to the second embodiment are associated with each other.

FIG. 56 is a flow diagram illustrating a procedure of processes in the camera system according to the second embodiment.

FIG. 57 is a flow diagram illustrating a procedure of processes in an initial communication sequence according to the second embodiment.

### DESCRIPTION OF EMBODIMENTS

### First Embodiment

Exemplary embodiments of the present invention will be described below in detail. In the following description, components having the same or similar structure or functions are assigned the same reference numerals and signs, and the description thereof may be simplified or omitted.

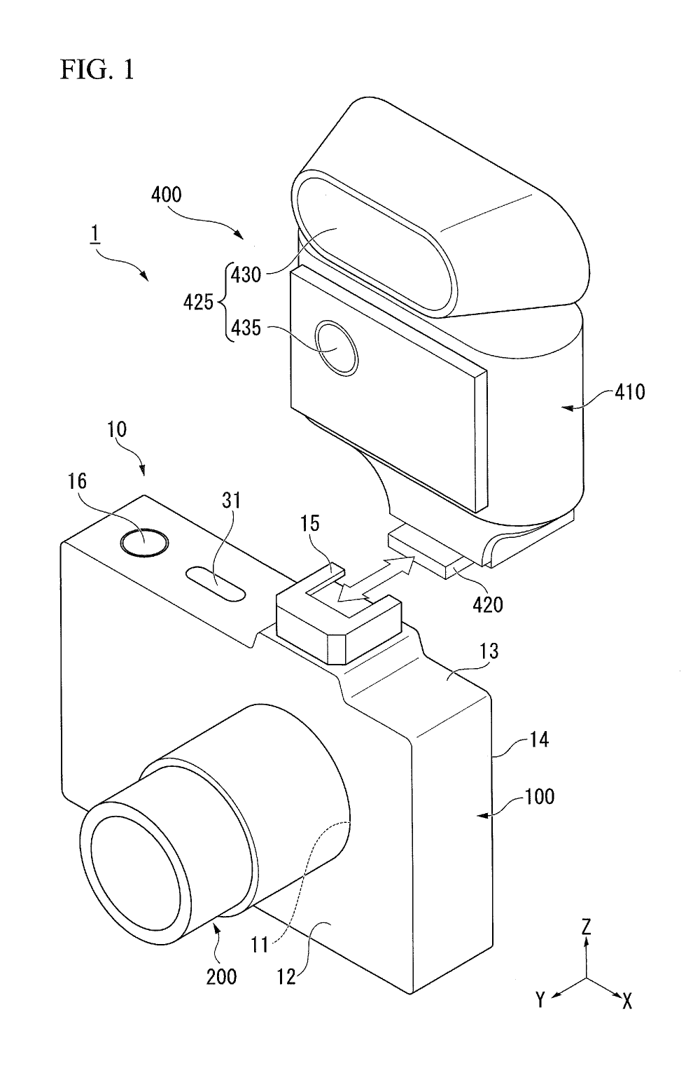

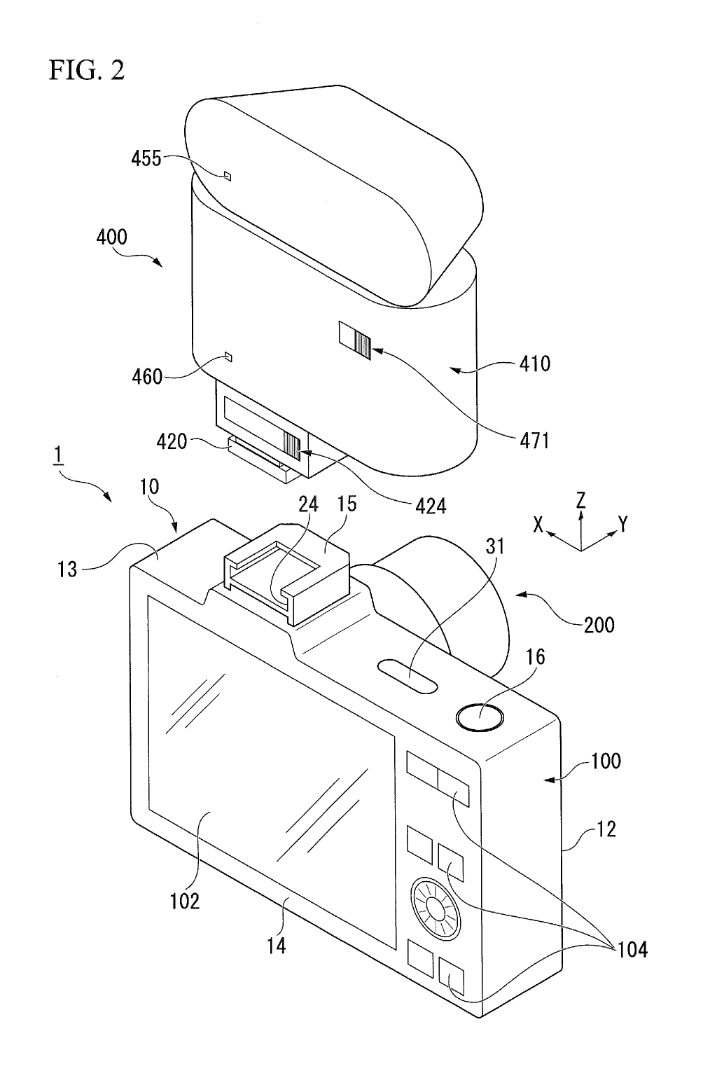

FIG. 1 is a diagram illustrating the appearance of a camera system 1 according to the present embodiment. FIG. 2 is a diagram illustrating the appearance of the camera system 1 when viewed from the side opposite to FIG. 1.

The camera system 1 shown in FIGS. 1 and 2 includes a camera 10 and an accessory 400. The camera 10 includes a camera body 100 and an image capture lens 200. The accessory 400, for example, has a light-emitting function, and is an external illumination device (attachable to and detachable from the camera 10) used to illuminate a subject. The camera 10 can communicate with the accessory 400 to control the accessory 400. The camera system 1 captures an image of the subject by using the camera 10, for example, while illuminating the subject using the accessory 400.

As shown in FIG. 1, the camera 10 includes the camera body 100 and the image capture lens (interchangeable lens) 200. The image capture lens is, for example, an interchangeable lens. The camera body 100 includes a lens mount 11 for installing the image capture lens 200. In addition, the image capture lens 200 includes a lens-side mount (not-shown) for mounting on the camera body 100. The image capture lens 200 is attachable and detachable to and from the lens mount 11 through the lens-side mount. The camera body 100 has a top surface (upper surface) 13 on the upper portion of side surfaces facing the lateral side with respect to a front surface 12 on which the lens mount 11 is arranged, and a back surface 14 on the side opposite to the front surface 12.

The camera body 100 includes a release button 16, an accessory shoe (hereinafter, referred to as a shoe seat 15), and a power switch 31 which each are disposed on the top surface 13. Upon detecting operation of the release button 16, the camera 10 performs various types of processes including an imaging process. The shoe seat 15 enables installation of the accessory 400. The power switch 31 is used to switch between an on-state and an off-state of the camera body 100.

In the present embodiment, a description may be made of a positional relationship and the like of components by setting an XYZ orthogonal coordinate system shown in FIG. 1 and the like. In this XYZ orthogonal coordinate system, the Y-axis direction is substantially parallel to the direction of the optical axis of the image capture lens 200. In the XYZ orthogonal coordinate system, the X-axis direction and the Z-axis direction are respectively orthogonal to the Y-axis direction, and are directions orthogonal to each other. The front surface 12 and the back surface 14 are respectively substantially orthogonal to the Y-axis direction. The top surface 13 is substantially orthogonal to the Z-axis direction.

The accessory 400 includes an accessory main body 410, a connector 420, and a light-emitting section 425. The light-emitting section 425 includes a flash light emitting section 430 and an illumination light emitting section 435 which are respectively provided with an emission surface that emits light. The accessory main body 410 houses the illumination light emitting section 435 and various types of electrical parts and the like. The connector 420 is arranged below the accessory main body 410. The connector 420 is attachable and detachable to and from the shoe seat 15 of the camera body 100. The accessory 400 is mounted on the camera body 100 and is fixed to the camera body 100 by the mounting of the connector 420 to the shoe seat 15. The flash light emitting section 430 is arranged on the side (upper side) opposite to the connector 420 with respect to the accessory main body 410. When the accessory 400 is mounted on the camera body 100 and the emission surface of the flash light emitting section 430 faces to the front surface 12 side (+Y direction side) of the camera body 100, the flash light emitting section 430 can emit flash illumination light (flash light from an Xe tube) in the direction substantially parallel to the optical axis of the image capture lens 200. The flash light emitting section 430 is arranged so as to change (posture change) a direction (posture) of the emission surface with respect to the accessory main body 410. For example, the flash illumination light can also be emitted with the emission surface of the flash light emitting section 430 toward the upper side (+Z side) of the accessory main body 410. On the other hand, the illumination light emitting section 435 can emit continuous illumination light (for example, LED illumination light) toward the front surface 12 side (+Y side) of the camera body 100 (direction substantially parallel to the optical axis of the image capture lens 200), in a state where the accessory 400 is mounted on the camera body 100.

As shown in FIG. 2, the camera body 100 includes a display section 102 arranged on the back surface 14, and setting switches 104 also arranged on the back surface 14. The display section 102 includes a liquid crystal display element or a display element such as an organic electroluminescent display element. The display section 102 displays a captured image, an image indicating various types of settings, an image indicating a state of the accessory 400, an image indicating the imaging conditions, and the like. The setting switches 104 are operated by the user of the camera system 1 when changing various types of setting items of the camera 10 and the accessory 400. The setting items include at least one of zoom magnification setting, image capture mode setting, white balance setting, exposure time setting, and display switching setting. The image capture mode setting is, for example, automatic mode setting or manual mode setting.

As shown in FIG. 2, the accessory 400 includes a first pilot lamp 455 (pilot lamp), a second pilot lamp 460 (pilot lamp), a first operating portion 424, and a second operating portion 471. The first pilot lamp 455 emits light depending on an operation state of the flash light emitting section 430 shown in FIG. 1. The second pilot lamp 460 emits light depending on an operation state of the illumination light emitting section 435 shown in FIG. 1. The first operating portion 424 is an operation member operated by the user when detaching the accessory 400 from the camera body 100 (in other words, the first operating portion 424 is a detaching operation member). The second operating portion 471 is an operation member operated by the user when switching between an on-state and an off-state of the entire function of the accessory 400 (in other words, the second operating portion 471 is an ON/OFF operating switch).

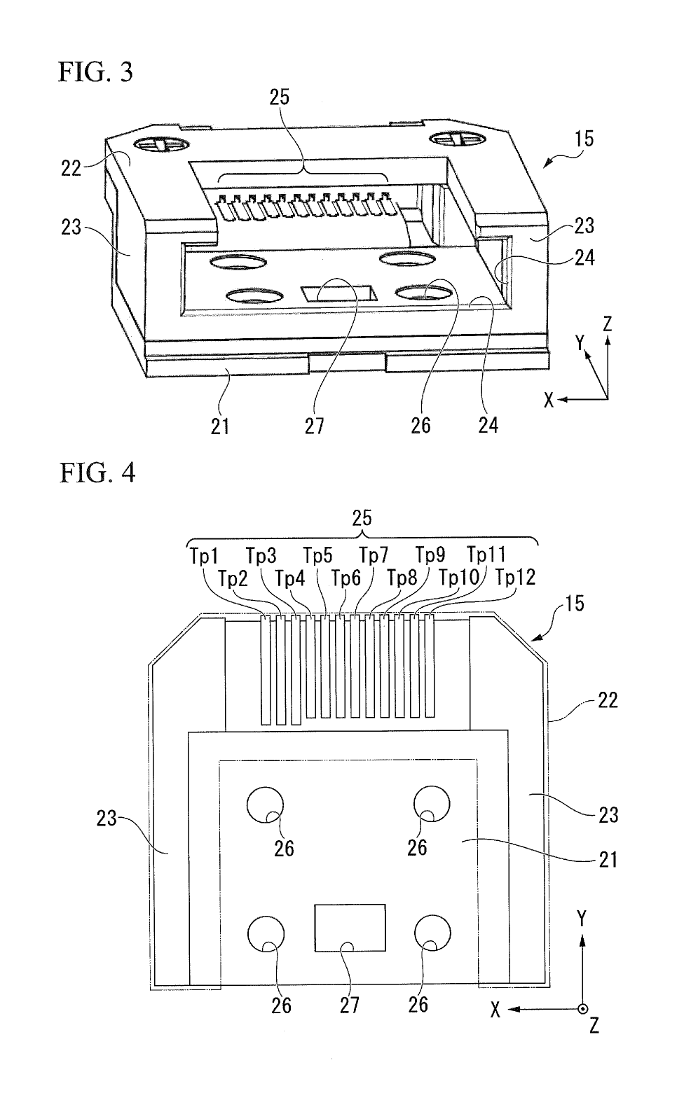

FIG. 3 is a diagram illustrating appearance of the shoe seat 15 of the present embodiment. FIG. 4 is a partially perspective plan view illustrating the shoe seat 15 from the top of FIG. 3 (in the −Z-axis direction from the top plate portion 22 of FIG. 3).

The shoe seat 15 includes a bottom plate portion 21, a top plate portion 22, a side plate portion 23 arranged between the bottom plate portion 21 and the top plate portion 22, an opening 24 arranged between the bottom plate portion 21 and the top plate portion 22, and a terminal section 25 arranged on the bottom plate portion 21.

The bottom plate portion 21 is mounted on the top surface 13 of the camera body 100 shown in FIG. 1. The bottom plate portion 21 has installing holes 26 used in positioning the shoe seat 15 on the top surface 13 of the camera body 100, and a locking hole 27 used in locking the accessory 400. The bottom plate portion 21 is fixed to the top surface 13 of the camera body 100 by screws or the like arranged in the inner side of the installing holes 26. In the present embodiment, the +Z-axis direction may be called the “upper side”.

The shape of the top plate portion 22 viewed from the upper side (Z-axis direction) is substantially U-shaped. The top plate portion 22 overhangs the inner side further than (more than) the side plate portion 23 as viewed from the upper side (Z-axis direction). The side plate portion 23 has a pair of inner walls extending in a predetermined direction (Y-axis direction) from the opening 24. The pair of inner walls of the side plate portion 23 is disposed to face each other in the direction (X-axis direction) orthogonal to the extending direction (Y-axis direction) of the inner wall.

The opening 24 opens toward the direction intersecting the direction (Z-axis direction) directed from the bottom plate portion 21 to the top plate portion 22. The opening 24 opens toward the direction substantially parallel to the extending direction (Y-axis direction) of the inner wall of the side plate portion 23. The dimensions and the shape of the opening 24 are set such that the connector 420 can be inserted in the opening 24.

The terminal section 25 includes a plurality of (twelve) terminals indicated by reference symbols Tp1 to Tp12 in FIG. 4. The plurality of terminals of the terminal section 25 extend in the direction substantially parallel to the extending direction (Y-axis direction) of the inner wall of the side plate portion 23. The terminals of the terminal section 25 are arranged side by side in the direction (X-axis direction) orthogonal to the extending direction of the inner wall of the side plate portion 23. The terminals of the terminal section 25 are arranged in a region partially overlapping (covered with) the top plate portion 22 as viewed from the upper side.

The terminals may have varying lengths in the Y-axis direction. For example, in the present embodiment, the ends of all the twelve terminals Tp1 to Tp12 are flush with each other on the +Y side. However, among the twelve terminals Tp1 to Tp12, the three terminals Tp1 to Tp3 are longer in the −Y-axis direction than the other terminals indicated by signs Tp4 to Tp12. That is, in the present embodiment, the three terminals Tp1 to Tp3 protrude further to the −Y side than the other terminals. As described later, the terminals Tp1 to Tp3 serve as the ground terminals. The reason why these ground terminals are made longer than the other terminals will be described later.

The accessory 400 is mounted on the shoe seat 15 by inserting the connector 420 into the opening 24 of the shoe seat 15 and slidably moving the connector 420 in a predetermined direction (+Y-axis direction) (see FIG. 1).

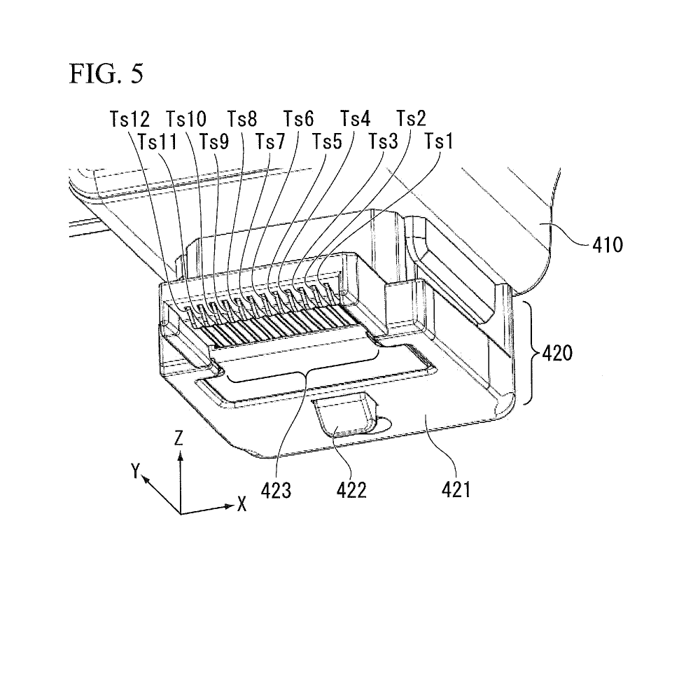

FIG. 5 is a diagram illustrating the appearance of the connector 420 of the present embodiment. The connector 420 includes a bottom 421, a movable member (hereinafter, referred to as a locking claw 422) protruding from the bottom 421 toward the outside of the connector 420, and a terminal section 423 provided on the bottom 421.

The bottom 421 comes into contact with the bottom plate portion 21 of the shoe seat 15 when the connector 420 is mounted on the shoe seat 15. The locking claw 422 is advanceable and retreatable (movable) in a predetermined direction. In the present embodiment, the predetermined direction in which the locking claw 422 advances and retreats is a direction (Z-axis direction) in which the locking claw 422 protrudes from the bottom 421. The locking claw 422 can move between a position protruding from the bottom 421 and a position housed inside the accessory 400. The locking claw 422 is biased by springs or the like so as to be pushed from the bottom 421 to the side (−Z side) protruding outside the connector 420. While the connector 420 is slidably moved when the connector 420 is mounted on the shoe seat 15, the locking claw 422 is pushed by the bottom plate portion 21 of the shoe seat 15 (receives force) and retreats to the +Z side, and then advances into the locking hole 27 in a position where the locking hole 27 is formed. That is, the connector 420 is configured such that the locking claw 422 is locked to the inner circumferential surface of the locking hole 27 of the shoe seat 15, and the movement of the shoe seat 15 is regulated in the sliding direction (Y-axis direction).

When the connector 420 is inserted into the opening 24, the connector 420 is located between the bottom plate portion 21 and the top plate portion 22, and the movement of the shoe seat 15 is regulated in a direction from the bottom plate portion 21 toward the top plate portion 22. When the connector 420 is inserted into the opening 24, the connector 420 is located between a pair of inner walls of the side plate portion 23, and the movement against the shoe seat 15 is regulated in a direction (X-axis direction) from one inner wall of the side plate portion 23 toward the other inner wall thereof.

The first operating portion 424 (see FIG. 2) is an operation member operated by the user when moving the locking claw 422 in a predetermined direction. The first operating portion 424 of the present embodiment is provided on the back side of the accessory main body 410. The first operating portion 424 includes a linkage mechanism that transmits force received by the user's operation to the locking claw 422. The locking claw 422 is moved in a predetermined direction (+Z-axis direction of FIG. 5) by the force received from the linkage mechanism of a first operating portion 424. That is, when the first operating portion 424 is operated in a state where the locking claw is locked to the locking hole 27 shown in FIG. 3, the locking claw 422 is moved to the +Z side so as to retreat from the inner side of the locking hole 27. As a result, the accessory 400, which was regulated to be at the position against the camera body 100, is released, and can be detached from the camera body 100. The terminal section 423 includes a plurality of (twelve) terminals indicated by reference symbols Ts1 to Ts12.

The number of terminals included in the terminal section 423 is the same as the number of terminals included in the terminal section 25 of the shoe seat 15. The terminals of the terminal section 423 have a one-to-one correspondence with the terminals of the terminal section 25 of the shoe seat 15. When the connector 420 is connected to the shoe seat 15, a certain terminal of the terminal section 423 is in electrical contact with a corresponding terminal of the terminal section 25 of the shoe seat 15.

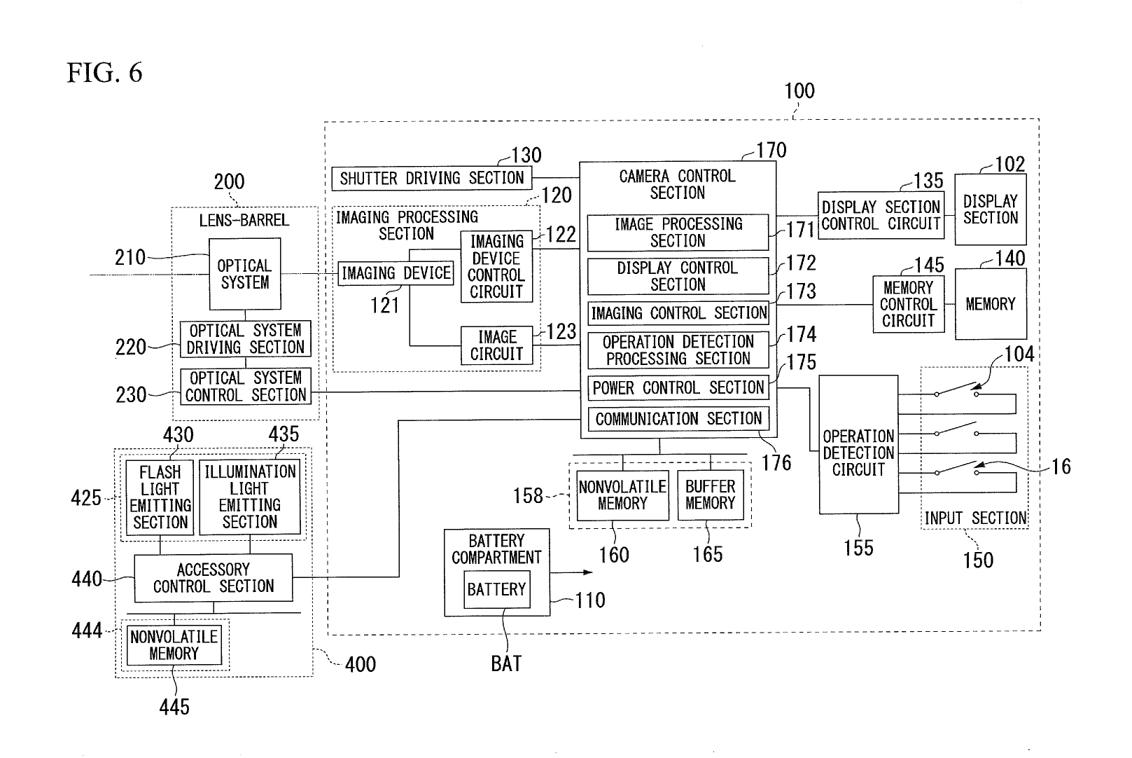

FIG. 6 is a block diagram illustrating a functional configuration of the camera system. As shown in FIG. 6, the image capture lens 200 includes an optical system 210, an optical system driving section 220, and an optical system control section 230. Light incident on the image capture lens 200 from a subject is incident on the light-receiving surface of an imaging device 121 of the camera body 100 through the optical system 210.

The optical system 210 includes a plurality of optical components such as a lens and an aperture, a lens barrel that houses a plurality of optical components, and the like. The optical system 210 forms an image based on light incident from the outside of the camera body 100.

The optical system driving section 220 includes an actuator that drives the optical system 210, an encoder that detects positions of the optical components in the optical system 210, and a sensor that detects a movement (at least one of a translational movement and a rotational movement) of the optical system 210 arising due to shaking or the like. The actuator of the optical system driving section 220 includes, for example, a focusing control motor, a power zoom control motor, an aperture opening control motor, a vibration reduction (VR) control motor, and an expansion and contraction control motor.

The optical system driving section 220 performs a focusing control, a zooming control, an exposure control, a VR control, and an expansion and contraction control of the image capture lens 200 by operating the actuator of the optical system driving section 220 in accordance with a control command from the optical system control section 230. The focusing control is a control for adjusting the focus of the optical system 210 by moving at least one of the optical components such as a lens included in the optical system 210 in the optical axis direction by the focusing control motor. The zooming control is a control for changing an imaging angle of view by moving at least one of the optical components such as a lens included in the optical system 210 in the optical axis direction by the power zoom control motor. The exposure control is a control for changing the aperture opening size by adjusting the amount of light incident on the imaging device 121 through the optical system 210 by driving an aperture constituting the optical system 210 by the aperture opening control motor. The VR control is a control for reducing image shaking due to vibration by moving at least one of the optical components such as a lens included in the optical system 210 in a direction intersecting the optical axis by the VR control motor. The expansion and contraction control is a control for expanding or contracting the image capture lens 200 in a direction of the optical axis by driving the expansion and contraction control motor.

The optical system driving section 220 is supplied with power from a battery BAT housed in a battery compartment 110 of the camera body 100. The optical system driving section 220 is supplied with power from the battery BAT through the terminals arranged in the lens mount 11 of the camera body 100. The actuator, the encoder, and the sensor constituting the optical system driving section 220 are operated by the power supplied from the battery BAT.

The optical system control section 230 communicates with a camera control section 170 (described later) of the camera body 100 through the terminals arranged in the lens mount 11 of the camera body 100. The optical system control section 230 supplies information indicating a detection result of the encoder and information indicating a detection result of the sensor of the optical system driving section 220 to the camera control section 170. Information supplied from the optical system control section 230 to the camera control section 170 includes lens type information indicating a type of the image capture lens 200, focal length information of a lens, an aperture value set by the exposure control, focal length information of a subject set by the focusing control, power consumption information, and the like. The power consumption information is information that indicates power consumed in a drive state, and changes depending on the lens type information or a driven state.

The accessory 400 includes the flash light emitting section 430, the illumination light emitting section 435, an accessory control section 440, and a nonvolatile memory 445. The illumination light emitting section 435, the accessory control section 440, and the nonvolatile memory 445 are housed in, for example, the accessory main body 410 shown in FIGS. 1 and 2. A detailed description of the accessory 400 will be given later.

The camera body 100 includes the battery compartment 110, an imaging processing section 120, a shutter driving section 130, a display section control circuit 135, a memory 140, a memory control circuit 145, an input section 150, an operation detection circuit 155, a storage section 158, and a camera control section 170.

The battery compartment 110 houses the battery BAT such as a primary battery or a secondary battery. The battery BAT, when housed in the battery compartment 110, is mounted on the camera body 100. The battery BAT received in the battery compartment 110 supplies power (PWR) necessary for operations of components of the camera system 1, for example, the display section 102, the image capture lens 200, the accessory 400 and the like.

The imaging processing section 120 includes the imaging device 121, an imaging device control circuit 122, and an image circuit 123. The imaging device 121 includes a plurality of two-dimensionally arranged pixels. Each pixel of the imaging device 121 includes a light receiving element such as a CCD (Charge Coupled device) or CMOS (Complementary Metal Oxide Semiconductor) sensor. The light receiving element of the imaging device 121 generates electric charge based on the amount of light incident on each pixel from the optical system 210. The imaging device 121 converts the electric charge generated in the light receiving element by the light incident on each pixel into an electric signal. The imaging device 121 generates an analog image signal based on an image (optical image) formed on the light-receiving surface of the imaging device 121 through the optical system 210. The imaging device 121 is connected to each of the imaging device control circuit 122 and the image circuit 123. The image circuit 123 amplifies the analog image signal output from the imaging device 121, and converts the analog image signal into a digital signal. The imaging device control circuit 122 performs acts such as generating an image signal based on the image in the imaging device 121, outputting the generated image signal by controlling the imaging device 121, and the like.

The shutter driving section 130 controls opening and closing of a shutter housed in the camera body 100. Light incident on the light-receiving surface of the imaging device 121 through the optical system 210 is shielded when the shutter is closed. In addition, when a shutter mechanism for an exposure control is not mounted on the camera body 100, the shutter driving section 130 is also unnecessary.

The display section control circuit 135 executes, for example, a display control such as turn-on, brightness adjustment, and turn-off of the display section 102, or a process of displaying image data output from the camera control section 170 on the display section 102.

The memory 140 is, for example, a recording medium removable from the camera body 100 such as a memory card or the like. The memory 140 stores, for example, image data or the like generated by the camera control section 170. The memory control circuit 145 controls input and output of information between the camera control section 170 and the memory 140. The memory control circuit 145 performs, for example, a process of storing the information such as the image data generated by the camera control section 170 in the memory 140, a process of reading out information such as image data stored in the memory 140 to output the information to the camera control section 170, or the like.

The input section 150 includes the setting switches 104 and the release button 16 that are operated by the user. The operation detection circuit 155 detects a user's operation input to the input section 150. The operation detection circuit 155 generates operation information indicating the user's operation input to the input section 150, and outputs the generated operation information to the camera control section 170.

The storage section 158 includes a nonvolatile memory 160 and a buffer memory 165. The nonvolatile memory 160 stores a series of computer-readable instructions (hereinafter, “program”) for operating the camera control section 170, image data generated by the image capture, information indicating a state of the device, information indicating power consumption of each load section of the camera system 1, and information such as various types of settings or imaging conditions which are input from the user. The information indicating a state of the device includes voltage information (remaining battery level) of the battery BAT housed in the battery compartment 110 of the camera body 100, information indicating a control state of each actuator of the image capture lens 200, and the like. The information indicating power consumption of each load section of the camera system 1 includes power (necessary for an operation) consumed in the shutter driving section 130, power (necessary for an operation) consumed in the actuator of the image capture lens 200, power (necessary for an operation) consumed in the accessory 400, and the like. The buffer memory 165 is a storage section for storing therein temporary information used in the control process of the camera control section 170. The camera control section 170 temporarily stores, for example, an image signal output from the imaging device 121, image data generated in response to the image signal, or the like in the buffer memory 165.

The camera control section 170 includes a CPU (Central Processing Unit) that controls operations of components of the camera body 100 based on the program stored in the nonvolatile memory 160, and electronic parts such as an ASIC (Application Specific Integrated Circuit). The camera control section 170 performs a supply of power to the camera body 100, a driving control of the optical system 210 through the optical system driving section 220, a driving control of the imaging device 121 through the imaging device control circuit 122, a display control of the display section 102 through the display section control circuit 135, a control of a process for the image signal output to the image circuit 123, and the like, for example, in accordance with operation information which is output to the camera control section 170 by the operation detection circuit 155.

The camera control section 170 includes an image processing section 171, a display control section 172, an imaging control section 173, an operation detection processing section 174, a power control section 175, and a communication section 176.

The image processing section 171 generates image data by performing image processing on the image signal output from the image circuit 123. The image processing section 171 stores the generated image data in the buffer memory 165.

The display control section 172 reads out the image data, stored in the buffer memory 165, which is generated by the image processing section 171, for each given time interval, and repeatedly displays the readout image data on the display section 102. Moreover, the display control section 172 reads out the image data, stored in the buffer memory 165, which is generated by the image processing section 171, for each given time interval, and records the image data in the memory 140 as moving-image format data (moving image data). Moreover, the display control section 172 displays the remaining charging level of the battery BAT on the display section 102 in accordance with a determination result of the power control section 175 described later.

The operation detection processing section 174 determines the user's operation detected by the operation detection circuit 155 based on operation information which is output by the operation detection circuit 155, and stores determined information in the buffer memory 165. The operation detection processing section 174 outputs control commands of various types of processes based on operations from the user to components (functional sections) that execute processes corresponding to the operations. For example, when the operation detection circuit 155 detects an input requesting execution of the imaging process to the input section 150, the operation detection processing section 174 outputs a control command for requesting the execution of the imaging process to the imaging control section 173 based on the operation information which is output to the operation detection processing section 174 by the operation detection circuit 155. In addition, for example when the operation detection circuit 155 detects an input requesting execution of the automatic focus (AF) process to the input section 150, the operation detection processing section 174 outputs a control command for requesting the execution of the AF process based on the operation information which is output to the operation detection processing section 174 by the operation detection circuit 155. In the AF process, the optical system control section 230 controls the focusing control motor of the optical system driving section 220 while referring to a ranging result using the image detected in the imaging device 121 through the optical system 210 based on the control command which is output by the operation detection processing section 174, and adjusts the focus of the optical system 210, for example, so as to focus on a subject designated by the user.

The imaging control section 173 outputs to the components of the camera system 1 a control signal for causing the components of the camera system 1 to execute the imaging process, based on the control command which is output by the operation detection circuit 155. The imaging control section 173 executes, for example, the following process as a process associated with the imaging process. In the imaging process, the imaging control section 173 performs controls such as the focusing control, the exposure control, the zooming control, and the VR control of the optical system 210 through the optical system control section 230, in accordance with the imaging conditions which are previously input from a user. In addition, in the imaging process, the imaging control section 173 controls the time (exposure time) for which the shutter is to be opened by controlling the shutter driving section 130, and irradiates the light-receiving surface of the imaging device 121 with light from the optical system 210 only for the exposure time. In addition, the imaging control section 173 controls the accessory 400 as necessary, and performs light irradiation from the accessory 400 in synchronization with the image capture timing.

The power control section 175 determines the remaining amount of power in the battery BAT by comparing a result of detecting a power-supply voltage output from the battery BAT with a determination threshold. In addition, the power control section 175 collects information indicating power consumption of each load section of the camera system 1, and monitors power consumption of each load section of the camera system 1.

The communication section 176 is communicably connected to the load control section that controls each load section located inside the camera body 100. The load section located inside the camera body 100 is, for example, the display section 102 or the like, and the load control section is, for example, the display section control circuit 135 or the like. In addition, the communication section 176 is connected to external devices arranged outside the camera body 100 in the camera system 1, communicably with a control section of each external device. The image capture lens 200 of the present embodiment is an example of the external devices, and the optical system control section 230 is communicably connected to the communication section 176. In addition, the accessory 400 of the present embodiment is one of the external devices, and the accessory control section 440 is communicably connected to the communication section 176.

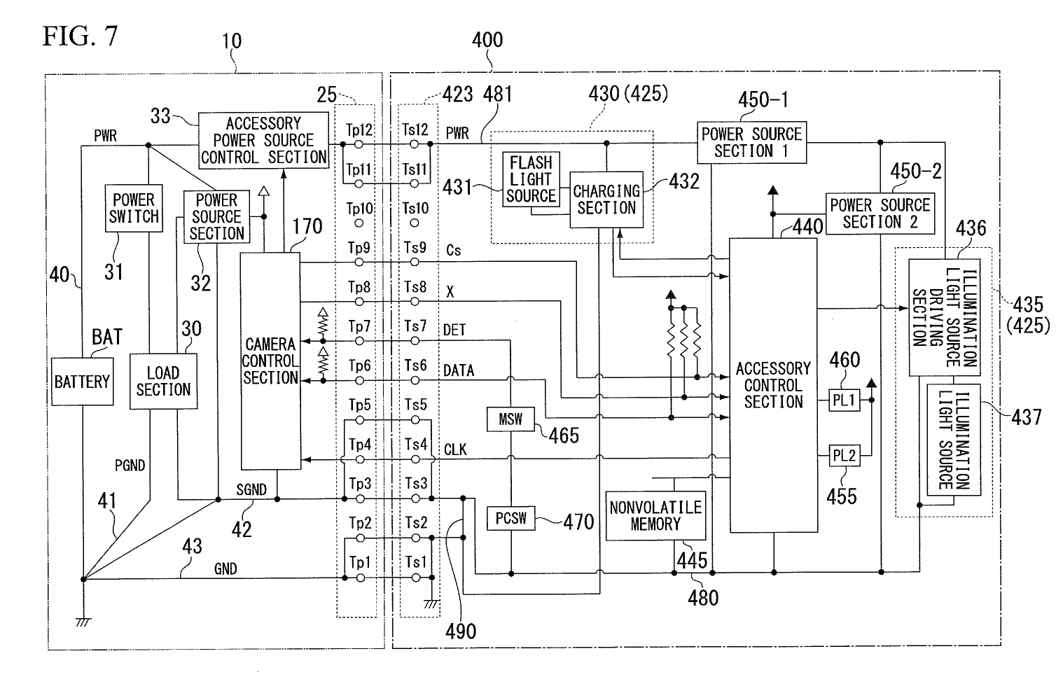

FIG. 7 is a diagram illustrating a configuration of the accessory 400, and a connection relationship between the accessory 400 and the camera 10 (the camera body 100 and the image capture lens 200 mentioned above).

First, the camera 10 will be described. The camera 10 includes a load section 30, a power switch 31, a power source section 32, and an accessory power source control section 33.

The load section 30 includes a load section of the camera body 100 such as the shutter driving section 130 or the display section 102 mentioned above, and a load section arranged outside the camera body 100 such as the optical system driving section 220 or the optical system control section 230. The load section 30 includes a heavy load section of which the power consumption is high, and a light load section of which the power consumption is relatively lower than the heavy load section. The heavy load section includes a load section having an actuator such as, for example, the optical system driving section 220 or the shutter driving section 130 in the camera body 100. The light load section includes the optical system control section 230, the image processing section 171, each control circuit, the display section and the like.

The power switch 31 is a switch for cutting off a supply of power from the battery BAT to the heavy load section of the load section 30.

The power source section 32 stabilizes an output voltage of the battery BAT and supplies the stabilized output voltage to the light load section of the load section 30 and the camera control section 170. The power source section 32 includes a voltage detection sensor that detects an output voltage of the battery BAT, and a constant voltage circuit that stabilizes the output voltage of the battery BAT.

The accessory power source control section 33 includes a first terminal, a second terminal, and a control terminal. The accessory power source control section 33 is a switch for switching between conduction states of the first terminal and the second terminal in response to a control signal input to the control terminal. In the description of the present embodiment, a state of a switch in which its terminals are electrically connected to become conducting is called “a circuit is closed”, and a state in which the terminals are electrically disconnected to become non-conducting is called “a circuit is opened”.

The terminal section 25 of the camera body 100 is electrically connectable to the terminal section 423 of the accessory 400. The terminal section 25 includes a plurality of terminals Tp1 to Tp12 (see FIG. 4). In the description of the present embodiment, each of the terminals of the terminal section 25 of the shoe seat 15 is assigned the number indicating an arrangement order of the terminals, and may be distinguished from each other. This number is the number ascending from one side (+X side) in the array direction (X-axis direction) of the terminals toward the other side (−X side). For example, among the terminals of the terminal section 25, the terminal disposed farthest on the +X side is the first terminal, and the terminal disposed farthest on the −X side is the twelfth terminal.

As shown in FIGS. 4 and 7, each of the terminals in the terminal section 25 of the camera body 100 is assigned as explained below.

In the terminal section 25, the eleventh terminal (i.e., the power terminal Tp11) and the twelfth terminal (i.e., the power terminal Tp12) are terminals that supply power PWR of the battery BAT arranged within the camera body 100 to the accessory 400. In addition, the power terminal may be configured such that only any one of the power terminal Tp11 and the power terminal Tp12 is provided.

The first terminal (i.e., the ground terminal Tp1) and the second terminal (i.e., the ground terminal Tp2) are ground terminals corresponding to the power terminal Tp11 and the power terminal Tp12. The ground terminal Tp1 and the ground terminal Tp2 are terminals of which a potential serves as a reference potential of the power PWR. In addition, the ground terminal Tp1 and the ground terminal Tp2 are ground terminals for the circuit (heavy load section of the load section 30) within the camera body 100 in which the power PWR is used.

The third terminal (i.e., the reference potential terminal Tp3) and a fifth terminal (i.e., the reference potential terminal Tp5) are terminals (reference potential terminal, that is, terminals serving as a reference potential for performing transmission and reception of a signal) of which a potential serves as a reference potential SGND (signal ground). In addition, the reference potential terminal Tp3 and the reference potential terminal Tp5 are ground terminals for the circuits (camera control section 170, power source section 32, and light load section of the load section 30) within the camera body 100.

The fourth terminal (i.e., the synchronous signal terminal Tp4) is a terminal at which a synchronous signal (clock signal) CLK which is a communication clock signal generated in the accessory 400 is input from the accessory 400.

The sixth terminal (i.e., the communication signal terminal Tp6) is a terminal for outputting a communication signal DATA including data in the camera (including various types of commands) to the accessory 400, and is also a terminal at which the communication signal DATA including various types of information items in the accessory 400 (specific information, setting information and the like of the accessory 400) are input from the accessory 400.

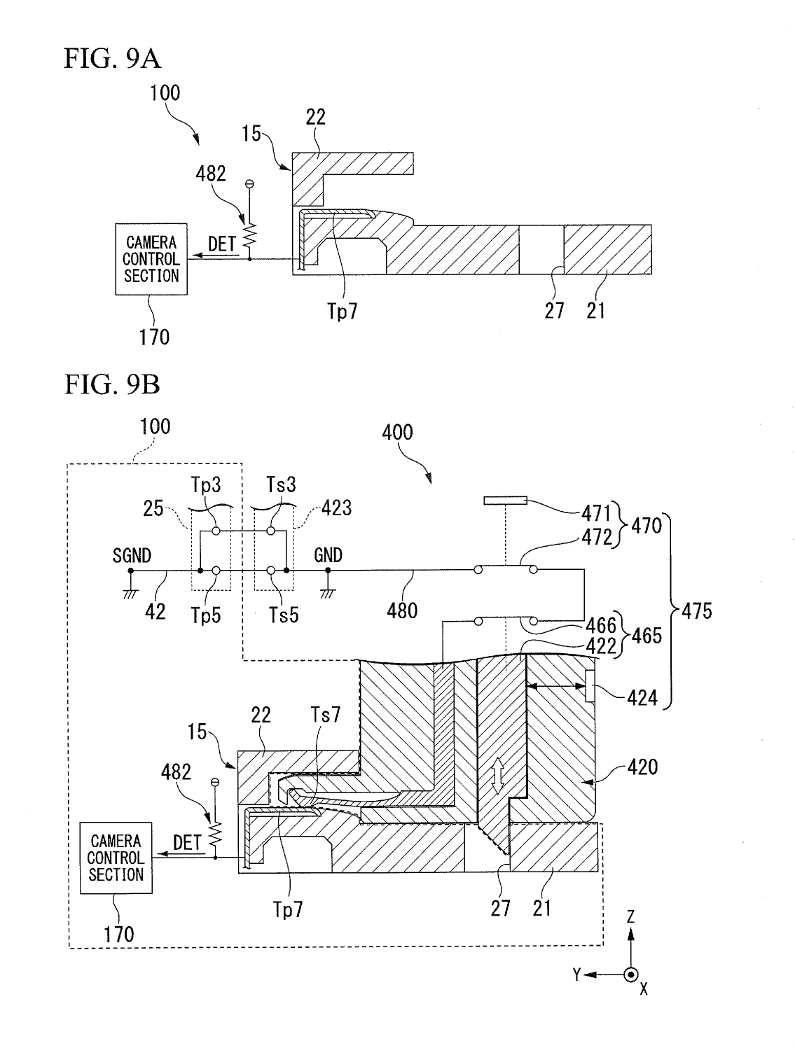

The seventh terminal (i.e., the startup state detecting terminal Tp7) is a terminal for the camera control section 170 to detect whether the accessory 400 provides a startup detection level (electrical L level) DET indicating a state where the connector 420 is mounted on the shoe seat 15 and an accessory startup state (in other words, indicating a startup state (function enabling state) in which the accessory 400 starts up and is enabled to function). This will be explained in detail later with reference to FIGS. 9A and 9B.

The eighth terminal (i.e., the emission control signal terminal Tp8) is a terminal for outputting an emission control (emission command) signal X controlling at least one emission of the flash light emitting section 430 and the illumination light emitting section 435 of the accessory 400 to the accessory 400. In plain words, the emission control (emission command) signal X is a control command for instructing the flash light emitting section 430 or the illumination light emitting section 435 to perform an emission start.

The ninth terminal (i.e., the communication control signal terminal Tp9) is a terminal for outputting a communication control (communication start) signal Cs from the camera 10 to the accessory 400 when communication starts from the camera 10 to the accessory 400. The communication control signal Cs is a signal for determining the communication start timing of DATA communication between the camera 10 and the accessory 400 through the above-mentioned communication signal terminal Tp6.

The tenth terminal (i.e., the open terminal Tp10) is a terminal to which neither the power nor the signal is supplied, and is a so-called open terminal. This open terminal Tp10 is a terminal preliminarily provided for a future function expansion of the system.

Among the terminals of the terminal section 25, the power terminal Tp11 and the power terminal Tp12 are arranged on one side (−X side) in the array direction (X-axis direction). In other words, the power terminal Tp11 and the power terminal Tp12 are arranged side by side on one end in the arrangement of the twelve terminals of the terminal section 25. Among the terminals of the terminal section 25, the ground terminal Tp1 and ground terminal Tp2 are arranged on the other side (+X side) in the array direction (X-axis direction). In other words, the ground terminal Tp1 and the ground terminal Tp2 are arranged side by side on the other end (end on the side opposite to the arrangement side of the power terminal Tp11 and the power terminal Tp12) in the arrangement of the twelve terminals of the terminal section 25. In other words, the ground terminal Tp1 and the ground terminal Tp2 are arranged at positions which are farther (relatively distant position) from the power terminals Tp11 and Tp12 than the communication system terminals Tp3 to Tp9. Furthermore, the communication system terminals Tp3 to Tp9 are, in other words, arranged at the other side (+X-side) which is an opposite side against the one side (−X-side) with respect to the power terminals Tp11 and Tp12.

In addition, among the twelve terminals of the terminal section 25, the terminals (communication signal terminal Tp6, emission control signal terminal Tp8, and communication control signal terminal Tp9) for outputting the control signal to the accessory 400, the terminal (synchronous signal terminal Tp4) to which the control signal is input from the accessory 400, and the terminal (startup state detecting terminal Tp7) for discriminating whether to be in a state where the accessory 400 is enabled to function, are sandwiched between the power terminal Tp11 and the ground terminal Tp2.

In the arrangement of twelve terminals of the terminal section 25, the open terminal Tp10 is arranged between the power terminal Tp11 and the communication control signal terminal Tp9. This location of the open terminal Tp10 allows the terminals (Tp4, Tp6, Tp8, and Tp9) used in a signal communication system or the startup state detecting terminal Tp7 for detecting a startup state of the accessory 400 to be separated apart from the power terminals Tp11 and Tp12.

In addition, in the above-mentioned terminal arrangement, the emission control signal terminal Tp8 is arranged next to the communication control signal terminal Tp9 on the side opposite to the open terminal Tp10. The startup state detecting terminal Tp7 is arranged next to the emission control signal terminal Tp8 on the side opposite to the communication control signal terminal Tp9.

That is, the emission control signal terminal Tp8 is sandwiched between the startup state detecting terminal Tp7 and the communication control signal terminal Tp9.

In addition, in the above-mentioned terminal arrangement, the communication signal terminal Tp6 is arranged next to the startup state detecting terminal Tp7 on the side opposite to the emission control signal terminal Tp8. That is, the startup state detecting terminal Tp7 is sandwiched between the communication signal terminal Tp6 and the emission control signal terminal Tp8.

The reference potential terminal Tp5 is arranged next to the communication signal terminal Tp6 on the side opposite to the startup state detecting terminal Tp7. That is, the communication signal terminal Tp6 is sandwiched between the reference potential terminal Tp5 and the startup state detecting terminal Tp7.

In the above-mentioned terminal arrangement, the synchronous signal terminal Tp4 is arranged next to the reference potential terminal Tp5 on the side opposite to the communication signal terminal Tp6. One more reference potential terminal Tp3 is arranged next to the synchronous signal terminal Tp4 on the side opposite to the reference potential terminal Tp5. That is, the synchronous signal terminal Tp4 is sandwiched between two reference potential terminals (Tp3 and Tp5).

The ground terminal Tp2 is arranged next to the reference potential terminal Tp3 on the side opposite to the synchronous signal terminal Tp4. That is, three terminals (reference potential terminal Tp3 and two ground terminals Tp1 and Tp2) having a GND relationship are disposed biased in the vicinity of one end of the terminal arrangement.

In addition, detailed descriptions of the signal input to each of the terminals of the terminal section 25 and the signal output by each of the terminals will be described later.

The camera control section 170 supplies the control signal for controlling the accessory 400 in communication with the accessory 400 through the terminal section 25 and the terminal section 423 to the accessory 400. In the present embodiment, the control signals supplied to the accessory 400 by the camera control section 170 are the emission control signal X for controlling the emission of the light-emitting section 425 in the accessory 400, the communication signal DATA, and the communication control signal Cs for determining the communication timing between the camera 10 and the accessory 400.

The camera control section 170 reads out information stored in at least one of the nonvolatile memory 160 and the buffer memory 165 shown in FIG. 6, and transmits the readout information to the accessory control section 440. The camera control section 170 stores information received from the accessory control section 440 in at least one of the nonvolatile memory 160 and the buffer memory 165.

The information stored in the nonvolatile memory 160 includes camera initial state information indicating an initial state of the camera 10, and camera setting state information indicating a setting state of the camera 10. The camera control section 170 can transmit at least one information item of various types of information items included in the camera initial state information or the camera setting state information to the accessory control section 440.

The camera initial state information includes information indicating a type of the camera 10, information indicating a type of the function included in the camera 10, information indicating the characteristics of each function included in the camera 10, and the like. The information indicating a type of the function included in the camera 10 is, for example, information indicating whether to perform an AE (Automatic Exposure) control, information indicating whether to perform an AWB (Auto White Balance) control, and the like. The camera setting state information is setting information indicating whether to cause each function included in the camera 10 to function, information indicating an image capture mode of the camera 10, and the like. The information indicating an image capture mode is, for example, information indicating whether the camera 10 is set to a still image capture mode for capturing an image as a moving image, information indicating whether the camera 10 is set to the still image capture mode for capturing an image as a still image, and the like. The information indicating whether the camera 10 is set to an image capture mode for capturing an image as a still image is, for example, information indicating whether the camera is set to a mode for performing any of single shooting and continuous shooting. The mode for performing single shooting is, for example, an image capture mode for capturing one image whenever the release button 16 is held down. The mode for performing continuous shooting is an image capture mode for capturing a plurality of images while the release button 16 is being held down.

Next, the connection relationship between each of the components in the camera 10 will be described with reference to FIG. 7. The battery BAT is assumed to be housed in the battery compartment 110. A positive electrode of the battery BAT is connected to one end of the power switch 31 through a power source line 40 (PWR).

The other end of the power switch 31 is connected to a power terminal of the heavy load section of the load section 30. A ground terminal of the heavy load section of the load section 30 is connected to a negative electrode of the battery BAT in the battery compartment 110 through a grounding line 41 (PGND).

The positive electrode of the battery BAT is connected to an input terminal of the power source section 32 through the power source line 40. A first output terminal of the power source section 32 is connected to a power terminal of the light load section of the load section 30. A ground terminal of the light load section of the load section 30 is connected to the negative electrode of the battery BAT through a grounding line 42 (SGND). In addition, a second output terminal of the power source section 32 is connected to a power terminal of the camera control section 170. A potential of the second output terminal is different from a potential of the first output terminal. A ground terminal of the camera control section 170 is connected to the negative electrode of the battery BAT through the grounding line 42 (SGND).

The ground terminal Tp1 is connected to the negative electrode of the battery BAT through a grounding line 43 (GND). The ground terminal Tp2 is connected to the negative electrode of the battery BAT through the grounding line 43 in parallel with the ground terminal Tp1. The reference potential terminal Tp3 is connected to the negative electrode of the battery BAT through the grounding line 42. The reference potential terminal Tp5 is connected to the negative electrode of the battery BAT through the grounding line 42 in parallel with the reference potential terminal Tp3. In addition, the ground of the camera 10 in the present embodiment adopts a so-called single point ground (single point earth).

The synchronous signal terminal Tp4, the communication signal terminal Tp6, the startup state detecting terminal Tp7, the emission control signal terminal Tp8, and the communication control signal terminal Tp9 are respectively connected to the camera control section 170 through a signal line. The open terminal Tp10 is insulated from other circuits such as the camera control section 170, the power source line 40, the grounding line 41, the grounding line 42, and the grounding line 43.

A pull-up resistor is arranged on the line connected to the communication signal terminal Tp6. This pull-up resistor is electrically connected to the output side of the power source section 32. For this reason, the potential (level) in the communication signal terminal Tp6 is maintained to an H level before the mounting of the accessory 400 and before the start of communication with the accessory 400. In addition, a pull-up resistor is arranged on the line connected to the startup state detecting terminal Tp7 similarly to the above-mentioned communication signal terminal Tp6. This will be described later with reference to FIGS. 9A and 9B.

The power terminal Tp11 is connected to a first terminal of the accessory power source control section 33. The power terminal Tp12 is connected to the first terminal of the accessory power source control section 33 in parallel with the power terminal Tp11. A second terminal of the accessory power source control section 33 is connected to the positive electrode of the battery BAT through the power source line 40. The accessory power source control section 33 can block a supply of power from the battery BAT to the power terminal Tp11 and the power terminal Tp12 by a control signal which is input from the camera control section 170 to a control terminal thereof.

Next, the configuration of the accessory 400 will be described with reference to FIG. 7. The accessory 400 of the present embodiment is operated by the power PWR supplied from the camera 10. When the power source that supplies power consumed in the accessory 400 is not mounted on the accessory 400, the accessory 400 causes each of the components of the accessory 400 to function by the power PWR supplied from the camera 10.

The accessory 400 includes the flash light emitting section 430, the illumination light emitting section 435, the accessory control section 440, a nonvolatile memory 445, a first power source section (power source section 1) 450-1, a second power source section (power source section 2) 450-2, the second pilot lamp 460, the first pilot lamp 455, a first switch section 465, and a second switch section 470. The accessory 400 cannot have a battery built-in.

The flash light emitting section 430 includes a flash light source 431 and a charging section 432. The flash light source 431 includes a known flash illumination light source such as a xenon tube.

The charging section 432 includes a booster circuit section (also referred to as a booster section) which boosts a voltage supplied from the camera body 100, and an accumulation circuit section (accumulation section/condenser/or capacitor) which is able to accumulate power necessary for causing the flash light source 431 to emit light based on the voltage boosted in the booster circuit section. The charging section 432 causes the flash light source 431 to emit light by supplying the power accumulated in the accumulation section (accumulation circuit section) to the flash light source 431.

The charging section 432 starts or stops charging of the charging section 432 to the accumulation section in accordance with a signal supplied from the accessory control section 440. The charging section 432 can detect the amount of charging (the amount of electric accumulation or the amount of charge) accumulated by the accumulation section, by detecting a voltage (charging voltage) between electrodes of the accumulation section during a charging process of charging the accumulation section. The charging section 432 supplies information indicating the detected amount of charging of the accumulation section to the accessory control section 440.

In addition, the charging section 432 includes a known light emission control circuit (for example, a circuit such as a known IGBT, which controls start and stop of emission). The charging section can cause the flash light source 431 to emit light in synchronization with the image capture timing and control the amount of light emitted of the flash light source 431, in accordance with a signal which is input from the accessory control section 440.

The illumination light emitting section 435 includes an illumination light source driving section 436 and an illumination light source 437. The illumination light source 437 of the present embodiment includes a solid-state light source such as a light-emitting diode (LED) capable of emitting continuous illumination light. The illumination light source driving section 436 causes the illumination light source 437 to emit light by supplying a current to the illumination light source 437. Of course, the illumination light source 437 is intermittently supplied with a current by the illumination light source driving section 436, thereby also allowing not only continuous illumination light but illumination light to be intermittently emitted. The illumination light source driving section 436 causes the illumination light source 437 to emit light in synchronization with the image capture timing by the control of the accessory control section 440. The illumination light source driving section 436 controls the time duration (turn-on time) for which the illumination light source 437 is caused to emit light in accordance with a signal which is input from the accessory control section 440.

In addition, the accessory 400 includes a first conduction switch for switching an electrical conduction state (ON/OFF) with respect to a power source line 481 of the flash light emitting section 430 and a second conduction switch for switching an electrical conduction state (ON/OFF) with respect to the power source line 481 with respect to the illumination light-emitting section 435, which are not shown in the drawings. The first and second conduction switches are controlled by the accessory control section 440. Thus, when the camera system 1 causes the light-emitting section 425 to function to thereby perform an image capture, the accessory 400 can emit light alternatively from the flash light emitting section 430 or the illumination light emitting section 435, or from both light-emitting sections, by the control of the accessory control section 440 over the first and second conduction switches and the flash light emitting section 430 and the illumination light emitting section 435.

In the present embodiment, the maximum amount of light emitted of the flash light emitting section 430 is larger than the maximum amount of light emitted of the illumination light emitting section 435. The flash light emitting section 430 is turned on, for example, at the time of capturing a still image, and can illuminate the subject more brightly than at the time of turn-on of the illumination light emitting section 435. In the present embodiment, the longest turn-on time (longest turn-on time, light-emittable time, and time at which continuous turn-on which is set in advance is permitted) of the illumination light emitting section 435 is longer than the longest turn-on time of the flash light emitting section 430. The illumination light emitting section 435 is turned on, for example, at the time of capturing a moving image, and can illuminate a subject over a longer period of time than the turn-on time of the flash light emitting section 430.

In the present embodiment, light emitted by the flash light emitting section 430 may be referred to as a flash, and a function of the flash light emitting section 430 emitting a flash may be referred to as a flash light emitting function. In addition, light emitted by the illumination light emitting section 435 may be referred to as illumination light, and a function of the illumination light emitting section 435 emitting illumination light may be referred to as an illumination light emitting function.

In the present embodiment, the first pilot lamp 455 (PL2) and the second pilot lamp 460 (PL1), respectively, include a solid-state light source such as an LED. The first pilot lamp 455 is turned on depending on the state of the flash light emitting section 430, by the control of the accessory control section 440. For example, when the flash light emitting section 430 is in a state where it is capable of emitting light (state where the charging to the charge accumulation section is completed), the accessory control section 440 turns on the first pilot lamp 455. In addition, when the flash light emitting section 430 is in a state where it is not capable of emitting light (when the amount of charging of the charge accumulation section is insufficient), the accessory control section 440 turns off the first pilot lamp 455.

The second pilot lamp 460 is turned on or turned off depending on whether the illumination light emitting section 435 is in a state where it is capable of emitting light (the above-mentioned second conduction switch is in an ON state) by the accessory control section 440, similarly to the first pilot lamp 455.

In the present embodiment, the first switch section 465 (MSW) is mechanically associated with the above-mentioned locking claw 422 (see FIG. 4). The first switch section 465 closes or opens a circuit by the movement of the locking claw 422 in a predetermined direction (Z-axis direction). When the tip of the locking claw 422 protrudes by more than a predetermined distance which is previously set from the bottom 421 of the connector 420, the first switch section 465 closes a circuit. That is, when mounting of the accessory 400 on the camera 10 is completed, the first switch section 465 closes the circuit. On the other hand, when the locking claw 422 is thrust by more than a predetermined amount of the movement which is previously set toward the bottom 421 of the connector 420, the first switch section 465 opens the circuit.

In the present embodiment, the second switch section 470 (PCSW) is mechanically coupled to the second operating portion 471 (see FIG. 2). The second switch section 470 closes or opens the circuit depending on the operation of the second operating portion 471.

The first power source section (power source section 1) 450-1 includes a constant voltage circuit for stabilizing a voltage of power (controlling a constant voltage) supplied from the camera 10. The first power source section 450-1 can supply the power of which the voltage is stabilized by the constant voltage circuit to the second power source section (power source section 2) 450-2 and the illumination light emitting section 435. The first power source section 450-1 is connected to a reference potential line 480 (SGND). The second power source section 450-2 generates power for the accessory control section 440 from the power supplied from the first power source section 450-1. The second power source section 450-2 is also connected to the reference potential line 480 (SGND).

The storage section 444 includes the nonvolatile memory 445. The nonvolatile memory 445 can hold information even in a state where the power is not supplied to the accessory 400. The nonvolatile memory 445 includes at least one of a memory which is capable of rewriting stored data and a memory (for example, ROM) which is not capable of rewriting stored data. The nonvolatile memory 445 stores a program for operating the accessory control section 440, or information such as information indicating the states (initial state and various setting states of the accessory presently set in a memory within the accessory control section 440) of the accessory 400 and information indicating the states (initial state and setting state) of the camera acquired from the camera 10.

The accessory control section 440 includes a CPU that controls the operations of the components of the accessory 400 based on a program stored in the nonvolatile memory 445, and electronic parts such as an ASIC. The accessory control section 440 communicates with the camera control section 170 through the terminal section 423 and the terminal section 25. The accessory control section 440 sends accessory initial state information stored in the storage section 444 or at least one information item of various types of information items included in accessory setting state information to the camera control section 170. In addition, the accessory control section 440 stores information received from the camera control section 170 in the storage section 444.

The accessory initial state information includes accessory type information indicating a type of the accessory 400. The accessory type information includes battery presence or absence information indicating whether a battery is set in the accessory 400, function type information indicating a type of each function included in the accessory 400, and characteristics information indicating the characteristics of each function included in the accessory 400. The function type information includes information indicating the presence or absence of a flash light emitting function, information indicating the presence or absence of an illumination light emitting function, and information indicating the presence or absence of extended functions. The extended functions are functions other than the flash light emitting function and the illumination light emitting function, and are, for example, a multi-turn-on commander function, a GPS (Global Positioning System) function, a communication function with devices other than the camera body 100, and the like. The characteristics information of the flash light emitting function includes information (profile information) indicating the emission characteristics of the flash light emitting section 430. The characteristics information of the illumination light emitting function includes information (illumination profile information) indicating the emission characteristics of the illumination light emitting section 435 (LED for image capture illumination), and information indicating the longest time (that is, the above-mentioned longest turn-on time) for which the illumination light emitting section 435 is capable of continuously emitting light.

The accessory setting state information includes information indicating whether the flash light emitting function is in an on-state (effective) or in an off-state (ineffective), and information indicating whether the illumination light emitting function is in an on-state (effective) or in an off-state (ineffective).

The accessory control section 440 controls the components of the accessory 400 based on the control signal supplied from the camera control section 170. The accessory control section 440 performs a light emission control for causing the flash light emitting section 430 or the illumination light emitting section 435 to emit light, in accordance with the emission control signal X supplied from the camera control section 170. In the light emission control for causing the flash light emitting section 430 to emit light, the accessory control section 440 controls the charging section 432 so that the flash light source 431 emits light in synchronization with the image capture timing of the camera. In the light emission control for causing the illumination light emitting section 435 to emit light, the accessory control section 440 controls the illumination light source driving section 436 so that the illumination light source 437 emits light in synchronization with the image capture timing.

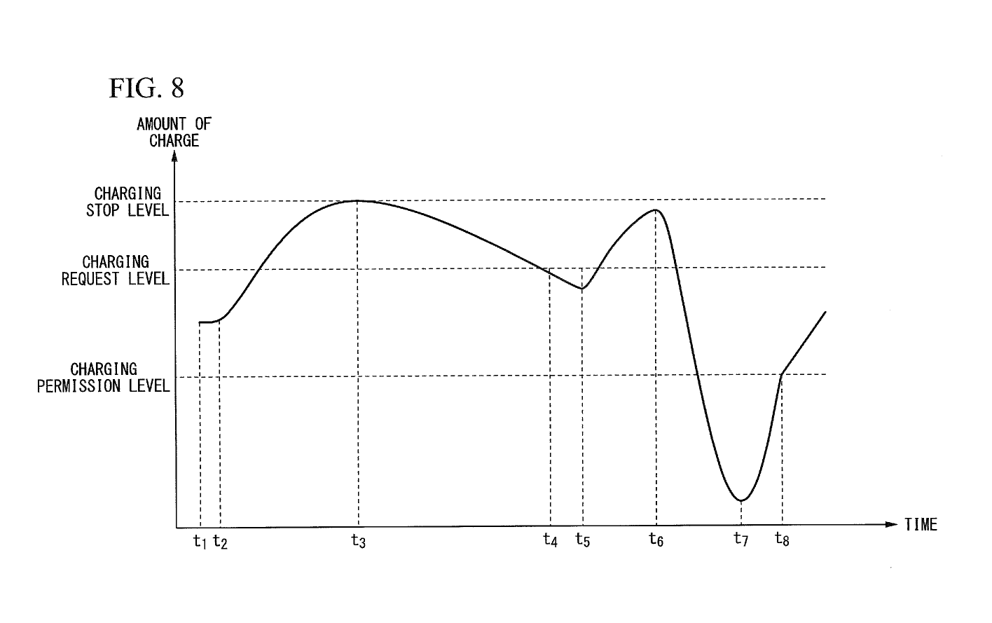

A method of controlling the charging section 432 by the accessory control section 440 is described below in detail while referring to FIG. 8.

FIG. 8 is a diagram illustrating a timing of performing each process in a charging control. The accessory 400 of the present embodiment is not equipped with a power source (battery) for charging the accumulation section (charge accumulation section) of the charging section 432. That is, the accessory 400 receives power from the camera 10. When a command instructing the charging start to the accumulation section (charge accumulation section) (hereinafter, called the “charging command”) is received from the camera control section 170, the accessory control section 440 causes the charging section 432 to start charging to the accumulation section (charge accumulation section).

There are two main types of the charging operations performed under the control of the accessory control section 440 by the charging section 432. One type is called a “monitor charging operation”. The charging section 432 can detect the amount of charging (charging voltage) in the accumulation section during the charging of the accumulation section (charge accumulation section). However, the charging section 432 cannot detect the amount of charging of the accumulation section at a desired point in time except for the above-mentioned charging to the accumulation section (charge accumulation section). Consequently, the accessory control section 440 performs the “monitor charging operation” as a special charging operation for detecting the amount of charging of the accumulation section at a desired point in time. The accessory control section 440 stops the monitor charging in the lapse of a predetermined time period after the monitor charging is started. The charging time of this monitor charging is very short, for example, approximately 10 ms.

One more charging operation is a main charging operation (hereinafter, called the “main charging”) performed for securing the amount of charging necessary for causing the flash light source 431 to emit light. Normally, the charging time of the main charging operation is much longer than the charging time of the monitor charging operation. In other words, normally, the amount of charge accumulating in the accumulation section (charge accumulation section) at the time of the main charging operation is much larger than the charge at the time of the monitor charging operation. During the main charging, the charging section 432 detects the amount of charging (charging voltage) of the accumulation section (charge accumulation section), and supplies information indicating the amount of charging thereof to the accessory control section 440. When the amount of charging does not reach a predetermined amount (charging stop level described later) shown in FIG. 8, the accessory control section 440 controls the charging section 432 so as to continue the charging operation until the amount of charging reaches the predetermined amount (charging stop level). The charging operation of the accessory control section 440 is continued until the amount of charging reaches the predetermined amount (charging stop level), as long as a charging stop command for forcibly stopping the charging operation is not transmitted from the camera control section 170 to the accessory control section 440.

However, in the present embodiment, if the “charging command” is not received from the camera control section 170, the accessory control section 440 is configured to cause the charging section 432 not to start the charging operations (the monitor charging operation and the main charging operation) for the accumulation section (charge accumulation section). For this reason, the accessory control section 440 submits a request for transmission of the “charging command” (hereinafter, called the “charging request”) to the camera control section 170. There are a “monitor charging request” of a case where a command of the above-mentioned monitor charging is requested from the camera 10 and a main charging request of a case where a command of the above-mentioned main charging is requested from the camera 10, in the charging requests (in the present embodiment, these two types of charging requests are collectively called the “charging request”). The “monitor charging request” is transmitted from the accessory control section 440 to the camera control section 170 in an initial communication sequence (details thereof will be described later) performed between the camera control section 170 and the accessory control section 440, or a steady communication sequence (details thereof will be described later) performed regularly (periodically) between both. On the other hand, the “main charging request” is output from the accessory control section 440 in the case where the amount of charging falls below the “charging request level” shown in FIG. 8 as a result of the above-mentioned monitor charging, or in the steady communication sequence performed immediately after the emission operation.

The accessory control section 440 is configured to charge the accumulation section (charge accumulation section) of the charging section 432 by receiving each “charging command” output from the camera control section 170 in accordance with each “charging request” from the accessory 400.

Herein, a general charging sequence will be described with reference to FIG. 8. When the charging section 432 is not in the charging operation (in the initial communication sequence or in the steady communication sequence), the accessory control section 440 sends the “monitor charging request” to the camera control section 170. The accessory control section 440 causes the charging section 432 to start the monitor charging in accordance with the “monitor charging command” which is output from the camera control section 170 in accordance with the “monitor charging request” (time t1 in FIG. 8). The accessory control section 440 acquires information indicating the amount of charging detected during the monitor charging by the charging section 432 (hereinafter, called the “charging amount of the monitor”) from the charging section 432. The accessory control section 440 stops the monitor charging when a predetermined time (for example, 10 ms) has lapsed after the monitor charging is started.

The accessory control section 440 performs a determination regarding the charging state of the charging section 432 based on information indicating the amount of charging (the amount of charging of the monitor or the main amount of charging) detected by the charging section 432. The accessory control section 440 determines whether the amount of charging is equal to or more than the amount of charging (“emission permission level” in FIG. 8) minimally necessary for causing the flash light source 431 to emit light. When the amount of charging of the monitor is determined to be equal to or more than the emission permission level, the accessory control section 440 determines that the flash light emitting section 430 is in a state in which it is capable of emitting light (hereinafter, called the “ready state”). When the amount of charging of the monitor is determined to be less than the emission permission level, the accessory control section 440 determines that the flash light emitting section 430 is in a state where it is not capable of emitting light. The accessory control section 440 stores emission possibility information indicating whether the flash light emitting section 430 is in the “ready state” in the nonvolatile memory 445 as one item of “charging state information” (details thereof will be described later) indicating the charging state of the charging section 432.

In addition, the accessory control section 440 determines whether the amount of charging is equal to or more than a predetermined threshold (“charging request level” in FIG. 8), based on information indicating the amount of charging (the amount of charging of the monitor or the main amount of charge) detected by the charging section 432. The “charging request level” is set to a level higher than the “emission permission level”.

When the amount of charging of the monitor is determined to be less than the charging request level, the accessory control section 440 outputs the main charging request to the camera control section 170 in order to receive a command for starting the main charging (hereinafter, called the main charging command) from the camera 10. The accessory control section 440 starts the main charging in accordance with the main charging command from the camera control section 170 based on the main charging request (time t2 in FIG. 8). In addition, when the flash light emitting function is set so as to be stopped, the accessory control section 440 does not output the main charging request to the camera control section 170 even when the amount of charging of the monitor is determined to be smaller than the charging request level.

In addition, the accessory control section 440 determines whether the main amount of charging is equal to or more than a threshold (“charging stop level” in FIG. 8) which is previously set, based on information indicating the main amount of charging detected during the main charging by the charging section 432. The “charging stop level” is previously set in accordance with the maximum value of the amount of electric accumulation capable of being accumulated in the accumulation section (charge accumulation section), and is set to be higher than the above-mentioned “charging request level”. When the main amount of charging is determined to be equal to or more than a charging completion level, the accessory control section 440 controls the charging section 432 to stop the main charging of the accumulation section (charge accumulation section), regardless of the control of the camera control section 170 (time t3 in FIG. 8).

In addition, when a command for requesting a stop of charging of the charging section 432 to the accumulation section (charge accumulation section) (hereinafter, called the “charging stop command”) is received from the camera control section 170, the accessory control section 440 causes the charging section 432 to stop charging the accumulation section (charge accumulation section) in accordance with the “charging stop command”, even though the main amount of charging is less than the charging stop level.

In this manner, in the camera system of the accessory 400 and the camera 10 according to the present embodiment, the camera 10 outputs a charging command in accordance with the “charging request” from the accessory 400, and the accessory 400 performs the charging using power received from the camera 10 by receiving the command. In this manner, when the charging is performed at the accessory 400, a system is configured to necessarily ask the camera 10 for a request (charging permission) in order to obtain permission (control command of the charging). For this reason, for example, when a heavy load operation (for example, lens driving operation or the like) is performed at the camera 10, it is possible to suppress concern to cause harm (stop of the operation on the camera, or the like) in the operation on the camera 10 by causing excessive power consumption in the entirety of the system due to arbitrary execution of the main charging operation on the accessory 400. In addition, since the camera 10 (camera control section 170) may wait for a charging request from the accessory 400 without performing a process of checking the amount of charge accumulated of the accumulation section on the accessory 400, a process burden of the camera control section 170 can be reduced. In addition, even in the accessory 400 (accessory control section 440), the camera 10 does not check whether to be in a chargeable state (whether to be in a heavy load operation), and the “charging request” may be just made in accordance with only the remaining amount of charge accumulated of the accumulation section (the charging execution timing is determined in the camera 10). Therefore, it is not necessary to make the charging request while the load state on the camera 10 is checked, and thus a process burden of the accessory control section 440 can be reduced in this point.

However, the amount of charging of the accumulation section (charge accumulation section) decreases with time due to leakage or the like after a stop of the charging (after time t3 in FIG. 8). The accessory control section 440 stops the charging, and then periodically sends the “monitor charging request” to the camera control section 170. The accessory control section 440 then causes the charging section 432 to periodically perform the monitor charging in accordance with the “monitor charging command” which is periodically output from the camera control section 170 in accordance with the periodic “monitor charging request”.

In addition, the accessory control section 440 determines whether the amount of charging of the monitor is less than the charging request level based on information indicating the amount of charging detected during the monitor charging by the charging section 432. When the amount of charging of the monitor is determined to be less than the charging request level, the accessory control section 440 sends the “main charging request” to the camera control section 170 (time t4 in FIG. 8). The accessory control section 440 then causes the charging section 432 to perform the main charging in accordance with the “main charging command” which is output from the camera control section 170 in accordance with the “main charging request” (time t5 in FIG. 8).

In addition, when the flash light emitting section 430 emits light (time t6 in FIG. 8), the amount of charging of the accumulation section (charge accumulation section) may be reduced to less than the emission permission level. Consequently, after the flash light emitting section 430 emits light, the accessory control section 440 sends the “main charging request” to the camera control section 170.

The accessory control section 440 then causes the charging section 432 to perform the main charging in accordance with the “main charging command” which is output from the camera control section 170 in accordance with the “main charging request” after the emission (time t7 in FIG. 8).

In addition, when the amount of charging of the accumulation section (charge accumulation section) is less than the emission permission level as in the case after the emission of the flash light emitting section 430 or the case after the startup of the accessory 400, the accessory control section 440 causes the charging section 432 to perform the charging operation at a first charging rate by the control of the camera control section 170 (time t7 to time t8 in FIG. 8). In addition, when the amount of charging of the accumulation section (charge accumulation section) detected by the charging section 432 is equal to or more than the emission permission level (t8 in FIG. 8), the accessory control section 440 causes the charging section 432 to perform the charging at a second charging rate (by the control of the camera control section 170) (after time t8 in FIG. 8). The second charging rate is previously set to a charging rate slower than the first charging rate. In the present embodiment, the main charging operation performed at the first charging rate may be called a “normal charging”, and the main charging operation performed at the second charging rate may be called a “slow charging”.

In addition, the accessory control section 440 sends the “charging state information” indicating the control state of the control for the charging section 432 to the camera control section 170. The charging state information is a portion of the accessory setting state information stored in the storage section 444.

The charging state information will be described now. The charging state information includes “charging request information” indicating whether the “charging request” is present, “charging lapse information” indicating whether the charging section 432 is being charged at that point in time (presently), “chargeability information” indicating whether the charging section 432 is capable of being charged, and “emission possibility information” indicating whether the flash light emitting section 430 is in a state in which it is capable of emitting light (the ready state).

The “chargeability information” will be described now. Even when the charging command is received from the camera 10, the charging operation may not be performed depending on the state of the accessory 400. For example, when the temperature of the flash light emitting section 430 rises due to generation of heat by the emission of the flash light emitting section 430 on the accessory 400, the accessory control section 440 may prohibit the charging operation in order to suppress a further rise in temperature due to the emission operation. Alternatively, when a circuit section such as a booster circuit within the charging section 432 generates heat and exceeds a specified temperature, the accessory control section 440 may prohibit the charging operation. Alternatively, when the charging operation of the charging section 432 cannot be terminated within a specified time and the charging process is timed out, the accessory control section 440 may determine that a defect is generated in the charging section 432 and prohibit the charging operation. In the manner, when the accessory control section 440 determines prohibition of the charging operation, information indicating “charging-disabled (prohibition)” is set to “chargeability information”, and on the other hand, when the charging operation is prohibited, information indicating “charging-enabled” is set to “chargeability information”. The accessory control section 440 transmits the above-mentioned information to the camera control section 170. In addition, the charging request information, the charging lapse information, and the emission possibility information are already described above.

Next, the terminal section 423 of the accessory 400 will be described. As shown in FIGS. 5 and 7, when the accessory 400 is mounted on the camera 10, the terminal section 423 is electrically connected to the terminal section 25 of the camera 10. The terminal section 423 includes a plurality of (twelve) terminals indicated by signs Ts1 to sign Ts12. Herein, the number indicating the arrangement order of the terminals described next is the number ascending from one side (+X side) in the array direction (X-axis direction) of the terminals toward the other side (−X side).

In addition, the terminals Ts1 to Ts12, respectively, include a linear (line-shaped) portion extending in the direction substantially parallel to (+Y direction) the direction of the mounting in the camera (see FIG. 5). The contact portion formed in the vicinity (+Y direction side) of the tip of the line shape (portion which comes into contact with the terminal Tp7 in FIG. 9B) is formed so as to be physically in contact with each of the corresponding terminals (Tp1 to Tp12) on the camera side and electrically connected thereto (see a contact structure between the terminal Ts7 and the terminal Tp7 shown in FIG. 9B). These terminals Ts1 to Ts12, respectively, are formed in a flat spring structure in which the contact portion formed in the vicinity of the tip is biased in the −Z direction (direction pressed against each of the corresponding contacts on the camera side) of the drawing.

The function assigned to each of the terminals in the terminal section 423 are explained below. Each of the terminals Ts1 to Ts12 of the terminal section 423 is provided corresponding to each of the terminals (Tp1 to Tp12) of the terminal section 25 on the camera 10 side described in FIGS. 3 and 4. The function of each of the terminals in the terminal section 423 is also associated with the function of each of the terminals in the terminal section 25. For this reason, in the description of the present embodiment, in order to avoid repeating the description mentioned above with respect to the terminal section 25, the terminal numbers 1 to 12 of each of the terminals are assigned the same numbers as the terminal numbers of the terminals corresponding to each of the terminals in the terminal section 25 on the camera side, and thus a repeated description regarding the function or the arrangement of each of the terminals will be simplified or omitted.

In the terminal section 423, a power terminal Ts11 and a power terminal Ts12, respectively, are terminals supplied with the power PWR from the camera 10. A ground terminal Ts1 and a ground terminal Ts2 are ground terminals corresponding to the power terminal Ts11 and the power terminal Ts12, and are terminals of which the potential serves as a reference potential (ground) of the power PWR.

A reference potential terminal Ts3 and a reference potential terminal Ts5 are respectively terminals of which the potential serves as a reference potential (ground signal) for performing transmission and reception of a signal.

A synchronous signal terminal Ts4 is a terminal for outputting a synchronous signal (clock signal) CLK which is a communication clock signal to the camera 10.

A communication signal terminal Ts6 is a terminal for inputting the communication signal DATA including communication data on the camera side as explained above from the camera 10 side, or outputting the communication signal DATA on the accessory side to the camera 10.

A startup state providing terminal Ts7 is a terminal for providing the startup detection level DET (reference potential based on L level/SGND) to the camera 10.

An emission control signal terminal Ts8 is a terminal to which the emission control signal (emission command signal) X is input from the camera 10.

A communication control signal terminal Ts9 is a terminal to which the communication control signal (communication startup signal) Cs is input from the camera 10.

An open terminal Ts10 is arranged between the power terminal Ts11 and the communication control signal terminal Ts9.

The arrangement of each of the terminals regarding these twelve terminals Ts1 to Ts12 corresponds to each of the terminals Tp1 to Tp12 of the terminal section 25, respectively, and therefore will be described only briefly.

The power terminal Ts11 and the power terminal Ts12 are arranged against one end in the terminal arrangement of the terminal section 423. The ground terminal Ts1 and the ground terminal Ts2 are arranged against the other end (end on the side opposite to the arrangement side of the power terminal Ts11 and the power terminal Ts12) in the terminal arrangement of the terminal section 423. In other words, the ground terminal Ts1 and the ground terminal Ts2 are arranged at positions which are farther (relatively distant position) from the power terminals Ts11 and Ts12 than the communication system terminals Ts3 to Ts9 (including the signal input terminals Ts6, Ts8 and Ts9 which inputs the above-mentioned various signals).

The open terminal Ts10 is arranged between the power terminal Ts11 and the communication control signal terminal Ts9 in the terminal arrangement of the terminal section 423.

The emission control signal terminal Ts8 is arranged next to the startup state providing terminal Ts7, and is sandwiched between the startup state providing terminal Ts7 and the communication control signal terminal Ts9.

The communication signal terminal Ts6 is arranged next to the startup state providing terminal Ts7. Thus, the startup state providing terminal Ts7 is sandwiched between the communication signal terminal Ts6 and the emission control signal terminal Ts8.

The reference potential terminal Ts5 is arranged next to the communication signal terminal Ts6. Thus, the communication signal terminal Ts6 is sandwiched between the reference potential terminal Ts5 and the startup state providing terminal Ts7.

The synchronous signal terminal Ts4 is arranged next to the reference potential terminal Ts5. In addition, the reference potential terminal Ts3 is arranged next to the synchronous signal terminal Ts4. Thus, the synchronous signal terminal Ts4 is sandwiched between the reference potential terminal Ts3 and the reference potential terminal Ts5. The ground terminal Ts2 is arranged next to the reference potential terminal Ts3 on the side opposite to the synchronous signal terminal Ts4. As stated previously, the power terminal Ts11 and the power terminal Ts12 are arranged on one side of the terminal arrangements of the terminal section 423, and the communication system terminals Tp3 to Tp9 (including the signal input terminals Ts6, Ts8 and Ts9 which inputs the above-mentioned various signals) are, in other words, arranged at the other side which is an opposite side against the one side with respect to the power terminals Ts11 and Ts12.

Next, the connection relationship of each of the components in the accessory 400 will be described with reference to FIG. 7.

The ground terminal Ts1 and the ground terminal Ts2 are connected to each other through a connection pattern shown in FIG. 7. When the accessory 400 is mounted on the camera 10, the ground terminal Ts1 and the ground terminal Ts2 are connected to the grounding line 43 of the camera 10 through the terminals Tp1 and Tp2 of the camera 10. The ground terminal Ts1 and the ground terminal Ts2 are ground terminals for the circuit (charging section 432) on the accessory 400 in which the power PWR is used, terminals serving as a reference potential of a supplied voltage in the accessory 400, and terminals serving as a reference potential of a charging voltage.

The power terminal Ts11 is connected to the power source line 481. The power terminal Ts12 is connected to the power source line 481 in parallel with the power terminal Ts11. The power source line 481 is formed as a relatively thick wiring pattern (wiring pattern having a line width equal to or more than a line width obtained by adding a line width of a wiring pattern directly connected to Ts11 and a line width of a wiring pattern directly connected to Ts12 together) on a circuit substrate so as to cause a large current supplied from the camera 10 to flow through two power terminals (power terminals Ts11 and Ts12). In addition, a wiring pattern connected to the accessory power source control section 33 of the camera 10 is also formed as a relatively thick wiring pattern, similarly to that of the accessory 400.

The reference potential terminal Ts3 and the reference potential terminal Ts5 are connected to each other through a connection line as shown in FIG. 7. The reference potential terminal Ts3 and the reference potential terminal Ts5 are connected in parallel to the reference potential line 480 (SGND). When the accessory 400 is connected to the camera 10, the reference potential line 480 is connected to the ground line (SGND) 42 of the camera 10 through the reference potential terminals Ts3 and Ts5 and the terminals Tp3 and Tp5 of the camera 10.

The reference potential terminal Ts3 and the reference potential terminal Ts5 are terminals serving as a reference potential for performing transmission and reception of a signal, in each circuit within the accessory 400 (MSW465, PCSW470, the nonvolatile memory 445, the first power source section 450-1, the second power source section 450-2, the accessory control section 440, and the illumination light emitting section 435). In addition, the ground terminal Ts1 and the ground terminal Ts2 are also connected in parallel to the reference potential line 480 (SGND) through a connection line 490. However, the connection line connected to the ground terminal Ts1 and the ground terminal Ts2 (line connected to the connection line 490) has a lower resistance (impedance) than that of the line connected to the connection line 490 and the reference potential terminals Ts3 and Ts5. For this reason, the large current flowing through the charging section 432 does not flow to the SGND line (reference potential terminals Ts3 and Ts5).

In addition, the current flowing through the reference potential line 480 flows to the ground terminals Ts1 and Ts2 through the connection line 490, and the ground terminals Ts1 and Ts2 can be used as a reference of a voltage supplied to each of the above-mentioned circuits within the accessory 400. In addition, as the ground of the accessory 400 of the present embodiment, a so-called single point ground (single point earth) is adopted.

The startup state providing terminal Ts7 is connected to a first terminal of a switch 466 (shown in FIG. 9B) in the first switch section 465 through the signal line. A second terminal of the switch 466 in the first switch section 465 is connected to a first terminal of a switch 472 (shown in FIG. 9B) in the second switch section 470. A second terminal of the switch 472 in the second switch section 470 is connected to the reference potential line 480. In this manner, the second switch section 470 is connected to the signal line which is connected to the startup state providing terminal Ts7 in series with the first switch section 465.

The synchronous signal terminal Ts4 is connected to the accessory control section 440 through the signal line. The communication signal terminal Ts6 is connected to the accessory control section 440 through the signal line. The signal line connected to the communication signal terminal Ts6 is provided with a pull-up resistor. The pull-up resistor is electrically connected to the output side of the second power source section 450-2. For this reason, the potential (level) in the communication signal terminal Ts6 is maintained to an H level (a high level) before the mounting in the camera 10 and before the start of communication with the camera 10.

The communication control signal terminal Ts9 is connected to the accessory control section 440 through the signal line. The signal line connected to the communication control signal terminal Ts9 is provided with a pull-up resistor. The pull-up resistor is electrically connected to the output side of the second power source section 450-2. Thus, the potential (level) in the communication signal terminal Ts6 is maintained to an H level before the mounting in the camera 10 and before the start of communication with the camera 10.

The emission control signal terminal Ts8 is connected to the accessory control section 440 through the signal line. The signal line connected to the emission control signal terminal Ts8 is provided with a pull-up resistor. The pull-up resistor is electrically connected to the output side of the second power source section 450-2. Thus, the potential (level) in the communication signal terminal Ts6 is maintained to an H level before the mounting in the camera 10 and before the start of communication with the camera 10.

The open terminal Ts10 is a so-called open terminal which is not connected to any of the power supply system and the signal system. The open terminal Ts10 is insulated from circuits such as the accessory control section 440, the power source line 481, and the reference potential line 480.

A first electrode for main discharge in the flash light source 431 of the flash light emitting section 430 is connected to the charging section 432. A second electrode for main discharge is connected to the power source line 481. A power terminal of the charging section 432 is connected to the power source line 481. A ground terminal of the charging section 432 is connected to the grounding line which is connected to the ground terminal Ts1.

A power terminal of the illumination light source driving section 436 is connected to the first power source section 450-1. A ground terminal of the illumination light source driving section 436 is connected to the reference potential line 480. A control terminal of the illumination light source driving section 436 is connected to the accessory control section 440 through the signal line.

The illumination light source 437 is configured so that an anode of a solid-state light source is connected to the illumination light source driving section 436, and a cathode of the solid-state light source is connected to the reference potential line 480.

The first pilot lamp 455 and the second pilot lamp 460 are configured so that each one end thereof is electrically connected to the output side of the second power source section (power source section 2) 450-2. The other end of the first pilot lamp (PL2) 455 is connected to the accessory control section 440 through the signal line. The other end of the second pilot lamp (PL1) 460 is connected to the accessory control section 440 through the signal line different from that of the first pilot lamp 455.

An input terminal of the first power source section (power source section 1) 450-1 is connected to the power source line 481. A ground terminal of the first power source section 450-1 is connected to the reference potential line 480. An output terminal of the first power source section 450-1 is connected to an input terminal of the second power source section (power source section 2) 450-2 and the illumination light source driving section 436. An output terminal of the second power source section 450-2 is connected to a power terminal of the accessory control section 440. A ground terminal of the second power source section 450-2 is connected to the reference potential line 480.

Next, the connection relationship between the camera 10 and the accessory 400 will be described. In the state (hereinafter, called the mounted state) where the accessory 400 is mounted on the camera 10, the ground terminal Ts1 is connected to the ground terminal Tp1 of the camera 10, and the ground terminal Ts2 is connected to the ground terminal Tp2 of the camera 10. In the mounted state, a terminal (ground terminal of the charging section 432) connected to the ground terminals Ts1 and Ts2 on the accessory 400 is connected to the negative electrode of the battery BAT by the connection to the grounding line 43 through at least one of a path between the ground terminal Tp1 and the ground terminal Ts1 and a path between the ground terminal Tp2 and the ground terminal Ts2. For this reason, in the mounted state, the potentials of the ground terminals Ts1 and Ts2 and the terminal connected thereto serve as a reference potential based on the potential of the negative electrode of the battery BAT.

In the mounted state, the power terminal Ts11 is connected to the power terminal Tp11 of the camera 10, and the power terminal Ts12 is connected to the power terminal Tp12 of the camera 10. In the mounted state, the accessory power source control section 33 is connected to the power source line 481 through at least one of a path between the power terminal Tp11 and the power terminal Ts11 and a path between the power terminal Tp12 and the power terminal Ts12. For this reason, the accessory power source control section 33 can supply the power PWR, supplied from the battery BAT to the accessory power source control section 33, to each of the circuits or electrical parts within the accessory 400 through the power source line 481, in accordance with the control of the camera control section 170.

In the mounted state, the reference potential terminal Ts3 is connected to the reference potential terminal Tp3 of the camera 10, and the reference potential terminal Ts5 is connected to the reference potential terminal Tp5 of the camera 10. In the mounted state, the potential of the reference potential terminal Ts3 serves as a potential (reference potential) of the reference potential terminal Tp3, and the potential of the reference potential terminal Ts5 serves as a potential (reference potential) of the reference potential terminal Tp5.

As shown in FIG. 4, the ground terminal Tp1, the ground terminal Tp2, and the reference potential terminal Tp3 are longer in the slide movement direction (+Y-axis direction) than the other terminals. For this reason, in the present embodiment, when the accessory 400 is mounted on the camera 10, three terminals of the ground terminal Tp1, the ground terminal Tp2, and the reference potential terminal Tp3 come into contact with each of the corresponding terminals (ground terminal Ts1, ground terminal Ts2, and reference potential terminal Ts3) of the terminal section 423 of the accessory 400 ahead of other terminals.

The startup state providing terminal Ts7 is connected to the grounding line 42 through the reference potential line 480 in a state where the accessory 400 is mounted on the camera 10, and in a state (on-state) where the second switch section 470 closes a circuit. For this reason, when the second switch section 470 is in an on-state and in a state where it is connected to the camera 10 (hereinafter, referred to as the first state), the camera control section 170 can detect the startup detection level DET (SGND level/reference potential level/Low level/L level) indicating the second switch section is in the first state, through the startup state providing terminal Ts7 and the startup state detecting terminal Tp7. In addition, when the second switch section is in a second state mentioned below, the camera control section 170 can detect the startup detection level DET having an electrical level different from that of the first state. The second state includes any states of a state where the second switch section 470 is in an off-state and is mounted on the camera 10, and a state where the accessory 400 is not mounted on the camera 10.

In the mounted state, the synchronous signal terminal Ts4 is connected to synchronous signal terminal Tp4 of the camera 10. That is, in the mounted state, the accessory control section 440 is connected to the camera control section 170 through the synchronous signal terminal Tp4 and the synchronous signal terminal Ts4. Accordingly, the accessory control section 440 can transmit a synchronous signal CLK for performing synchronous communication with the camera control section 170 to the camera control section 170 through the synchronous signal terminal Ts4 and the synchronous signal terminal Tp4. In addition, the camera control section 170 can transmit a monitor emission control signal for causing the accessory 400 to perform monitor emission mentioned below to the accessory control section 440 through the synchronous signal terminal Ts4 and the synchronous signal terminal Tp4.

In addition, the monitor emission is emission performed prior to the main emission used in the main image capture. The result of image capture (monitor image capture) through the monitor emission is used in at least one of adjustment of white balance such as auto white balance (AWB) control, and exposure control such as auto exposure (AE) control.

In the mounted state, the communication signal terminal Ts6 is connected to the communication signal terminal Tp6 of the camera 10. That is, in the mounted state, the accessory control section 440 is connected to the camera control section 170 through the communication signal terminal Tp6 and the communication signal terminal Ts6. For this reason, in the mounted state, the camera control section 170 and the accessory control section 440 can perform serial data communication through the communication signal terminal Tp6 and the communication signal terminal Ts6. The communication signal terminals Tp6 and Ts6 can all switch input/output functions, and communication between both of these terminals is two-way communication, i.e., it is possible to switch between the communication directions. Data communicated as the communication signal DATA include the following. Data output from the camera 10 include a command through which the camera control section 170 causes the accessory 400 to execute a process, information regarding the camera 10 (camera data), and the like. On the other hand, data output from the accessory 400 side include information regarding the accessory 400 (accessory information) and the like. In the present embodiment, transmission (or reception) of data indicating a command or information may be just called transmission (or reception) of a command or information. In addition, in any of the cases where the camera control section 170 performs transmission and the accessory control section 440 performs transmission, the communication signal DATA is transmitted in synchronization with the synchronous signal CLK output from the accessory 400.

For example, the camera control section 170 transmits a transmission notification command for transmission of information on designated items from the camera control section 170 to the accessory control section 440, to the accessory control section 440. After transmission termination of the transmission notification command, the camera control section 170 transmits information on the items designated as the transmission notification command to the accessory control section 440, subsequently to the transmission of the transmission notification command at a predetermined time interval.

In addition, for example, the camera control section 170 can transmit a transmission request command for requesting transmission of the designated information from the accessory control section 440 to the camera control section 170, to the accessory control section 440. After reception termination of the transmission request command, the accessory control section 440 transmits the information on the items designated as the transmission notification command to the camera control section 170, subsequently to the reception of the transmission notification command.

In the mounted state, the communication control signal terminal Ts9 is connected to the communication control signal terminal Tp9 of the camera 10. That is, in the mounted state, the accessory control section 440 is connected to the camera control section 170 through the communication control signal terminal Tp9 and the communication control signal terminal Ts9.

For this reason, the camera control section 170 can supply the communication control signal Cs to the accessory control section 440 through the communication control signal terminal Tp9 and the communication control signal terminal Ts9.

In addition, when information such as the above-mentioned “charging request” is transmitted from the accessory 400 side to the camera 10 side, the accessory control section 440 transmits information to the camera control section 170, in the steady communication sequence (described later) started based on the communication control signal Cs received from the camera 10 side at the above-mentioned communication control signal terminal Ts9.

The communication control signal Cs is a signal for determining the communication start timing of communication between the camera 10 and the accessory 400 through the communication signal terminal Ts6. In the accessory 400 side, a pull-up resistor is connected to a wiring pattern which is connected to the communication control signal terminal Ts9. For this reason, the signal level of the communication control signal Cs in the communication signal terminal Ts6 is maintained to an H level before the communication start. The signal level of the communication control signal Cs is maintained down to an L level by the camera control section 170 at the time of the start of data communication through the communication signal terminal Ts6. In a period when the signal level of the communication control signal Cs is maintained to an L level, multiple bits of data are transmitted and received as the communication signal DATA in synchronization with the synchronous signal CLK. After multiple bits of data are transmitted and received, the signal level of the communication control signal Cs is maintained to an H level again by the above-mentioned pull-up resistor, in a period until the transmission of the next communication signal DATA. In this manner, the communication control signal Cs is a signal having a low number of switching per unit time of the signal levels (H level and L level), as compared to the communication signal DATA and the synchronous signal CLK.

In the mounted state, the emission control signal terminal Ts8 is connected to the emission control signal terminal Tp8 of the camera 10. That is, in the mounted state, the accessory control section 440 is connected to the camera control section 170 through the emission control signal terminal Tp8 and the emission control signal terminal Ts8.

For this reason, the camera control section 170 can supply the emission control signal X for causing the accessory 400 to perform emission (main emission) in synchronization with the image capture timing to the accessory control section 440 through the emission control signal terminal Ts8 and the emission control signal terminal Tp8. The accessory control section 440 performs the light emission control in accordance with the emission control signal X.

The charging section 432 includes a booster circuit that boosts a voltage of power supplied through the power source line 481, and an accumulation section (charge accumulation section) charged by the voltage boosted in the booster circuit. In addition, the charging section 432 is connected to the accessory control section 440 through a first signal line.

The accessory control section 440 can supply a signal for controlling the charging section 432 to the charging section 432 through the first signal line. The charging section 432 is connected to the accessory control section 440 through a second signal line. The charging section 432 can supply information indicating the amount of charging of the charging section 432 to the accessory control section 440 through the second signal line.

The accessory control section 440 supplies a signal for controlling the illumination light source driving section 436 to the illumination light source driving section 436 through the signal line. For this reason, the illumination light source 437 can emit light by power supplied through the power source line 481 and the illumination light source driving section 436.

The turn-on states of the first pilot lamp 455 and the second pilot lamp 460 are each controlled by the control signal supplied from the accessory control section 440 through the signal line. The first pilot lamp 455 is turned on, for example, in a state where the emission of the flash light emitting section 430 is permitted by the accessory control section 440. The first pilot lamp 455 is turned off, for example, in a state where the flash light emitting section 430 is not capable of being caused to emit light. Similarly to the first pilot lamp 455, the second pilot lamp 460 is turned on or turned off depending on the state of the illumination light emitting section 435 by the control of the accessory control section 440.

The first power source section 450-1 stabilizes a voltage which is input to an input terminal of the first power source section 450-1 and supplies the voltage to a subsequent-stage circuit, based on power supplied from the power source line 481. The second power source section 450-2 stabilizes a voltage which is input to the input terminal of the second power source section 450-2 and supplies the voltage to the subsequent-stage circuit, based on power supplied from the first power source section 450-1.

Next, a level switching section 475 will be described.

FIGS. 9A and 9B are diagrams schematically illustrating the connection relationship between the startup state detecting terminal Tp7 and the camera control section 170. In FIG. 9A, the connection relationship between the startup state detecting terminal Tp7 and the camera control section 170 is shown in association with the cross-sectional view of the shoe seat 15. In FIG. 9B, the configuration of the level switching section 475 and the connection relationship are shown in association with the cross-sectional view of the connector 420.

As shown in FIG. 9A, a voltage is applied to the startup state detecting terminal Tp7 connected to the camera control section 170 through a pull-up resistor 482. In a state where the startup state detecting terminal Tp7 is not connected to the startup state providing terminal Ts7 of the accessory 400, the potential of the startup state detecting terminal Tp7, that is, the startup detection level DET is in an H (high) level. The H level is set to, for example, a higher potential than the reference potential SGND of the grounding line 42.

The accessory 400 of the present embodiment includes the level switching section 475. As shown in FIG. 9B, the level switching section 475 includes the first switch section 465, the second switch section 470, the first operating portion 424, and the second operating portion 471.

The first switch section 465 switches the state depending on attachment and detachment between the camera body 100 and the accessory 400. The first switch section 465 includes a movable member (locking claw 422) and a switch 466 (electrical switch) associated with the movement of the locking claw 422. The locking claw 422 moves in a predetermined direction (+Z side in the Z-axis direction) by force received from the camera body 100 when the accessory 400 is mounted on the camera body 100. The switch 466 closes or opens a circuit in association with the movement of the locking claw 422. When the connector 420 is inserted up to a predetermined position of the shoe seat 15, the locking claw 422 of the connector 420 protrudes inside the locking hole 27 of the shoe seat 15, and thus the switch 466 of the first switch section 465 closes a circuit of FIG. 9B. In addition, when the accessory 400 is mounted on the camera body 100, the locking claw 422 regulates the movement of the accessory 400 with respect to the camera body 100 by locking to the camera body 100.

In addition, when the first switch section 465 performs a detachment operation (operation for detaching the connector 420 from the shoe seat 15) on the first operating portion 424, the locking claw 422 is moved in the Z-axis direction by the operation and is thrust from the inside of the locking hole 27 toward the accessory main body 410 side. Consequently, the switch 466 opens a circuit of FIG. 9B (opens a circuit).

The second switch section 470 switches the level of the startup detection level DET by a user's operation. The second switch section 470 includes the second operating portion 471 and the switch 472 (electrical switch).

The second switch section 470 closes or opens the circuit of FIG. 9B (closes the circuit by a function on operation, and opens it by a function off operation) by the switch 472 associated with the movement of the second operating portion 471, in accordance with a user's function on operation or function off operation on the second operating portion 471.

The first operating portion 424 is operated by a user in order to move the locking claw 422 in a predetermined direction. The first operating portion 424 moves the locking claw 422 in a predetermined direction (Z-axis direction) by transmitting force received by the user's operation to the locking claw 422. When the first operating portion 424 is operated in a state where the accessory 400 is mounted on the camera body 100, the locking claw 422 moves in the Z-axis direction and retreats from the inner side of the locking hole 27 toward the accessory main body 410. Consequently, the accessory 400 is unfixed to the camera body 100 and is detached from the camera body 100, and the first switch section 465 opens a circuit.

The startup state providing terminal Ts7 of the accessory 400 is connected to the reference potential line 480 through the switch 466 and the switch 472, in a state where the switch 466 closes a circuit and in a state (position of “on”) where the switch 472 closes a circuit. When the connector 420 is connected to the shoe seat 15, the reference potential line 480 is electrically connected to the grounding line (SGND/signal ground) 42 of the camera body 100 as explained above.

In a state (mounted state) where the connector 420 is connected to the shoe seat 15, the startup state providing terminal Ts7 of the accessory 400 is electrically connected to the grounding line 42 of the camera body 100, and the potential of the startup state providing terminal Ts7 is changed to an L (low) level. In a state where the connector 420 is connected to the shoe seat 15, the potential of the startup state detecting terminal Tp7 of the camera body 100 is short-circuited to the startup state providing terminal Ts7 of the accessory 400, and thus the startup detection level DET is changed to an L level. The L level is set to the same potential as that of the grounding line 42 (reference potential SGND). When the first operating portion 424 is operated in a state where the connector 420 is connected to the shoe seat 15, the startup detection level DET is changed to an H level in order for the first switch section 465 to break a circuit. In addition, even when the second operating portion 471 of the second switch section 470 is subject to the function off operation in a state where the connector 420 is connected to the shoe seat 15, the startup detection level DET is changed to an H level in order for the switch 472 to break a circuit. That is, in the case where the accessory 400 is mounted on the camera 10, the startup detection level DET is changed to an H level, even when the operation for detaching the connector 420 from the shoe seat 15 is performed on the first operating portion 424, even when the function off operation is operated on the second operating portion 471, or even when any of the operations are performed.

However, generally, in the camera system, when a short-circuit is generated by attachment of dusts and the like between the terminals of the terminal section of the accessory or the camera, an unexpected current flows between the short-circuited terminals, and thus there is a possibility that the camera system is not stably operated. In addition, there is a possibility that the camera system is not stably operated by the influence of noise (electrical noise) on a signal supplied through the terminals between the camera and the accessory. There is a possibility that the camera system does not respond to the user's operation or causes a response delay due to, for example, an unstable operation, to thereby lower the convenience.

On the other hand, as shown in FIGS. 5 and 7, the accessory 400 of the present embodiment is configured such that the terminal arrangement of the terminal section 423 is made as follows. The power terminal Ts11 and the power terminal Ts12 to which power is supplied from the camera 10 are arranged in the eleventh and twelfth positions, respectively. The ground terminal Ts1 and the ground terminal Ts2 corresponding to the power terminal Ts11 and the power terminal Ts12 are arranged in the first and second positions, respectively. The startup state providing terminal Ts7 is for outputting the startup detection level DET changes depending on attachment and detachment between the camera 10 and the accessory 400 to the camera 10. Terminal Ts7 is arranged in the seventh position. The emission control signal terminal Ts8, to which the emission control signal X for controlling the light-emitting state of the flash light emitting section 430 or the illumination light emitting section 435 is input from the camera 10, is arranged in the eighth position. The communication signal terminal Tp6, to which the control signal for the controlling the accessory 400 is supplied as the communication signal DATA for communicating with the camera 10, is arranged in the sixth position. The synchronous signal terminal Ts4 for outputting the synchronous signal CLK synchronized with the communication signal DATA to the camera 10. Terminal Ts4 is arranged in the fourth position. The communication control signal terminal Ts9, to which the communication control signal Cs for determining the communication timing of communication between the camera 10 and the accessory 400 is input from the camera 10, is arranged in the ninth position. The reference potential terminal Ts3 and the reference potential terminal Ts5 are arranged in the third and fifth positions, respectively, and the potential thereof serves as a reference potential of the startup detection level DET, the communication signal DATA, the synchronous signal CLK, the emission control signal X, and the communication control signal Cs.

That is, the power terminal Ts11 and the power terminal Ts12 are arranged biased to one side of the array direction of the terminals, and the ground terminal Ts1 and the ground terminal Ts2 are arranged biased to the other side of the array direction of the terminals. Thus, the camera system 1 is configured such that the power terminals (power terminal Ts11 and power terminal Ts12) and the ground terminals (ground terminal Ts1 and ground terminal Ts2) are considerably separated from each other and thus the generation of a short-circuit between the both is suppressed. Therefore, it is possible to suppress the occurrence of defects such as a response stop due to the short circuit between the power terminals and the ground terminals, and to maintain the electrical safety.

In addition, the accessory 400 has a high freedom of design of the power source line 481 connected to the power terminal Ts11 and the power terminal Ts12 or the reference potential line 480 connected to the ground terminal Ts1 and the ground terminal Ts2 within the accessory 400. In addition, since the power terminals are not arranged between multiple terminals but are arranged against the end of the arrangement, multipolarization thereof is facilitated, and thus a plurality of power terminals can be designed side by side. As a result, the accessory 400 is configured so that, for example, the width of the power source line 481 or the reference potential line 480 is easily widened, and thus it is possible to make the resistance of the power source line 481 or the reference potential line 480 lower, and to supply large power through the power source line 481 or the reference potential line 480. In the present embodiment, as is obvious from being capable of making the resistance thereof lower as mentioned above, it is possible to suppress the generation of heat in the contact portion, and, as a result, to suppress the occurrence of defects such as deformation due to the generation of heat in the contact portion.

In addition, the communication signal terminal Ts6 supplied with the communication signal DATA indicating information necessary for image capture is disposed adjacent to the reference potential terminal Ts5 supplied with a reference potential. Therefore, the communication signal DATA hardly receives noise from the side opposite to the communication signal terminal Ts6 with respect to the reference potential terminal Ts5. In addition, the communication signal terminal Ts6 is arranged adjacent to the startup state providing terminal Ts7 on the side opposite to the reference potential terminal Ts5 with respect to the communication signal terminal Ts6. The startup detection level DET is maintained to an L level in a state where the camera 10 and the accessory 400 are capable of communicating with each other. Therefore, in a state where the camera 10 and the accessory 400 are capable of communicating with each other, the communication signal DATA hardly receive noise from the side opposite to the communication signal terminal Ts6 with respect to the startup state providing terminal Ts7. In this manner, since the camera system 1 receives little influence from noise on the communication signal DATA, it is possible to maintain safety of communication and to suppress the occurrence of defects such as malfunction due to the influence of noise on the communication signal DATA.

In addition, the emission control signal terminal Ts8 is arranged adjacent to the startup state providing terminal Ts7. The startup detection level DET is maintained to an L level when the camera 10 and the accessory 400 are capable of communicating with each other. Therefore, the emission control signal X hardly receives noise from the side opposite to the startup state providing terminal Ts7 with respect to the emission control signal terminal Ts8. In addition, the emission control signal terminal Ts8 is adjacent to the communication control signal terminal Ts9 on the side opposite to the startup state providing terminal Ts7 with respect to the emission control signal terminal Ts8. The communication control signal Cs is maintained in an L level in a period where multiple bits of data are communicated in synchronization with the synchronous signal CLK, and is maintained to an H level in a period until data communication is terminated and then the next data communication is started. In this manner, switching of the signal level of the communication control signal Cs is performed at a lower frequency than any of the synchronous signal CLK and the communication signal DATA. Consequently, the emission control signal X is hardly influenced by noise from the side opposite to the communication control signal terminal Ts9 with respect to the emission control signal terminal Ts8. In this manner, since the camera system 1 receives little influence from noise on the emission control signal X, it is possible to maintain safety of communication, and to suppress the occurrence of defects such as malfunction (erroneous emission operation) due to the influence of noise on the emission control signal X.

In addition, the startup state providing terminal Ts7 is arranged adjacent to the communication signal terminal Ts6.

The communication signal DATA is maintained to an H level in a state where the camera control section 170 does not transmit and receive data. Therefore, when the startup state providing terminal Ts7 is short-circuited to the communication signal terminal Ts6, the startup detection level DET is changed to an H level, and the camera control section 170 determines that the accessory 400 is not mounted. Thus, when the accessory 400 is in an off-state, the camera system 1 detects that the accessory 400 is in an on-state and thus the occurrence of malfunction can be suppressed. In addition, the startup state providing terminal Ts7 is arranged adjacent to the emission control signal terminal Ts8. The emission control signal X is maintained to an H level in a state where the camera control section 170 causes the light-emitting section 425 not to emit light, and is changed to an L level when the camera control section 170 causes the light-emitting section 425 to emit light. Therefore, when the startup state providing terminal Ts7 is short-circuited to the emission control signal terminal Ts8, the startup detection level is changed to an H level, and the camera control section 170 determines that the accessory 400 is not mounted. Thus, when the accessory 400 is in an off-state, the camera system 1 detects that the accessory 400 is in an on-state, and thus it is possible to suppress the occurrence of malfunction and to enhance the electrical safety. In addition, when the accessory 400 is detached from the camera 10, the terminal Tp6 is also maintained at an H level by a pull-up resistor at the camera body 100 side as mentioned above, and the terminal Tp8 is at an H level normally (in a case other than the case where an emission signal is sent). For this reason, even when the terminal Tp7, which is exposed, on the camera body 100 side is short-circuited to the adjacent terminal (Tp6 or Tp8) due to, for example, dust or the like, the camera body 100 does not make an erroneous determination (erroneous determination that the accessory is mounted and is in a startup state).

In the present embodiment, the synchronous signal terminal Ts4 is arranged adjacent to the reference potential terminal Ts5 supplied with a reference potential. Therefore, the synchronous signal CLK is hardly influenced by disturbances (such as noise) from the side (terminal Ts6 side) opposite to the synchronous signal terminal Ts4 with respect to the reference potential terminal Ts5. In addition, the synchronous signal terminal Ts4 is arranged adjacent to the reference potential terminal Ts3 supplied with a reference potential, on the side opposite to the reference potential terminal Ts5 with respect to the synchronous signal terminal Ts4. Therefore, the synchronous signal CLK is hardly influenced by disturbance (such as noise) from the side (ground terminal Ts2 side) opposite to the synchronous signal terminal Ts4 with respect to the reference potential terminal Ts3. In addition, since the terminal arranged on the side opposite to the synchronous signal terminal Ts4 with respect to the reference potential terminal Ts3 is the ground terminal Ts2, and the potential of the ground terminal Ts2 is substantially the same potential as a reference potential, the synchronous signal CLK hardly receives noise. In this manner, since the camera system 1 receives little influence from noise on the synchronous signal CLK, it is possible to maintain safety of communication, and to suppress the occurrence of defects such as malfunction due to the influence of noise on the synchronous signal CLK serving as a reference signal of communication.

In addition, the level switching section 475 switches the state (electrical level) of the startup detection level DET in accordance with the operation of detaching the accessory 400 from the camera 10 or the function off operation. Therefore, the camera 10 can control the accessory 400 in accordance with the detachment operation of accessory 400 or the function off operation, and stably control the accessory 400. In addition, in the camera system 1, the camera control section 170 detects that, for example, the accessory 400 is mounted on the camera 10 and is subject to the function on operation, and the camera control section 170 can start the control of the accessory 400 based on the detection result. Therefore, it is possible to shorten the time until the accessory 400 is mounted and then is capable of being caused to function.

In addition, in the camera system 1, the open terminal Ts10 is arranged between a power terminal group (Ts11 and Ts12) and a terminal group for communication or detection (Ts4 and Ts6 to Ts9; also called a communication terminal group), and thus it is possible to reduce a possibility that electrical disturbance (such as noise) from a power source adversely influences a communication terminal group. In addition, although the open terminal Ts10 is actually arranged in the present embodiment, it is possible to equalize contact force (contact pressure) between each of the terminals on the respective other side in the entirety of twelve terminals (compared to the configuration in which the open terminal Ts10 is not arranged and no terminal is present in this position), by providing the terminal Ts10. Additionally, as mentioned above, the open terminal Ts10 is a terminal which is preliminarily provided for a future function expansion, and is a terminal which is not connected to the circuit. For this reason, in the present embodiment, the terminal Ts10 does not have any functional operation. For this reason, even when the accessory 400 does not include the open terminal Ts10, the accessory operates (functions) as the accessory 400 and as a camera system. For this reason, for example, in order to reduce the number of parts, the open terminal Ts10 may be omitted on the accessory 400. The same is true of the camera body 100.

In addition, as shown in FIG. 4, the ground terminal Tp1, the ground terminal Tp2, and the reference potential terminal Tp3 of the terminal section 25 in the shoe seat 15 protrude further than the terminals Tp4 to Tp12 toward the direction (−Y side) of penetration when the connector 420 is installed.

Consequently, the ground terminal Tp1, the ground terminal Tp2, and the reference potential terminal Tp3 are connected to the ground terminal Tp1, the ground terminal Tp2, and the reference potential terminal Tp3 of the connector 420, respectively, ahead of any of the terminals indicated by signs Tp4 to Tp12. As a result, the startup state providing terminal Ts7 of the accessory 400 can stably output the startup detection level DET in a state where the accessory 400 is mounted on the camera body 100.

As stated above, the accessory 400 can suppress the occurrence of malfunction, and enhance the convenience of the camera system 1. In addition, the camera 10, the shoe seat 15, and the connector 420 are all formed in the terminal arrangement as mentioned above, and thus it is possible to enhance the convenience of the camera system 1.

In addition, one of the power terminal Tp11 and the power terminal Tp12 can be omitted. Thereby, the number of parts can be reduced. In addition, an open terminal may be provided, for example, instead of one terminal of the power terminal Tp11 and the power terminal Tp12. The power terminal Tp11 and the power terminal Tp12 can be formed integrally with each other. Similarly to the power terminal Tp11 and the power terminal Tp12, one of the ground terminal Tp1 and the ground terminal Tp2 may be omitted. Thereby, the number of parts can be reduced. In addition, an open terminal may be disposed, for example, instead of one terminal of the ground terminal Tp1 and the ground terminal Tp2. The ground terminal Tp1 and the ground terminal Tp2 can be formed integrally with each other. In addition, the terminals arranged between the power terminal including at least one of the power terminal Tp11 and the power terminal Tp12, and the ground terminal including at least one of the ground terminal Tp1 and the ground terminal Tp2 can include one, two or more, or all of the terminals indicated by signs Tp3 to sign Tp10.

In addition, the configuration in which the emission control signal terminal Tp8 is sandwiched between the startup state detecting terminal Tp7 and the communication control signal terminal Tp9 includes a configuration in which when an integer equal to or greater than 2 is set to L, in the terminal arrangement of the terminal section 25, the startup state detecting terminal Tp7 is arranged in the (L−1)-th position, the emission control signal terminal Tp8 is arranged in the L-th position, and the communication control signal terminal Tp9 is arranged in the (L+1)-th position. For example, when L is equal to 6, the terminal arrangement of the terminal section, the startup state detecting terminal Tp7 is arranged in the fifth position, the emission control signal terminal Tp8 is arranged in the sixth position, and the communication control signal terminal Tp9 is arranged in the seventh position.

In addition, the configuration in which the communication signal terminal Tp6 is sandwiched between the startup state detecting terminal Tp7 and the emission control signal terminal Tp8 includes a configuration in which when an integer equal to or greater than 2 is set to M, in the terminal arrangement of the terminal section 25, the communication signal terminal Tp6 is arranged in the (M−1)-th position, the startup state detecting terminal Tp7 is arranged in the M-th position, and the emission control signal terminal Tp8 is arranged in the (M+1)-th position. For example, when M is equal to 4, the terminal arrangement of the terminal section, the communication signal terminal Tp6 is arranged in the third position, the startup state detecting terminal Tp7 is arranged in the fourth position, and the emission control signal terminal Tp8 is arranged in the fifth position.

In addition, the configuration in which the communication signal terminal Tp6 is sandwiched between the reference potential terminal Tp5 and the startup state detecting terminal Tp7 includes a configuration in which when an integer equal to or greater than 2 is set to N, in the terminal arrangement of the terminal section 25, the reference potential terminal Tp5 is arranged in the (N−1)-th position, the communication signal terminal Tp6 is arranged in the N-th position, and the startup state detecting terminal Tp7 is arranged in the (N+1)-th position. For example, when N is equal to 8, in the terminal arrangement of the terminal section, the reference potential terminal Tp5 is arranged in the seventh position, the communication signal terminal Tp6 is arranged in the eighth position, and the startup state detecting terminal Tp7 is arranged in the ninth position.

In addition, the configuration in which the synchronous signal terminal Tp4 is sandwiched between the reference potential terminal Tp3 and the reference potential terminal Tp5 includes a configuration in which when an integer equal to or greater than 2 is set to P, in the terminal arrangement of the terminal section 25, the reference potential terminal Tp3 is arranged in the (P−1)-th position, the synchronous signal terminal Tp4 is arranged in the P-th position, and the reference potential terminal Tp5 is arranged in the (P+1)-th position. For example, when P is equal to 6, in the terminal arrangement of the terminal section, the reference potential terminal Tp3 is arranged in the fifth position, the synchronous signal terminal Tp4 is arranged in the sixth position, and the reference potential terminal Tp5 is arranged in the seventh position.

In this manner, in the camera system 1, the convenience can be enhanced for a similar reason to that in the case of the terminal arrangement explained by using the FIG. 5 and the like, by arranging the terminals Tp1 to Tp12 in the positions as mentioned above.

In addition, in the present embodiment, the number indicating the arrangement of each of the terminals is the number ascending from one side (+X side) in the array direction (X-axis direction) of the terminals toward the other side (−X) side, but may be the number ascending from the other side (−X side) toward one side (+X) side. In this case, in the terminal arrangement of the terminal section 25, the first and second terminals serve as the power terminal Tp12 and the power terminal Tp11, respectively, and the eleventh and twelfth terminal serve as the ground terminal Tp2 and the ground terminal Tp1, respectively. In addition, the modified arrangement of the terminals in the terminal section 25 of the camera body 100 as mentioned above can be applied to the arrangement of the terminals in the terminal section 423 of the accessory 400.

In addition, in the present embodiment, the image capture lens 200 shown in FIG. 1 is attachable and detachable to and from the camera body 100, but may not be attachable and detachable to and from the camera body 100 and may be formed integrally with the camera body 100. At least a portion of the image capture lens 200 may be receivable in the camera body 100. In the present embodiment, the camera 10 may include at least the camera body 100, and may not include the image capture lens 200. That is, the image capture lens 200 may be an external device (accessory) of the camera, and may be a component of the camera system 1. In addition, the accessory 400 can have a structure in which it can be electrically connected between the connector 420 and the shoe seat 15 through a cable or the like, and may be held by a separate device from the camera body 100, for example, a tripod or the like.

In addition, in the present embodiment, the battery compartment 110 shown in FIG. 6 is built-in to the camera body 100, but the battery compartment 110 may be external component (accessory) of the camera body 100. For example, the battery compartment 110 may be attachable outside the camera body 100. In addition, the camera system 1 can also operate the components of the camera system 1 by power supplied from the outside of the camera body 100 through an AC adapter or the like. The camera system 1 can supply the power from the outside to each of the components of the camera system 1, similarly to power supplied from the battery BAT received in the battery compartment 110.

In addition, in the present embodiment, the memory 140 shown in FIG. 6 may be built-in to the camera body 100, or may be a device (accessory) located outside the camera body 100.

In addition, in the present embodiment, the first pilot lamp 455 shown in FIG. 2 indicates an emittable state of the flash light emitting section 430 by switching between turn-on and turn-off, but may be configured to indicate an emittable state of the flash light emitting section 430 by changing the wavelength of light emitted, the period for which turn-on and turn-off are repeated, or the like. Similarly to the first pilot lamp 455, the second pilot lamp 460 may be configured to indicate an emittable state of the illumination light emitting section 435 by change in the wavelength of light emitted, the period for which turn-on and turn-off are repeated, or the like.

Next, a process procedure in the camera system will be described. In the following description, the same processes are assigned the same reference numerals and signs, and the description thereof may be simplified or omitted.

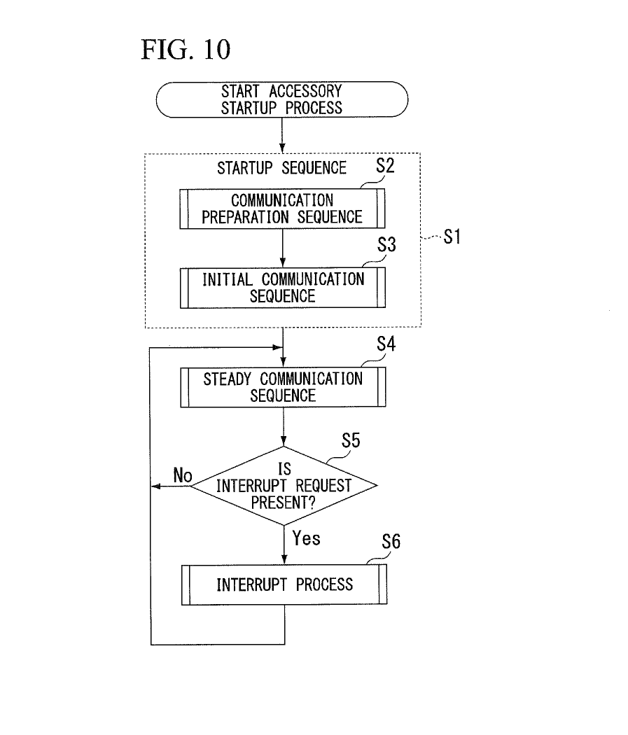

FIG. 10 is a flow diagram illustrating a procedure of processes in the camera system. The camera system 1 performs a series of processes (startup sequence) for starting up the accessory 400. In the startup sequence (step S1), the camera system 1 performs a series of processes (communication preparation sequence) so that communication between the camera 10 and the accessory 400 becomes possible (step S2). After the communication preparation sequence is terminated in the startup sequence, the camera system 1 performs a series of processes (initial communication sequence) for mutually communicating information necessary for image capture between the camera control section 170 and the accessory control section 440 (step S3). After the initial communication sequence is terminated, the camera system 1 performs a series of processes (steady communication sequence) for mutually communicating between the camera control section 170 and the accessory control section 440 so as to be capable of updating information varied by a setting change or the like (step S4).

After the steady communication sequence is terminated, the camera control section 170 performs a determination process of determining whether an interrupt request is present (step S5). When it is determined in step S5 that the interrupt request is not present (step S5; No), the camera system 1 performs the process of the steady communication sequence once again.

When it is determined in step S5 that the interrupt request is present (step S5; Yes), the camera system 1 performs an interrupt process (step S6). The interrupt process is, for example, a series of processes included in an image capturing sequence. After the interrupt process is terminated, the camera system 1 performs the process of the steady communication sequence once again. That is, the camera system 1 does not perform the process of the steady communication sequence in the image capturing sequence.

Next, a communication preparation sequence will be described. In the communication preparation sequence, the camera system 1 detects whether the accessory 400 is mounted on the camera body 100 in an on-state. When the accessory 400 is mounted on the camera body 100 in an on-state, the camera system 1 starts a supply of power to the accessory 400, and the camera body 100 notifies the accessory 400 that communication is permitted. Hereinafter, an example of a process flow in the communication preparation sequence will be described.

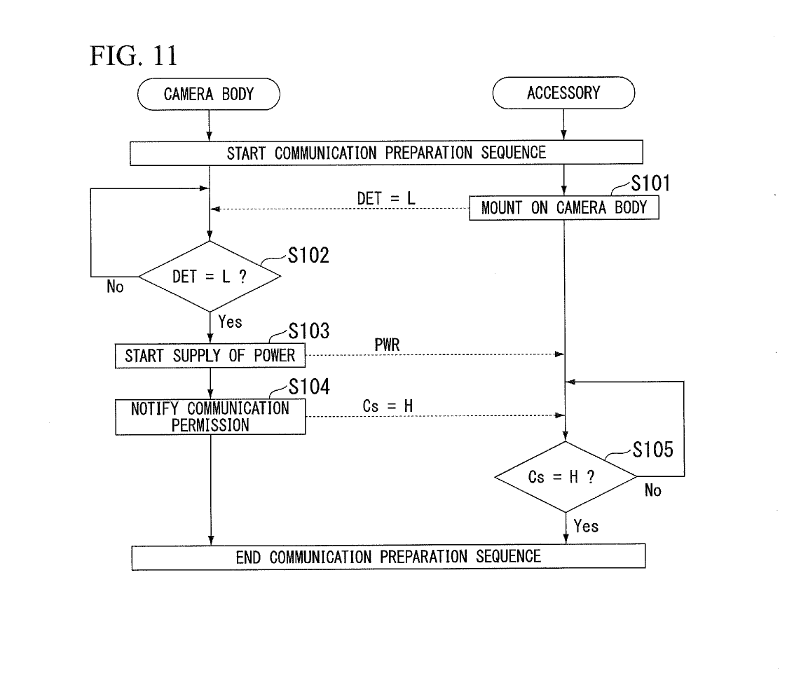

FIG. 11 is a diagram illustrating a procedure of processes in the communication preparation sequence.

When the accessory 400 is mounted on the camera 10 and the second switch section 470 closes a circuit (position of “on”), the signal level of the startup detection level DET output by the level switching section 475 (see FIGS. 9A and 9B) is changed to an L (low) level (step S101). The camera control section 170 performs a determination process of determining whether the startup detection level DET is an L level (step S102). When it is determined in step S102 that the startup detection level DET is not an L level (step S102; No), the camera control section 170 determines that the accessory 400 is not mounted on the camera 10, and performs the determination process of step S102 once again.

When it is determined in step S102 that the startup detection level DET is an L level (step S102; Yes), the camera control section 170 performs a control for starting a supply of power from the camera 10 to the accessory 400 (step S103). In step S103, the camera control section 170 controls the accessory power source control section 33, and causes the accessory power source control section 33 to start a supply of power from the camera 10 to the accessory 400. The accessory control section 440 (first power source section 450-1 and second power source section 450-2) is started up by power supplied from the camera 10 through the power source section 450.

After the control of step S103 is terminated, the camera control section 170 notifies the accessory control section 440 of communication permission (step S104). The potential of the communication control signal terminal Tp9 of the camera 10, that is, the signal level of the communication control signal Cs is in an L level in a state where the camera control section 170 determines that the accessory 400 is not mounted on the camera 10.

The accessory control section 440 performs a determination process of determining whether the potential of the communication control signal terminal Ts9, that is, the signal level of the communication control signal Cs is an H level (step S105). When it is determined in step S105 that the communication control signal Cs is not in an H level (step S105; No), the accessory control section 440 performs the determination process of step S105 once again. When it is determined in step S105 that the communication control signal Cs is in an H level (step S105; Yes), the accessory control section 440 recognizes that communication with the camera control section 170 is permitted.

The communication preparation sequence is terminated after the camera control section 170 gives notice of communication permission by raising the communication control signal Cs to an H level in step S104, and the accessory control section 440 recognizes that communication with the camera control section 170 is permitted.

In this manner, the camera system 1 starts supply of power to the accessory 400 based on the startup detection level DET output from the accessory 400, and thus reliability of the control for a supply of power to the accessory 400 is increased. In addition, the camera system 1 gives notice of communication permission after the camera control section 170 starts the supply of power to the accessory 400. Consequently, in the camera system 1, the accessory control section 440 is notified of communication permission in a state where the accessory 400 is started up, thereby allowing the start of communication between the camera 10 and the accessory 400 to be stably controlled. In this manner, the camera system 1 exhibits greater convenience, since the system can stably control the accessory 400, and is stably operated.

In addition, the startup detection level DET of the camera 10 is changed to an H level when the second switch section 470 of the accessory 400 mounted on the camera 10 is in a state (“off” position) where it opens a circuit. In this case, the camera control section 170 determines that the accessory 400 is not mounted on the camera 10. That is, when the second switch section 470 is positioned in an “off” position, the accessory 400 cannot be supplied with power from the camera 10, and thus is not started up (in other words, “does not function”). In this manner, the second switch section 470 substantially functions as a power switch (function on/off switch) of the accessory 400.

Next, processes in the initial communication sequence will be described. In the initial communication sequence, the camera system 1 mutually sends information required for image capture between the camera 10 and the accessory 400. In the initial communication sequence, the camera 10 and the accessory 400 transmit and receive a plurality of information items in accordance with a predetermined order. As the initial conditions of processes in the initial communication sequence, information (first response information, first information) including accessory type information indicating an accessory type is previously stored in the storage section 444 of the accessory 400. The accessory type information includes function type information and battery presence or absence information.

The function type information is information (type information) indicating types of objects to be controlled by the accessory control section 440. The objects to be controlled by the accessory control section 440 include the illumination light emitting section 435 causing an illumination light emitting function to work, the flash light emitting section 430 causing a flash light emitting function to work, a GPS function section causing a GPS function to work, a multi-turn-on commander function section causing a multi-turn-on commander function to work, and the like. The objects to be controlled are divided into a plurality of groups in accordance with the type of the function of each object to be controlled. The objects to be controlled relating to a light-emitting function, that is, the flash light emitting section 430 and the illumination light emitting section 435, belong to a first group. The objects to be controlled relating to functions other than the light-emitting function, for example, the GPS function section and the multi-turn-on commander function section, belong to a second group. In this manner, the type information is information indicating a list of the types of functions included in the accessory 400.

The battery presence or absence information is information (in other words, information indicating whether the accessory 400 side supplies power consumed in the accessory 400 side for itself) indicating whether a power source such as a battery is included on the accessory 400 side. The battery presence or absence information is information used in the control (described later) or the like in which power is supplied to the accessory 400 by the camera 10. The detailed description of the battery presence or absence information will be given later.

In addition, characteristics information (second response information, second information) indicating the characteristics of each function included in the accessory 400 is previously stored in the storage section 444. The characteristics information includes information indicating the characteristics of each function section which takes charge of each function of the accessory 400. For example, the characteristics information of the flash light emitting function includes information (profile information) indicating the emission characteristics of the flash light emitting section 430. The characteristics information of the illumination light emitting function includes information (illumination profile information) indicating the emission characteristics of the illumination light emitting section 435 (LED for image capture illumination), and information indicating the longest time (longest turn-on time) for which the illumination light emitting section 435 is capable of continuously emitting light. The longest turn-on time is, for example, the time which is set in advance, as an upper limit of the allowable range of the continuous turn-on time. In addition, when the extended function is, for example, a GPS function, the characteristic information of the extended function includes information indicating the type of an object to be positioned (such as latitude, longitude, and time), or the like. In addition, the characteristic information of the multi-turn-on commander function includes, for example, information indicating how many illuminating devices (strobes) a command can be transmitted to, or the like.

The camera control section 170 transmits each item of information, regarding a plurality of information items for requesting transmission from the accessory control section 440, to the accessory control section 440, in accordance with a predetermined order (request order). Information is previously stored in the storage section 444 so that the accessory control section 440 can read out information sequentially in accordance with the request order. The accessory control section 440 reads out information from the storage section 444 in accordance with the request order, and transmits the communication signal DATA indicating readout information to the camera control section 170. In addition, the camera control section 170 transmits camera initial state information indicating an initial state of the camera body 100 to the accessory control section 440, in order previously set with respect to the request order. The initial state information is previously stored in the storage section 158 of the camera body 100. The camera initial state information includes monitor charging permission information and the like. The monitor charging permission information is used in a charging control described later. Hereinafter, an example of a process flow in the initial communication sequence will be described.

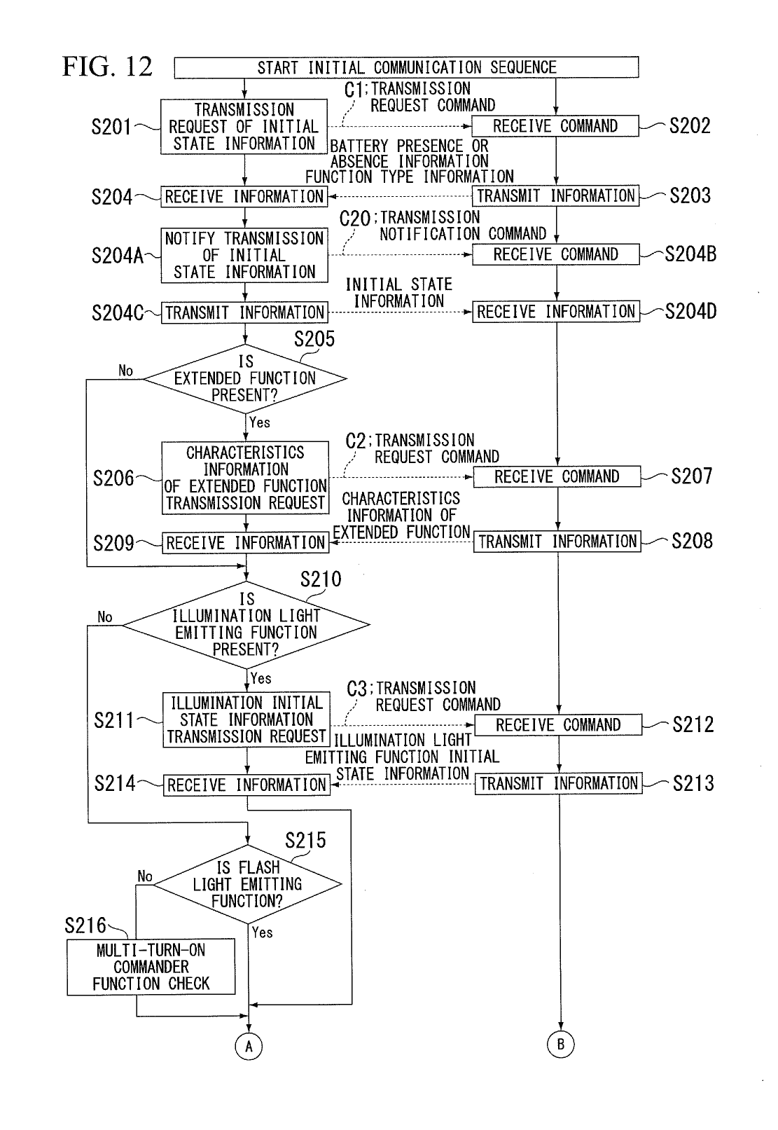

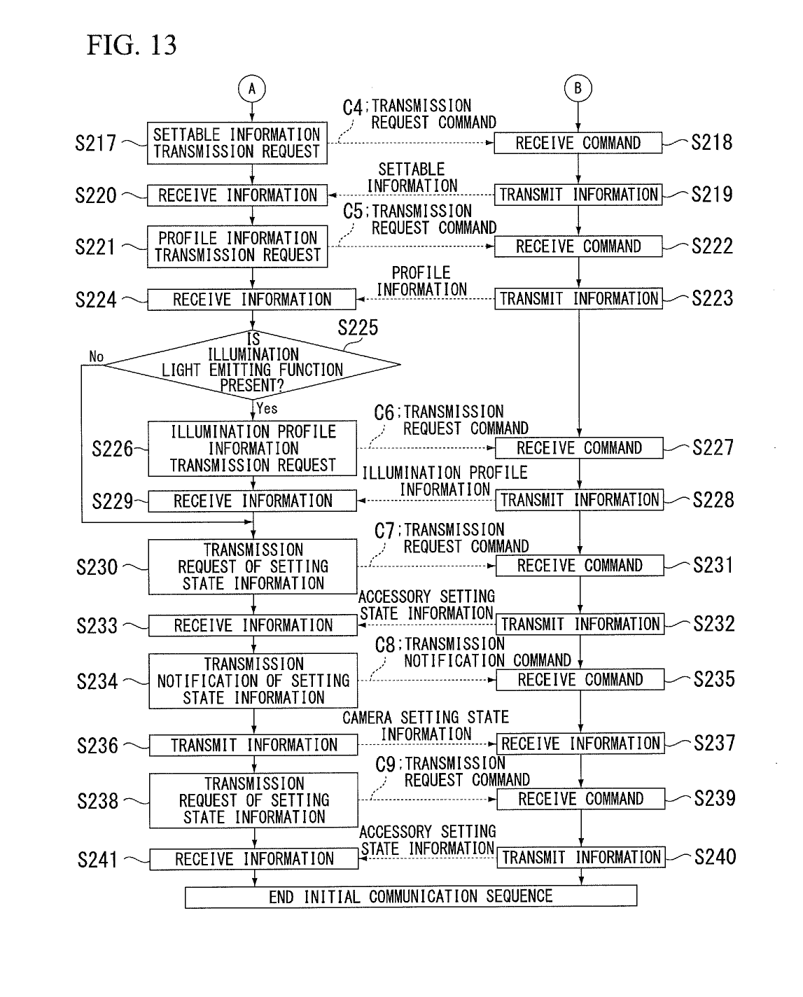

FIG. 12 is a diagram illustrating a procedure of processes in the initial communication sequence. FIG. 13 is a diagram illustrating a procedure of processes subsequent to FIG. 12. In FIGS. 12 and 13, similarly to FIG. 11, a left flow in the drawing is the processing details in the camera control section 170 of the camera body 100, and a right flow in the drawing is the processing details in the accessory control section 440 of the accessory 400.

When the communication preparation sequence (see FIGS. 9A, 9B and 10) is terminated and then the initial communication sequence is started, the camera control section 170 transmits a transmission request command C1 for requesting transmission of information included in the accessory initial state information to the accessory control section 440, and prepares for receiving the accessory initial state information (step S201). The transmission request command C1 is request information indicating that the camera control section 170 requests transmission of the accessory type information of the accessory initial state information.

The accessory control section 440 receives the transmission request command C1 (step S202). The accessory control section 440 previously stores response information responding in accordance with the request information (transmission request command C1) from the camera control section 170 in the storage section 444, before the transmission thereof to the camera control section 170. The accessory control section 440 reads out the response information stored in the storage section 444 and sends (transmits) the readout response information to the camera control section 170, in accordance with the request information sent from the camera control section 170 (step S203). The camera control section 170 receives the battery presence or absence information and the function type information (step S204).

The camera control section 170 transmits a transmission notification command C20 for transmission of the above-mentioned “camera initial state information” to the accessory control section 440, and prepares for transmitting the camera initial state information (step S204A). The accessory control section 440 receives the transmission notification command C20, and prepares for receiving the camera initial state information (step S204B). The camera control section 170 transmits the transmission notification command C20 in step S204A, and then transmits the camera initial state information to the accessory control section 440 (step S204C). The accessory control section 440 receives the camera initial state information (step S204D).

The camera control section 170 determines whether the accessory 400 has an extended function, based on the function type information received in step S204 (step S205). When it is determined in step S205 that the accessory 400 has an extended function (step S205; Yes), the camera control section 170 transmits a transmission request command C2 for requesting transmission of characteristics information indicating the details of the extended function to the accessory control section 440 (step S206). The accessory control section 440 receives the transmission request command C2 (step S207), and transmits the characteristics information of the extended function to the camera control section 170, in accordance with the transmission request command C2 (step S208). The camera control section 170 receives the characteristics information of the extended function (step S209).

When it is determined in step S205 that a priority function (for example, GPS function) is included as the extended function, the camera control section 170 can receive characteristics information of the priority function in step S209 by designating the priority function based on the transmission request command C2. This priority function is a function in which a function for a setting to be in an on-state (effective) preferentially out of the functions included in the accessory 400 is previously set. When the characteristics information of the priority function is received in step S209, the camera control section 170 processes the priority function preferentially over other functions within the accessory 400. The camera control section 170 can transmit, for example, a command for making the priority function effective to the accessory control section 440 (for this reason, the startup of the extended function can be expedited).

After the reception of the characteristics information of the extended function is terminated, or when it is determined in step S205 that the accessory 400 does not have the extended function (step S205; No), the camera control section 170 determines whether the accessory 400 has the illumination light emitting function, based on the function type information received in step S204 (step S210). When it is determined in step S210 that the accessory 400 has the illumination light emitting function (step S210; Yes), the camera control section 170 transmits a transmission request command C3 for requesting transmission of initial state information (third response information, third information) of the illumination light emitting function to the accessory control section 440 (step S211). The accessory control section 440 receives the transmission request command C3 (step S212), and transmits the initial state information of the illumination light emitting function to camera control section 170, in accordance with the transmission request command C3 (step S213). The camera control section 170 receives the initial state information of the illumination light emitting function (step S214).

When it is determined in step S210 that the accessory 400 does not have the illumination light emitting function (step S210; No), the camera control section 170 determines whether the accessory 400 has the flash light emitting function, based on the function type information received in step S204 (step S215). When it is determined in step S215 that the accessory 400 does not have the flash light emitting function (step S215; No), the camera control section 170 determines whether the accessory 400 has a function which does not correspond to any of the illumination light emitting function and the flash light emitting function, for example, the multi-turn-on commander function, or the like, based on the function type information received in step S204 (step S216). In this manner, the accessory 400 may not have both the illumination light emitting function and the flash light emitting function. The light-emitting section 425 of which the light-emitting state is controlled by the accessory control section 440 may be provided in a separate device different from the accessory 400.

After the process of step S214 is terminated, or when it is determined in step S215 that the accessory 400 has the flash light emitting function (step S215; Yes), or after the process of step S216 is terminated, the camera control section 170 transmits a transmission request command C4, for requesting transmission of settable information indicating a function capable of setting the characteristics in the function of the accessory 400, to the accessory control section 440 (step S217). After the transmission request command C4 is received (step S218), the accessory 400 transmits the settable information of the accessory 400 to the camera control section 170 (step S219). The camera control section 170 receives the settable information of the accessory 400 (step S220).

The camera control section 170 transmits a transmission request command C5 for requesting transmission of profile information indicating a profile of the accessory 400 to the accessory control section 440 (step S221).

In the present embodiment, the profile information is information indicating the characteristics of the flash light emitting function. The profile information includes, for example, information indicating the emission characteristics of the flash light source 431. The emission characteristics of the flash light source 431 include, for example, at least one of the amount of light (brightness) and the wavelength (shade) of light emitted by the flash light source 431. The profile information is used in the AWB control or the like, for example, in an image capture mode causing the flash light emitting function to work.

After the transmission request command C5 is received (step S222), the accessory 400 transmits the profile information to the camera control section 170 (step S223). The camera control section 170 receives the profile information (step S224).

The camera control section 170 determines whether the accessory 400 has the illumination light emitting function, based on the function type information received in step S204 (step S225). When it is determined in step S225 that the accessory 400 has the illumination light emitting function (step S225; Yes), the camera control section 170 transmits a transmission request command C6 for requesting transmission of the illumination profile information to the accessory control section 440 (step S226).

In the present embodiment, the illumination profile information is information indicating the characteristics of the illumination light emitting function. The illumination profile information includes, for example, information indicating the emission characteristics of the illumination light source 437. The emission characteristics of the illumination light source 437 include, for example, at least one of the amount of light (brightness) and the wavelength (shade) of light emitted by the flash light source 431. The illumination profile information is used in the AE control, the AWB control or the like, for example, in an image capture mode causing the illumination light emitting function to work.

After the transmission request command C6 is received (step S227), the accessory control section 440 transmits the illumination profile information to the camera control section 170 (step S228). The camera control section 170 receives the illumination profile information (step S229).

When it is determined in step S225 that the accessory 400 does not have the illumination light emitting function (step S225; No), or after the process of step S229 is terminated, the camera control section 170 transmits a transmission request command C7 for requesting transmission of the accessory setting state information to the accessory control section 440 (step S230). After the transmission request command C7 is received (step S231), the accessory 400 transmits the accessory setting state information to the camera control section 170 (step S232). The camera control section 170 receives the accessory setting state information (step S233).

The camera control section 170 transmits a transmission notification command C8 for transmission of the above-mentioned “camera setting state information” to the accessory control section 440 (step S234). The accessory 400 receives the transmission notification command C8 (step S235). The camera control section 170 transmits the camera setting state information to the accessory control section 440 (step S236). The accessory control section 440 receives the camera setting state information (step S237).

A transmission request command C9 for requesting transmission of the accessory setting state information is transmitted to the accessory control section 440 (step S238). After the transmission request command C9 is received (step S239), the accessory 400 transmits the accessory setting state information to the camera control section 170 (step S240). The camera control section 170 receives the accessory setting state information (step S241). After the process of step S241 is terminated, the initial communication sequence is terminated.

The following processes are performed in the camera system 1, in accordance with the procedure of the above-mentioned initial communication sequence. A first process included in the procedure of the initial communication sequence includes a process in which the accessory control section 440 sends information stored in the storage section 444 as a response to the transmission request from the camera control section 170. The response process to the transmission request is performed, for example, in accordance with a control procedure given as follows.

As mentioned above, the storage section 444 previously stores response information responding in accordance with request information from the camera control section 170. For example, the accessory control section 440 sends the response information stored in the storage section 444 to the camera control section 170, in accordance with the request information (see step S203) sent from the camera control section 170 (see step S204). By using such a process, for example, the accessory control section 440 transmits type information of an object to be controlled by the accessory control section 440 to the camera control section 170, in accordance with the request information from the camera control section 170.

In addition, when the storage section 444 stores the first response information including the type information indicating the type of the object to be controlled by the accessory control section 440, the accessory control section 440 sends the first response information to the camera control section 170, in accordance with the request information sent from the camera.

In addition, the storage section 444 may store the second response information including detail information of the object to be controlled by the accessory control section 440 in performing the control of the object to be controlled by the accessory control section 440, in association with the type information in the first response information. In this case, the accessory control section 440 sends the second response information to the camera control section 170, in accordance with the request information sent from the camera control section 170.

In addition, the accessory control section 440 sends the second response information to the camera control section 170 at the timing (see step S208) different from the timing (see step S203) of sending the first response information. For example, after the first response information is sent to the camera control section 170 (see step S203), the accessory control section 440 sends the second response information to the camera 10, in accordance with the request information sent from the camera control section 170 (see step S208).

In addition, the accessory control section 440 may be required to control a plurality of objects to be controlled. In such a case, the storage section 444 stores, for each object to be controlled, the second response information including the detail information of the object to be controlled by the accessory control section 440, with respect to each of the plurality of objects to be controlled, in association with the type information of the object to be controlled. The accessory control section 440 sends the second response information, including the detail information of the object to be controlled, which is designated by the request information sent from the camera control section 170 out of a plurality of objects to be controlled, to the camera control section 170. For example, the accessory control section 440 transmits the characteristics information of the extended function (for example, GPS function), in accordance with the request information (see step S207) of the camera control section 170 (see step S208). In addition, the accessory control section 440 transmits characteristics information of the illumination light emitting function, in accordance with request information (see step S212) of the camera control section 170 regarding a separate function (for example, illumination light emitting function) from the characteristics information of the extended function (see step S213).

In addition, a plurality of objects to be controlled may be divided into a plurality of groups depending on the type of the object to be controlled by the accessory control section 440. In the present embodiment, the objects to be controlled belonging to a first group include the flash light emitting section 430 and the illumination light emitting section 435 which take charge of the light-emitting function. Functions of the objects to be controlled belonging to the first group may be set to basic functions included in the accessory 400. In addition, the objects to be controlled belonging to a second group include, for example, the GPS function section and the like which take charge of functions other than the light-emitting function. Functions of the objects to be controlled belonging to the second group may be set to the extended function included in the accessory 400.

The accessory control section 440 sends the third response information, including detail information of the objects to be controlled (for example, illumination light emitting section 435) belonging to the first group of a plurality of groups, to the camera control section 170 as the second response information (see step S213). When there are objects to be controlled belonging to the second group different from the first group of a plurality of groups, the accessory control section 440 sends fourth response information including detail information of the objects to be controlled belonging to the second group to the camera 10 as a second response signal, after the first response information is sent (see step S203), and before the third response information is sent (step S213) (step S208).

In this manner, the camera system 1 performs a process in which the accessory control section 440 responds to the transmission request from the camera control section 170, and thus the occurrence of a failure or the like of communication due to, for example, mismatching between the request information and the response information is suppressed. In addition, in the camera system 1, for example, the accessory 400 is mounted to the camera control section 170, and then the presence or absence of the extended function is first determined based on the first response information. When it is determined that the extended function is “present” in the accessory 400 side, the camera 10 side acquires information (fourth response information, fourth information) early regarding the extended function. Therefore, a preparation operation for the extended function can be expedited on the camera 10 side based on the extended function information acquired early. For example, in the case of the accessory provided with the GPS function as the extended function, it is possible to early start the acquisition of GPS positioning information early, and to start a transmission process (reception process on the camera 10 side) to the camera 10 side. In this manner, the camera system 1 has greater convenience.

Next, a process in a control of supplying power to the accessory 400 (hereinafter, called the power supply control) will be described. In the power supply control, the camera system 1 starts a supply of power from the camera 10 to the accessory 400. The camera system 1 controls a supply of power from the camera 10 to the accessory 400 based on information indicating whether to supply power consumed in the accessory 400 from a power source mounted on the accessory 400. Hereinafter, an example of a process flow in a control of supplying power to the accessory 400 will be described.

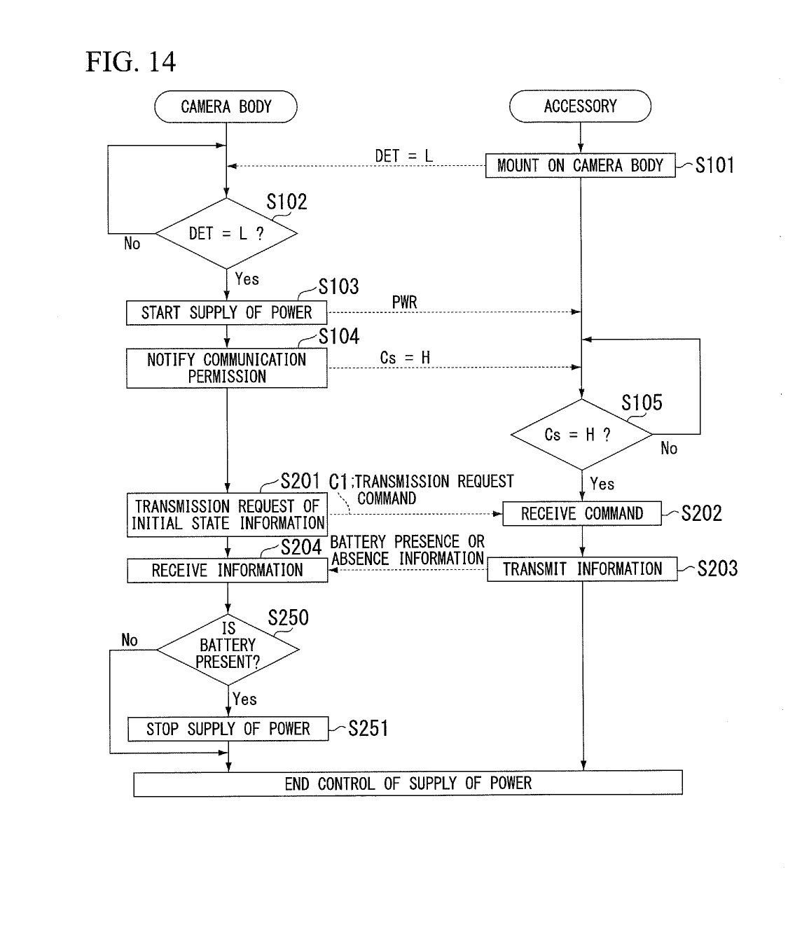

FIG. 14 is a diagram illustrating a procedure of processes in a control of supplying power to the accessory. Processes of step S101 to step S105 of processes shown in FIG. 14 are processes similar to the processes described in the communication preparation sequence (see FIG. 11). With the processes of step S101 to step S105, the camera control section 170 starts a supply of power to the accessory 400, in the communication preparation sequence, based on the signal level of the startup detection level DET (see step S103).

In addition, processes of step S201 to step S204 of processes shown in FIG. 14 are processes similar to the processes described in the initial communication sequence (see FIG. 12). In the process of step S204, the camera control section 170 receives, for example, battery presence or absence information from the accessory control section 440, as information indicating whether to supply the power consumed in the accessory 400 from the power source mounted on the accessory 400.

After the process of step S204 is terminated, the camera control section 170 determines whether a battery is mounted on the accessory 400, based on the battery presence or absence information received in step S204 (step S250). When it is determined in a determination process of step S250 that the battery is mounted on the accessory 400 (step S250; Yes), the camera control section 170 performs a control for stopping a supply of power to the accessory 400 which is started in step S103 of the communication preparation sequence (step S251). That is, in step S251, the camera control section 170 controls the accessory power source control section 33, and causes the accessory power source control section 33 to stop a supply of power from the camera body 100 to the accessory 400. When it is determined in the determination process of step S250 that the battery is not mounted on the accessory 400 (step S250; No), the camera control section 170 maintains a supply of power to the accessory 400 which is started in step S103 of the communication preparation sequence.

The control of a supply of power to the accessory 400 is terminated after the camera control section 170 determines that the battery is not mounted on the accessory 400, or after the camera control section 170 stops a supply of power to the accessory 400.

As stated above, when it is determined that the battery is mounted on the accessory 400 based on the battery presence or absence information, the camera control section 170 determines that the power consumed in the accessory 400 is supplied from the battery mounted on the accessory 400, and stops a supply of power to the accessory 400. In addition, when it is determined that the battery is not mounted on the accessory 400 based on the battery presence or absence information, the camera control section 170 determines the power consumed in the accessory 400 is not supplied from the battery mounted on the accessory 400, and continues a supply of power to the accessory 400. In this manner, the accessory control section 440 sends the battery presence or absence information to the camera control section 170, as information indicating whether the power source is included in the accessory 400, in other words, whether the power consumed on the accessory 400 side is supplied from the battery mounted on the accessory 400 (whether the power is supplied only to the accessory 400 side without requiring a supply of power from the camera 10), further in other words, whether a supply of power consumed in the accessory 400 is requested from the camera 10. In the present embodiment, the accessory control section 440 sends the battery presence or absence information in accordance with the request from the camera control section 170 (see step S201).

The camera system 1 in the present embodiment is configured such that the camera 10 supplies power to the accessory 400, and the power source is not mounted on the accessory 400. For this reason, the accessory control section 440 sends the battery presence or absence information (battery “absence” information), indicating that the power source is not mounted on the accessory 400, to the camera 10. The camera control section 170 continues a supply of power to the accessory 400 which is started before the battery presence or absence information is sent, based on the battery presence or absence information (see step S204) sent from the accessory control section 440. In this manner, the accessory control section 440 in the accessory 400 which is not provided with the power source sends the battery presence or absence information (battery “absence” information) to the camera 10, in order to supply the power consumed in the accessory 400 from the camera 10.

In addition, the accessory 400 may be supplied with the power consumed on the accessory 400 side from other than the camera 10. For example, there is a case where the power source (battery or the like) is mounted inside the accessory 400, a case where an external power source for supplying a power source from the outside with respect to the accessory 400 is included (for example, a system in which a battery pack for supplying a power source to the accessory 400 is mounted, or a system for supplying a household (commercial) power source through an AC adapter or the like to the accessory 400), or the like. In such a case, for example, in the case where the battery is mounted inside the accessory 400, the accessory control section 440 sends the battery presence or absence information (battery “presence” information), indicating an accessory supplied with the power consumed in the accessory 400 from the power source within the accessory, to the camera 10. The camera control section 170 in this case stops a supply of power to the accessory 400 which is started before the battery presence or absence information (battery “presence” information) is received, based on the battery presence or absence information (battery “presence” information) (step S204) sent from the accessory control section 440 (see step S251).

Such a control of a supply of power is performed, whereby, for example, when the power source is mounted on the accessory 400 side, the camera 10 can suppress the occurrence of power shortage of the camera 10 due to continuation of a supply of power unnecessary to be provided to the accessory 400 side. In this manner, the camera system 1 can suppress the occurrence of defects such as an operation stop, for example, due to power shortage of the camera 10, and thus, the camera system 1 has greater convenience.

In addition, in the above description, the battery presence or absence information is described as information indicating whether the power consumed in the accessory 400 is supplied from the power source mounted on the accessory 400, but the embodiment is not limited thereto. For example, the battery presence or absence information may be information indicating whether the power can be received from the camera 10, in other words, information indicating whether the accessory 400 has an ability to receive power from the camera 10. In this manner, even when the battery presence or absence information indicates any of the above-mentioned information, the camera system 1 can reliably determine whether the power has to be supplied from the camera 10 to the accessory 400 (whether a supply of power from the camera 10 to the accessory 400 has to be continued), and the accessory 400 can continue the operation through the supply of power. Therefore, the camera system can suppress the occurrence of defects such as an operation stop on the accessory 400 side due to the stop of a supply of power from the camera 10, and becomes a system having greater convenience.

Next, a steady communication sequence will be described. During the steady communication sequence, in the camera system 1, the camera 10 and the accessory 400 mutually exchange information necessary for image capture. In a period for which the interrupt request is not generated as shown in FIG. 10, the steady communication sequence is repeatedly executed, for example, at an interval of approximately 200 ms. In each of the steady communication sequences repeatedly performed, the camera 10 and the accessory 400 transmit and receive a plurality of information items in accordance with a predetermined order, similarly to the above-mentioned communication sequence.

In addition, the camera 10 and the accessory 400, respectively, update information received the previous initial communication sequence or the previous steady communication sequence to information received in this steady communication sequence, as necessary. In addition, when the initial state information is updated, the camera system 1 can restart the initial communication sequence, or update the initial state information by designating items necessary to be updated. Hereinafter, an example of a process flow of the steady communication sequence will be described.

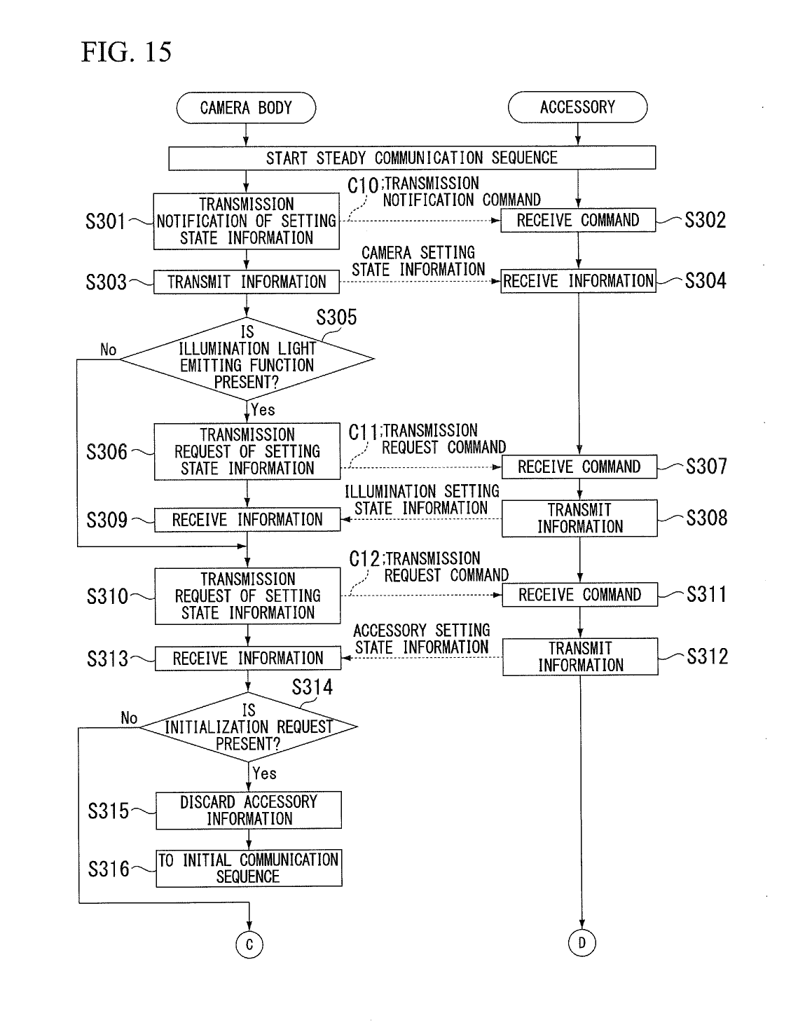

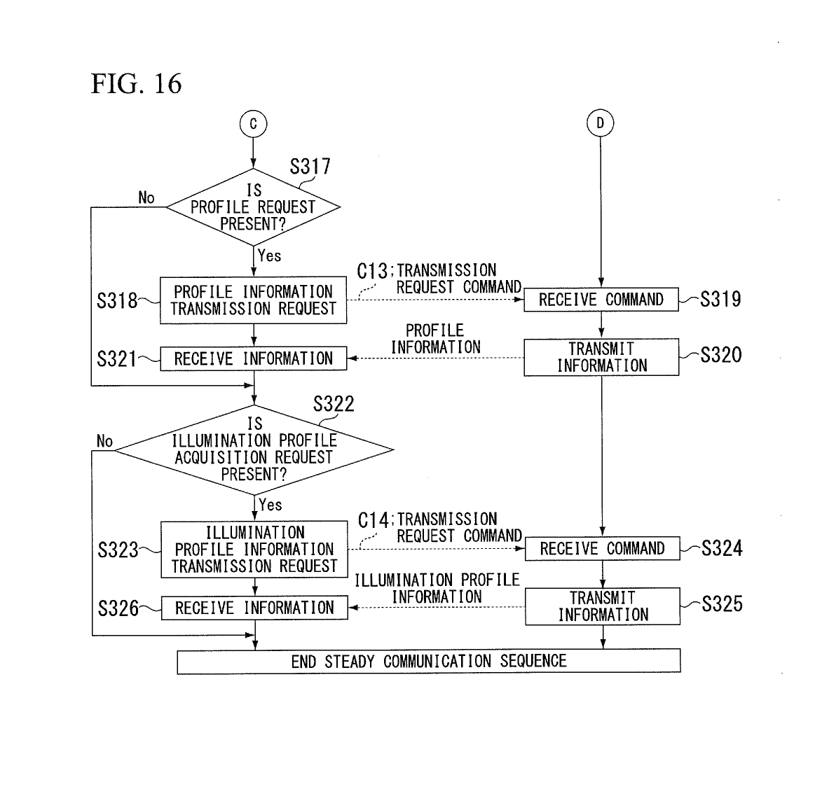

FIG. 15 is a diagram illustrating a procedure of processes in the steady communication sequence. FIG. 16 is a diagram illustrating a procedure of processes subsequent to FIG. 15.

When the steady communication sequence is started, the camera control section 170 transmits a transmission notification command C10 for transmission of the camera setting state information to the accessory control section 440 (step S301). The accessory control section 440 receives the transmission notification command C10, and prepares for receiving the camera setting state information (step S302). The camera control section 170 transmits up-to-date camera setting state information of items designated by the transmission notification command C10 to the accessory control section 440 (step S303). The accessory control section 440 receives the up-to-date camera setting state information of items designated by the transmission notification command C10 (step S304).

The camera control section 170 determines whether the accessory 400 has the illumination light emitting function based on the function type information acquired in step S204 (see FIG. 12) of the initial communication sequence (step S305). When it is determined in step S305 that the accessory 400 has the illumination light emitting function (step S305; Yes), the camera control section 170 transmits a transmission request command C11 for requesting transmission of illumination setting state information indicating the setting state of the illumination light emitting function, to the accessory control section 440 (step S306). After the transmission request command C11 is received (step S307), the accessory control section 440 transmits the illumination setting state information to the camera control section 170 (step S308). The camera control section 170 receives the illumination setting state information (step S309).

When it is determined in step S305 that the accessory 400 does not have the illumination light emitting function (step S305; No), or after the process of step S309 is terminated, the camera control section 170 transmits a transmission request command C12 for requesting transmission of the accessory setting state information to the accessory control section 440 (step S310). The accessory control section 440 receives the transmission request command C12 (step S311), and transmits up-to-date accessory setting state information of items designated by the transmission request command C12 to the camera control section 170 (step S312). The camera control section 170 receives the up-to-date accessory setting state information of items designated by the transmission request command C12 (step S313).

The camera control section 170 determines whether an initialization request is included in the accessory setting state information acquired in step S313 (step S314). The initialization request is information indicating that the accessory control section 440 requests the camera control section 170 to reacquire information regarding the accessory 400 acquired in the initial communication sequence or the steady communication sequence.

When it is determined in step S314 that the initialization request is included in the accessory setting state information (step S314; Yes), the camera control section 170 discards the information regarding the accessory 400 acquired in the initial communication sequence or the steady communication sequence (step S315). After the process of step S315 is terminated, the camera control section 170 starts the initial communication sequence (step S316).

When it is determined in step S314 that the initialization request is not included in the accessory setting state information (step S314; No), the camera control section 170 determines whether profile update request information is included in the accessory setting state information received in step S313 (step S317). The profile update request information is information indicating that the accessory control section 440 requests the camera control section 170 to update profile information of characteristics information of the illumination light emitting function acquired in the initial communication sequence.

When it is determined in step S317 that the profile update request information is included in the accessory setting state information received in step S313 (step S317; Yes), the camera control section 170 transmits a transmission request command C13 for requesting transmission of the profile information to the accessory control section 440 (step S318). The accessory control section 440 receives the transmission request command C13 (step S319), and transmits the profile information to the camera control section 170 (step S320). The camera control section 170 receives the profile information (step S321), and updates the profile information held prior to the process of step S321 to the characteristics information of the illumination light emitting function received in step S321.

After the process of step S321 is terminated, or when it is determined in step S317 that the profile update request information is not included in the accessory setting state information (step S317; No), the camera control section 170 determines whether illumination profile update request information is included in the accessory setting state information received in step S313 (step S322). The profile update request information is information indicating that the accessory control section 440 requests the camera control section 170 to update the illumination profile information acquired in the initial communication sequence.

When it is determined in step S322 that the illumination profile update request information is included in the accessory setting state information in step S313 (step S322; Yes), the camera control section 170 transmits a transmission request command C14 for requesting transmission of the illumination profile information to the accessory control section 440 (step S323). The accessory control section 440 receives the transmission request command C14 (step S324), and transmits the illumination profile information (step S325). The camera control section 170 receives the illumination profile information (step S326), and updates the illumination profile information held before the process of step S321 to characteristics information of the flash light emitting function received in step S321.

The steady communication sequence is terminated after the camera control section 170 terminates the reception of the illumination profile information, or when the camera control section 170 determines in step S322 that update request information regarding the flash light emitting function is not included in the accessory setting state information (step S322; No).

As stated above, the storage section 444 previously stores a plurality of response information items responding in accordance with the request information from the camera control section 170. For example, the accessory control section 440 sends a plurality of response information items stored in the storage section 444 to the camera control section 170 in an order previously set, in accordance with the request information (see step S311) sent from the camera control section 170 (step S312). Consequently, the camera system 1 can suppress the occurrence of a failure or the like of communication, for example, due to mismatching between the request information and the response information, and thus the camera system has greater convenience.

In addition, according to the present embodiment, when a response indicating that the extended function is present is included in the response of the accessory 400 for the initial transmission request command C1 of the camera 10 and the accessory 400, the camera 10 first requests the characteristics information of the extended function (see step S206) before requesting the illumination initial state information (see step S211). The accessory 400 first starts the startup of the extended function in accordance with the request procedure from the camera 10. It is possible to expedite the startup of the extended function through such a procedure.

The camera control section 170 may be required to change the setting regarding the accessory 400 depending on the accessory setting state information or the accessory initial state information updated in the above-mentioned steady communication sequence. When the accessory control section 440 is required to change the setting regarding the camera 10 depending on the camera setting state information updated in this steady communication sequence, the required change of the setting is completed until the next steady communication sequence. For example, the accessory control section 440 performs the setting for making any of the illumination light emitting function and the flash light emitting function effective, and performs a control for causing the light-emitting function made effective to function.

As an example of this, a setting process for making each light-emitting function effective or ineffective will be described. The setting process for making each light-emitting function effective or ineffective is performed in accordance with an image capture mode of the camera 10. The camera system 1 controls the light-emitting section 425 of the accessory 400 in accordance with the image capture mode of the camera 10. The image capture mode is set, for example, in accordance with an input from a user or the like. When there is an input (input, from a user, of the purport to set a mode for performing the capture of a moving image) indicating that the image capture mode is set to a moving image capture mode, the accessory 400 is set to a first image capture mode for causing the illumination light emitting function to work. In addition, when an input (input, from a user, of the purport to set a mode for performing the capture of one still image whenever the release button 16 is fully pressed) indicating that the image capture mode is set to a still image capture mode, the accessory 400 is set to a second image capture mode for causing the flash light emitting function to work. In addition, when there is an input from a user indicating that the image capture mode is set to an emission prohibition image capture mode (mode for capturing an image without causing the light-emitting function to work), or when the light-emitting function is caused not to work in securing the amount of exposure, the accessory 400 is set to a third image capture mode for causing any of the illumination light emitting function and the flash light emitting function not to work.

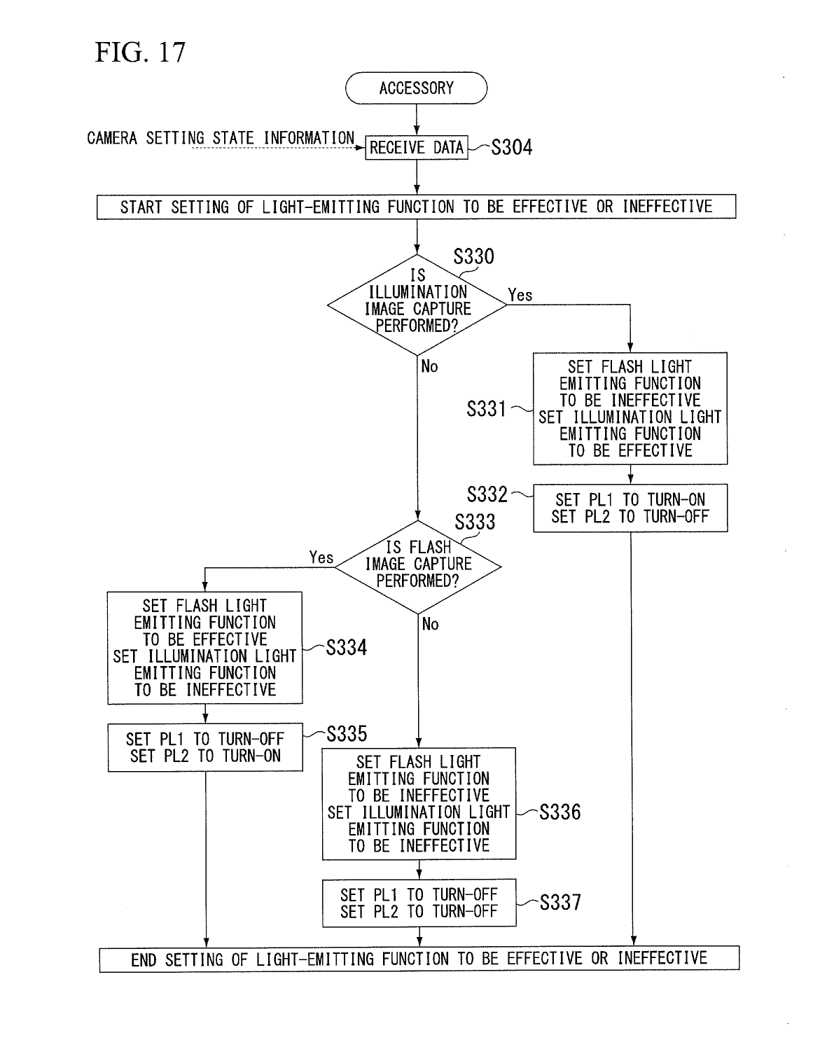

Next, a process flow of setting processes of making each light-emitting function effective or ineffective will be described with reference to a flow diagram of FIG. 17.

FIG. 17 is a diagram illustrating a procedure of setting processes of each light-emitting function effective or ineffective. A process of step S304 of processes shown in FIG. 17 is similar to the information receiving process (for example, step S204D or step S237) described in the steady communication sequence (see FIGS. 12 and 13).

In step S304, the accessory control section 440 receives the above-mentioned “camera setting state information” including image capture mode information indicating which image capture mode (moving image mode or still image mode) the camera 10 is set to. For example, when the image capture mode information included in the camera setting state information received in step S304 of the steady communication sequence is updated, the setting process of making each light-emitting function effective or ineffective is completed, for example, until the next steady communication sequence is started.

The accessory control section 440 determines whether the image capture mode of the camera 10 is set to the first image capture mode (illumination imaging) for causing the illumination light emitting function to work, based on the image capture mode information included in the camera setting state information received in step S304 of the steady communication sequence (step S330). When it is determined that the image capture mode of the camera 10 is set to the first image capture mode (step S330; Yes), the accessory control section 440 sets the flash light emitting function to an off-state (ineffective), sets the illumination light emitting function to an on-state (effective), and holds the set states by a flag (step S331).

In addition, in the step where the flash light emitting function is set to an off-state and the illumination light emitting function is set to an on-state (effective), the accessory control section 440 sets the above-mentioned first conduction switch to an OFF state and sets the second conduction switch to an ON state. In addition, in the step where the flash light emitting function is set to an off-state, the accessory control section 440 stops a preparation process for flash emission, that is, the main charging process to the accumulation section mentioned above, or the monitor charging process of monitoring the amount of charging of the accumulation section.

Subsequently to the process in step S331, the accessory control section 440 sets the first pilot lamp 455 (PL2) to turn-off, and sets the second pilot lamp 460 (PL1) to turn-on (step S332). When the image capture mode of the camera 10 is set to the first image capture mode, the setting process of making each light-emitting function effective or ineffective is terminated after the process of step S332 is terminated.

In addition, in the steady communication sequence, when any of the transmission request command (C11, C12, C13 or C14) is received from the camera control section 170, the accessory control section 440 may transmit the light-emittable time information to the camera control section 170 in step S308, step S312, step S320, and step S325.

When it is determined that the image capture mode of the camera 10 is not set to the first image capture mode (step S330; No), the accessory control section 440 determines whether the image capture mode of the camera 10 is set to the second image capture mode (flash image capture) for causing the flash light emitting function to work, based on the image capture mode information (step S333). When it is determined that the image capture mode of the camera 10 is set to the second image capture mode (step S333; Yes), the accessory control section 440 sets the flash light emitting function to be effective, sets the illumination light emitting function to be ineffective, and holds the set states by a flag (step S334).

In addition, in the step where the flash light emitting function is set to be effective and the illumination light emitting function is set to be ineffective, the accessory control section 440 sets the above-mentioned first conduction switch to an on-state and sets the second conduction switch to an off-state. In addition, in the step where the flash light emitting function is set to be effective, the accessory control section 440 performs the preparation process for flash emission, that is, the charging process to the accumulation section mentioned above.

When the preparation process (charging process) of flash emission is completed by the process in step S334, the accessory control section 440 sets the first pilot lamp 455 to turn-on subsequently to the completion, and sets the second pilot lamp 460 to turn-off (step S335).

A user can know that the flash light emitting section 430 is in an emittable state (charging completion state) through turn-on of the first pilot lamp 455. When the image capture mode of the camera 10 is set to the second image capture mode, the setting process of making each light-emitting function effective or ineffective is terminated after the process of step S335 is terminated.

When it is determined that the image capture mode of the camera 10 is not set to the first image capture mode (step S330; No) and it is determined that the image capture mode of the camera 10 is not set to the second image capture mode (step S333; No), the accessory control section 440 determines that the image capture mode of the camera 10 is set to the third image capture mode in which the light-emitting function is not used, and the accessory control section sets the flash light emitting function to be ineffective, also sets the illumination light emitting function to be ineffective, and holds the set states by a flag (step S336). Subsequently to the process of step S336, the accessory control section 440 sets the first pilot lamp 455 to turn-off, and also sets the second pilot lamp 460 to turn-off (step S337). When the image capture mode of the camera 10 is set to the third image capture mode, the setting process of making each light-emitting function effective or ineffective is terminated after the process of step S337 is terminated.

In such a process flow, the image capture mode information indicating the image capture mode of the camera 10 is input to the accessory control section 440 (see step S304). For example, when the selected image capture mode is the first image capture mode, first image capture mode information is input to the accessory control section 440. When the selected image capture mode is the second image capture mode, the second image capture mode information is input to the accessory control section 440.

The accessory control section 440 controls the processes in the accessory 400 in accordance with the image capture mode of the camera 10. For example, the accessory control section 440 controls the emission process of the flash light emitting section 430 and the emission process of the illumination light emitting section 435, in accordance with the image capture mode. For example, when the image capture mode is set to the first image capture mode, the accessory control section 440 sets the illumination light emitting function to be effective (see step S331), and controls the emission process of the illumination light emitting section 435. In addition, for example, when the image capture mode is set to second image capture mode, the accessory control section 440 sets the flash light emitting function to be effective (see step S334), and controls the emission process of the flash light emitting section 430. When the flash light emitting function is set to be effective, the accessory control section 440 performs a control such as a charging control described later.

In this manner, in the camera system 1, the accessory control section 440 automatically sets each light-emitting function to be effective or ineffective, for example, in accordance with the image capture mode selected by a user. When the flash light emitting section 430 is set to be ineffective with the automatic setting in the accessory 400, the emission preparation operation, such as the charging process, in the flash light emitting section 430 is also automatically stopped. Because the camera system can suppress useless power consumption within the accessory 400, it has greater convenience.

Next, a charging control to the flash light emitting section 430 for working in the flash light emitting function will be described.

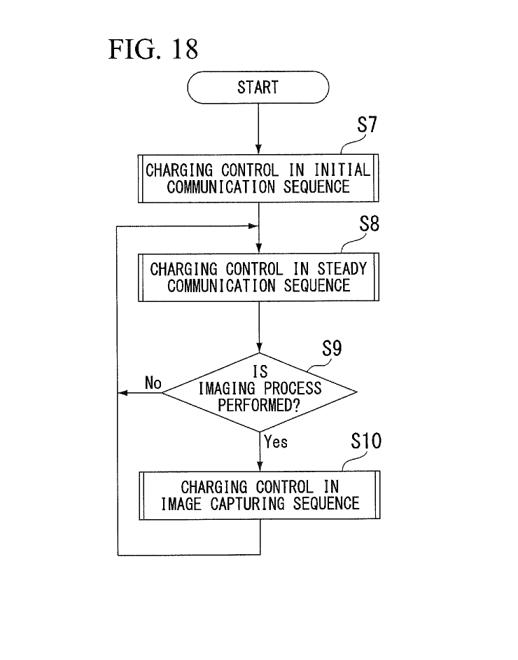

FIG. 18 is a diagram illustrating a procedure of processes of the charging control to the flash light emitting section 430 for working in the flash light emitting function. When the charging control is started, the camera system 1 performs each process of the charging control in the initial communication sequence (step S7), and next performs each process of the charging control in the steady communication sequence (step S8). After the process of step S8 is terminated, the camera system 1 determines whether to perform an imaging process (interrupt process) (step S9). When the camera control section 170 determines in step S9 that the imaging process is performed (step S9; Yes), the camera system 1 performs each process of the image capturing sequence.

In the present embodiment, the camera system 1 performs an image capture process including the imaging process, the AF control, the AE control, the AWE control and the like, in the image capturing sequence. Moreover, in the image capturing sequence, the camera system 1 performs each process of the charging control in the image capturing sequence together with the image capture process (step S10). After the image capture process in the image capturing sequence and each process of the charging control are terminated, or when the camera control section 170 determines in step S9 that the imaging process is not performed (step S9; No), the process returns to step S8 and the camera system 1 performs the charging control in the steady communication sequence once again.

As mentioned above, the steady communication sequence is repeatedly performed at specific intervals (for example, 200 ms) in a period of time for which the imaging process is not performed. In addition, the steady communication sequence subsequent to the image capturing sequence is performed after the period of time based on the amount of time for performing the process of the image capturing sequence that elapses after the steady communication sequence performed immediately before the image capturing sequence. That is, the steady communication sequence is repeatedly performed at regular or irregular intervals.

In each steady communication sequence, the accessory control section 440 transmits the charging state information, including the charging state information indicating the control state of the control for the charging section 432, to the camera control section 170. Since the steady communication sequence is repeatedly performed at regular or irregular intervals, the accessory control section 440 sends the charging state information to the camera control section 170 repeatedly at regular or irregular intervals. The camera control section 170 causes the accessory control section 440 to control the charging section 432, based on the charging state information received from the accessory control section 440.

Since the steady communication sequence is stopped when the imaging sequence is started, the accessory control section 440 does not transmit the charging state information to the camera control section 170 in a period of time for which the camera 10 performs the image capture process. In the imaging sequence, the camera control section 170 sends a command for causing the accessory control section 440 to control the charging section 432 to the accessory control section 440, even when the camera control section does not receive the charging state information from the accessory control section 440.

As stated above, in the camera system 1, the charging control for the flash light emitting section 430 is performed corresponding to each sequence. Hereinafter, a process in each sequence of the charging controls for the flash light emitting section 430 will be described for each sequence.

First, a charging control in the initial communication sequence of the charging controls for the flash light emitting section 430 will be described. In the accessory 400 of the present embodiment, a power source (battery) for supplying power consumed in the accessory 400 is not mounted. In addition, the charging section 432 of the accessory 400 cannot detect the amount of electric accumulation (the amount of charge) accumulated in the accumulation section except for the time of the charging process of charging the accumulation section. That is, the accessory 400 of the present embodiment does not hold information indicating the amount of charging of the charging section 432 in a point in time when the initial communication sequence is started. Consequently, in the initial communication sequence, the camera control section 170 transmits the camera initial state information, including monitor charging information indicating permission of the monitor charging operation in the accessory 400 (charging section 432) as setting information, to the accessory control section 440, and causes the accessory control section 440 to perform the monitor charging. The monitor charging information is information indicating whether the camera control section 170 permits the monitor charging operation to the accessory control section 440. The monitor charging information is monitor charging permission flag data in which “permission” and “prohibition” of the monitor charging are expressed by “0 (zero)” and “1”. The monitor charging information is previously stored in the storage section 158. Hereinafter, an example of a process flow of the charging control in the initial communication sequence will be described.

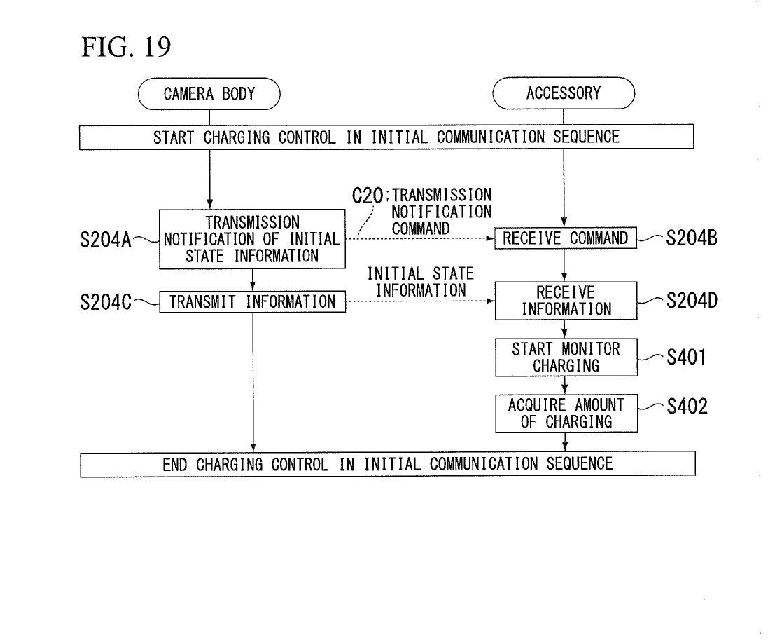

FIG. 19 is a diagram illustrating a procedure of processes of the charging control in the initial communication sequence. Processes of step S204A to step S204D of processes show in FIG. 19 are similar to those described in the initial communication sequence (see FIG. 12). The camera control section 170 transmits the transmission notification command C20 to the accessory control section 440 through the process of step S204A, and then reads out the camera initial state information stored in the storage section 158. This camera initial state information includes the above-mentioned monitor charging “permission” information. Next, the camera control section 170 transmits the camera initial state information read out in step S204A to the accessory control section 440 through the process of step S204C.

When the camera initial state information is received through the process of step S204D, the accessory control section 440 causes the storage section 444 to store the camera initial state information. That is, the monitor charging “permission” information supplied from the camera body 100 is stored in the storage section 444. The accessory control section 440 causes the charging section 432 to start the monitor charging process for slightly charging the accumulation section of the charging section 432, based on the monitor charging “permission” information (step S401). The charging section 432 detects the amount of electric accumulation (amount of charging of the monitor) accumulated in the charging section 432 through the monitor charging process, and calculates the amount of charge of the accumulation section at this point in time based on this amount of charging of the monitor. The accessory control section 440 acquires information indicating the amount of charge from the charging section 432 (step S402). The accessory control section 440 generates the charging state information transmitted to the camera control section 170 in the steady communication sequence subsequent to the initial communication sequence, based on information acquired in step S402 indicating the amount of charge accumulated, and causes the storage section 444 to store the generated charging state information. The charging control in the initial communication sequence is terminated after the accessory control section 440 causes the storage section 444 to store the charging state information.

As stated above, before periodic communication (steady communication sequence) with the camera control section 170 is started, the accessory control section 440 acquires information indicating the amount of charging of the monitor. In addition, in the initial communication sequence, the accessory control section 440 can cause the charging section 432 to perform the monitor charging without sending the charging request to the camera control section 170. Consequently, in the initial communication sequence, the accessory control section 440 can prepare the charging state information transmitted to the camera control section 170 in an initial steady communication sequence subsequent to the initial communication sequence. As a result, in the initial steady communication sequence, the camera control section 170 receives the charging state information from the accessory control section 440, and can start the charging control based on the received charging state information. Consequently, in the camera system 1 it is possible to shorten the time to start the charging control after the accessory 400 is mounted on the camera body 100. As a result, the camera system 1 can shorten the time taken until image capture for causing the flash light emitting function to work is performed, and the camera system has greater convenience. Additionally, in the above-mentioned example, the accessory control section 440 performs the monitor charging in accordance with the monitor charging “permission” information received from the camera control section 170, without sending the monitor charging request to the camera control section 170 in the initial communication sequence, but the embodiment is not limited thereto. For example, the accessory control section 440 may transmit the monitor charging request for requesting a command of the monitor charging to the camera control section 170, in a period until the accessory 400 is mounted on the camera body 100 and then the initial communication sequence is started, or in the initial communication sequence. In this case, the camera control section 170 may not transmit the monitor charging “permission” information.

Next, a charging control in the steady communication sequence of the charging controls for the flash light emitting section 430 will be described. The camera system 1 of the present embodiment determines a plurality of items indicating the charging state of the charging section 432 in order of the increasing influence on the image capture process, as a first process of the charging control in the steady communication sequence. As the first process, the camera control section 170 determines the charging state of the charging section 432, based on the charging state information included in the accessory setting state information received from the accessory control section 440 in this steady communication sequence. The accessory control section 440 sends the charging state information indicating the control state of the control for the charging section 432 to the camera control section 170. In addition, as stated previously, the charging state information includes the charging request information indicating whether the charging request is present, the charging lapse information indicating whether the charging section 432 is being charged, the chargeability information indicating whether the charging section 432 is capable of being charged, and the emission possibility information indicating whether the flash light emitting section 430 is in an emittable state (ready state).

In addition, as a second process of the charging control in the steady communication sequence, the camera system 1 of the present embodiment prioritizes a process of charging the accumulation section (charge accumulation section) of the charging section 432 of a plurality of processes performed in the camera system 1, when the flash light emitting section 430 is not in an emittable state (ready state).

For example, when the flash light emitting section 430 is not in a ready state, the camera control section 170 stops the operation, such as the AF control and the power zoom control, on the camera 10 (sets the operation to an operation prohibition state), and prioritizes the process of charging the accumulation section (charge accumulation section) of the charging section 432 over the AF control or the power zoom control. When it is set to an operation prohibition state, the camera control section 170 causes the charging section 432 to perform charging (normal charging) at a first charging rate which is previously set. In addition, when the flash light emitting section 430 is in a ready state, the camera control section 170 causes the charging section 432 to perform charging (slow charging) at a second charging rate slower than the first charging rate, and releases the operation prohibition state.

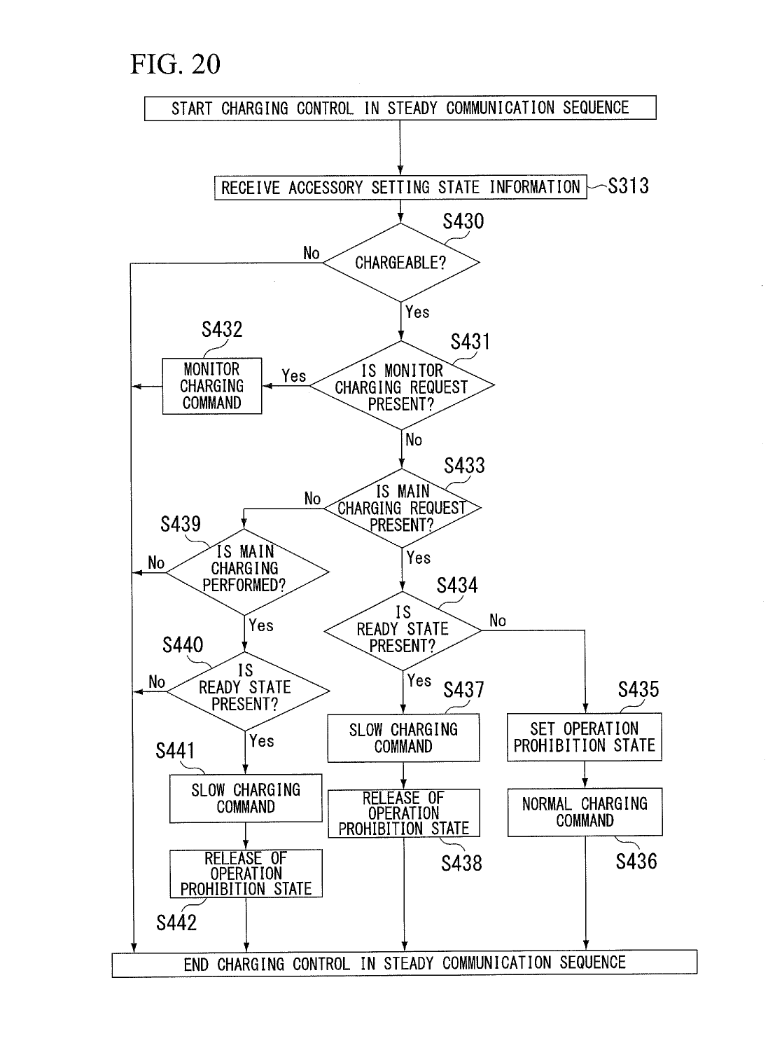

FIG. 20 is a diagram illustrating a procedure of processes of the charging control in the steady communication sequence. A process of step S313 of processes shown in FIG. 20 is a similar process to that described in the steady communication sequence (see FIG. 15). In step S313, the camera control section 170 receives the accessory setting state information including the charging state information. The camera control section 170 determines whether the charging section 432 can be charged, based on the above-mentioned chargeability information of the charging state information acquired in step S313 (step S430). When the camera control section 170 determines in step S430 that the charging section 432 is not capable of being charged (step S430; No), the charging control in the steady communication sequence is terminated.

When it is determined in step S430 that the charging section 432 is capable of being charged (step S430; Yes), the camera control section 170 determines whether the monitor charging request is present, based on the charging request information of the charging state information acquired in step S313 (step S431). When it is determined in step S431 that the monitor charging request is present (step S431; Yes), the camera control section 170 transmits a command (monitor charging command), for requesting the start of the monitor charging from the accessory control section 440, to the accessory control section 440 (step S432). The charging control in the steady communication sequence is terminated after the process of step S432 is terminated.

When it is determined in step S431 that the monitor charging request is not present (step S431; No), the camera control section 170 determines whether the main charging request is present, based on the charging request information of the charging state information acquired in step S313 (step S433). When it is determined in step S433 that the main charging request is present (step S433; Yes), the camera control section 170 determines whether the flash light emitting section 430 is in a ready state, based on the emission possibility information of the charging state information acquired in step S313 (step S434).

When it is determined in step S434 that the flash light emitting section 430 is not in a ready state (step S434; No), the camera control section 170 performs setting to an operation prohibition state in which a portion of the operations of the load section 30 is limited (prohibited) (step S435). In the present embodiment, the camera control section 170 limits at least a portion of the operations of the heavy load section of the load section 30 in step S435. In the present embodiment, the camera control section 170 limits (prohibits) the operation of the optical system driving section 220 in step S435.

After the process of step S435 is terminated, the camera control section 170 transmits a normal charging command, for commanding the accessory control section 440 to cause the charging section 432 to start the main charging using the normal charging, to the accessory control section 440 (step S436). The normal charging command is a command for requesting that the main charging at the first charging rate previously set is performed. After the process of step S436 is terminated, the charging control in the steady communication sequence is terminated.

The time required for the charging section 432 to charge the accumulation section (charge accumulation section) is longer than the time required until the AF control is started and then focused. When the flash light emitting section 430 is not capable of emitting light (is not in a ready state), the camera control section 170 of the present embodiment sets a portion of the load section 30 to an operation prohibition state, and prioritizes the main charging of the charging section 432 over a portion of the operations of the load section 30. Consequently, in the camera control section 170, the full-pressing operation of the release button 16 is performed in order to perform the main image capture with flash emission, and then the time required until the image capture with actual flash emission is possible can be shortened.

As an example, in an image capture situation requiring emission of the flash light emitting section 430, when a subject is brought into focus by completing the AF control and then the charging of the accumulation section is started, there is a concern to miss a best shot due to the movement or the like of the subject during the charging thereof. In the present embodiment, in such a situation, since the operation on the camera 10 side such as the AF control is prohibited, and the charging of the accumulation section of the charging section 432 is prioritized, it is possible to perform the image capture without missing the best shot.

In addition, the camera control section 170 of the present embodiment sets a portion of the load section 30 to an operation prohibition state, similarly to step S435 immediately after the image capture process for causing the flash light emitting function to work, and prioritizes the main charging of the charging section 432 over a portion of the operations of the load section 30.

When it is determined in step S434 that the flash light emitting section 430 is in a ready state (step S434; Yes), the camera control section 170 releases the operation prohibition state of the load section 30 (step S437). After the operation prohibition state of the load section 30 is released, the camera control section 170 transmits a slow charging command, for commanding the accessory control section 440 to cause the charging section 432 to start the main charging using the slow charging, to the accessory control section 440 (step S438). The slow charging command is a command for requesting that the main charging is performed at the second charging rate slower than the first charging rate. In the present embodiment, the second charging rate is a fixed value previously set (for example, substantially half of the first charging rate). The accessory control section 440 designates the charging rate to the second charging rate, and causes the charging section 432 to charge the accumulation section (charge accumulation section). After the process of step S438 is terminated, the charging control of the steady communication sequence is terminated.

When it is determined in step S433 that the main charging request is not present (step S433; No), the camera control section 170 determines whether the charging section 432 is being charged, based on the charging lapse information of the charging state information acquired in step S313 (step S439). When the camera control section 170 determines in step S439 that the charging section 432 is not being charged (step S439; No), the charging control in the steady communication sequence is terminated.

When it is determined in step S439 that the charging section 432 is being charged (step S439; Yes), the camera control section 170 determines whether the flash light emitting section 430 is in a ready state, based on the emission possibility information of the charging state information acquired in S313 (step S440). When the camera control section 170 determines in step S440 that the flash light emitting section 430 is not in a ready state (step S440; No), the charging control in the steady communication sequence is terminated.

When it is determined in step S440 that the flash light emitting section 430 is in a ready state (step S440; Yes), the camera control section 170 transmits the slow charging command to the accessory control section 440 similarly to step S437 (step S441). The camera control section 170 transmits the slow charging command to the accessory control section 440, and releases the operation prohibition state to the load section 30, similarly to step S438 (step S442). After the process of step S442 is terminated, the charging control in the steady communication sequence is terminated.

As stated above, as the first process of the charging control in the steady communication sequence, the camera control section 170 determines the charging state of the charging section 432 in accordance with the order of a predetermined priority, based on the charging state information. For example, the camera control section 170 initially determines whether the charging section 432 is in a chargeable state, among items indicating the charging state (see step S431). In addition, the camera control section 170 determines whether the charging section 432 is in a chargeable state, and then determines whether the charging request for charging the charging section 432 is present (see step S431 and step S433). In addition, the camera control section 170 determines whether the charging request for charging the charging section 432 is present, and then determines whether the charging section 432 is being charged (see step S439). In addition, the camera control section 170 determines whether the charging section 432 is being charged, and then determines whether the amount of charging of the accumulation section (charge accumulation section) of the charging section 432 is in a state (ready state) where it reaches a predetermined amount of charging which is previously set (see step S434). The order of priority of a plurality of items indicating the charging state is set, for example, so that the item having an increasing influence on the image capture process of the camera 10 is first determined. In this manner, the camera system 1 can perform the charging control efficiently to determine the charging state of the accessory 400 in accordance with the order of priority which is previously set, and therefore, the camera system has greater convenience.

In addition, as the second process of the charging control in the steady communication sequence, the camera control section 170 controls the priority regarding the charging process performed in the accessory 400 among processes of controlling the object to be controlled, based on the charging state information. For example, when the amount of charging of the charging section 432 is less than the threshold (less than the emission permission level) which is previously set, the camera control section 170 performs a control so as to limit (see step S435) of the driving of the optical system 210. That is, when the flash light emitting section 430 is not in a ready state, the camera control section 170 performs a control so that the charging process is prioritized over the process performed by the heavy load section (for example, optical system driving section 220). As stated above, the camera system 1 of the present embodiment does not miss a good time to take a picture even in an image capture situation requiring emission of the flash light emitting section 430, and thus has greater convenience.

Next, processes in the image capturing sequence will be described. First, a description will be made with an emphasis on the processes in the image capturing sequence for causing the flash light emitting function to work.

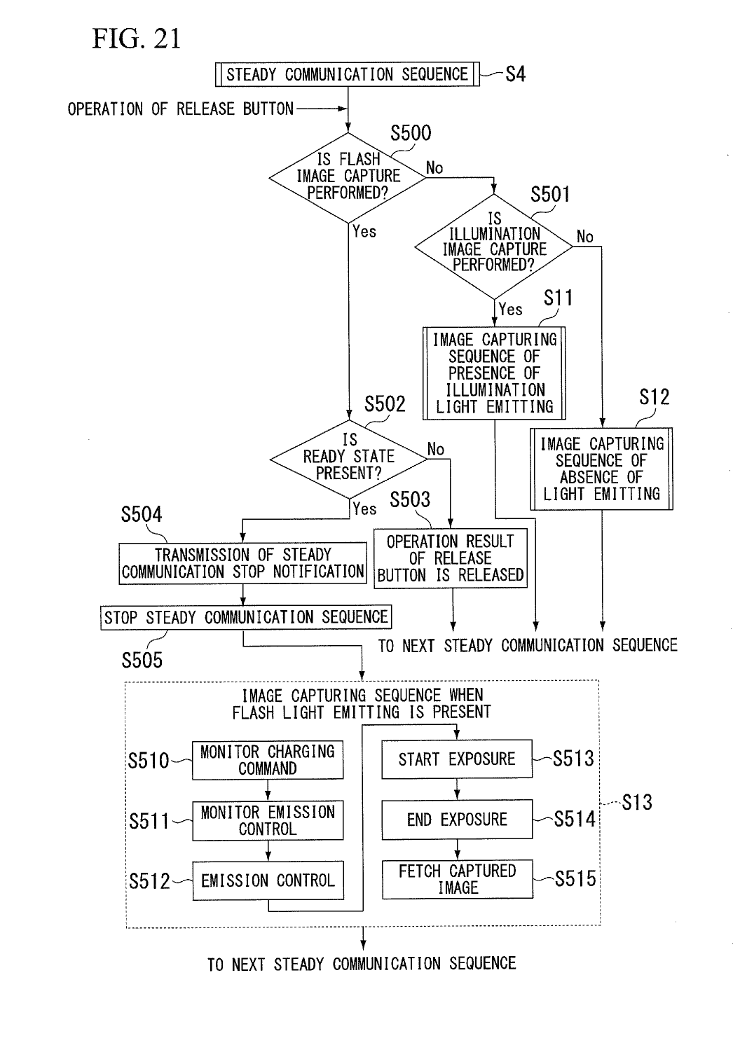

FIG. 21 is a diagram illustrating a procedure of processes in the image capturing sequence. When it is detected that the release button 16 is operated by the termination of the steady communication sequence of step S4, the camera control section 170 determines whether the image capture mode of the camera 10 is the second image capture mode (flash image capture) for causing the flash light emitting function to work, based on the image capture mode information (step S500). In addition, when it is detected that the release button 16 is operated during the process in the steady communication sequence of step S4, the camera control section 170 stops the process regarding the operation of the release button 16 until the termination of the steady communication sequence of step S4.

When it is determined in step S500 that the image capture mode of the camera 10 is not the second image capture mode (step S500; No), the camera control section 170 determines whether the image capture mode of the camera 10 is the first image capture mode (illumination imaging) for the illumination light emitting function to work (step S501). When it is determined in step S501 that the image capture mode of the camera 10 is the first image capture mode (step S501; Yes), the camera control section 170 executes the image capturing sequence for causing the illumination light emitting function to work (step S11). When it is determined in step S501 that the image capture mode of the camera 10 is not the first image capture mode (step S501; No), the camera control section 170 executes the image capturing sequence for causing both the flash light emitting function and the illumination light emitting function not to work (step S12).

When it is determined in step S500 that the image capture mode of the camera 10 is the second image capture mode (step S500; Yes), the camera control section 170 determines whether the flash light emitting section 430 is in a ready state, based on the emission possibility information of the accessory setting state information received from the accessory control section 440 in the steady communication sequence of step S4 (step S502). When it is determined in step S502 that the flash light emitting section 430 is not in a ready state (step S502; No), the camera control section 170 determines that the release button is not operated (the operation result of the release button is released) in step S503. After the process of step S503 is terminated, the next steady communication sequence is started.

When it is determined in step S502 that the flash light emitting section 430 is in a ready state (step S502; Yes), the camera control section 170 transmits a steady communication stop notification, indicating the start of the next steady communication sequence is stopped (delayed) until the termination of the image capturing sequence, to the accessory control section 440 (step S504). After it is detected that the steady communication stop notification transmitted in step S504 is received by the accessory control section 440, the camera control section 170 stops the steady communication sequence together with the accessory control section 440 (step S505). After the process of step S505 is terminated, the image capturing sequence for causing the flash light emitting function to work is started (step S13).

After the image capturing sequence for causing the flash light emitting function to work is started, the camera control section 170 performs the AF control so as to focus on a subject designated by a user. In addition, the camera control section 170 transmits the above-mentioned monitor charging command to the accessory control section 440 (step S510), and causes the accessory control section 440 to start charging the charging section 432. The charging of the charging section 432 is continuously performed for a predetermined time which is previously set as mentioned above.

After the process of step S510 is terminated, the camera control section 170 performs a known monitor emission (pre-emission) control in order to measure reflectance of the subject, depending on the setting state of the camera 10 (step S511). In the monitor emission control, the camera control section 170 transmits a monitor emission control signal for performing monitor emission to the accessory control section 440 through the synchronous signal terminal Ts4 and the synchronous signal terminal Tp4. The accessory control section 440 causes the flash light emitting section 430 to emit light in accordance with the monitor emission control signal received from the camera control section 170. The camera control section 170 performs at least one of the AE control and the AWB control making use of a result obtained by capturing an image (monitor image capture) when the flash light emitting section 430 performs monitor emission, depending on the setting state of the camera 10. In addition, at least one of the monitor emission control, the AE control, and the AWB control may be omitted depending on the setting state of the camera 10.

When operation information (full-pressing operation of the release button 16) of the release button 16 to command the execution of image capture (main image capture) is detected, the camera control section 170 performs a light emission control (main light emission control) (step S512). The camera control section 170 transmits the emission control signal X, for requesting emission of the flash light emitting section 430 in synchronization with the image capture timing to be set in accordance with the timing at which the operation information (full-pressing operation) of the release button 16 is detected, to the accessory control section 440. The emission control signal X is maintained to an H level before execution of the light emission control, within the accessory 400, and the camera control section 170 notifies the accessory control section 440 of the image capture timing by changing the emission control signal X to an L level. When it is detected that the emission control signal X is changed to an L level, the accessory control section 440 causes the flash light emitting section 430 to emit light, in accordance with the timing at which the emission control signal X is changed to an L level.

The camera control section 170 starts exposure of the imaging device 121 in synchronization with the timing at which the flash light emitting section 430 emits light (step S513). The camera control section 170 starts exposure in step S513, and then terminates the exposure of the imaging device 121 when the exposure time set by the AE control or the like elapses (step S514). After the process of step S514 is terminated, the camera control section 170 performs an imaging process of fetching image data indicating an image captured by the imaging device 121 (step S515). The camera control section 170 stores the fetched image data in, for example, the memory 140. After the process of step S515 is terminated, the image capturing sequence for causing the flash light emitting function to work is terminated.

After the image capturing sequence is terminated, the next steady communication sequence is started. As mentioned above, the accessory control section 440 transmits the charging state information including the charging request information, the charging lapse information, the chargeability information, and the emission possibility information to the camera control section 170 in the steady communication sequence. However, the camera system 1 stops the steady communication sequence while the process of the image capturing sequence is performed, and thus the accessory control section 440 stops transmission of the charging state information. Consequently, the camera control section 170 sends a command for causing the accessory control section 440 to execute the charging control to the accessory control section 440, as necessary (see step S510). In this manner, in the image capturing sequence, the camera control section 170 can cause the accessory control section 440 to execute the charging without receiving the charging request from the accessory control section 440. In addition, in the image capturing sequence, the accessory control section 440 can cause the charging section 432 to charge the accumulation section (charge accumulation section) by receiving a command from the camera control section 170 without transmitting the charging request to the camera control section 170.

In addition, the processes in the image capturing sequence (step S12) of the third image capture mode for causing both the flash light emitting function and the illumination light emitting function to work include, for example, processes of step S513 to step S515. The image capturing sequence of the third image capture mode is different from the image capturing sequence for causing the flash light emitting function to work in that the light emission control is not performed. The processes in the image capturing sequence of the third image capture mode are the same as those of the image capturing sequence for causing the flash light emitting function to work except that the light emission control is not performed, and thus the description thereof will be omitted. In addition, the camera control section 170 stops the start of the steady communication sequence while performing the image capturing sequence of the third image capture mode, and starts the steady communication sequence after the image capturing sequence of the third image capture mode is terminated.

Next, an image capturing sequence for causing the illumination light emitting function to work will be described. When the image capture mode of the camera 10 is set to the first image capture mode (illumination image capture), the accessory control section 440 controls the emission process of the illumination light emitting section 435. The first image capture mode is, for example, any of the image capture mode for performing multiple still image capture processes in a predetermined time previously set, and the image capture mode for performing a moving image capture process continued for a predetermined time previously set.

As a first process in the image capturing sequence for causing the illumination light emitting function to work, the accessory 400 turns on the illumination light emitting section 435 in the timing at which focusing completion information is received from the camera 10 that is, after the AF control of the camera 10 is terminated, focusing is completed, and the focusing completion information transmitted from the camera 10 is received. The AE control or the AWB control is performed in a state where the illumination light emitting section 435 is turned on.

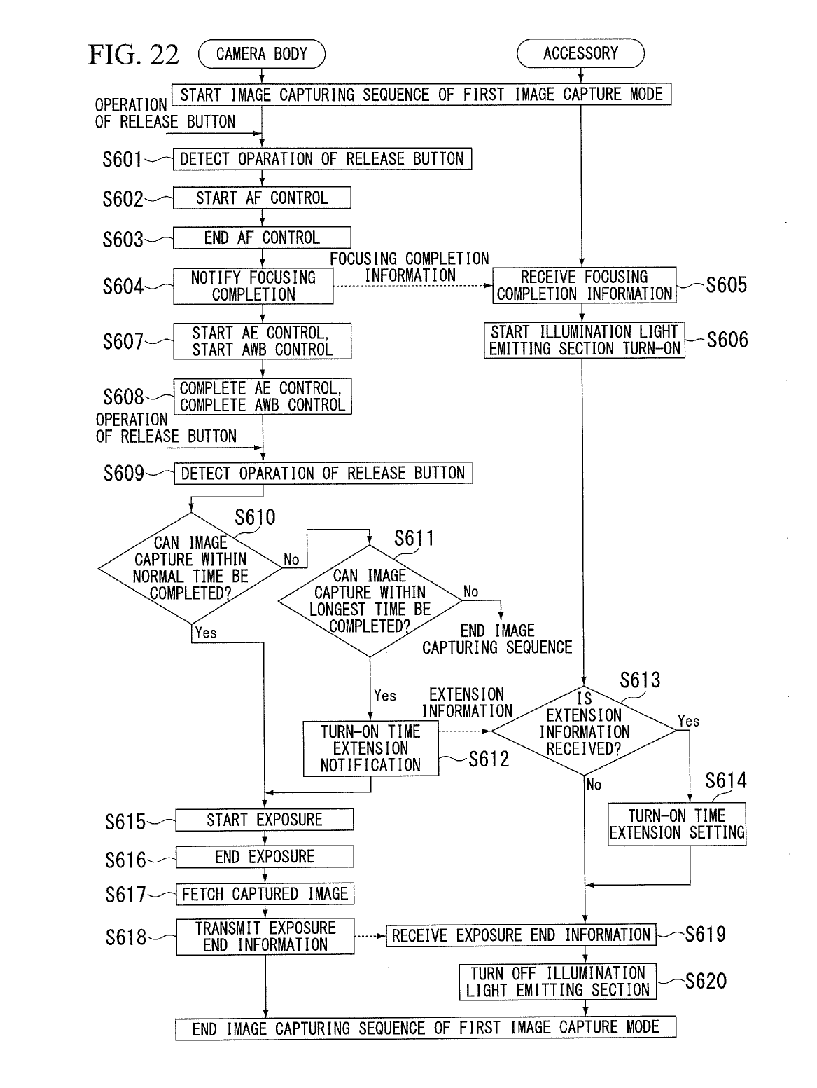

In addition, as a second process in the image capturing sequence for causing the illumination light emitting function to work, the camera body 100 extends the turn-on time in excess of the longest turn-on time, when the release button 16 is fully pressed just before the termination of the longest turn-on time. The longest turn-on time is, for example, the time which is set in advance, as an upper limit of the allowable range of the continuous turn-on time. As the initial conditions of the second process, the camera body 100 receives characteristics information of the illumination light emitting function from the accessory control section 440, in the above-mentioned steady communication sequence (see, for example, step S309 of FIG. 15) performed before the image capturing sequence of the first image capture mode for causing the illumination light emitting function to work is started (before the execution of the flow diagram of FIG. 22 is started). The characteristics information of the illumination light emitting function includes information indicating the longest turn-on time (information indicating the period (time) for which the illumination light emitting section 435 is capable of being continuously turned on).

FIG. 22 is a flow diagram illustrating a procedure of processes in the image capturing sequence for causing the illumination light emitting function to work. In FIG. 22, a left flow in the drawing is the processing details in the camera control section 170 of the camera body 100, and a right flow in the drawing is the processing details of the accessory control section 440 of the accessory 400. When the image capturing sequence of the first image capture mode for causing the illumination light emitting function to work is started, and then the operation (full pressing) of the release button 16 indicating the start of preparation of image capture is detected (step S601), the camera control section 170 starts the AF control (step S602). After the focusing state is detected by an AF sensor and the AF control is terminated (step S603), that is, after the focusing operation for a desired subject is completed and reaches a focusing state, the camera control section 170 transmits focusing completion information (focusing state information), indicating the completion (reaching the focusing state) of the focusing operation for the desired subject, to the accessory control section 440 (step S604). After the focusing state information is received (step S605), the accessory control section 440 causes the illumination light emitting section 435 to start turn-on (step S606). In a point in time when the image capturing sequence starts, the time (normal turn-on time) at which the accessory control section 440 turns on the illumination light emitting section 435 is set to be shorter than the longest turn-on time of the illumination light emitting section 435 by a predetermined time previously set.

After the process of step S604 is terminated, the camera control section 170 starts the AE control and the AWB control (step S607), and performs the AE control and the AWB control in a state where the illumination light emitting section 435 illuminates a subject. The camera control section 170 completes the AE control and the AWB control (step S608), and detects the operation (full pressing) of the release button 16 indicating a request of image capture (step S609). After the process of step S609 is terminated, the camera control section 170 determines whether the image capture can be completed within the longest turn-on time (step S610).

In step S610, the camera control section 170 determines whether the image capture can be completed within the normal turn-on time, based on the timing at which the focusing completion (state) information is transmitted (step S604), the normal turn-on time, and the timing (image capture start time) at which the operation (full pressing) of the release button 16 is detected in step S609. The camera control section 170, for example, seeks the turn-on time remaining in the illumination light emitting section 435 in a point in time when the operation (full pressing) of the release button 16 is detected, and determines whether the image capture can be completed within the normal turn-on time by comparing the sought turn-on time with the time required to complete the image capture.

When it is determined that the image capture can be completed within the normal turn-on time (step S610; Yes), the camera control section 170 starts exposure of the imaging device 121 (step S615).

When it is determined that the image capture cannot be completed within the normal turn-on time (step S610; No), the camera control section 170 extends the turn-on time from the normal turn-on time to the time equal to or less than the longest turn-on time (time indicating the upper limit of the continuous turn-on (light-emitting) time and time which is set in advance, in other words, longest time in which continuous turn-on (continuous light emitting) is allowed, i.e., “light-emittable time”), and further determines whether the image capture can be completed within the light-emittable time (step S611).

When camera control section 170 determines in step S611 that the image capture cannot be completed within the time extended further than the normal turn-on time (step S611; No), the image capturing sequence is terminated. When it is determined in step S611 that the image capture can be completed within the time extended further than the normal turn-on time (step S611; Yes), the camera control section 170 transmits extension information indicating an extension of the turn-on time to the accessory control section 440 (step S612). The accessory control section 440 receives the extension information (step S613). After the process of step S612 is terminated, the camera control section 170 starts exposure of the imaging device 121 (step S615).

The camera control section 170 starts the exposure in step S615, and then terminates the exposure of the imaging device 121 when the exposure time set by the AE control elapses (step S616). After the process of step S616 is terminated, the camera control section 170 generates image data of an image captured by the imaging device 121, and fetches and stores the generated image data in the memory 140 or the like (step S617). After the process of step S617 is terminated, the camera control section 170 transmits exposure termination information indicating a termination of the exposure to the accessory control section 440 (step S618).

After turn-on of the illumination light emitting section 435 is started in step S606, the accessory control section 440 determines whether the extension information is received from the camera control section 170 (step S613). When it is determined in step S613 that the extension information is received from the camera control section 170 (step S613; Yes), the accessory control section 440 sets the extension conditions of the illumination light emitting section 435 so that the turn-on time of the illumination light emitting section 435 exceeds the normal turn-on time to continue turn-on of the illumination light emitting section 435.

When it is determined in step S613 that the extension information is not received from the camera control section 170 (step S613; No), the accessory control section 440 maintains the illumination light emitting section 435 in a turn-on state without changing the turn-on time of the illumination light emitting section 435. The accessory control section 440 receives the exposure termination information from the camera control section 170 (step S619), and then turns off the illumination light emitting section 435 (step S620).

The accessory control section 440 turns off the illumination light emitting section 435, when the turn-on time of the illumination light emitting section 435 is equal to the longest turn-on time in a state where the extension information is not received from the camera control section 170. After the process of step S618 and the process of step S620 are terminated, the image capturing sequence using the illumination light emitting function is terminated.

In the first process performed in the procedure as mentioned above, when the camera control section 170 detects the focusing state, the accessory control section 440 turns on the illumination light emitting section 435 by the control of the camera control section 170 (step S606). For example, the accessory control section 440 turns on the illumination light emitting section 435 in accordance with the focusing completion information (step S605) received from the camera control section 170 (step S606). The focusing completion information is information indicating the focusing state.

In addition, in a state where a subject is illuminated by the illumination light emitting section 435, the camera control section 170 starts at least one of the AE control for adjusting the amount of exposure and the AWB control for adjusting the color tone (step S608). The AE control and the AWB control are performed based on information indicating the emission characteristics of the illumination light emitting section 435. Consequently, the camera system 1 can image a subject in a state where the influence of light with which a subject is irradiated from the illumination light emitting section 435 on the amount of exposure (brightness) or the influence thereof on the color tone (shade) is added. The camera system 1 is configured such that it starts (the emission start timing is delayed further than the AF start timing) the turn-on of the illumination light emitting section 435 after the accessory control section 440 receives the focusing completion information. Therefore, it is possible to lengthen the period for which illumination light can be emitted (turned on) in parallel with the main image capture operation during the main image capture period, as compared to a case where illumination light is emitted at the AF start timing (point in time of the half pressing operation). For this reason, it is possible to reduce a risk that the latter half of the image capture in the image capture period falls into a shortage of the amount of light illuminated (underexposure) due to the termination of turn-on of the illumination light emitting section 435 before the completion of the image capture operation. In this manner, the camera system 1 has greater convenience.

In addition, in the second process performed in the procedure as mentioned above, the camera control section 170 performs a control so as to make the turn-on time of the illumination light emitting section 435 longer than the normal turn-on time in accordance with the image capture start time. The longest turn-on time is previously set, for example, in accordance with the amount of heat generation of the illumination light source 437. The normal turn-on time is previously set in accordance with the longest turn-on time. The longest turn-on time is previously set, for example, in accordance with the amount of heat generation of the illumination light source 437. The accessory control section 440 turns on the illumination light emitting section 435 in the normal turn-on time previously set. The accessory control section 440 performs a control so as to make the turn-on time of the illumination light emitting section 435 long than the normal turn-on time in accordance with the image capture start time. Hereinafter, the second process will be described by way of a numerical example.

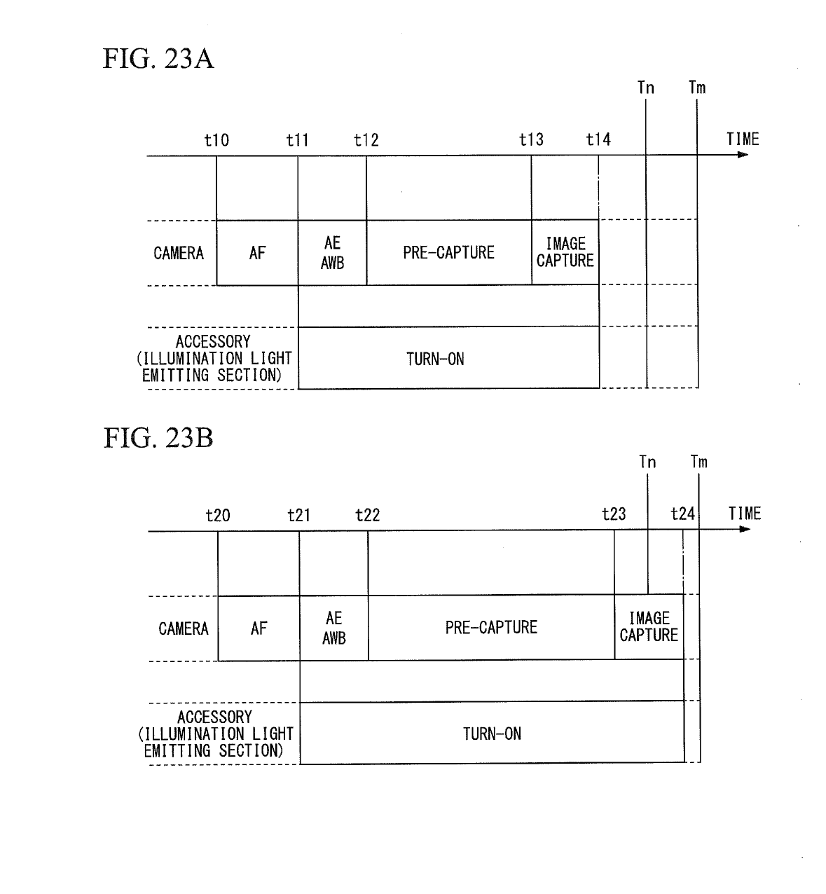

FIGS. 23A and 23B are diagrams illustrating a timing of executing each process of a control for extending the turn-on time. FIG. 23A shows a timing of executing each process in a case where the image capture is completed within the normal turn-on time. FIG. 23B shows a timing of executing each process in a case where the image capture is completed by extending the turn-on time within the longest turn-on time. In FIGS. 23A and 23B, sign Tn denotes the time when the normal turn-on time (for example, 6 seconds) elapses from the image capture start time, and sign Tm denotes the time when the longest turn-on time (for example, 8 seconds) elapses from the image capture start time. The time (image capture time) for which the image capture is performed is the time from the start (step S615) of exposure to the termination (step S616) of exposure, and is the time (for example, 2 seconds) previously set.

The camera system 1 of the present embodiment captures a multiple-frame image during the image capture time. In addition, the camera system 1 of the present embodiment performs pre-capture prior to a desired period for which an image capture process (shown by “image capture” in FIGS. 23A and 23B) is performed. The pre-capture is a process of starting fetching of an image before the release button 16 is fully pressed. Herein, the camera system 1 is configured such that when full pressing of the release button 16 is detected, the image capture is started before the time at which full pressing of the release button 16 is detected. That is, in the camera system 1, an image fetched in a predetermined time continuing before the time at which full pressing of the release button 16 is detected, and an image fetched in a predetermined time continuing after the time at which full pressing of the release button 16 is detected are set to images captured in the imaging process.

First, an example in which the image capture process is completed without extending the turn-on time will be explained. As shown in FIG. 23A, at time t10, the camera 10 starts the AF control in accordance with the time at which half pressing of the release button 16 is detected. Moreover, at time t11, which is after time t10, the camera 10 turns on the illumination light emitting section 435 of the accessory 400 in accordance with the time at which the AF control is completed. Furthermore, at time t11, the camera 10 starts at least one of the AE control and the AWB control, and performs at least one of the AE control and the AWB control, for example, in a state where a subject is illuminated by the illumination light emitting section 435.

At time t12, which is after time t11, the camera 10 starts pre-capture in accordance with the time at which the AE control and the AWB control are completed. At time t13, which is after time t12, the camera 10 starts the image capture process. As mentioned above, the camera 10 starts the image capture before the time at which full pressing of the release button 16 is detected. That is, the time at which full pressing of the release button 16 detected by the camera 10 is any of the time between time t13 at which the image capture process is started and time t14 at which the image capture process is terminated. In the present example, the image capture start time t13 is set to, for example, the time when 3 seconds elapsed from the turn-on start time (t11). In this case, when the image capture time is set to 2 seconds, the image capture time is terminated at time t14 (second time) when 5 seconds elapsed from the turn-on start time. In this case, the image capture process is terminated from turn-on start time t10 to time Tn (first time) when the normal turn-on time (6 seconds) elapsed. In such a case, at time t14, the camera 10 terminates the image capture process and turns off the illumination light emitting section 435.

Next, an example in which the image capture process is completed by extending the normal turn-on time will be explained. As shown in FIG. 23B, at time t20, the camera 10 starts the AF control in accordance with the time when half pressing of the release button 16 is detected. In addition, at time t21, which is after time t20, the camera 10 turns on the illumination light emitting section 435 of the accessory 400 in accordance with the time when the AF control is completed. In addition, at time t21, the camera 10 starts at least one of the AE control and the AWB control, and performs at least one of the AE control and the AWB control, for example, in a state where a subject is illuminated by the illumination light emitting section 435. In addition, at time t22 which is after time t21, the camera 10 starts pre-capture in accordance with the time when the AE control and the AWB control are completed.

In the camera 10 of the present embodiment, the time from image capture start time t23 to the time when full pressing of the release button 16 is detected, and the time from the time when full pressing of the release button 16 is detected to image capture ending time t24 when the image capture process is completed are previously set. In the present example, image capture start time t23 is set to, for example, the time when 5 seconds elapsed from the turn-on start time (t21). In this case, when the image capture time is set to 2 seconds, the image capture time is terminated at time t24 (second time) when 7 seconds elapsed from the turn-on start time. In this case, the image capture process cannot be completed from turn-on start time t20 to time Tn (first time) when the normal turn-on time (6 seconds) elapsed, but can be completed from turn-on start time t20 to time Tm when the longest turn-on time (8 seconds) elapsed. In such a case, in the camera 10, the image capture process is completed by extending the turn-on time of the illumination light emitting section 435. Thus, the camera system 1 extends the turn-on time in accordance with the image capture start time, and thus has greater convenience.

Next, a termination process of terminating the process in the accessory 400 will be described. In the control (see FIG. 14) for supplying power, the camera 10 starts a supply of power to the accessory 400 (see step S103). In addition, when it is determined that power consumed in the accessory 400 is not supplied from a power source mounted on the accessory 400 (see step S250), the camera 10 continues a supply of power to the accessory 400. The accessory 400 of the present embodiment outputs the signal (startup detection level DET), indicating a termination of the process performed by the accessory 400, to the camera 10. The startup detection level DET shown in FIGS. 9A and 9B is maintained to an L level, when the first switch section 465 is closed, and the second switch section 470 is closed. The startup detection level DET is changed to an H level, when at least one of the first switch section 465 and the second switch section 470 is cut off. For example, in the accessory 400, when a user detaches the accessory 400 from the camera 10, and operates the first operating portion 424 (see FIGS. 2 and 9A, 9B) so as to release fixation of the accessory 400 to the camera 10, the first switch section 465 opens a circuit. Consequently, the startup detection level DET is changed to an H level. In addition, the accessory 400 is configured such that when a user performs the function off operation on the second operating portion 471 (see FIGS. 2 and 9A, 9B) of the second switch section 470, the second switch section 470 opens a circuit. Consequently, the startup detection level DET is also changed to an H level. The accessory control section 440 of the accessory 400 provides to the camera 10 the startup detection level DET (H level) indicating that the process of the accessory 400 is terminated, and then starts the termination process. Hereinafter, an example of a process flow of the termination process will be described.

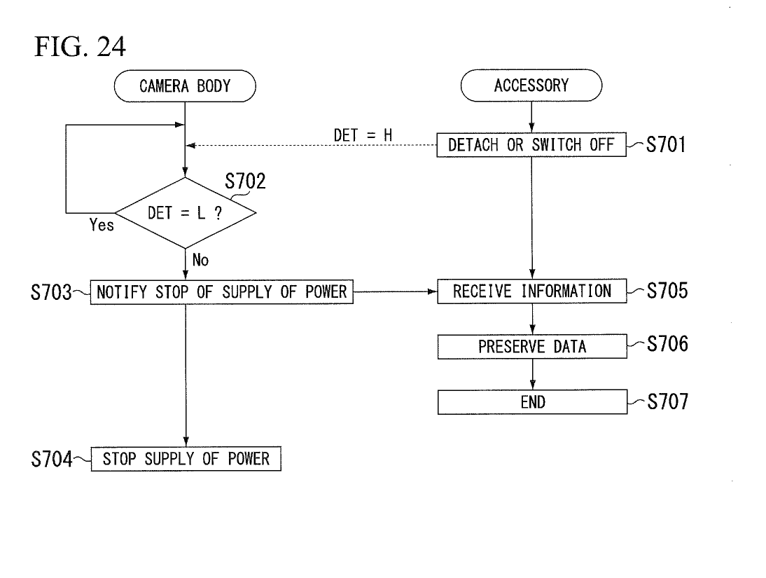

FIG. 24 is a diagram illustrating a procedure of processes of terminating the process in the accessory 400. The camera control section 170 continuously detects the potential of the startup state detecting terminal Tp7, and repeatedly performs a determination process of determining whether the startup detection level DET is an L level at a predetermined timing (predetermined period). That is, the camera control section 170 executes the determination process of determining whether the startup detection level DET is an L level (step S702). Moreover, when it is determined in step S702 that the startup detection level DET is an L level (step S702; Yes), the camera control section 170 determines that the accessory 400 is mounted on the camera 10, and the process returns to the determination process of step S702.

When it is determined in step S702 that the startup detection level DET is not an L level (step S702; No), the camera control section 170 transmits power supply stop information, indicating that a supply of power from the camera 10 to the accessory 400 is stopped, to the accessory control section 440 (step S703). At the timing after the power supply stop information is transmitted to the accessory control section 440 (step S703) and a predetermined power supply period previously set elapses from a point in time of transmission of the power supply stop information, the camera control section 170 controls the accessory power source control section 33, and stops a supply of power from the camera 10 to the accessory 400 (step S704). That is, in the accessory control section 440, the startup detection level DET is provided to the camera control section 170 or the power supply stop information is received from the camera, and a supply of power from the camera 10 is maintained for a while (for the above-mentioned predetermined power supply period), without cutting off a supply of power from the camera 10.

The accessory control section 440 performs the termination process described later, in a short period of time (in the above-mentioned predetermined power supply period) before a supply of power from the camera 10 to the accessory 400 is stopped. When the power supply stop information is received from the camera 10 (step S705), the accessory control section 440 starts the termination process for terminating the process of the accessory 400 (step S706). This termination process is a process for storing (preserving), in the nonvolatile memory 445 (storage section 444), information (for example, emission history information such as the number of emissions, accessory setting state information such as a set emission mode, or the like), temporarily stored in the storage section 444 within the accessory 400, indicating various types of states of the accessory 400 at that point in time. The accessory control section 440 terminates the process after step S706 (step S707).

In this manner, for example, when a user attempts to detach the accessory 400 from the camera 10, the camera system 1 performs the process (termination process mentioned above) necessary to terminate the process of the accessory 400. Therefore, the camera system can preserve the setting or the history of the accessory 400, and thus has greater convenience.

In addition, the technical scope of the present invention is not limited to the above-mentioned embodiment. At least one of the constituent elements described in the above-mentioned embodiment may be omitted. Each of the constituent elements described in the above-mentioned embodiment may be appropriately combined. In the above-mentioned embodiment, the accessory includes an accessory (that is, a flash device) having a flash light emitting function, an accessory (that is, an illuminating device) having an illumination light emitting function, an accessory (that is, a positioning device) having a GPS function, and a device (that is, a commander device) having a multi-turn-on commander function, but may be an accessory other than the above. For example, when the open terminals Tp10 and Ts10 are caused to function as terminals for transferring image data from the camera to the accessory, the above-mentioned accessory can also be used as an accessory (that is, an EVF) having an electronic viewfinder function, or an accessory (wireless transmitter) having a transmitter function for transmitting image data or the like to an external server or the like. In addition, when the open terminals Tp10 and Ts10 are caused to function as terminals for transferring audio data from the accessory to the camera, the above-mentioned accessory can also be used as an accessory (that is, a microphone) having a microphone function.

Additionally, as described with reference to FIG. 14, when it is determined that the battery is mounted on the accessory 400 (step S250: Yes), the camera control section 170 stops the supply of power to the accessory 400 (step S251), but the embodiment is not limited thereto. For example, the camera control section 170 may perform a control for stopping or suppressing the supply of power from the camera 10 (camera body 100) to the accessory 400, based on predetermined conditions other than that the battery being mounted on the accessory 400. The camera control section 170 stops or limits the supply of power to the accessory 400, thereby allowing at least a portion of the operation of the accessory 400 to be prohibited or limited when the accessory 400 performs an operation (called an unexpected operation) other than an operation previously expected on the camera 10 (camera body 100). Hereinafter, such a modified example will be described.

### Modified Example 1

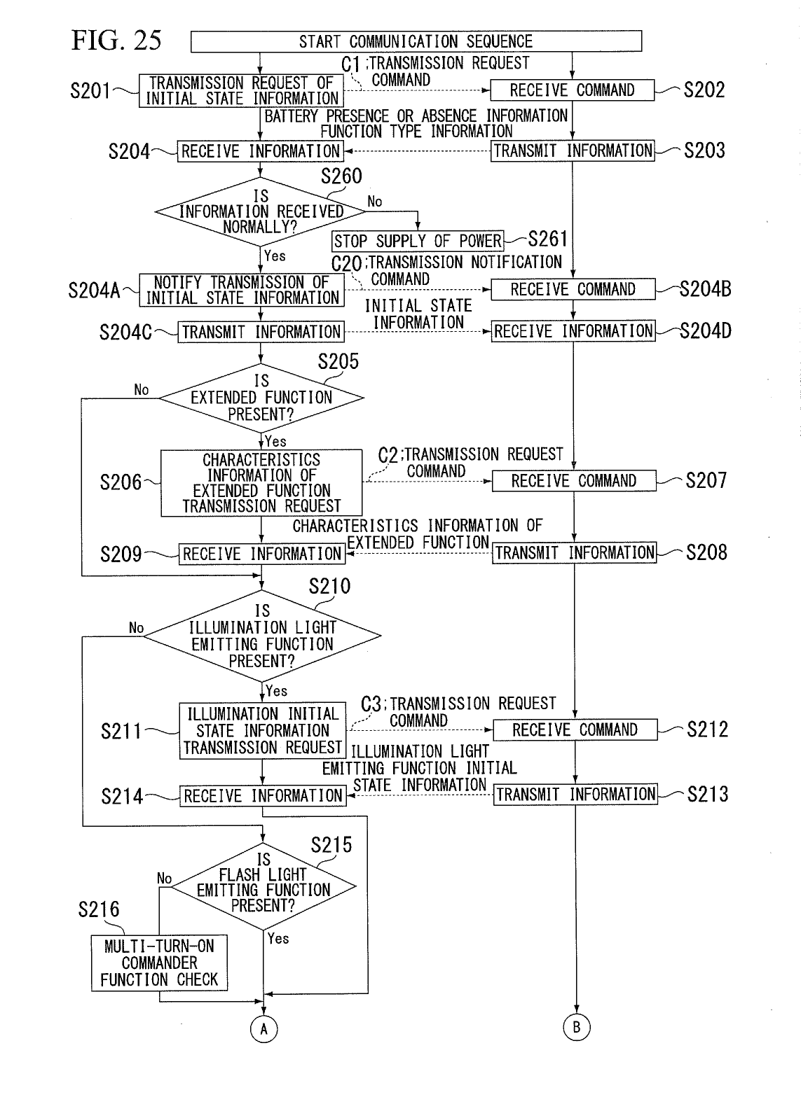

First, Modified Example 1 will be described. FIG. 25 is a diagram illustrating a procedure of processes in an initial communication sequence of Modified Example 1. A series of processes in Modified Example 1 is different from a series of processes described with reference to FIG. 12, in that after the process of step S204, it is determined in step S260 whether information is received normally from the accessory control section 440.

In Modified Example 1, subsequently to the reception of the accessory initial state information from the accessory control section 440, for example, in step S204, the camera control section 170 determines whether information is received normally from the accessory control section 440 (step S260).

Explaining for more details, in step S260, when the accessory initial state information received in step S204 includes information (for example, battery presence or absence information and function type information) of items designated by the transmission request command C1 of step S201 in just proportion, the camera control section 170 determines that the information is received normally (step S260: Yes). The camera control section 170 then performs the processes after step S204A, similarly to those described with reference to FIGS. 12 and 13.

In addition, when the accessory initial state information cannot be received from the accessory control section 440 in step S204, and the accessory initial state information received in step S204 does not include information of at least one item of items designated by the transmission request command C1 of step S201, the camera control section 170 determines that the information is not received normally in step S260 (step S260: No). The camera control section 170 then performs a process of stopping the supply of power to the accessory 400 (step S261). In this case, the camera control section 170 terminates, for example, the initial communication sequence. In addition, as described with reference to FIG. 24, the camera control section 170 notifies the accessory 400 that the supply of power is stopped (step S703), and then controls the accessory power source control section 33 (see FIG. 7) and stops the supply of power (step S704).

In the processes shown in Modified Example 1, when information previously expected cannot be received from the accessory 400 in the initial communication sequence, the camera control section 170 can detect that the accessory 400 performs an unexpected operation. Since the camera control section 170 stops the supply of power from the camera 10 to the accessory 400 based on this detection result, the occurrence of malfunction or the like in the unpredictable accessory 400 can be suppressed beforehand.

However, the number of bytes (first number of bytes) of information to be transmitted by the accessory control section 440 is determined in accordance with contents of the request from the camera control section 170. Consequently, the camera control section 170 may perform the determination of step S260 based on the number of bytes (second number of bytes) of information received from the accessory control section 440. For example, the camera control section 170 may determine that the information is received normally when the second number of bytes is the same as the first number of bytes, and may determine that the information is not received normally when the second number of bytes is different from the first number of bytes.

In addition, the camera control section 170 can also perform the determination of step S260 based on contents of information received from the accessory control section 440. For example, the camera control section 170 may determine that the information is not received normally in at least one of a case where the information received by the camera control section 170 in step S204 does not include information of items designated by the transmission request command C1, a case where the information is different from a format which is set in advance, and a case where the information includes information other than items designated by the transmission request command C1. For example, in step S204, the camera control section 170 may determine that the information is not received normally when it is expected that the battery presence or absence information and the function type information are received and the battery “presence” information and the battery “absence” information are not all received, when at least a portion of the function type information is not received, or the like.

Additionally, in Modified Example 1 shown in FIG. 25, the camera control section 170 determines whether the information is received normally (step S204) with respect to the accessory initial state information to be received, but the camera control section 170 may also determine whether the information is received normally with respect to information other than the accessory initial state information. For example, in each process of steps S209 and S214 shown in FIG. 12, and each process of steps S220, S224, S229, S233, and step S241 shown in FIG. 13, the camera control section 170 receives information from the accessory 400. Whenever each information item is received in each of the processes of receiving the information, the camera control section 170 may determine whether the information is received normally.

In addition, when at least one piece of information requested by the camera control section 170 out of the characteristic information of the extended function, the initial state information of the illumination light emitting function, the settable information, the profile information, the illumination profile information, and the accessory setting state information cannot be received from the accessory control section 440, the camera control section 170 may determine that the accessory 400 is in a state where it performs an operation (malfunction) other than an expected operation.

Here, the characteristic information of the extended function is, for example, information indicating the characteristics of the extended function such as the GPS function or the multi-turn-on commander function. When it is determined in step S205 that the accessory 400 has the extended function, the characteristic information of the extended function is information received by the camera control section 170 in step S209.

The initial state information of the illumination light emitting function is information indicating the initial state before the characteristics of the illumination light emitting function are changed and set. When it is determined in step S210 that the accessory 400 has the illumination light emitting function, the initial state information of the illumination light emitting function is information received by the camera control section 170 in step S214.

The settable information is information indicating a function capable of setting the characteristics in the functions of the accessory 400. The settable information is information received by the camera control section 170 in step S220.

The profile information is information indicating a profile (characteristics of the flash light emitting function) of the accessory 400. The profile information is information received by the camera control section 170 in step S224.

The illumination profile information is information indicating the emission characteristics of the illumination light emitting section 435. When it is determined in step S225 that the accessory 400 has the illumination light emitting function, the illumination profile information is information received by the camera control section 170 in step S229.

The accessory setting state information is information including setting information indicating the setting state of the flash light emitting function, setting information indicating the setting state of the illumination light emitting function, charging state information indicating the control state of the control for the charging section 432, and the like. The accessory setting state information is information received by the camera control section 170 in step S233 and step S241.

When it is determined that at least one of these pieces of information is not received normally, the camera control section 170 may stop the supply of power to the accessory 400 similarly to step S261. In addition, when it is not determined that the information is not received normally, the camera control section 170 determines that the information is received normally, and may perform the subsequent process the same as that of the above-mentioned embodiment. Additionally, the camera control section 170 may determine whether the information of one or more items selected from various types of information items mentioned above is received normally.

### Modified Example 2

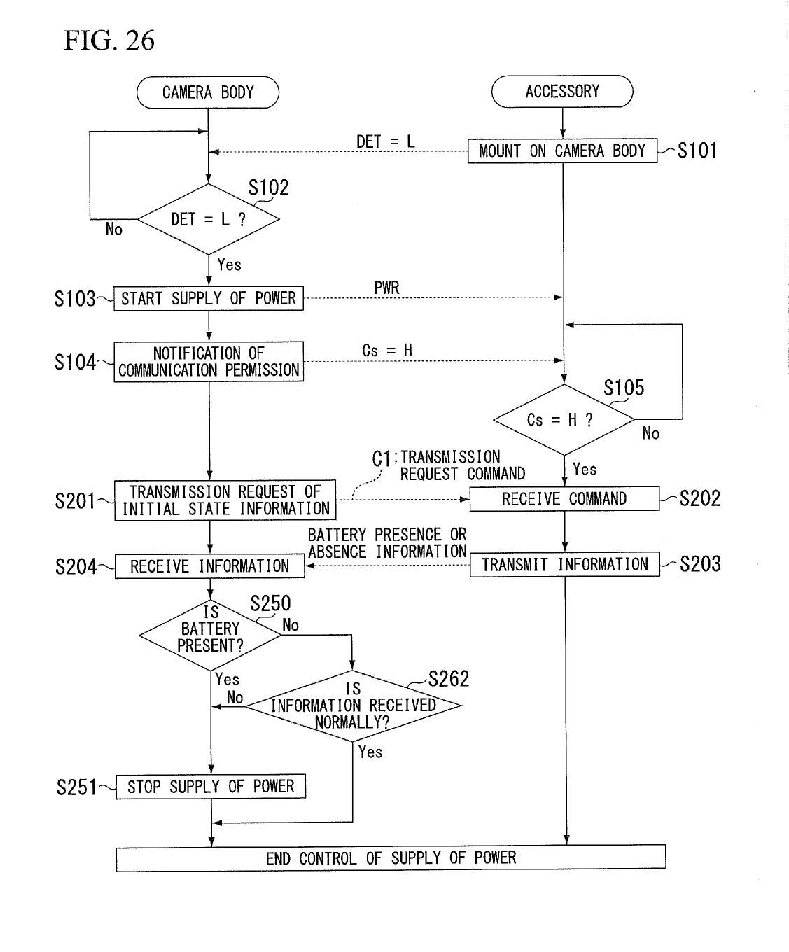

Next, Modified Example 2 will be described. FIG. 26 is a diagram illustrating a procedure of processes in a power supply control of Modified Example 2. A series of processes in Modified Example 2 is different from a series of processes described with reference to FIG. 14, in that after the process of step S250, it is determined in step S262 whether the information is received normally from the accessory control section 440.

In Modified Example 2, when it is determined in step S250 that the accessory 400 does not have a battery (step S250: NO), the camera control section 170 determines whether the battery “absence” information is received normally in step S262. In step S262, the camera control section 170 determines that the information is received normally (step S262: Yes) when the battery “absence” information is received in step S204, and continues the supply of power to the accessory 400 started in step S103. In addition, in step S262, the camera control section 170 determines that the information is not received normally (step S262: No) when the battery “absence” information is not received in step S204 or when information different from a format which is set in advance is received, and stops, in step S251, the supply of power started in step S103.

In this manner, the camera control section 170 can detect that the accessory 400 performs an unexpected operation. Since the camera control section 170 stops the supply of power to the accessory 400 based on this detection result, the occurrence of malfunction or the like of the accessory 400 can be suppressed. Additionally, the determination of step S262 can be performed prior to the determination of step S250.

### Modified Example 3

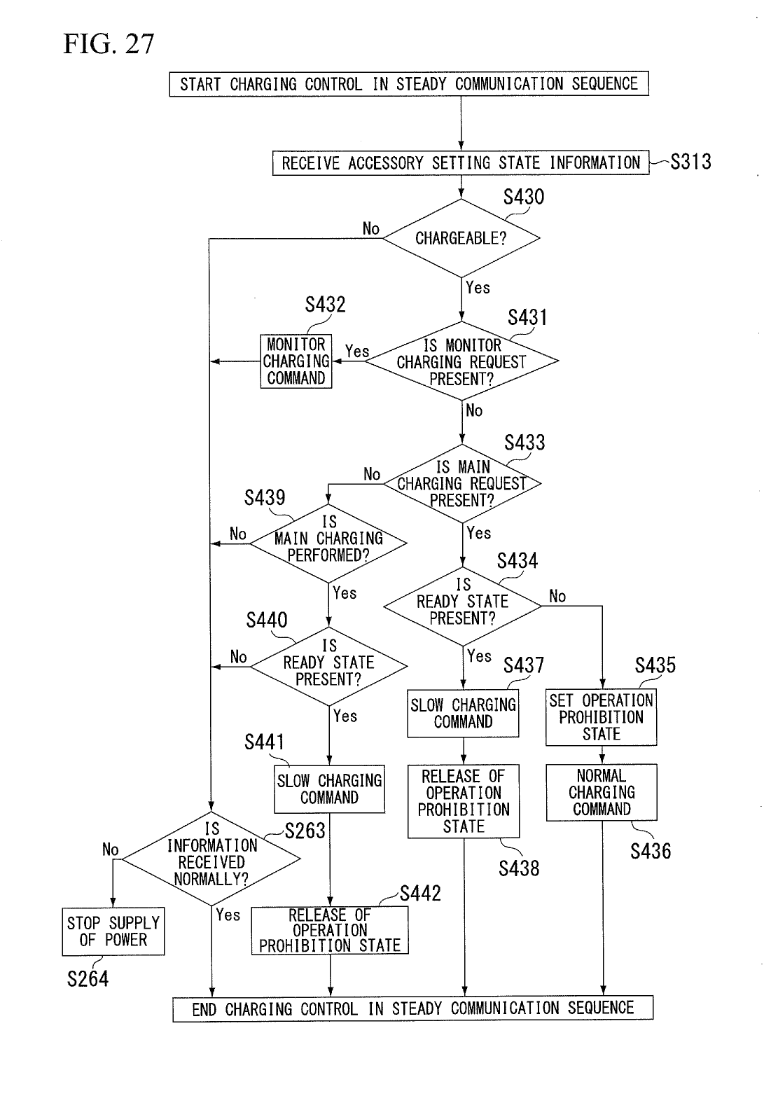

Next, Modified Example 3 will be described. FIG. 27 is a diagram illustrating a procedure of processes of a charging control in Modified Example 3. A series of processes in Modified Example 3 is different from a series of processes described with reference to FIG. 20, in that after the process of step S430, it is determined in step S263 whether the information is received normally from the accessory control section 440.

In Modified Example 3, the determination process of step S263 is executed in each of the cases where it is determined in step S430 that the charging section 432 is not capable of being charged based on the chargeability information (step S430: No), it is determined in step S431 that the monitor charging request is not present based on the charging request information (step S431: No), it is determined in step S439 that the charging section 432 is not being charged based on the charging lapse information (step S439: No), and it is determined in step S440 that the flash light emitting section 430 is not in a ready state based on the emission possibility information (step S440: No).

In step S263, the camera control section 170 determines whether the following information is received normally: the chargeability information, the charging request information, the charging lapse information, and the emission possibility information which are included in the charging state information out of the accessory setting state information received in step S313.

In Modified Example 3, the camera control section 170 determines whether correct information is received (whether the accessory is operating normally) based on consistency of contents indicated by each of the chargeability information, the charging request information, the charging lapse information, and the emission possibility information. As an example, in a case where the amount of charging of the charging section 432 is less than the emission permission level mentioned above, it is expected that if it is in a normal state, the emission possibility information indicates that the flash light emitting section 430 is not in a ready state and the charging request information indicates that the main charging request is performed. However, in such a case, when the main charging request is not performed in the charging request information regardless of the emission possibility information indicating that the flash light emitting section is not in a ready state, the camera control section 170 determines that correct information is not received (the accessory 400 performs an unexpected operation) (step S263: No), and stops the supply of power to the accessory 400 in step S264. In addition, when it is determined in step S263 that contents indicated by each of the chargeability information, the charging request information, the charging lapse information, and the emission possibility information have consistency (step S263: Yes), the camera control section 170 terminates the charging control in the steady communication sequence.

In this manner, the camera control section 170 can detect whether or not the accessory 400 has performed an unexpected operation by determining if multiple pieces of information received from the accessory control section 440 are consistent with each other. Since the camera control section 170 stops the supply of power to the accessory 400 based on this detection result, the occurrence of malfunction or the like on the accessory 400 can be suppressed beforehand.

Additionally, similarly to the way that the determination of whether the information is received normally is described in Modified Example 1, the camera control section 170 may perform each of the chargeability information, the charging request information, the charging lapse information, and the emission possibility information based on one or both of the number of bytes and the contents. In addition, when information indicating the amount of charging (charging rate) of the charging section 432 is supplied from the accessory control section 440 to the camera control section 170, the camera control section 170 may detect that the accessory 400 performs an unexpected operation, by determining consistency with the charging rate (charging amount) of the charging section 432 with respect to at least one of the chargeability information, the charging request information, the charging lapse information, and the emission possibility information. For example, when the chargeability information indicates that the flash light emitting section is not in a ready state regardless of the charging rate (charging amount) of the charging section 432 being the emission permission level or more (ready state), the camera control section 170 may determine that correct information is not received. For example, in the steady communication sequence (for example, step S313 of FIG. 15), the accessory control section 440 transmits the charging rate information, indicating the charging rate of the charging section 432 as a portion of the accessory setting state information, to the camera control section 170. After the determination process (for example, step S440 and step S434) of whether or not the flash light emitting section is in a ready state, the camera control section 170 may determine consistency between the emission possibility information and the charging rate information.

### Modified Example 4

Next, Modified Example 4 will be described. Modified Example 4 is a modified example regarding the processes of the charging control similarly to Modified Example 3, and a procedure of processes is the same as that of Modified Example 3 shown in FIG. 27. In Modified Example 4, it is determined whether the accessory 400 performs an unexpected operation by determining consistency between the information indicating power supplied from the camera 10 to the accessory 400 and the charging state information, instead of evaluating (determining) consistency of the charging state information based on the chargeability information and the charging request information.

Explaining for more detail, in Modified Example 4, the accessory power source control section 33 within the camera 10 shown in FIG. 7 detects power (for example, current value) supplied from the camera 10 to the accessory 400, and supplies information indicating the detected power (hereinafter, referred to as supply power detection information) to the camera control section 170. When the operation state (charging state) of the accessory 400 indicated by the charging state information received from the accessory control section 440 and the amount of power supplied indicated by the supply power detection information are not consistent with each other, the camera control section 170 determines that the accessory 400 has performed an unexpected operation. For example, when power to be supplied to the accessory 400, though the charging section 432 is not being charged, is larger than a predetermined amount (normal power necessary for the accessory control section 440 on the accessory 400 side to perform a normal operation (an operation for charging is not included)), the camera control section 170 determines that the accessory 400 has performed an unexpected operation. Specifically, when the charging request information of the charging state information indicates that “the charging request is not performed”, and the amount of power supplied indicated by the supply power detection information exceeds the allowable range of the amount of power supplied in the case where the charging section is not being charged, the camera control section 170 determines that the accessory 400 has performed an unexpected operation. When it is determined that the accessory 400 has performed an unexpected operation, the camera control section 170 stops the supply of power to the accessory 400 as described in Modified Example 1.

In this manner, the camera control section 170 detects that the accessory 400 performs an unexpected operation by determining the consistency between the information received from the accessory control section 440 and the supply power detection information. Since the camera control section 170 stops the supply of power to the accessory 400 based on this detection result, the occurrence of malfunction or the like on the accessory 400 can be suppressed beforehand.

Additionally, in Modified Examples 1 to 4 mentioned above, when it is determined that the accessory 400 has performed an unexpected operation, the camera control section 170 stops the supply of power to the accessory 400, but may limit (reduce) an upper limit value of power supplied to the accessory 400 to a value which is set in advance, and may prohibit at least a portion of the functions of the accessory 400. For example, when the illumination light emitting function is not included in a function indicated by the function type information received from the accessory 400 in the initial communication sequence described with reference to FIG. 12, the camera control section 170 does not transmit a command regarding the illumination light emitting function to the accessory 400, and thereby the camera control section may make the illumination light emitting function ineffective.

Additionally, when information of items requested from the accessory control section 440 cannot be received, the camera control section 170 requests (retries) transmission of the information again from the accessory control section 440, and when the information of the requested items cannot be received, the camera control section may limit or stop the supply of power to the accessory 400, or may limit at least a portion of the functions of the accessory 400. The number of retries may be one or more as predetermined.

Additionally, when it is determined that the accessory 400 performs an operation other than an expected operation, the camera control section 170 may give notice of, for example, the operation (malfunction) accessory 400. In addition, when the camera control section 170 limits or stops the supply of power to the accessory 400, or limits at least a portion of the functions of the accessory 400, the camera control section may give notice of performing the limit or stop. The above-mentioned notice can be given, for example, by displaying one or both of a character and an image on the display section 102 shown in FIG. 2.

In addition, the technical scope of the present invention is not limited to the above-mentioned embodiment. At least one of the constituent elements described in the above-mentioned embodiment may be omitted. Each of the constituent elements described in the above-mentioned embodiment may be appropriately combined.

For example, in the accessory 400, in a state where the accessory 400 is mounted to the camera 10, the startup state providing terminal Ts7 may be connected to the reference potential line 480 through the MSW 465 and the PCSW 470 so as to be connected to the grounding line 42 through the reference potential line 480.

The above is the whole description for the camera system 1 in the embodiments of the present invention.

Next, a detailed description will be made of a control regarding illumination of the illumination light emitting section 435 and a control regarding the charging of the electric accumulating section in the charging section 432 of the flash light emitting section 430, in the camera system 1.

The camera control section 170 of the camera body 100 and the accessory control section 440 of the accessory 400 (illuminating device) perform a control regarding illumination of the flash light emitting section 430 and the illumination light emitting section 435 and a control regarding the charging of the electric accumulating section of the flash light emitting section 430, by performing communication through the shoe seat (camera terminal section) 15 and the connector (accessory terminal section) 420.

In addition, in the following description, “turn-on” and “turn-off” of the illumination light emitting section 435 may be called “emission” and “non-emission”.

<Configuration of Camera and Accessory>

The configuration of the camera 10 and the accessory 400 will be described in more detail.

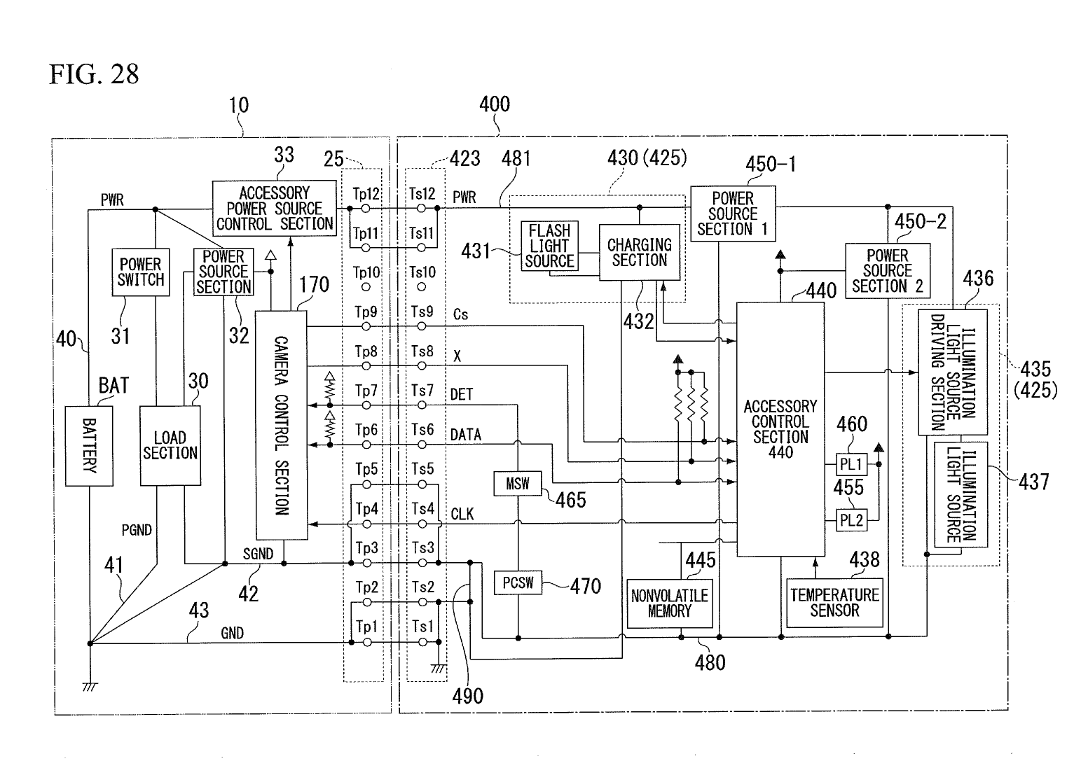

FIG. 28 is a block diagram illustrating a portion of the functional configurations of the camera and the accessory in the present embodiment. In the same drawing, the same components as those of FIG. 7 are assigned the same reference numerals and signs, and the description thereof will be omitted. FIG. 28 and FIG. 7 are different from each other in that the accessory 400 is added with a temperature sensor 438.

The temperature sensor 438 is a thermometer for obtaining a temperature value by detecting a temperature of heat generation of the illumination light emitting section 435. The temperature sensor 438 is provided in the vicinity of the illumination light emitting section 435, and supplies the measured temperature value to the accessory control section 440.

In addition, the temperature sensor 438 may be built in to the illumination light emitting section 435.

Next, a detailed description will be made of the illumination light source 437 of the illumination light emitting section 435. The illumination light source 437 is a solid-state light source (light source) such as an LED or an organic EL source. The solid-state light source used in the present embodiment is, for example, a white LED that emits white light, or a three-color LED in which red light, green light, and blue light are respectively emitted and the three-color light is synthesized to obtain white light.

In addition, the number of white LEDs included in the illumination light source 437 is not limited to one, but may be plural. In this case, the types of a plurality of white LEDs may be different from each other (for example, the color temperatures are different from each other). In addition, a combination of blue LED and a phosphor may be made, for example, in which a fluorescent material which emits fluorescence when excited is excited with blue light, and blue light is converted into white light.

<Camera Initial State Information>

Next, a further description will be made of the above-mentioned camera initial state information. The camera initial state information includes shoe type information (type information on the camera side) in addition to various types of information items mentioned above.

The shoe type information is information indicating a type of the shoe seat 15 (the camera terminal section or the camera contact portion may also be called). The type of the shoe seat 15 is divided in accordance with, for example, the shape of the shoe seat, the version, the model number, series of the model number, the electrical specification, or the physical specification. The shoe type information is, for example, shoe type flag data corresponding to multiple classifications like the standard type and the extended type, the old type and the new type, and the like. Alternatively, the shoe type information is, for example, shoe seat identification data association with the shape of the shoe seat, the version, the model number, and the like.

The shoe type information is previously stored in the nonvolatile storage section (nonvolatile memory 160) controlled by the camera control section 170. Generally, after the shoe type information is written in the nonvolatile memory 160 in the manufacturing and inspection stage of the camera 10, the camera 10 is shipped from the factory.

The camera control section 170 reads out the camera initial state information stored in the nonvolatile memory 160, in accordance with a transmission request from the accessory control section 440, and transmits the camera initial state information to the accessory control section 440.

<Accessory Initial State Information>

Next, a further description will be made of the above-mentioned accessory initial state information. The accessory initial state information includes connector type information (type information on the accessory side), illumination light emitting function information (light-emitting function information), and illumination turn-on possible time information (light-emittable time information), in addition to various types of information items mentioned above.

The connector type information is information indicating a type of the connector 420 (the accessory terminal section or the accessory contact portion may also be called). The type of the connector 420 is divided in accordance with, for example, the shape of the connector, the version, the model number, series of the model number, the electrical specification, or the physical specification. The connector type information is, for example, connector type flag data corresponding to multiple classifications like the standard type and the extended type, the old type and the new type, and the like. Alternatively, the connector type information is, for example, connector identification data associated with the shape of the connector, the version, the model number, and the like.

The connector type information is previously stored in the nonvolatile storage section (nonvolatile memory 445) controlled by the accessory control section 440. Generally, after the connector type information is written in the nonvolatile memory 445 in the manufacturing and inspection stage of the accessory 400, the accessory 400 is shipped from the factory.

The illumination light emitting function information is information regarding the illumination light emitting function corresponding to the illumination light emitting section 435. The illumination light emitting function information is, for example, information indicating whether the illumination light emitting section 435 includes a solid-state light source in the illumination light source 437, in other words, information indicating whether the accessory 400 has the illumination light emitting function. Specifically, for example, when the illumination light emitting section 435 includes a white LED in the illumination light source 437, the illumination light emitting function information is illumination light emitting function presence or absence flag data in which “presence” and “absence” of the white LED are expressed by “1” and “0 (zero)”.

In addition, the illumination light emitting function information is, for example, information indicating the configuration (characteristics or feature) of the above-mentioned solid-state light source used as the illumination light source 437. The information indicating the configuration (characteristics or feature) of the solid-state light source is, for example, information indicating the type of the solid-state light source, the emission color, and the color temperature. Specifically, for example, when the illumination light emitting section 435 includes three independent LEDs (hereinafter, called a three-color LED) emitting each of the colors of red light, green light, and blue light as the illumination light source 437, the illumination light emitting function information is solid-state light source color configuration data in which bits are associated with each of a red LED, a green LED, and a blue LED, and “presence” and “absence” of the LED are expressed by “1” and “0 (zero)” for each bit. In addition, for example, when the illumination light emitting section 435 includes four independent white LEDs having color temperatures different from each other as the illumination light source 437, the illumination light emitting function information is solid-state light source type data in which bits are associated with each of a first white LED to a fourth white LED, and “presence” and “absence” of the white LED are expressed by “1” and “0 (zero)” for each bit.

The above-mentioned illumination light emitting function information is previously stored in the nonvolatile storage section (nonvolatile memory 445) controlled by the accessory control section 440.

In addition, the illumination turn-on possible time information (light-emittable time information) is information indicating the above-mentioned “longest turn-on time (light-emittable time)”. That is, the information is time information indicating the longest time (duration or period) for which the illumination light emitting section 435 is capable of continuously turned on. In detailed description, the time information means the time (period) from the start of one turn-on of the illumination light source 437 to the forcible stop (turn-off) of the turn-on, and the longest turn-on time (period) previously determined in the accessory 400 side. In other words, the information is time information indicating the maximum time (period) for which the illumination light source 437 is permitted to be continuously turned on. As stated previously, in the present embodiment, as an example, a description will be made setting the longest turn-on time to 8 seconds (the number of seconds obtained by adding the extensible maximum time of 2 seconds to the normal turn-on time of 6 seconds for which the light source can be turned on in the normal image capture).

Similarly to the above-mentioned illumination light emitting function information, the illumination turn-on possible time information is also previously stored in the nonvolatile storage section (nonvolatile memory 445) controlled by the accessory control section 440.

Generally, similarly to the above-mentioned connector type information, the accessory 400 is shipped from the factory after the illumination light emitting function information and the illumination turn-on possible time information are written in the nonvolatile memory 445 in the manufacturing and inspection stage of the accessory 400.

In addition, time information indicating the virtual time may be stored in the nonvolatile memory 445 as the illumination turn-on possible time information. This virtual time is time (for example, one hour) longer than the actual turn-on possible time.

The accessory control section 440 reads out the accessory initial state information stored in the nonvolatile memory 445 in accordance with a transmission request from the camera control section 170, and transmits the accessory initial state information to the camera control section 170.

<Illumination Setting State Information>

Next, a further description will be made of the above-mentioned illumination setting state information. The illumination setting state information includes illumination turn-on state information (light-emitting state information), illumination availability information, and illumination setting information.

The illumination turn-on state information is information indicating whether the solid-state light source included in the illumination light source 437 of the illumination light emitting section 435 is in a turn-on (emission) state, in other words, information indicating whether the illumination light emitting section 435 fulfills (is fulfilling) the illumination light emitting function. Specifically, for example, when the illumination light emitting section 435 includes one white LED in the illumination light source 437, the illumination turn-on state information is illumination turn-on state flag data in which “turn-on” and “turn-off” of the white LED are expressed by “1” and “0 (zero)”.

In addition, the illumination turn-on state information is, for example, information indicating a state of turn-on/turn-off of the solid-state light source included in the illumination light source 437 of the illumination light emitting section 435. Specifically, for example, when the illumination light emitting section 435 includes a three-color LED in the illumination light source 437, the illumination turn-on state information is illumination turn-on state data in which bits are associated with each of a red LED, a green LED, and a blue LED, and “turn-on” and “turn-off” of the LED are expressed by “1” and “0 (zero)” for each bit. In addition, for example, when the illumination light emitting section 435 includes four white LEDs having color temperatures different from each other in the illumination light source 437, the illumination turn-on state information is illumination turn-on state data in which bits are associated with each of a first white LED to a fourth white LED, and “turn-on” and “turn-off” of the white LED are expressed by “1” and “0 (zero)” for each bit.

The accessory control section 440 controls the illumination light source driving section 436 of the illumination light emitting section 435 to turn on the illumination light source 437, based on illumination instruction information (described later) supplied from the camera control section 170, and then generates the illumination turn-on state information corresponding to the above-mentioned illumination instruction information, and stores the illumination turn-on state information in a memory within the accessory control section 440. In addition, the accessory control section 440 reads out the illumination turn-on state information stored in the memory within the accessory control section 440, in accordance with a periodic transmission request from the camera control section 170, and transmits the illumination turn-on state information to the camera control section 170.

In addition, the accessory control section 440 may detect a consumption current of the illumination light source 437 from the illumination light emitting section 435, in accordance with the transmission request from the camera control section 170, may generate the illumination turn-on state information based on the level (current value) of the consumption current, and may transmit the illumination turn-on state information to the camera control section 170. At this time, the illumination light source 437 is stably turned on, and may generate the illumination turn-on state information.

The illumination availability information is information indicating whether the illumination light emitting section 435 is available to the accessory 400. Specifically, for example, when the illumination light emitting section 435 includes one white LED in the illumination light source 437, the illumination availability information is illumination availability flag data in which “available” and “unavailable” of the white LED are expressed by “1” and “0 (zero)”. In addition, for example, when the illumination light emitting section 435 includes a three-color LED in the illumination light source 437, the illumination availability information is solid-state light source availability data in which bits are associated with each of a red LED, a green LED, and a blue LED, and “available” and “unavailable” of the LED are expressed by “1” and “0 (zero)” for each bit. In addition, for example, when the illumination light emitting section 435 includes four white LEDs having color temperature different from each other in the illumination light source 437, the illumination availability information is solid-state light source availability data in which bits are associated with each of a first white LED to a fourth white LED, and “available” and “unavailable” of the white LED are expressed by “1” and “0 (zero)” for each bit.

The accessory control section 440 acquires a temperature value of the illumination light emitting section 435 from the temperature sensor 438, and compares the temperature value and the temperature threshold determined previously. When it is determined that the acquire temperature value exceeds the above-mentioned temperature threshold, the accessory control section 440 controls the illumination light source driving section 436 and turns off the illumination light source 437. This is to prevent the illumination light source 437 or the illumination light emitting section 435 from being out of order due to the generation of heat concomitant with emission of the illumination light source 437. The accessory control section 440 generates the illumination availability information indicating that the illumination light emitting section 435 is unavailable, and stores the illumination availability information in a memory within the accessory control section 440. In addition, the accessory control section 440 reads out the illumination availability information stored in the memory within the accessory control section 440, in accordance with the transmission request from the camera control section 170, and transmits the illumination availability information to the camera control section 170.

The illumination setting information is information including the above-mentioned illumination profile update request information. The illumination setting information is, for example, illumination profile update request flag data in which “absence of request” and “presence of request” are expressed by “0 (zero)” and “1”.

The illumination setting information is stored in the memory within the accessory control section 440 by the control of the accessory control section 440.

<Procedure of Initial Communication Sequence>

Next, the procedure of the initial communication sequence executed by the camera control section 170 and the accessory control section 440 will be supplementarily described with reference to the flow diagram of FIG. 12. This initial communication sequence is a sequence executed in steps of the startup sequence as stated previously. In this startup sequence, the communication preparation sequence is initially executed, but in this communication preparation sequence, as mentioned previously, it is first detected that the accessory 400 is mounted in the camera body 100 in an ON-state. That is, in the present embodiment, the initial communication sequence in the same drawing is executed when the accessory 400 (illumination device for image capture in the present embodiment) of which a startup switch is already set to an ON-state is mounted on the camera body 100, or when the startup switch of the accessory 400 mounted in the camera body 100 is switched to ON.

In the same drawing, when the transmission request command C1 is received the process of step S202, the accessory control section 440 reads out the a portion of the accessory initial state information stored in the nonvolatile memory 445. A portion of the accessory initial state information is the above-mentioned connector type information.

Next, the accessory control section 440 transmits the readout accessory initial state information to the camera control section 170 through the process of step S203.

Next, when the accessory initial state information is received through the process of step S204, the camera control section 170 stores the accessory initial state information in the buffer memory 165. That is, the connector type information is supplied from the accessory 400 to the camera body 100 and is stored in the buffer memory 165.

Next, the camera control section 170 transmits the transmission notification command C20 to the accessory control section 440 through the process of step S204A, and then reads out the camera initial state information stored in the nonvolatile memory 160. The camera initial state information is the above-mentioned shoe type information.

Next, the camera control section 170 transmits the readout camera initial state information to the accessory control section 440 through the process of step S204C.

Next, when the camera initial state information is received through the process of step S204D, the accessory control section 440 stores the camera initial state information in the memory within the accessory control section 440. That is, the shoe type information is supplied from the camera body 100 to the accessory 400 and is stored in the memory within the accessory control section 440.

In addition, when the transmission request command C3 is received through the process of step S212, the accessory control section 440 reads out a portion of the accessory initial state information stored in the nonvolatile memory 445. A portion of the accessory initial state information is the illumination light emitting function information and the illumination turn-on possible time information which are mentioned above.

Next, the accessory control section 440 transmits the readout accessory initial state information to the camera control section 170 through the process of step S213.

Next, when the accessory initial state information is received through the process of step S214, the camera control section 170 stores the accessory initial state information in the buffer memory 165. That is, the illumination light emitting function information and the illumination turn-on possible time information are supplied from accessory 400 to the camera body 100 and are stored in the buffer memory 165.

<Procedure of Steady Communication Sequence>

Next, the procedure of the steady communication sequence executed by the camera control section 170 and the accessory control section 440 will be supplementarily described with reference to the flow diagram shown in FIG. 15.

In the same drawing, when the transmission request command C11 is received through the process of step S307, the accessory control section 440 reads out the illumination setting state information stored in the memory within the accessory control section 440, that is, the illumination turn-on state information, the illumination availability information, and the illumination setting information which are mentioned above.

Next, the accessory control section 440 transmits the readout illumination setting state information to the camera control section 170 through the process of step S308.

Next, when the illumination setting state information is received through the process of step S309, the camera control section 170 stores the illumination setting state information in the buffer memory 165. That is, the illumination turn-on state information, the illumination availability information, and the illumination setting information are supplied from the accessory 400 to the camera body 100 and are stored in the buffer memory 165.

<Control Based on Illumination Light Emitting Function Information and Illumination Turn-on Possible Time Information>

Next, a description will be made of processes in which the camera control section 170 acquires the illumination light emitting function information and the illumination turn-on possible time information from the accessory control section 440 in the initial communication sequence, and then executes a control based on the illumination light emitting function information and the illumination turn-on possible time information.

The camera control section 170 stores, in the buffer memory 165, the illumination light emitting function information and the illumination turn-on possible time information acquired in the initial communication sequence between the camera control section 170 and the accessory control section 440.

The camera control section 170 reads out the illumination light emitting function information and the illumination turn-on possible time information stored in the buffer memory 165, during an interrupt process or a task process of a camera control program. The camera control section 170 then executes a process based on the illumination light emitting function of the illumination light emitting section 435 or a process based on the time for which the illumination light emitting section 435 is capable of being turned on, based on the readout illumination light emitting function information and the illumination turn-on possible time information.

In addition, when the illumination turn-on possible time information is not received in the initial communication sequence, the camera control section 170 sets “0 (zero)” to the illumination turn-on possible time information and store the value in the buffer memory 165. In this case, the camera control section 170 substantially prohibits turn-on of the illumination light emitting section 435.

Alternatively, when the illumination turn-on possible time information is not received in the initial communication sequence, the camera control section 170 may set an arbitrary time (predetermined, for example, 5 seconds or the like) to the illumination turn-on possible time information and may store the value in the buffer memory 165.

For example, when the illumination light emitting function information is illumination light emitting function presence or absence flag data in which “presence” and “absence” of the white LED are expressed by “1” and “0 (zero)”, the camera control section 170 detects the illumination light emitting function presence or absence flag data stored in the buffer memory 165. The camera control section 170 then confirms that the detect illumination light emitting function presence or absence flag data is “1”, and generates illumination instruction information which is illumination on and off instruction data.

In addition, for example, when the illumination light emitting function information is solid-state light source color configuration data in which “presence” and “absence” of each of a red LED, a green LED, and a blue LED are expressed by “1” and “0 (zero)” for each bit, the camera control section 170 reads out the solid-state light source color configuration data stored in the buffer memory 165, and generates illumination instruction information which is illumination color change instruction data, using a bit of “1”, from the solid-state light source color configuration data.

In addition, for example, when the illumination light emitting function information is solid-state light source type data in which “presence” and “absence” of each of four white LEDs having color temperatures different from each other are expressed by “1” and “0 (zero)” for each bit, the camera control section 170 reads out the solid-state light source type data stored in the buffer memory 165, and generates illumination instruction information which is illumination light color temperature change instruction data, using a bit of “1”, from the solid-state light source type data.

In addition, for example, the camera control section 170 reads out the illumination turn-on possible time information stored in the buffer memory 165, and sets the time obtained by subtracting the surplus time (for example, 2 seconds) from the illumination turn-on possible time information to the continuous turn-on possible time mentioned above.

In addition, in the case where the illumination turn-on possible time information indicating the above-mentioned virtual time is stored in the nonvolatile memory 445 of the accessory 400 and the illumination light emitting section 435 is turned on, when the temperature value of the temperature sensor 438 rises and exceeds the temperature threshold, the accessory control section 440 controls the illumination light source driving section 436, and turns off the illumination light source.

<Control Based on Illumination Setting State Information>

Next, a description will be made of processes in which the camera control section 170 acquires the illumination setting state information from the accessory control section 440 in the steady communication sequence, and then executes a control based on the illumination setting state information. The processes based on the illumination setting state information which are executed by the camera control section 170 are, for example, a turn-on and turn-off control process of the illumination light emitting section, an AE control and AWB control process, and other processes. Hereinafter, each of the processes will be described in detail.

(1) Turn-on and Turn-Off Control Process of Illumination Light Emitting Section

The camera body 100 can request the accessory 400 for turn-on or turn-off of the illumination light emitting section 435. Specifically, the camera control section 170 generates illumination instruction information indicating a turn-on start request or a turn-on termination request (turn-off request), and requests the accessory for turn-on or turn-off of the illumination light emitting section 435 by transmitting the illumination instruction information to the accessory control section 440.

The illumination instruction information is information for controlling illumination (emission) of the illumination light emitting section 435. The illumination instruction information is, for example, information for instructing the accessory to turn on or turn off the illumination light emitting section 435. Specifically, for example, when the illumination light emitting section 435 includes one white LED in the illumination light source 437, the illumination instruction information is illumination on and off instruction data in which “turn-on request” and “turn-off request” of the white LED are expressed by “1” and “0 (zero)”.

In addition, the illumination instruction information is, for example, information for instructing the accessory to change the color (illumination color) of illumination light of the illumination light emitting section 435. Specifically, for example, when the illumination light emitting section 435 includes a three-color LED in the illumination light source 437, the illumination instruction information is illumination color change instruction data in which bits are associated with each of a red LED, a green LED, and a blue LED, and “turn-on request” and “turn-off request” of the LED are expressed by “1” and “0 (zero)” for each bit.

In addition, the illumination instruction information is, for example, information for instructing the accessory to change the color temperature of illumination light of the illumination light emitting section 435. Specifically, for example, when the illumination light emitting section 435 includes four white LEDs having color temperatures different from each other in the illumination light source 437, the illumination light emitting function information is illumination light color temperature change instruction data in which bits are associated with each of a first white LED to a fourth white LED, and “turn-on request” and “turn-off request” of the white LED are expressed by “1” and “0 (zero)” for each bit.

In addition, the accessory 400 can return a response to the received illumination instruction information to the camera body 100. Specifically, the accessory control section 440 gives notice of whether to consent a request of turn-on or turn-off of the illumination light emitting section 435, by transmitting illumination response information regarding instructions indicated by the illumination instruction information to the camera body 100.

The illumination response information is, for example, information indicating whether to consent instructions indicated by the illumination instruction information. Specifically, for example, the illumination response information is illumination instruction response flag data in which “consent” and “non-consent” of the illumination instruction information are expressed by “1” and “0 (zero)”.

When the instruction request for turn-on of the illumination light emitting section 435 is supplied to the camera control section 170 by the control through a user's operation or a camera control program, the camera control section 170 confirms the current turn-on state of the illumination light emitting section 435, before the illumination instruction information indicating the turn-on start request is transmitted. That is, when the illumination light emitting section 435 is in a turn-off state, and the instruction request for turn-on of the illumination light emitting section 435 is supplied, the camera control section 170 transmits the illumination instruction information indicating the start request for turn-on of the illumination light emitting section 435 to the accessory control section 440. Similarly, when the illumination light emitting section 435 is in a turn-on state, and the instruction request for turn-off of the illumination light emitting section 435 is supplied, the camera control section 170 transmits the illumination instruction information indicating the termination request for turn-on of the illumination light emitting section 435 to the accessory control section 440.

In addition, when turn-on instructions indicated by the received illumination instruction information are consented, the accessory 400 turns on the illumination light emitting section 435.

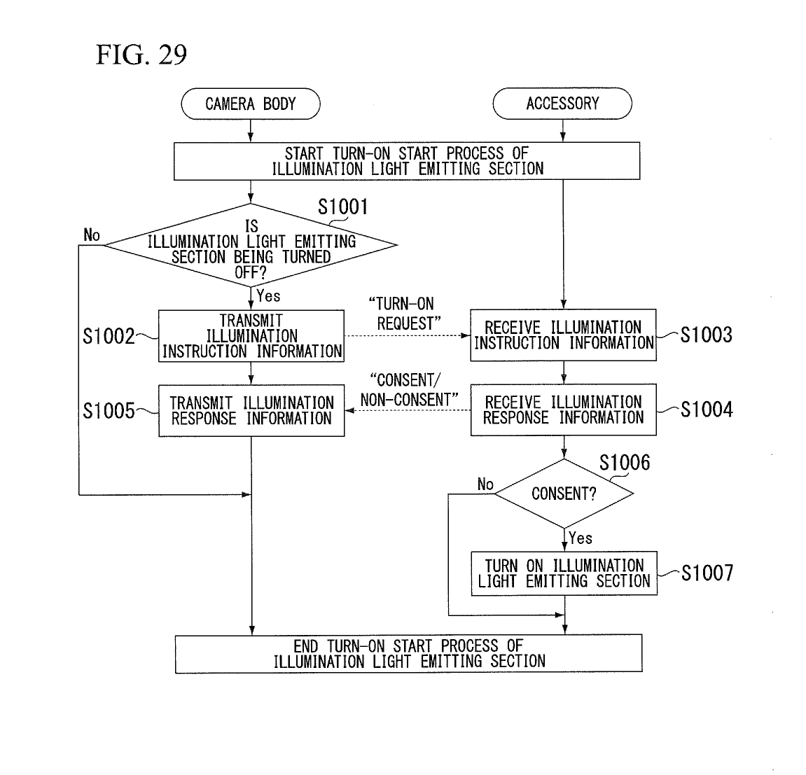

FIG. 29 is a flow diagram illustrating a procedure of turn-on start processes of the illumination light emitting section executed by the camera control section and the accessory control section. In addition, the flow diagram is an example of the process in the case where the illumination light emitting section 435 includes one white LED in the illumination light source 437.

When the illumination setting state information acquired in the steady communication sequence between the camera control section 170 and the accessory control section 440 is stored in the buffer memory 165, and then the illumination setting state information stored in the buffer memory 165 is detected, that is, the light-emitting state of the illumination light emitting section 435 is detected, the camera control section 170 generates an interrupt, or starts up a new task, to thereby start the process shown in the flow diagram of the same drawing.

First, the camera control section 170 reads out the illumination turn-on state information from the buffer memory 165, and determines whether the illumination light emitting section 435 is turned off depending on the illumination turn-on state information. When the camera control section 170 determines that the illumination turn-on state information is data (for example, “0 (zero)”) indicating “turn-off” (step S1001: Yes), the flow of processes goes to step S1002. On the other hand, when the camera control section 170 determines that the illumination turn-on state information is data (for example, “1”) indicating “turn-on” (step S1001: NO), the processes of the flow diagram are terminated.

When it is determined to be “Yes” in the process of step S1001, the camera control section 170 generates illumination instruction information including data (for example, “1”) indicating “turn-on request”, and transmits the illumination instruction information to the accessory control section 440 (step S1002).

Next, the accessory control section 440 receives the illumination instruction information transmitted from the camera control section 170 (step S1003).

Next, the accessory control, section 440 detects data indicating “turn-on request” included in the illumination instruction information, and determines whether to turn on the illumination light source 437. Specifically, for example, the accessory control section 440 acquires a temperature value of the illumination light source 437 from the temperature sensor 438, compares the temperature value and the above-mentioned temperature threshold, and determines whether the acquired temperature value is equal to or more than the temperature threshold.

Next, the accessory control section 440 generates illumination response information in accordance with the determination result, and transmits the illumination response information to the camera control section 170 (step S1004). Specifically, for example, when it is determined that the temperature value acquired from the temperature sensor 438 is equal to or more than the above-mentioned temperature threshold, the accessory control section 440 generates illumination response information including data (for example, “1”) indicating “consent”, and transmits the illumination response information to the camera control section 170. In addition, when it is determined that the temperature value exceeds the above-mentioned temperature threshold, the accessory control section 440 generates illumination response information including data (for example, “0 (zero)”) indicating “non-consent”, and transmits the illumination response information to the camera control section 170.

Next, the camera control section 170 receives the illumination response information transmitted from the accessory control section 440 (step S1005).

Subsequently to the process of step S1004, when the accessory control section 440 consents the illumination instruction information (step S1006: Yes), the flow of processes goes to step S1007, and when it does not consent the illumination instruction information (step S1006: NO), the processes of the flow diagram are completed.

When it is determined to be “Yes” in process of the step S1006, the accessory control section 440 drives the illumination light source driving section 436 and turns on the illumination light source 437 (step S1007).

In addition, when the camera body 100 instructs the accessory 400 to terminate turn-on of the illumination light emitting section 435 as an instruction request (when the illumination light emitting section 435 is turned off), the camera body confirms the current turn-on state of the illumination light emitting section 435, before the illumination instruction information is transmitted. Specifically, when the camera body 100 confirms that the illumination light emitting section 435 is in a turn-on state, the camera body transmits the illumination instruction information indicating turn-off instructions to the accessory 400. On the other hand, when the camera body 100 confirms that the illumination light emitting section 435 is in a turn-off state, the camera body does not perform transmission of the illumination instruction information indicating the turn-off instructions.

In addition, when the accessory 400 consents the turn-off instructions indicated by the received illumination instruction information, the accessory turns off the illumination light emitting section 435.

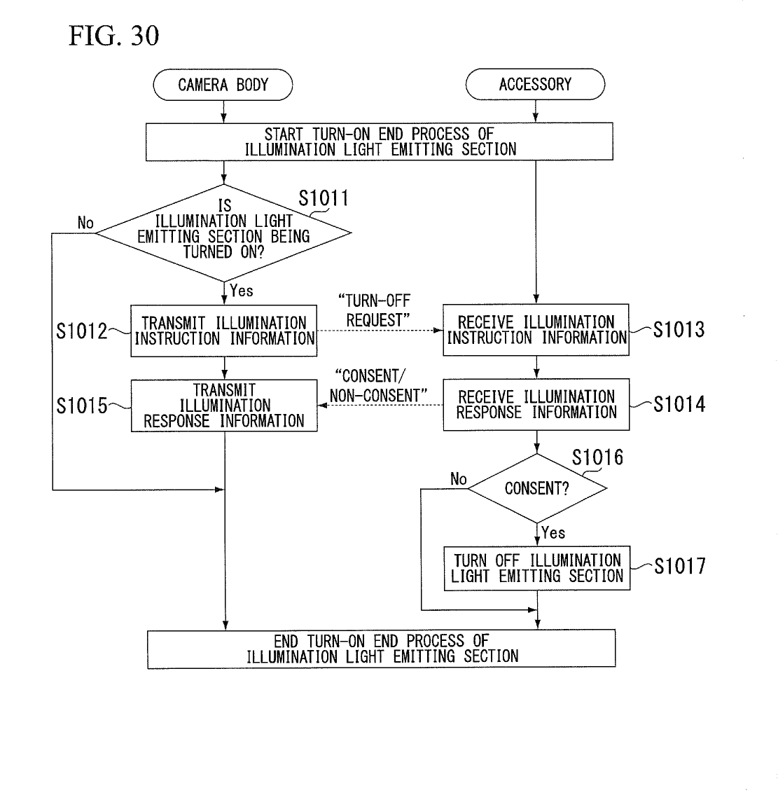

FIG. 30 is a flow diagram illustrating a procedure of turn-on termination processes of the illumination light emitting section executed by the camera control section and the accessory control section. In addition, the flow diagram is an example of the process in the case where the illumination light emitting section 435 includes one white LED in the illumination light source 437.

When the illumination setting state information acquired in the steady communication sequence between the camera control section 170 and the accessory control section 440 is stored in the buffer memory 165, and then the illumination setting state information stored in the buffer memory 165 is detected, that is, the light-emitting state of the illumination light emitting section 435 is detected, the camera control section 170 generates an interrupt, or starts up a new task, to thereby start the process shown in the flow diagram of the same drawing.

First, the camera control section 170 reads out the illumination turn-on state information from the buffer memory 165, and determines whether the illumination light emitting section 435 is turned on depending on the illumination turn-on state information. When the camera control section 170 determines that the illumination turn-on state information is data (for example, “1”) indicating “turn-on” (step S1011: Yes), the flow of processes goes to step S1012. On the other hand, when the camera control section 170 determines that the illumination turn-on state information is data (for example, “0 (zero)”) indicating “turn-off” (step S1011: NO), the processes of the flow diagram are terminated.

When it is determined to be “Yes” in the process of step S1011, the camera control section 170 generates illumination instruction information including data (for example, “0 (zero)”) indicating “turn-off request”, and transmits the illumination instruction information to the accessory control section 440 (step S1012).

Next, the accessory control section 440 receives the illumination instruction information transmitted from the camera control section 170 (step S1013).

Next, the accessory control section 440 detects data indicating “turn-off request” included in the illumination instruction information, and determines whether to turn off the illumination light source 437. Specifically, for example, the accessory control section 440 determines that turn-off of the illumination light emitting section 435 is permitted by execution of a camera control program.

Next, the accessory control section 440 generates illumination response information in accordance with the determination result, and transmits the illumination response information to the camera control section 170 (step S1014). Specifically, for example, when it is determined that turn-off of the illumination light emitting section 435 is permitted, the accessory control section 440 generates illumination response information including data (for example, “1”) indicating “consent”, and transmits the illumination response information to the camera control section 170. In addition, when it is determined that turn-off of the illumination light emitting section 435 is not permitted, the accessory control section 440 generates illumination response information including data (for example, “0 (zero)”) indicating “non-consent”, and transmits the illumination response information to the camera control section 170.

Next, the camera control section 170 receives the illumination response information transmitted from the accessory control section 440 (step S1015).

Subsequently to the process of step S1014, when the accessory control section 440 consents the illumination instruction information (step S1016: Yes), the flow of processes goes to step S1017, and when it does not consent the illumination instruction information (step S1016: NO), the processes of the flow diagram are completed.

When it is determined to be “Yes” in the process of step S1016, the accessory control section 440 drives the illumination light source driving section 436 and turns off the illumination light source 437 (step S1017).

(2) AE Control and AWB Control Process

The camera body 100 can turn on or turn off the illumination light emitting section 435 of the accessory 400 by the operation (manual operation) of a user (operator or photographer). Specifically, for example, the camera control section 170 displays an operation menu of the accessory 400 on the display section 102. Next, the setting switch 104 is operated by a user in accordance with the operation menu, and thus the camera control section 170 receives an operation information signal indicating a request for turn-on or turn-off of the illumination light emitting section 435 from the operation detection circuit 155. The camera control section 170 then transmits the illumination instruction information to the accessory control section 440, in accordance with the request (instruction operation) for turn-on or turn-off through a user operation which is received in the operation detection circuit 155.

Even when the illumination light emitting section 435 of the accessory 400 is turned on in accordance with the manual operation of the camera body 100 by a user, the camera body 100 can acquire the illumination setting state information by execution of the steady communication sequence between the camera control section 170 and the accessory control section 440.

The camera control section 170 reads out the illumination turn-on state information from the buffer memory 165, and determines whether the illumination light emitting section 435 (for example, one white LED is included in the illumination light source 437) is turned on depending on the illumination turn-on state information. When it is determined that the illumination turn-on state information is data (for example, “1”) indicating “turn-on”, similarly to the process of step S607 in FIG. 22, the camera control section 170 executes any one of the AE control (exposure control) and the AWB control (white balance control) on the assumption that the illumination light emitting section 435 emits illumination light.

In addition, in a separate embodiment from the present embodiment, an operation member for switching turn-on/turn-off of the illumination light emitting section 435 may be provided on the accessory 400 side. In this manner, even in the case where the light-emitting state of the illumination light emitting section 435 is switched by the operation member provided on the accessory 400 side, as long as a system is configured to be capable of receiving the above-mentioned illumination turn-on state information from the accessory 400, the camera control section 170 perceives the state of emission of the illumination light emitting section 435, and then can perform suitable controls accordingly (for example, turn-on instructions, turn-off instructions, AE control, or AWB control mentioned above).

(3) Other Process

In addition, the camera control section 170 acquires the illumination setting state information from the accessory control section 440 through the processes of the periodic steady communication sequence executed by the camera control section 170 and the accessory control section 440, and then may perform the following processes based on the illumination setting state information.

For example, the camera control section 170 determines and executes executable processes in the camera 10 and the accessory 400 or in any one of them, or a combination of executable processes, depending on the light-emitting state indicated by the illumination turn-on state information in the illumination setting state information. That is, the camera control section 170 determines whether any of the processes is executable in the camera 10 and the accessory 400 or in any one of them, depending on the light-emitting state indicated by emission turn-on state information, and executes processes in accordance with this determination.

When the illumination light emitting section 435 is emitting light, power (required current) required for the emission becomes relative large power (current value). For this reason, while the illumination light emitting section 435 emits light, it is preferable, from the view point on the stable operation control of the camera system 1, to avoid (exclusively control) a process having a large current consumption (for example, a charging process to the electric accumulating section, a heavy load process inside the camera 10, or the like). For this reason, at the time of the above-mentioned determination (determination of whether any of the processes is executable), the camera control section 170 performs an exclusive determination using the illumination turn-on state information.

Specifically, the camera control section 170 reads out the illumination turn-on state information from the buffer memory 165, and determines whether the illumination light emitting section 435 (for example, one white LED is included in the illumination light source 437) is turned on depending on the illumination turn-on state information. When it is determined that the illumination turn-on state information is data (for example, “1”) indicating “turn-on”, the camera control section 170 determines the charging process of the electric accumulating section for the accessory 400 is not executable, and prohibits the charging process for the charging section 432. On the other hand, when it is determined that the illumination turn-on state information is data (for example, “0 (zero)”) indicating “turn-off”, the camera control section 170 determines that the charging process of the electric accumulating section for the accessory 400 is executable, and permits the charging process for the charging section 432.

In addition, when the camera body 100 transmits turn-on instruction information of the illumination light emitting section 435 to the accessory 400, the camera body may confirm whether the accessory 400 controls the illumination light emitting section 435 in accordance with the turn-on instructions information, using the illumination turn-on state information received from the accessory 400.

Specifically, the camera control section 170 transmits illumination instruction information indicating the start request for turn-on of the illumination light emitting section 435 to the accessory control section 440, and then receives the illumination setting state information transmitted from the accessory control section 440. Next, when it is determined that the light-emitting state indicated by the illumination turn-on state information in the received illumination setting state information is data (for example, “0 (zero)”) indicating “turn-off”, the camera control section 170 retransmits the illumination instruction information indicating a turn-on start request to the accessory control section 440.

In addition, the camera control section 170 transmits illumination instruction information indicating a termination request for turn-on of the illumination light emitting section 435 to the accessory control section 440, and then receives the illumination setting state information transmitted from the accessory control section 440. Next, when it is determined that the light-emitting state indicated by the illumination turn-on state information in the received illumination setting state information is data (for example, “1”) indicating “turn-on”, the camera control section 170 retransmits the illumination instruction information indicating the turn-on termination request to the accessory control section 440.

<Charging Control of Charging Section>

The charging control of the electric accumulating section through the charging section 432 having the electric accumulating section which is included in the flash light emitting section 430 will be supplementarily described with reference to FIG. 20.

The camera control section 170 generates charging control instruction information indicating instructions of the charging control for the charging section 432, and transmits the charging control instruction information to the accessory control section 440. The instructions of the charging control include, for example, instructions of the type of the charging process, instructions of the charging start, instructions of the charging termination, and instructions of the charging rate. Specifically, the type of the charging process includes a normal charging process (main charging process or first charging process) and a slow charging process (second charging process). The instructions of the charging rate are instructions for selectively switching the charging rate of multiple types. As mentioned above, in the charging rate, for example, there are two of the normal charging rate (first charging rate) corresponding to the normal charging process, and the slow charging rate (second charging rate), corresponding to the slow charging process, of which the charging rate is slower than the above-mentioned normal charging rate.

The camera body 100 controls the charging process of the electric accumulating section for the charging section 432 of the accessory 400, in accordance with the operation of the camera 10 or the camera system 1. Specifically, for example, the camera body 100 stops the charging process of the electric accumulating section for the charging section 432 of the accessory 400, when a process having a relative high electrical load (power load) as the entirety of the camera system 1, in other words, a process in the range of power consumption of which power consumption of the mounted battery BAT is previously determined is started, and while the corresponding process is executed. The process having a relative high electrical load is, for example, a driving process for expanding the image capture lens 200 (extending and elongating a barrel of the image capture lens 200 until the state where an image can be captured), or contracting thereof (contracting a barrel of the image capture lens 200 until the state where an image cannot be captured). On the other hand, the camera body 100 can start the charging process of the electric accumulating section for the charging section 432 of the accessory 400, when a process having a relative low electrical load as the entirety of the camera system 1, in other words, a process out of the range of power consumption of which power consumption of the mounted battery BAT is previously determined is started, and while the corresponding process is executed. A camera control program executed by the camera control section 170 is previously set so that the camera control section 170 can identify what the process having a relative high electrical load is. For this reason, the camera control section 170 can recognize the process having a relative high electrical load from the view of the entirety of the camera system 1, by executing this camera control program.

That is, the camera control section 170 generates charging control instruction information indicating instructions of the charging control for the charging section 432, in consideration of the situation of the electrical load, in each case, in accordance with the operations (process details) executed by the camera 10 or the camera system 1. Specifically, the camera control section 170 performs a control so as not to generate the charging control instruction information including instructions of the charging start (so as not to perform the process having a relative high electrical load and the charging process in parallel), when the process having a relative high electrical load is started, and while the corresponding process is executed. In other words, the camera control section 170 can generate the charging control instruction information including instructions of the charging start, while the process having a relative high electrical load is executed.

The accessory control section 440 receives the above-mentioned charging control instruction information transmitted from the camera control section 170, and controls the charging for the charging section 432 through the power PWR supplied from the battery BAT mounted in the camera body 100, based on the charging control instruction information.

Specifically, when the charging control instruction information indicates instructions of the charging start for the charging section 432, the accessory control section 440 starts the charging of the electric accumulating section for the charging section 432 through the power PWR supplied from the camera body 100.

In addition, when the charging control instruction information indicates instructions of the charging termination for the charging section 432, the accessory control section 440 terminates the charging of the electric accumulating section for the charging section 432 through the power PWR supplied from the camera body 100.

In addition, the accessory control section 440 selectively controls the normal charging rate corresponding to the normal charging process and the slow charging rate corresponding to the slow charging process in the charging process executed by the charging section 432, based on the charging control instruction information.

In the flow diagram of FIG. 20, using the process of step S436 in the same drawing, the camera control section 170 of the camera body 100 transmits the normal charging command to the accessory control section 440 of the accessory 400, and then the accessory control section 440 receives the normal charging command.

The accessory control section 440 starts the normal charging process of the charging section 432 in accordance with the received normal charging command.

In addition, using each process of step S437 and step S441 in the same drawing, the camera control section 170 transmits the slow charging command to the accessory control section 440, and then the accessory control section 440 receives the slow charging command. The accessory control section 440 starts the slow charging process of the charging section 432 in accordance with the received slow charging command.

In addition, when the conditions for terminating the normal charging process or the slow charging process of the charging section 432, that is, the charging of the electric accumulating section are detected or acquired, the camera control section 170 generates charging control instruction information (that is, charging stop command) indicating instructions of the charging termination, and transmits the charging control instruction information to the accessory control section 440. The conditions for terminating the charging include, for example, a case where the amount of charging reaches a predetermined amount which is previously set, power source off of the camera body 100, transition to the standby state, switching of the image capture mode, abnormal occurrence (for example, abnormal generation of heat) in the camera system 1, detachment of accessory 400, start of expansion or contraction of the image capture lens 200, a case where an operation command of a power zoom lens (power zoom operation) is input by a user, a case where an operation command of power focus is input, a case where the process having a relative high electrical load is started, and the like. For example, when the camera control section 170 issues the charging control instruction information for causing the accessory 400 to perform the normal charging process, and the above-mentioned charging termination conditions are prepared, the camera control section 170 changes the details of the charging control instruction information regarding the accessory 400 to the details of the charging control instruction information for stopping the charging operation. That is, the camera control section 170 changes the details of the charging control instruction information (to be transmitted to the accessory 400) to be created, in each case, depending on the operation contents (operation conditions) on the camera 10 side.

The accessory control section 440 receives the charging control instruction information indicating instructions of the charging termination transmitted by the camera control section 170, and stops the normal charging process or the slow charging process of the charging section 432, based on the charging control instruction information.

In addition, in FIG. 20, when it is determined that the flash light emitting section 430 is in a “ready state”, as in step S440: “Yes”, the processes of step S441 and step S442, step S434: “Yes”, and the processes of step S437 and step S438, the camera control section 170 transmits the slow charging command to the accessory control section 440.

That is, when the accessory control section detects, from the charging section 432, that the normal charging process of the charging section 432 is completed, and receives the charging control instruction information indicating instructions of the charging start of the slow charging process transmitted from the camera control section 170, the accessory control section starts the slow charging process of the charging section 432 through the power PWR supplied from the camera body 100, based on the charging control instruction information.

As stated above, the charging operation performed in the charging section 432 on the accessory 400 side is not independently performed in the accessory 400 side, but is performed in accordance with the charging control instructions supplied from the camera control section 170. This is because the accessory 400 itself of the present embodiment does not include a power source, and is entirely dependent on the camera 10 for a supply of power. The camera system 1 is configured as stated above, so that the camera 10 side can control the charging operation performed in the accessory 400, and a system can be configured without any concern of disturbing the operation of the camera 10 side due to arbitrary use of power of the camera 10 by the accessory 400. In other words, in the present embodiment, the charging operation of the accessory 400 (charging section 432) is dependent on the processing details (operation) in the camera 10 side, but there is no concern that the operation of the camera 10 is suddenly stopped in the above-mentioned camera system 1 due to this reason.

In addition, in FIG. 20, when it is determined that the flash light emitting section 430 is in a “ready state”, the accessory control section 440 receives the slow charging command from the camera control section 170 and then performs switching to the slow charging process. However, this switching process may be switched by an individual determination in the accessory control section 440, without waiting for the slow charging command from the camera control section 170 (independently of the charging control command currently received from the camera 10). That is, when the above-mentioned “ready state” is determined in the accessory control section 440, the accessory control section 440 switches the operation in the charging section 432 from the normal charging process to the slow charging process without receiving the charging stop command from the camera control section 170. This is a switching operation in the direction of decreasing consumption current within the accessory 400, and thus even though the accessory 400 side performs a process independently without waiting for a determination of the camera 10, there is a low possibility to have an adverse influence (operation stop or the like) on the operation in the camera 10 side. Since the consumption current can be reduced earlier than by the command (determination) in the camera control section 170, it is possible to achieve energy saving.

Alternatively, when it is determined in the accessory control section 440 that the flash light emitting section 430 is in the above-mentioned “ready state”, the accessory control section 440 may stop the normal charging process or the slow charging process of the charging section 432, without receiving the charging stop command from the camera control section 170. That is, when it is detected from the charging section 432 that the charging section 432 completes the charging even in the case where the normal charging command and the slow charging command are received, the accessory control section 440 stops the charging of the charging section 432 by an individual determination in the accessory control section 440, without receiving the charging stop command (without waiting for charging stop instructions from the camera control section 170, in other words, independently of the charging control command currently received from the camera 10). With such a configuration, the process is completed without performing the charging operation (current consumption) more than necessary, and thus it is possible to protect the charging section 432 or the accumulation section, and to achieve energy saving.

<Update Control of Program of Accessory>

Next, an update control of a program of the accessory 400 will be described. The program of the accessory 400 is a program (accessory control program) stored in the nonvolatile memory 445 of the accessory 400. The camera system 1 can update the accessory control program by an update program supplied from the outside.

The update program is stored in, for example, the memory (nonvolatile memory such as a memory card) 140 capable of being attached and detached to and from the camera body 100, and is supplied to the camera body 100 by the mounting of the memory 140 in the camera body 100. Alternatively, the update program is supplied from an external device through an external interface included in the camera body 100. The external interface is, for example, a USB (Universal Serial Bus) connector. The external device is, for example, a computer device having an update program.

In addition, a program is also called firmware, and update of a program is also called version update of firmware (firmware update).

The hardware environment for performing update of a program is, for example, the camera system 1 in which the memory 140 having an update program stored is mounted in the camera body 100, and the accessory 400 is mounted in the camera body 100.

Before execution of an update process (firmware update process) of the accessory control program is started, the camera control section 170 determines whether the types of the shoe seat 15 of the camera body 100 and the connector 420 of the accessory 400 are in accord with each other. When it is determined that the types are in accord with each other, the camera control section 170 permits the update process of the accessory control program, and when it is determined that the types are not in accord with each other, the camera control section prohibits (does not execute) the update process of the accessory control program.

As a process of the determination, for example, the camera control section 170 compares shoe type information stored in the nonvolatile memory 160 with connector type information which is received from the accessory control section 440 in the initial communication sequence and is stored in the buffer memory 165, and determines whether the types of the shoe seat 15 and the connector 420 are in accord with each other. Specifically, the camera control section 170 reads out the shoe type information from the nonvolatile memory 160 and reads out the connector type information from the buffer memory 165, and determined whether the shoe type information and the connector type information are in accord with each other, or become a pair previously determined by the camera control program.

In addition, before execution of the update process of the accessory control program is also started in the accessory control section 440 side, it is determined that the types of the connector 420 of the accessory 400 and the shoe seat 15 of the camera body 100 are in accord with each other. The accessory control section 440 permits the update process of the accessory control program when it is determined that the types thereof are in accord with each other, and prohibits the update process of the accessory control program when it is determined that the types thereof are not in accord with each other.

As a process of the determination, for example, the accessory control section 440 compares the connector type information stored in the nonvolatile memory 445 with shoe type information which is received from the camera control section 170 in the initial communication sequence and is stored in the memory within the accessory control section 440, and determines whether the types of the connector 420 and the shoe seat 15 are in accord with each other. Specifically, the accessory control section 440 reads out the connector type information from the nonvolatile memory 445 and reads out the shoe type information within the memory of the accessory control section 440, and determines whether the connector type information and the shoe type information are in accord with each other, or become a pair previously determined by the accessory control program.

In this manner, in the present embodiment, it is configured such that the shoe type information is mutually communicated between the camera body 100 and the accessory 400, and when the shoe type information and the connector type information are in accord with self's ones, the update process of the accessory control program is prohibited therebetween (in other words, doubly prohibited). For this reason, even though the camera body and the accessory of which the shoe type and the connector type are different are mounted, there is no concern that the firmware update process is executed by mistake, and the process is completed mutually without performing unnecessary processes such as a preparation operation for the firmware update process, whereby it is possible to reduce a process burden in the mutual control sections.

In addition, the shoe type information stored in the nonvolatile memory 160 may be set to information indicating the type of the connector 420 included in the accessory 400 mounted in the shoe seat 15 of the camera body 100.

In addition, similarly, the connector type information stored in the nonvolatile memory 445 may be set to information indicating the type of the shoe seat 15 included in the camera body 100 mounted in the connector 420 of the accessory 400.

As described above, the accessory 400 which is the embodiment of the present invention includes the connector 420 connected to the shoe seat 15 of the camera body 100, and the accessory control section 440 which sequentially receives the transmission request command C11, periodically transmitted from the camera body 100, through the connector 420, generates illumination turn-on state information indicating the light-emitting state (whether to be in a light-emitting state) of the illumination light emitting section 435 in accordance with reception of each transmission request command C11, and transmits the illumination turn-on state information through the connector 420 to the camera body 100.

Thereby, the accessory 400 can notify the camera body 100 of the light-emitting state of the illumination light emitting section 435. In addition, the accessory 400 can notify the camera body 100 of the light-emitting state of the illumination light emitting section 435, in accordance with a request from the camera body 100.

There are the following advantages by receiving the notification. In the camera control section 170, it is possible to determine (select) processes capable of being executed while maintaining a stable operation as the camera system 1, based on the received illumination light turn-on state information. In addition, even when the illumination light emitting section 435 emits light independently of instructions from the camera body 100 side (for example, by a manual operation by a user), the camera control section 170 can perceive it depending on the illumination light turn-on state information, and thus it is possible to perform a control suitable for the light-emitting state. In addition, even when normal communication cannot be performed by the influence of inferior communication due to noise or the like, regardless of the issue of an emission command (or turn-off command) from the camera control section 170, or the illumination light emitting section 435 cannot be operated in accordance with the command due to defects on the accessory 400 side, the camera control section 170 can perceive it depending on the illumination light turn-on state information, and thus it is possible to perform suitable processes afterward (for example, reissue of the emission command once again).

In addition, the accessory 400 is operated by the power PWR supplied from the battery BAT mounted in the camera body 100 through the shoe seat 15 and the connector 420 of the camera body 100.

Thereby, since it is not necessary that a battery is mounted in the camera body 100 and the accessory 400, only a battery on the camera body 100 side may be managed, and thus the convenience of a user is improved.

In addition, the accessory 400 includes the connector 420 connected to the shoe seat 15 of the camera body 100, the accessory control section 440 transmitting illumination light emitting function information indicating the characteristics of the illumination light emitting section 435, stored in the nonvolatile memory 445, through the connector 420 to the camera body 100, in accordance with the reception, through the connector 420, the transmission request command C3 indicating a transmission request of the illumination light emitting function information corresponding to the illumination light emitting section 435 transmitted from the camera body 100.

In addition, the illumination light emitting function information may be set to information indicating the type of the solid-state light source included in the illumination light-emitting section 435, for example, information indicating of the emission color of the solid-state light source, or information indicating the color temperature of the solid-state light source.

In addition, the accessory 400 notifies the camera body 100 of information regarding the illumination light emitting function of the illumination light emitting section 435. With such a configuration, the camera 10 side can select the command details capable of being requested from the illumination light-emitting section 435, using the illumination light emitting function information. For example, when the camera 10 receives illumination light emitting function information such as “accessory 400 includes a three-color LED” from the accessory 400, the camera 10 transmits a command for requesting the accessory 400 for the control of the emission color, and thus can perform image capture in which the emission color of illumination light is controlled. In addition, when the camera 10 receives illumination light emitting function information indicating the purport of “only a white LED is included” or “white LED is included” from the accessory 400, the camera 10 side can determine before command transmission that the accessory 400 cannot be cope with even when the emission color control command is sent to the accessory 400. Consequently, there is no concern that such useless communication is performed, and thus the easy-to-use camera system 1 can be made.

In addition, the accessory 400 includes the connector 420 connected to the shoe seat 15 of the camera body 100, and accessory control section 440 transmitting the illumination turn-on possible time information stored in the nonvolatile memory 445 through the connector 420 to the camera body 100, in accordance with the reception, through the connector 420, the transmission request command C3 of the illumination turn-on possible time information indicating the longest time for which the illumination light emitting section 435 is capable of continuously turning on illumination light, transmitted from the camera body 100. The communication herein is performed in the initial communication sequence.

Thereby, the accessory 400 can notify the camera body 100 of time information for which the illumination light emitting section 435 is capable of being continuously turned on. In addition, the accessory 400 can notify the camera body 100 of time information for which the illumination light emitting section 435 is capable of being continuously turned on, in accordance with a request from the camera body 100.

In addition, the accessory 400 includes the connector 420 connected to the shoe seat 15 of the camera body 100, the charging section 432 having the electric accumulating section, and the accessory control section 440 which receives, through the connector 420, the charging control instruction information indicating instructions of the charging control for the charging section 432 transmitted from the camera body 100, dependent on the operation details of the camera 10 or the camera system 1, and causes the charging section 432 to control the charging of the electric accumulating section through the power PWR supplied from the camera body 100 to the connector 420, based on the charging control instruction information.

In addition, when the charging control instruction information indicates instructions of the charging start for charging section 432, the accessory control section 440 causes the charging section 432 to start the charging of the electric accumulating section through the power PWR supplied from the camera body 100.

In addition, when the charging control instruction information indicates instructions of the charging termination for the charging section 432, the accessory control section 440 causes the charging section 432 to terminate the charging of the electric accumulating section through the power PWR supplied from the camera body 100.

In addition, the accessory control section 440 controls the charging rate in the charging process executed by the charging section 432, based on the charging control instruction information.

In addition, the accessory control section 440 selects any of the normal charging rate corresponding to normal charging process and the slow charging rate corresponding to the slow charging process of which the charging rate is slower than the normal charging rate, in the charging section 432, based on the charging control instruction information.

In addition, when the accessory control section 440 detects, from the charging section 432, that the normal charging process of the charging section 432 is completed, and receives the charging control instruction information indicating instructions the charging start of the slow charging process transmitted from the camera body 100, based on the charging control instruction information, the accessory control section starts the slow charging process of the charging section 432 through the power PWR supplied from the camera body 100.

In addition, when it is detected, from the charging section 432 that the charging through the charging section 432 is completed, the accessory control section 440 starts the slow charging process, independently of the charging control instruction information.

In addition, when it is detected, from the charging section 432, that the charging by the charging section 432 is completed, the accessory control section 440 stops the charging of the charging section 432.

Thereby, the accessory 400 receives instructions of the charging control for the charging section 432 from the camera body 100, and can cause the charging section 432 to control the charging of the electric accumulating section through the power PWR supplied from the camera body 100, based on the instructions.

In addition, when the normal charging process of the charging section 432 is completed, the accessory 400 can switch from the normal charging process to the slow charging process, or can stop the charging process.

In addition, the accessory 400 includes the nonvolatile storage section 445 which stores connector type information (accessory side type information) indicating the kind of the connector 420 connected to the shoe seat 15 of the camera body 100. Thereby, there are cases where this information is appropriately read out at a necessary scene and is used. For example, when the connector type information is transmitted to the camera body 100, it is possible to perform a process (the process in a case of not matching with a shoe type) based on a connector type of the accessory 400 of the camera 10 side. In addition, when the camera 10 side is configured to receive the shoe type information (camera side type information), a necessary process (the above-mentioned firmware update prohibition process when both are different from each other as a result of comparison thereof) may be performed by the use of the received shoe type information and the connector type of the camera 10.

In addition, the shoe type information may be information indicating the type of the shoe seat 15 included in the camera body 100. In addition, the shoe type information may be information indicating a terminal section included in the accessory 400, that is, the type of connector 420. In addition, the connector type information may be information indicating the type of connector 420. In addition, the connector type information may be information indicating a terminal section included in the camera body 100, that is, the type of shoe seat 15.

In addition, when a comparison result of the shoe type information and the connector type information indicates that they do not match with each other, the accessory control section 440 prohibits a firmware update process of the accessory 400 through software control on the accessory 400 side. Thereby, it can be determined whether or not a combination of the connector 420 of the accessory 400 connector 420 and the shoe seat 15 of the camera body 100 is suitable. Therefore, the accessory 400 performs firmware update only for a suitable combination with the camera body 100, and thus the firmware update can be performed without errors (normally). In addition, the accessory 400 can be safely supplied with the power PWR from the battery BAT in a suitable combination with the camera body 100.

In addition, the camera body 100 applied to the camera 10 according to the embodiment of the present invention includes the shoe seat 15 connected to the connector 420 of the accessory 400, and a camera control section which periodically transmits the transmission request command C11 indicating a transmission request of illumination lighting state information indicating light-emitting state (a state as to whether or not light is emitted) of the illumination light emitting section 435 to the accessory 400 via the shoe seat 15, receives illumination lighting state information transmitted from the accessory 400 via the shoe seat 15 in response to reception of the transmission request command C11, and detects a light-emitting state of the illumination light emitting section 435 based on the illumination lighting state information.

Thereby, the camera body 100 can be notified of the light-emitting state of illumination light emitting section 435 from the accessory 400. In addition, the camera body 100 may request the accessory 400 to confirm a light-emitting state of the illumination light emitting section 435, and acquire a light-emitting state of the illumination light emitting section 435 responded from the accessory 400 according to the request.

In addition, the camera control section 170 of the camera body 100 transmits illumination instruction information for controlling emission of the illumination light emitting section 435 to the accessory, depending on the detected light-emitting state.

For example, when the detected light-emitting state indicates that light is not emitted, and an instruction request for the illumination light emitting section 435 emitting light is supplied, the camera control section 170 may transmit illumination instruction information indicating a request for the illumination light emitting section 435 starting emission to the accessory 400.

In addition, when the detected light-emitting state indicates that light is emitted, and an instruction request for the illumination light emitting section 435 not emitting light is supplied, the camera control section 170 may transmit illumination instruction information indicating a request for the illumination light emitting section 435 stopping emitting light to the accessory 400.

Thereby, the camera body 100 can confirm a current light-emitting state of the illumination light emitting section 435 of the accessory 400, and control the illumination light emitting section 435.

In addition, the camera control section 170 retransmits the illumination instruction information indicating the start request to the accessory 400 when the illumination turn-on state information transmitted from the accessory 400 having received the illumination instruction information indicating the transmitted start request is received and the light-emitting state indicated by the received illumination turn-on state information indicates that light is not emitted.

Thereby, the camera body 100 can confirm whether the accessory 400 controls the illumination light emitting section 435 based on the illumination instruction information. Thus, for example, when the accessory 400 does not receive the illumination instruction information due to the communication error between the camera control section 170 and the accessory control section 440 and thus the illumination light emitting section 435 is not appropriately controlled, the camera body 100 can confirm the state and thus can retransmit the illumination instruction information to the accessory control section 440 to restore the normal operation.

In addition, when the light-emitting state indicated by the illumination turn-on state information indicates that light is emitted, the camera control section 170 executes the AE control and the AWB control or any one control thereof.

Thereby, the camera body 100 can execute the adjustment of the exposure and the color or any one thereof depending on the illumination, when it is detected that the illumination light-emitting section 435 is turned on.

In addition, the camera body 100 supplies the power PWR to the accessory 400 from the mounted battery BAT via the shoe seat 15.

Thereby, since it is not necessary to mount batteries on the camera body 100 and the accessory 400, respectively, only a battery on the camera body 100 side may be managed, and thus the convenience of a user is improved.

In addition, the camera control section 170 determines which process is executable depending on the light-emitting state indicated by the illumination turn-on state information.

For example, when the light-emitting state indicated by the illumination turn-on state information indicates that light is not emitted, the camera control section 170 determines that the charging process on the accessory 400 is executable.

In addition, when the light-emitting state indicated by the illumination turn-on state information indicates that light is emitted, the camera control section 170 determines that the charging process on the accessory 400 is not executable.

Thereby, while the illumination light emitting section 435 is turn on, the supply of the power PWR from the battery mounted on the camera body 100 to the charging section 432 is stopped and thus the increase in the power consumption of the camera system 1 can be prevented.

In addition, the camera body 100 includes the shoe seat 15 connected to the connector 420 of the accessory 400 and the camera control section 170 transmitting the transmission request command C3 indicating the transmission request of the illumination light emitting function information corresponding to the illumination light emitting section 435 to the accessory 400 via the shoe seat 15 and receiving the illumination light emitting function information transmitted from the accessory 400 via the shoe seat 15 in response to the reception of the transmission request command C3.

In addition, the illumination light emitting function information may be information indicating the type of the solid-state light source included in the illumination light-emitting section 435, for example, information indicating the emission color of the solid-state light source and information indicating the color temperature of the solid-state light source.

Thereby, the camera body 100 can acquire the illumination light emitting function information of the illumination light emitting section 435 from the accessory 400. In addition, the camera body 100 can request the accessory 400 for the illumination light emitting function information corresponding to the illumination light emitting section 435 and can acquire the illumination light emitting function information corresponding to the illumination light emitting section 435 transmitted from the accessory 400 in response to the request.

In addition, the camera body 100 includes the shoe seat 15 connected to the connector 420 of the accessory 400 and the camera control section 170 transmitting the transmission request command C3 of the illumination turn-on possible time information indicating the longest time in which the illumination light-emitting section 435 is capable of continuously emitting the illumination light to the accessory 400 via the shoe seat 15 and receiving the illumination turn-on possible time information transmitted from the accessory 400 via the shoe seat 15 in response to the reception of the transmission request command C3. Here, the communication is performed in the initial communication sequence.

Thereby, the camera body 100 can request the time information indicating the time in which the illumination light emitting section 435 is capable of being turned on from the accessory 400. In addition, the camera body 100 requests the accessory 400 for the time information indicating the time in which the illumination light emitting section 435 is capable of being turned on and can acquire the time information indicating the time in which the illumination light emitting section 435 is capable of being turned on and which is transmitted from the accessory 400 in response to the request.

In addition, the camera control section 170 transmits the transmission request command C3 to the accessory 400 but does not receive the illumination turn-on possible time information from the accessory 400, the camera control section 170 may set the time in which the illumination light emitting section 435 is capable of emitting light to a predetermined time. The predetermined time may be set to predetermined seconds (for example 5 seconds) previously stored in the camera side. Alternatively, it may be considered that the continuous turn-on function is not present based on the fact that the illumination turn-on possible time information cannot be received and the predetermined time may be set to “0 (zero)”, that is, the purport that the time in which the continuous turn-on is possible does not exist (that continuous turn-on is not possible) may be set.

In addition, the camera body 100 includes the shoe seat 15 connected to the connector 420 of the accessory 400 including the charging section 432 having the electric accumulating section and the camera control section 170 generating the charging control instruction information indicating the instructions of the charging control on the charging section 432 based on the processing details (based on the operation details) in the camera 10 or the camera system 1 and transmitting the charging control instruction information to the accessory 400 via the shoe seat 15.

In addition, when the power consumption of the mounted battery BAT is out of the range of the previously determined power consumption in accordance with the operation of the camera 10 or the camera system 1, the camera control section 170 generates the charging control instruction information indicating the instructions of the charging start of the charging section 432, transmits the charging control instruction information to the accessory 400, and supplies the power PWR to the charging section 432 from the battery BAT via the shoe seat 15.

In addition, when the power consumption of the mounted battery BAT is in the range of the previously determined power consumption in accordance with the operation of the camera 10 or the camera system 1, the camera control section 170 generates the charging control instruction information indicating the instructions of the charging stop of the charging section 432, transmits the charging control instruction information to the accessory 400, and stops the supply of the power PWR to the charging section 432 from the battery BAT.

In addition, the camera control section 170 generates the charging control instruction information indicating the instructions of the charging control on the charging section 432 in accordance with the operation of the camera body 100 or the camera 10.

Thereby, the camera body 100 can instruct the accessory 400 to perform the charging control of the charging section 432. In addition, the camera body 100 can instruct the charging start of the charging section 432 and can supply the power PWR to the charging section 432 from the mounted battery BAT. In addition, the camera body 100 can instruct the charging stop of the charging section 432 and can stop the supply of the power PWR to the charging section 432 from the mounted battery BAT. In addition, the camera body 100 can prevent an electrical load from being excessively applied to the camera body 100.

In addition, the camera body 100 includes the nonvolatile memory 160 storing the shoe type information (camera side type information) indicating the type of the shoe seat 15 connected to the connector 420 of the accessory 400. Thereby, this information can be appropriately read out and used as needed. For example, when this shoe type information is transmitted to the accessory 400, the accessory 400 side can perform the process (the process when it is not in accord with the connector type) based on the shoe type of the camera body 100. Moreover, when the connector type information (accessory side type information) is received by the accessory 400 side, a necessary process (the above-mentioned firmware update prohibition process when both information pieces are not in accord with each other) may be performed by the use of the received connector type information and the shoe type information stored in itself.

In addition, the connector type information may be information indicating the type of the connector 420 of the accessory 400. Moreover, the connector type information may be information indicating the type of the terminal section to be included in the camera body 100, that is, the shoe seat 15.

In addition, the camera control section 170 compares the shoe type information stored in the nonvolatile memory 160 with the connector type information.

In addition, the shoe type information may be information indicating the type of the shoe seat 15.

In addition, the shoe type information may be information indicating the type of the terminal section to be included in the accessory 400, that is, the connector 420.

In addition, when the comparison results between the connector type information and the shooter type information are not in accord with each other, the camera control section 170 causes the camera body 100 side to prohibit the update process of the firmware of the accessory 400 by the software control.

Thereby, the camera body 100 can determine whether the connector 420 of the accessory 400 connected via the shoe seat 15 is of a suitable type. Accordingly, the camera body 100 can update the firmware in combination with the suitable accessory 400. In addition, the camera body 100 can safely supply the power PWR to the accessory 400 from the battery BAT in combination with the suitable accessory 400.

Therefore, according to the embodiment of the invention, the operability of the camera and the accessory, that is, the camera system can be improved, thereby enhancing the convenience.

In addition, in the embodiment, it is described that the accessory 400 is used in the state where it is mounted on the camera body 100. However, when the camera body 100 and the accessory 400 are provided with well-known wireless communication sections (communication sections capable of communicating with each other) and the accessory 400 includes a battery or is supplied with power from means other than the camera body 100, the accessory 400 may be used separate from the camera body 100. In this case, various commands previously stated in the embodiment or various types of information (for example, the initial state information of the above-mentioned camera, the illumination light emitting function information, the illumination turn-on possible time information, the light-emitting state information, and the like) may be transmitted and received through the use of the wireless communication function.

[Description of Accessory Including GPS Function]

Next, an example of an accessory 600 will be described.

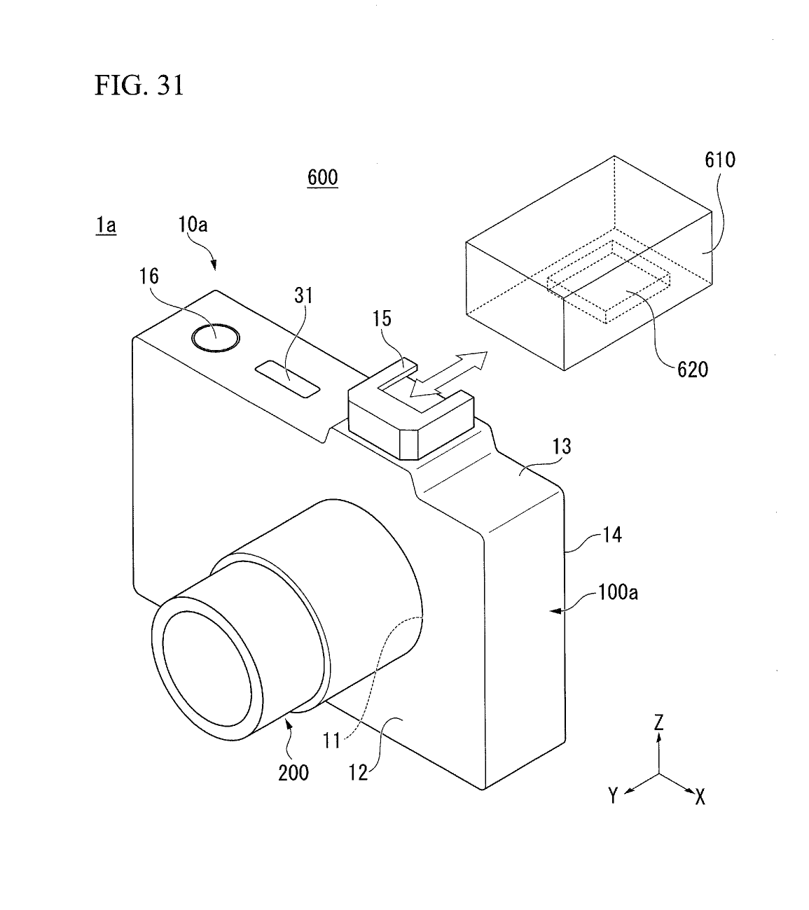

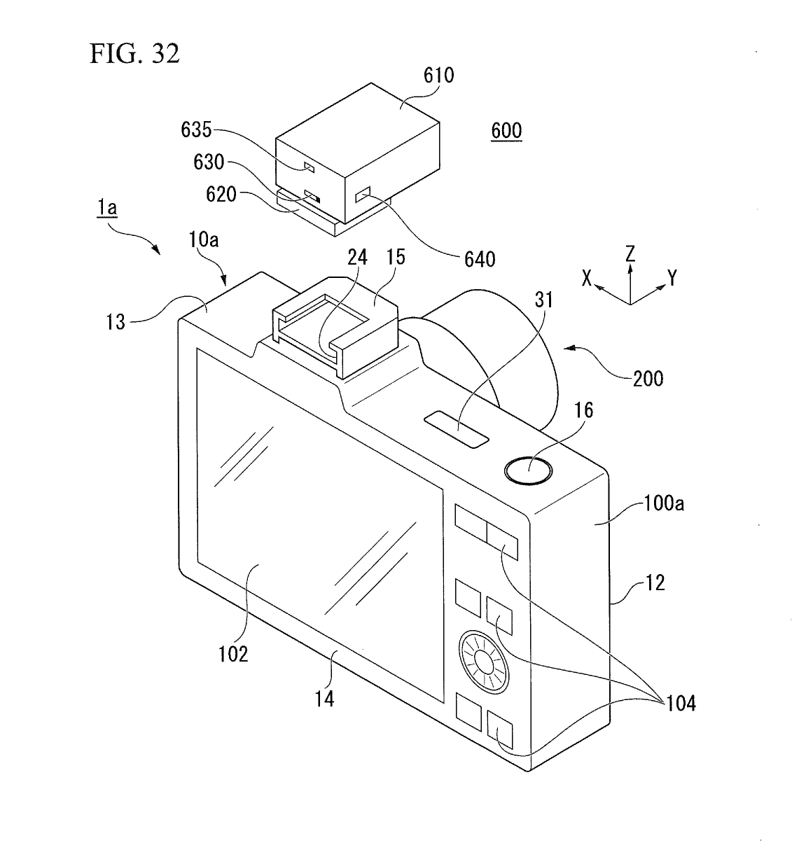

A camera system 1a shown in FIGS. 31 and 32 includes a camera 10a and the accessory 600. The accessory 600 according to the present embodiment has a GPS function and can perform positioning and the like. The camera 10a can control the accessory 600 by communication with the accessory 600. The camera system 1a can, for example, measure an image capture position by the accessory 600 and store image capture position information, measured in association with image data captured by the camera 10a, in the memory 140 (see FIG. 6). FIG. 31 is a diagram illustrating an appearance of the camera system 1a according to the present embodiment. FIG. 32 is a diagram when the camera system 1a according to the present embodiment is viewed from the side opposite to FIG. 31.

The appearance of the camera 10a is the same as the appearance of the camera 10 shown in FIGS. 1 and 2. In addition, the components inside the camera 10a are also the same as those of the camera 10 shown in FIG. 7 except that a clocking section 34 is included. Therefore, in the following description, the same components are assigned the same names and reference symbols, and the description thereof may be simplified or omitted.

The accessory 600 includes an accessory main body 610 receiving various types of parts and a second connector 620 provided to the accessory main body 610. The accessory 600 is attachable and detachable to and from the shoe seat 15. The accessory 600 is installed to the shoe seat 15 and is fixed to the camera body 100a. In addition, the accessory 600 can be electrically connected to the shoe seat 15 through a cable or the like and may be held by a device other than the camera body 100a.

The accessory 600 is installed to the shoe seat 15 by inserting the second connector 620 into the opening 24 of the shoe seat 15 and slidably moving the connector in a predetermined direction (+Y direction) (see FIGS. 31 and 32).

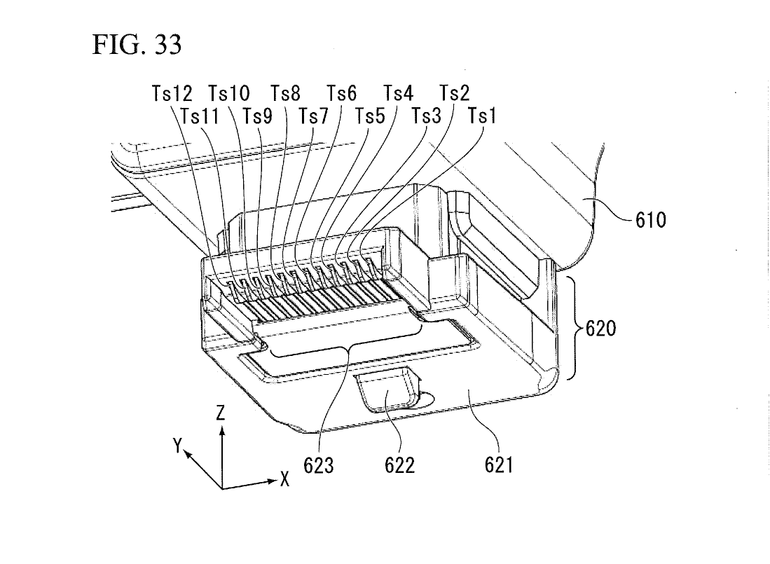

FIG. 33 is a diagram illustrating the second connector 620 according to the present embodiment.

As shown in FIG. 33, the second connector 620 includes a bottom 621 and a terminal section 623 provided on the bottom 621. The terminal section 623 includes a plurality of (twelve) terminals Ts1 to Ts12.

In addition, the structure of the second connector 620 is the same as the structure (see FIG. 5) of the connector 420 of the accessory 400. The structure of the terminal section 623 is the same as the structure (see FIG. 5) of the terminal section 423. Therefore, in the following description, the same components are assigned the same names and reference symbols, and the description thereof may be simplified or omitted.

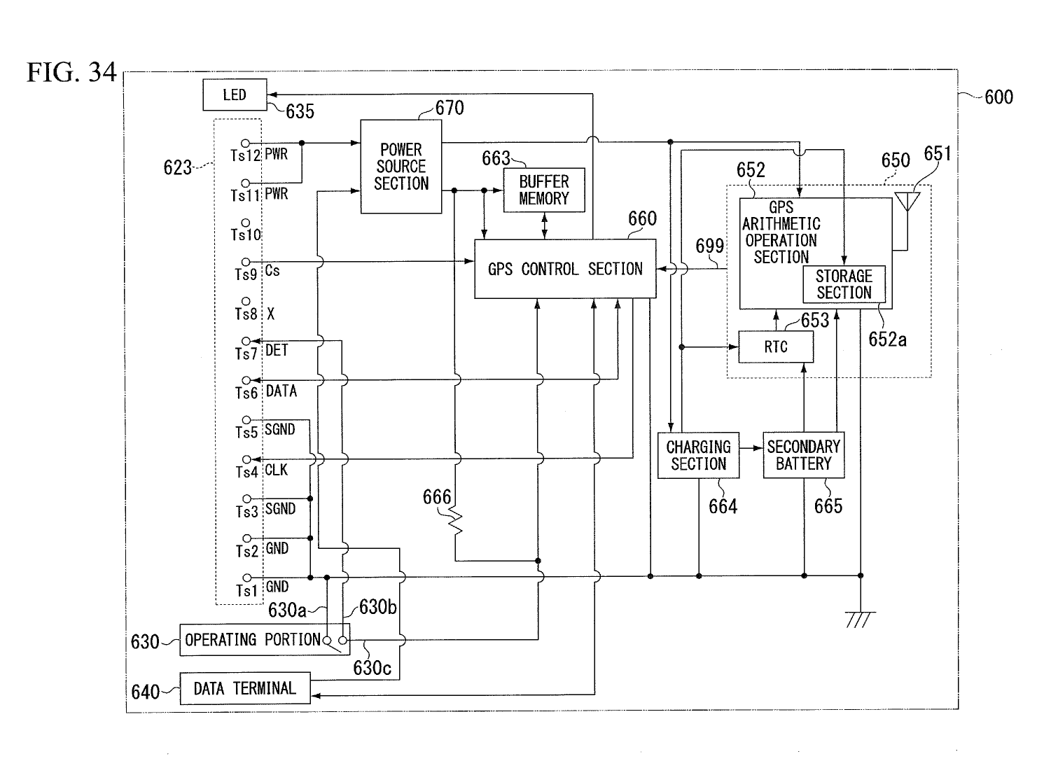

FIG. 34 is a block diagram illustrating a configuration of the accessory 600 according to the present embodiment. As shown in FIG. 34, the accessory 600 includes the terminal section 623 (second information communication section), an operating portion 630, an LED 635, a data terminal 640 (first information communication section), a GPS module section 650 (receiving section, positioning section, or first data generation section), a GPS control section 660 (second data generation section, control section, or accessory control section), a buffer memory 663 (second storage section), a charging section 664, a secondary battery 665, and a power source section 670. In addition, the GPS module section 650 includes an antenna 651, a GPS arithmetic operation section 652, and an RTC 653.

The accessory 600 according to the present embodiment is operated by power PWR supplied through the terminal section 25 of the camera 10a. In a state where the power PWR is not supplied from the camera 10a, the accessory 600 performs only an operation of the RTC 653 and retention of data stored in a storage section 652a (first storage section) of the GPS module section 650 through the secondary battery 665.

When the camera 10a detects that the accessory 600 is mounted (mounted state), the camera starts the supply of power to the accessory 600 through the terminal section 25. The detection of the mounting of the accessory 600 by the camera 10a is the same as the detection of the mounted state of the accessory 400, and thus the detailed description thereof will be omitted (see FIGS. 9A and 9B). When the accessory 600 is mounted to the camera 10a, the startup state detecting terminal Tp7 of the camera 10a is electrically connected to a terminal 630a through the startup state providing terminal Ts7 and a terminal 630b of the accessory 600. Since the terminal 630a is connected to the GND (reference potential), the potential of the startup state detecting terminal Tp7 of the camera 10a serves as a reference potential, and the camera 10a detects the mounted state of the accessory 600. The accessory 600 can be detached from the camera 10a by operating the operating portion 630.

The operating portion 630 is a lock release lever for releasing the lock of the accessory 600 fixed (locked) to the shoe seat 15. The operating portion 630 is a mechanical switch and includes the terminal 630a, the terminal 630b, and a terminal 630c. When the lock of the accessory 600 is released by the operating portion 630 and the accessory 600 is detached from the shoe seat 15, the terminal 630a and the terminal 630b are electrically disconnected from each other. The terminal 630a and the terminal 630b are electrically disconnected from each other, so that the potentials of the startup state detecting terminal Tp7 and the startup state providing terminal Ts7 become higher than the reference potential, and the camera 10a detects that the accessory 600 is detached therefrom.

In addition, the GPS control section 660 detects a state of the operating portion 630 (whether or not the terminal 630a and the terminal 630b are electrically connected to each other) by a change in the potential of the terminal 630c. For example, when the mechanical switch of the operating portion 630 is not closed (accessory 600 is not fixed to the shoe seat 15) due to the connection of the terminal 630c to a power source terminal group (Ts11 and Ts12) through a pull-up resistor 666, the potential of the terminal 630c is changed to an H level (higher than the reference potential). On the other hand, when the mechanical switch of the operating portion 630 is closed (the accessory 600 is fixed to the shoe seat 15), the terminal 630c is grounded, and thus the potential of the terminal 630c is changed to an L level (reference potential). The GPS control section 660 detects a state of the operating portion 630 by detecting the change in the potential of the terminal 630c.

Next, the GPS module section 650 will be described. The GPS arithmetic operation section 652 receives GPS information (navigation message) necessary for positioning or clocking from the positioning satellite (GPS satellite) through the antenna 651.

The GPS arithmetic operation section 652 extracts information indicating the GPS time (GPS time information) from the GPS information (navigation message) received from the positioning satellite. When the GPS time information can be extracted from the GPS information, the GPS arithmetic operation section 652 adjusts clocking information of the RTC 653 to the GPS time. When the GPS arithmetic operation section 652 cannot receive the GPS information, or can receive the GPS information but cannot extract the GPS time information, the clocking information of the RTC 653 is used instead of the GPS time information. In addition, the storage section 652a may be a flash memory.

In addition, the GPS arithmetic operation section 652 generates first GPS information (first data) from the GPS information, and outputs the first GPS information to the GPS control section 660. The first GPS information is, for example, NMEA data having a communication protocol of a GPS receiver or the like which is prescribed by the NMEA (National Marine Electronics Association). The GPS arithmetic operation section 652 stores the first GPS information in the storage section 652a.

In addition, the GPS arithmetic operation section 652 outputs information (whether or not the positioning is completed) indicating the positioning operation state of the GPS module section 650 to the GPS control section 660. The GPS control section 660 displays (turns on, or turns on and off) the positioning operation state of the GPS module section 650 by controlling an LED section 635.

The RTC (real-time clock) 653 generates (clocks) clocking information based on a clock signal generated by, for example, a crystal oscillator, and outputs the generated clocking information to the GPS arithmetic operation section 652. When the accessory 600 is not mounted to the camera 10a, the RTC 653 continues clocking using power supplied from the secondary battery 665.

The LED 635 displays the positioning operation state of the GPS module section 650 based on a control of the GPS control section 660. The LED 635 can emit, for example, multicolored light such as red and green. For example, when the accessory 600 is mounted to the camera 10a and the GPS information is acquired from three positioning satellites in the positioning by the GPS module section 650, the LED 635 turns on and off in red. When the GPS information is acquired from four or more positioning satellites in the positioning by the GPS module section 650, the LED turns on in green.

The data terminal 640 is, for example, a USB (Universal Serial Bus) terminal. The accessory 600 is connected to an external device such as a personal computer (PC) by the data terminal 640 through a connection cable, thereby allowing commands or data to be acquired from the personal computer. In addition, the accessory 600 transmits commands or data which is output by the GPS control section 660 through the data terminal 640 to the personal computer. In addition, the data terminal 640 supplies power supplied from the outside through the connection cable to the power source section 670.

The GPS control section 660 communicates with the camera control section 170 through the terminal section 623 and the terminal section 25 of the camera 10a. In addition, the GPS control section 660 performs a control of each component of the accessory 600.

The GPS control section 660 extracts data which is output to the camera 10a, from the first GPS information which is output by the GPS module section 650 (GPS arithmetic operation section 652). The data which is output to the camera 10a is, for example, data necessary for generating an Exif file and is such as information indicating the latitude, information indicating the longitude, information indicating the altitude, information indicating Universal Time Coordinated (UTC), information indicating the number of satellites used for positioning, information indicating reliability of positioning, information indicating a direction of travel, ground information, and the like.

In addition, the GPS control section 660 generates, from the first GPS information, a flag indicating whether or not the first GPS information is valid or invalid (hereinafter, referred to as the valid/invalid flag of the first GPS information), and a flag indicating whether or not the state is a 2D positioning state (state where the longitude and the latitude can be measured) or a 3D positioning state (state where the longitude, the latitude and the altitude can be measured) (hereinafter, referred to as the 2D positioning/3D positioning flag).

Further, the GPS control section 660 determines whether or not each piece of information of the data which is output to the camera 10a (information indicating the latitude, information indicating the longitude, information indicating the altitude, information indicating Universal Time Coordinated, information indicating the number of satellites used for positioning, information indicating reliability of positioning, information indicating a direction of travel, and ground information) can be acquired from the first GPS information as described later.

The GPS control section 660 generates a flag indicating whether or not each piece of the information can be acquired (hereinafter, referred to as the first GPS acquisition information flag), based on the determination result. The valid/invalid flag of the first GPS information, the 2D positioning/3D positioning flag, and the first GPS acquisition information flag will be described in detail later. The GPS control section 660 adds the valid/invalid flag of the first GPS information, the 2D positioning/3D positioning flag and the first GPS acquisition information flag to the data which is output to the camera 10a and converts the first GPS information into second GPS information (second data) which is output to the camera 10a. In addition, the first GPS information (NMEA data) is, for example, ASCII data. On the other hand, the second GPS information is, for example, data of 1-byte unit.

In addition, the GPS control section 660 may generate the second GPS information by associating the second GPS information with a generated information acquisition possibility flag.

The second GPS information converted by the GPS control section 660 is stored in the buffer memory 663.

The charging section 664 is connected to a second output terminal of the power source section 670. The charging section 664 charges the secondary battery 665 using power supplied from the camera 10a through the terminal Ts12 and the terminal Ts11.

The power source section 670 is configured such that a first input terminal thereof is connected to the terminals Ts11 and Ts12 of the terminal section 623 and a second input terminal thereof is connected to the data terminal 640. The power source section 670 is configured such that a first output terminal thereof is connected to the GPS arithmetic operation section 652 and the charging section 664 and a second output terminal thereof is connected to the GPS control section 660, the buffer memory 663 and one end of the pull-up resistor 666.

The power source section 670 converts power supplied from the camera 10a through the terminal section 623 into a voltage value used inside the accessory 600 and supplies the power converted into the voltage value from the first and second output terminals to each section.

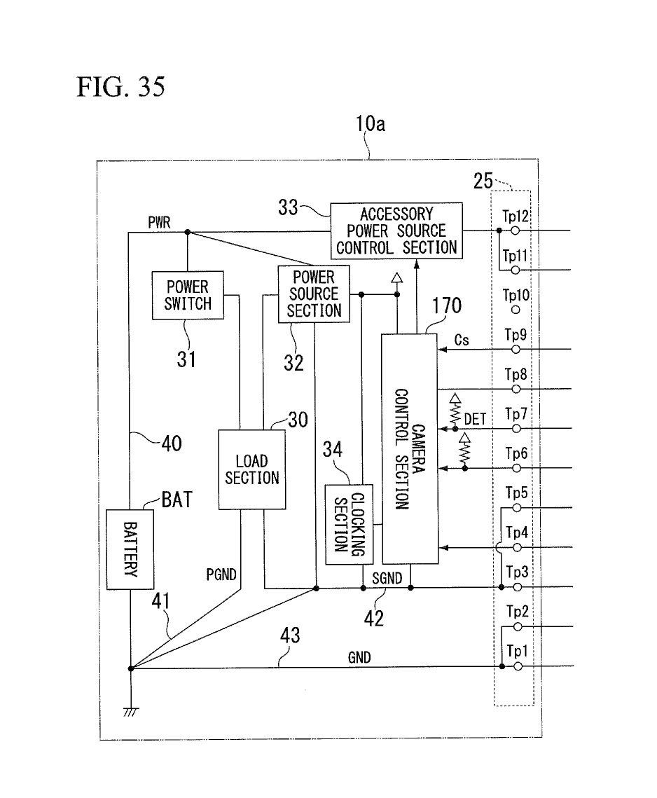

Next, the camera 10a will be described with reference to FIG. 35. FIG. 35 is a configuration diagram illustrating a connection relationship between the camera 10a and the accessory 600 according to the present embodiment.

As shown in FIG. 35, the camera 10a includes a load section 30, a power switch 31, a power source section 32, an accessory power source control section 33, and a clocking section 34. The difference from the camera 10 is the clocking section 34.

The clocking section 34 generates (clocks) clocking information based on a clock signal generated by a crystal oscillator or the like and outputs the generated clocking information to the camera control section 170. The clocking section 34 is connected to the power source and the GND (reference potential) similarly to the camera control section 170.

Next, an outline of the GPS will be described.

The GPS is used for position measurement, surveying and the like. Presently, twenty-four or more positioning satellites revolve around six orbits over the earth. Each of the positioning satellites transmits a navigation message (GPS information). The navigation message is transmitted in units of a frame. 30 seconds are required for transmission of 1 frame. One frame is composed of five sets of sub-frames, and sub-frames 1 to 5 are transmitted in order. In addition, sub-frames 1 to 3 include information specific to each positioning satellite and are composed of the same content every time. Sub-frames 4 and 5 include information with content common to all the positioning satellites and are composed of pages 1 to 25 for each sub-frame. For this reason, 25 frames are required for transmission of all pieces of information of sub-frames 4 and 5. For this reason, it takes 12 minutes and 30 seconds for the GPS receiver to obtain all pieces of information of the navigation message.

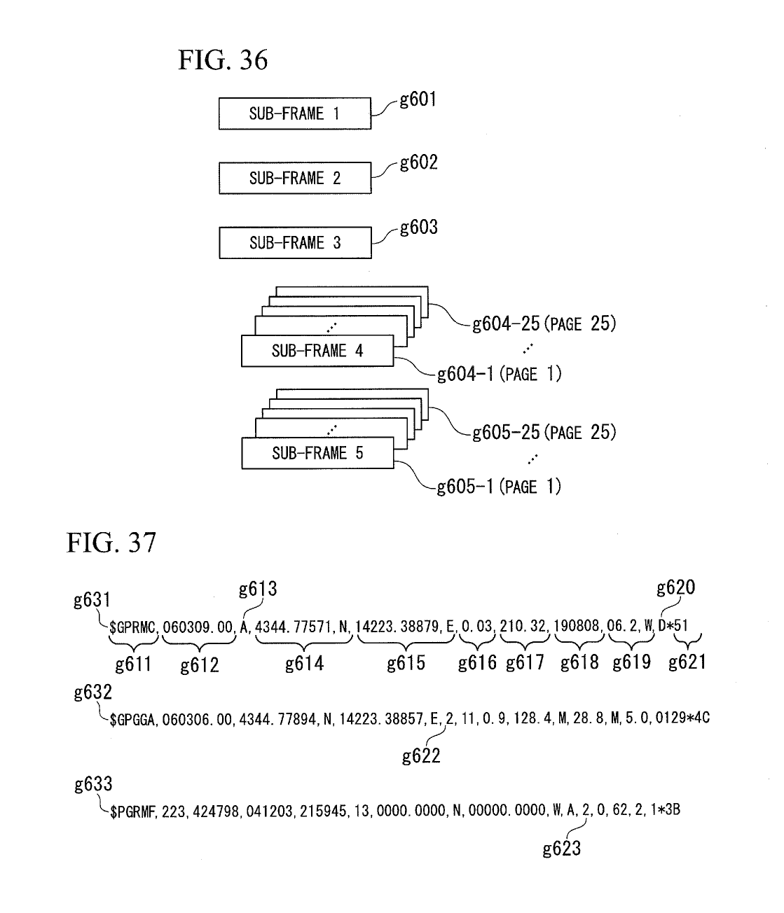

The navigation message as shown in FIG. 36 is received in five sets of sub-frames. FIG. 36 is a diagram illustrating a configuration of the navigation message.

Sub-frame 1 (g601) is composed of a state of each positioning satellite (whether or not to operate normally), a clock correction coefficient which is a coefficient for correcting a clock error of the positioning satellite which is transmitted by the positioning satellite, and the like.

Sub-frame 2 (g602) is composed of orbit information (ephemeris data) 1/2 of each positioning satellite.

Sub-frame 3 (g603) is composed of orbit information (ephemeris data) 2/2 of each positioning satellite.

Sub-frame 4 (g604-1 to g604-25) is composed of an ionospheric delay correction coefficient which is a coefficient for correcting the amount by which a signal received by the GPS receiver is delayed by the ionosphere, UTC relation information which is information indicating a relationship between the GPS time and the UTC (Universal Time, Coordinated), orbit information (almanac data) 1/2 of all the positioning satellites, and the like.

Sub-frame 5 (g605-1 to g605-25) is composed of orbit information (almanac data) 2/2 of all the positioning satellites. In addition, information indicating the GPS time is included in the forefront of each sub-frame. In addition, the GPS time is the time which is managed in the positioning satellite side in units of one week and is information expressed in the elapsed time from 0 o'clock every Sunday.

In addition, the ephemeris data transmitted by the sub-frames 2 and 3 is composed of data of six elements of the orbit (longitude of ascending node, orbit inclination, argument of perigee, semi-major axis, eccentricity, and true anomaly) necessary for calculating the position of the positioning satellite, each correction value, time of epoch toe (ephemeris reference time) of the orbit, and the like. The ephemeris data is updated every two hours. In addition, the valid period of the ephemeris data is two hours±two hours.

The almanac data is orbit information of each positioning satellite. In addition, the almanac data is updated at a frequency of about 1 degree per day. In addition, the valid period of the almanac data is ±3 days from time of epoch.

The GPS module section 650 stores the received data in the storage section 652a. The start of positioning from a state where the stored almanac data and ephemeris data are all valid is referred to as a hot start. In addition, the start of positioning from a state where the ephemeris data is invalid and only the almanac data is valid is referred to as a warm start. The start of positioning from a state where the almanac data and the ephemeris data are all invalid is referred to as a cold start.

In the case of the hot start, in the GPS module section 650, the time until initial position information is output after power-on is about a few seconds because the positioning can be performed using the stored ephemeris data.

On the other hand, in the case of the warm start, it is necessary for the GPS module section 650 to reacquire the ephemeris data. For this reason, it takes 30 seconds or more to reacquire the ephemeris data, and it takes extra time to inspect the acquired ephemeris data. For this reason, in the case of the warm start, the time until the initial position information is output after power-on is about 30 to 60 seconds.

Further, in the case of the cold start, it is necessary for the GPS module section 650 to acquire all the navigation messages. For this reason, it takes a few minutes to 12 minutes and 30 seconds to capture a positioning signal and acquire the navigation messages. Therefore, the time until the initial position information is output after power-on is about a few minutes to 12 minutes and 30 seconds.

FIG. 37 is an example of the NMEA data (first GPS information).

As shown in FIG. 37, the NMEA data is ASCII data in which data extracted from the navigation message (GPS information) is classified into specified content. The data is transmitted for each sentence and begins with “$” character and a character string indicating a type of the sentence, and the sentence ends with line feed codes “CR and LF”. In FIG. 37, an example of an RMC sentence, a GGA sentence, and an RMF sentence is shown. Sentence g631 is an RMC (Recommended Minimum Navigation Information) sentence. Sentence g631 includes sentence name g611, positioning time g612, status g613 indicating validity of data, latitude g614, longitude g615, ground speed g616, traveling direction g617, positioning month and year g618, magnetic deviation g619, positioning mode g620, and check sum g621. In addition, the positioning mode is a type of positioning such as single point positioning which is positioning by one GPS module section, or differential positioning (DGPS (Differential GPS)) which is positioning by two GPS module sections.

Sentence g632 is a GGA (Global Positioning System Fix Data. Time, Position and fix related data for a GPS receiver) sentence. Sentence g633 is an RMF (Position Fix Sentence) sentence.

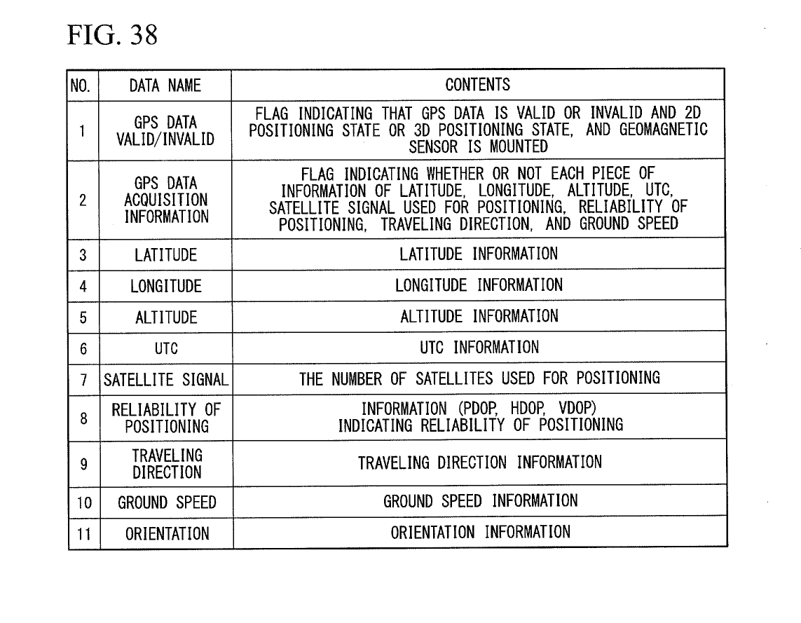

FIG. 38 is a diagram illustrating a configuration of data included in the second GPS information according to the present embodiment. As shown in FIG. 38, the second GPS information includes eleven types of data in order from numbers 1 to 11. The order from numbers 1 to 11 is configured to be in accord with the order of data, for example, when writing is performed on Exif data.

“GPS data valid/invalid” data includes a valid/invalid flag of the first GPS information, a 2D positioning/3D positioning flag, and a presence/absence flag of a geomagnetic sensor. In addition, “the first GPS information is valid” indicates a state (positioning state) where position information is obtained by the GPS module section 650. On the other hand, “the first GPS information is invalid” indicates a state (non-positioning state) where position information is not obtained by the GPS module section 650. In addition, the 2D positioning state is a state where GPS information is received from three positioning satellites and position information is obtained. The 3D positioning state is a state where GPS information is received from four positioning satellites and position information is obtained. In addition, the presence/absence flag of a geomagnetic sensor indicates whether or not the geomagnetic sensor is mounted to the accessory 600 as a flag. The GPS control section 660 extracts valid or invalid information of the first GPS information and information of 2D positioning or 3D positioning from the first GPS information. The GPS control section 660 generates “GPS data valid/invalid” data which is 1-byte data, based on each piece of the extracted information. The valid/invalid flag of the first GPS information indicates whether or not data (information indicating the latitude, information indicating the longitude, information indicating the altitude, information indicating Universal Time Coordinated, information indicating the number of satellites used for positioning, information indicating reliability of positioning, information indicating a direction of travel, and ground information) necessary for generating image file data (for example, Exif file data) is valid. That is, in the case of the flag indicating that the GPS information is invalid, it is indicated that data necessary for generating the image file data included in the first GPS information is invalid. When the data is invalid, the data is not stored in the image file data.

“GPS data acquisition information” data includes a first GPS acquisition information flag. The first GPS acquisition information flag is a plurality of flags indicating whether or not each piece of information of the latitude, the longitude, the altitude, the UTC, the positioning satellite signal used for positioning, reliability of positioning, the direction of travel, and the ground speed, which are included in the first GPS information can be acquired. The GPS control section 660 extracts each piece of the information from the first GPS information. It is determined whether or not each piece of the information can be acquired based on each piece of the extracted information. The GPS control section 660 generates the “GPS data acquisition information” data which is 1-byte data, based on the determination result.

“Latitude” data, “longitude” data and “altitude” data are information indicating the latitude, the longitude and the altitude. The GPS control section 660 extracts the information of the latitude, the longitude, and the altitude from the first GPS information, and sets the extracted information to the “latitude” data, the “longitude” data and the “altitude” data.

“UTC” data and “satellite signal” data are UTC information and information indicating the number of positioning satellites used for positioning. The GPS control section 660 extracts the information of the UTC and the satellite signal from the first GPS information, and sets the extracted information to the “UTC” data and the “satellite signal” data.

“Reliability of positioning” data is information indicating reliability of positioning and is a value such as PDOP (Position Dilution of Precision), HDOP (Horizontal Dilution of Precision), and VDOP (Vertical Dilution of Precision). The PDOP is a value obtained by indexing the geometrical arrangement of the positioning satellite. It is indicated that the position precision is high when the PDOP value is small and the position precision is low when it is large. Values obtained by indexing only a horizontal component and a vertical component of the PDOP are HDOP and VDOP, respectively. The GPS control section 660 extracts information of the PDOP, the HDOP, and the VDOP from the first GPS information and sets the extracted information to the “reliability of positioning” data.

“Direction of travel” data and “ground speed” data are traveling direction information and ground speed information of the positioning satellite. The GPS control section 660 extracts the information of the direction of travel and the ground speed from the first GPS information and sets the extracted information to the “direction of travel” data and the “ground speed” data.

“Orientation” data is information indicating the orientation acquired from a geomagnetic sensor which is not shown. The GPS control section 660 determines whether or not the geomagnetic sensor is mounted to the accessory 600. When it is determined that the geomagnetic sensor is mounted, the GPS control section 660 extracts the information indicating the orientation from data which is output from the geomagnetic sensor and sets the extracted information to the “orientation” data.

As stated above, the GPS control section 660 generates the second GPS information from the first GPS information obtained from the GPS module section 650. The GPS control section 660 transmits the second GPS information to the camera 10a through the communication signal terminal Ts6.

Next, a method of setting a flag of the “GPS data valid/invalid” data will be described.

First, the valid/invalid flag of the first GPS information will be described. The GPS control section 660 extracts a GGA sentence from the first GPS information which is output by the GPS module section 650, and extracts GPS quality indicator information g622 (see FIG. 37; hereinafter, referred to as information g622) from the extracted GGA sentence. When the value of information g622 is 0, this indicates non-receipt. When the value of information g622 is 0, the GPS control section 660 determines that the first GPS information is invalid, and sets 0 indicating invalidity on the flag indicating that the first GPS information is valid or invalid. When the value of information g622 is 1, this indicates a single receiving mode. When the value of information g622 is 2, this indicates a differential GPS positioning mode. When the value of information g622 is 1 or 2, the GPS control section 660 determines that the GPS data is valid and sets 1 indicating validity on the flag indicating that the GPS data is valid or invalid.

The 2D positioning/3D positioning flag will be described below. The GPS control section 660 extracts an RMF sentence from the first GPS information which is output by the GPS module section 650 and extracts fix type information g623 (see FIG. 37; hereinafter, referred to as information g623) from the extracted RMF sentence. When the value of information g623 is 1, this indicates that the GPS information from three satellites can be used. For this reason, the GPS control section 660 determines that the state is a 2D positioning state and sets 0 indicating the 2D positioning state on the flag indicating the 2D positioning state or the 3D positioning state. When the value of information g623 is 2, this indicates that the GPS information from four or more satellites can be used. For this reason, the GPS control section 660 determines that the state is a 3D positioning state and sets 1 indicating the 3D positioning state on the flag indicating the 2D positioning state or the 3D positioning state.

In this manner, the flag of the “GPS data valid/invalid” data is a flag which is set based on the value of information of the sentence extracted from the first GPS information.

Next, a method of setting a flag of the “GPS data acquisition information” data will be described.

The GPS control section 660 extracts data on the UTC from the first GPS information which is output by the GPS module section 650. The data on the UTC is, for example, ZDA (Time & Date—UTC, Day, Month, Year and Local Time Zone) data, GGA (Global Positioning System Fix Data; Time, Position and fix related data for a GPS receiver) sentence of the first GPS information, and the like. The GPS control section 660 extracts whether or not the status of the extracted data is valid and further extracts UTC data. The GPS control section 660 determines whether or not the extracted UTC data is a numerical value in a range which is set in advance. In addition, the UTC data is composed of A.D., month, and time (hour, minute, and second). When it is determined that data indicating “month” of the extracted UTC data is a value indicating January to December, the GPS control section 660 determines the data to be valid. When it is determined that data indicating “year” of the extracted UTC data is, for example, a value indicating 2000 to 3000, the GPS control section 660 determines the data to be valid. When it is determined that data indicating “date” of the extracted UTC data is a value indicating 1 to 31, the GPS control section 660 determines the data to be valid. When it is determined that data indicating “time” of the extracted UTC data is a value indicating 0 o'clock to 23 o'clock, the GPS control section 660 determines the data to be valid. When it is determined that data indicating “minute” of the extracted UTC data is a value indicating 0 minutes to 59 minutes, the GPS control section 660 determines the data to be valid. When it is determined that data indicating “second” of the extracted UTC data is a value indicating 0 seconds to 59 seconds, the GPS control section 660 determines the data to be valid. Based on such determinations, when all pieces of data are valid, and the status of the extracted data is valid, the GPS control section 660 determines that the UTC data can be acquired and sets the flag for the UTC data acquisition to 1.

When any data of A.D., month, and time (hour, minute, and second) is a value outside of the range which is set in advance, or the status of the extracted data is invalid, the GPS control section 660 determines that the UTC data cannot be acquired and sets the flag for the UTC data acquisition to 0.

In this manner, the GPS control section 660 extracts one or more sentences from the first GPS information, and determines whether or not the GPS data can be acquired based on information of the extracted sentence. The flag of the “GPS data acquisition information” data is a flag which is set based on the determination result.

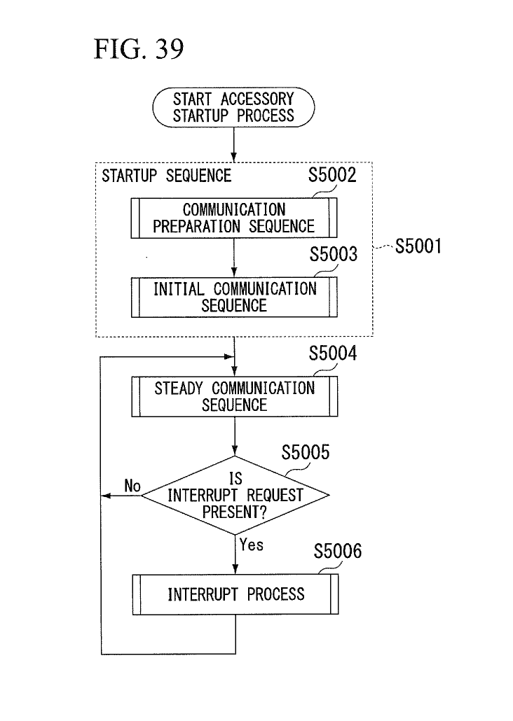

Next, a procedure of processes in the camera system 1a will be described. FIG. 39 is a flow diagram illustrating a procedure of processes in the camera system 1a according to the present embodiment.

(Step S5001) The camera system 1a performs a series of processes (startup sequence) for starting up the accessory 600.

(Step S5002) In the startup sequence, the camera system 1a performs a series of processes (communication preparation sequence) prepared so as to be capable of communicating between the camera 10a and the accessory 600.

(Step S5003) After the communication preparation sequence is terminated in the startup sequence, the camera system 1a performs a series of processes (initial communication sequence) for mutually communicating information necessary for image capture between the camera control section 170 and the GPS control section 660.

(Step S5004) After the initial communication sequence is terminated, the camera system 1a performs a series of processes (second steady communication sequence) for mutually communicating between the camera control section 170 and the GPS control section 660, so as to be capable of updating information changed by a setting change or the like. The second steady communication sequence is performed, for example, in the period (2T) two times the period T of the first steady communication performed by the accessory 400 and the camera 10. The period of the second steady communication sequence is, for example, 400 msec. The second steady communication sequence is performed only when the accessory 600 has a GPS function.

(Step S5005) The camera control section 170 performs a determination process of determining whether or not an interrupt request is present. When it is determined that the interrupt request is not present (step S5005; No), the process returns to step S5004, When it is determined that the interrupt request is present (step S5005; Yes), the process proceeds to step S5006.

(Step S5006) The camera system 1a stops the second steady communication sequence and performs an interrupt process. The interrupt process is, for example, a series of processes (image capturing sequence) included in an imaging process. After the interrupt process is terminated, the camera system 1a performs the process of the steady communication sequence once again. That is, the camera system 1a does not perform the process of the steady communication sequence in the image capturing sequence. Thereafter, while the accessory 600 starts up, the processes of steps S5004 to S5006 are repeated.

The communication preparation sequence performed in step S5002 (FIG. 39) is performed similarly to the procedure of the accessory 400 described in FIG. 11.

In addition, in the state (non-mounted state) where the accessory 600 is not connected to the shoe seat 15 of the camera 10a, the storage section 652a and the RTC 653 within the GPS module section 650 are supplied with power from the secondary battery 665. For this reason, clocking information of the RTC 653 continues to be generated. In addition, when positioning has been performed in the past, the GPS module section 650 has held, in the storage section 652a, information, which is set in advance, necessary for the positioning start, within the first GPS information (navigation message) acquired in the past.

Hereinafter, a description will be made of the state (mounted state) where the accessory 600 is connected to the shoe seat 15 of the camera 10a.

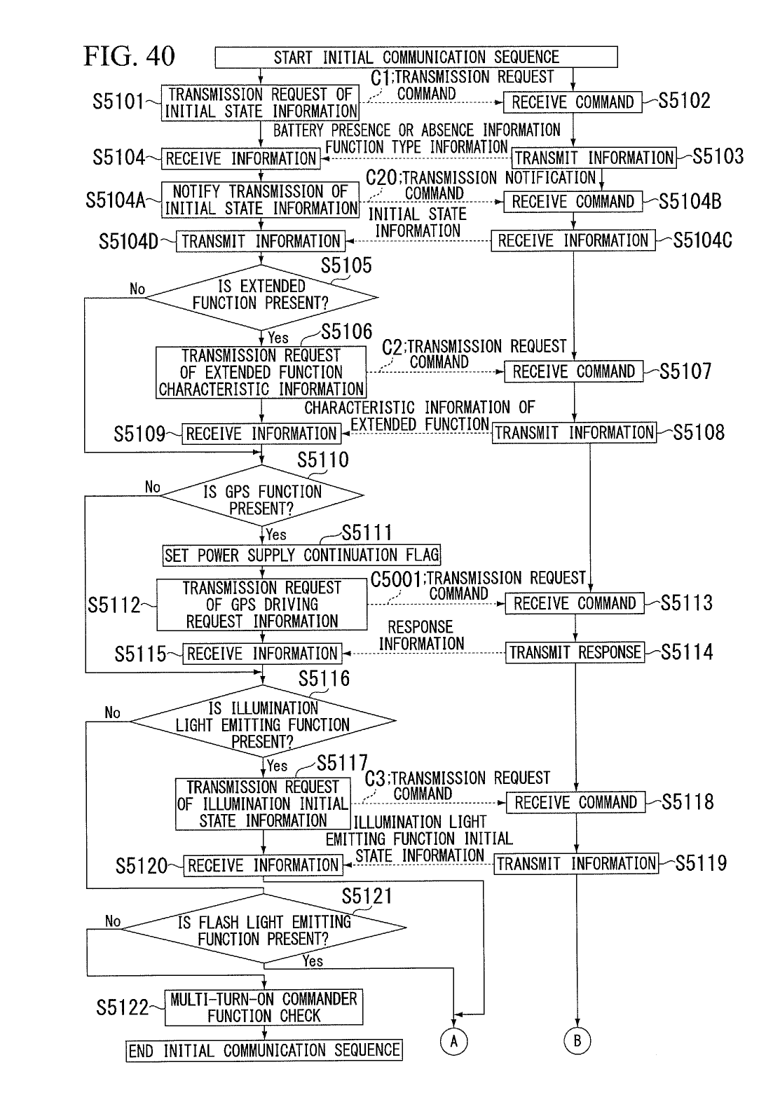

Next, reference will be made to FIG. 40 to describe a procedure of processes in the initial communication sequence performed in step S5003 (FIG. 39). FIG. 40 is a diagram illustrating a procedure of processes in the initial communication sequence in the accessory 600 according to the present embodiment. The sequence of FIG. 40 is analogous to the initial communication sequence in the case where the illumination device (flash device) 400 used as an accessory is mounted to the camera body 100 in FIG. 12 mentioned above, but the two sequences are different from each other in that operations of step S5110 to step S5115 are added as operations on the camera control section 170 side and that processes of step S5113 and step S5114 are added as operations on the GPS control section 660 side of the accessory 600 (GPS device).

(Step S5101) When the initial communication sequence is started, the camera control section 170 transmits a transmission request command C1 (second function query command) for requesting transmission of the accessory initial state information including the battery presence or absence information and the function type information to the GPS control section 660 and prepares for receiving the accessory initial state information.

(Step S5102) The GPS control section 660 receives the transmission request command C1 from the camera control section 170.

(Step S5103) The GPS control section 660 transmits the battery presence or absence information and the function type information to the camera control section 170 in accordance with the transmission request command C1. In this case, since the accessory 600 has an extended function, the GPS control section 660 transmits the function type information indicating that the accessory has an extended function to the camera control section 170.

(Step S5104) The camera control section 170 receives the battery presence or absence information and the function type information from the GPS control section 660.

(Step S5104A) The camera control section 170 transmits a transmission notification command C20 for transmission of the camera initial state information to the GPS control section 660 and prepares for transmitting the camera initial state information.

(Step S5104B) The GPS control section 660 receives the transmission request command C20.

(Step S5104C) The GPS control section 660 transmits the initial state information to the camera control section 170 in accordance with the transmission request command C20.

(Step S5104D) The camera control section 170 receives the initial state information.

(Step S5105) The camera control section 170 determines whether or not the accessory 600 has an extended function, based on the function type information received in step S5104. When it is determined that the accessory 600 has an extended function (step S5105; Yes), the process proceeds to step S5106. When it is determined that the accessory 600 does not have an extended function (step S5105; No), the process proceeds to step S5110.

(Step S5106) The camera control section 170 transmits the transmission request command C2 for requesting transmission of “characteristic information of the extended function” to the GPS control section 660. In addition, the term “characteristic information of the extended function” herein is special control information and the like in the accessory 600 having an extended function. In the accessory 600, “supply (power supply) continuation information” is included. The “supply (power supply) continuation information” is information for previously requesting maintenance of the supply of power (power supply) from the camera 10a to the accessory 600, from the accessory side to the camera 10a, even when a power OFF operation of turning off the power switch 31 by a user is performed in the camera 10a side (power OFF state), or the camera 10a transitions to a sleep state (low power consumption state that is transitioned to when a user's operation is not performed for a predetermined time). Both the power OFF state and the sleep state mentioned above are indicative of states where the camera 10a is not able to start up and execute various types of camera operations (for example, operations capable of fulfilling functions of the camera, such as an image capture operation). In other words, the power OFF state and the sleep state are states different from the startup state in which the camera starts up and executes camera operations.

In addition, the accessory 600 in the present embodiment is configured to transmit the “supply continuation information” to the camera 10a, but the accessory 400 described in the above-mentioned embodiment is configured not to transmit the “supply continuation information” to the camera 10a (see the sequence of FIG. 12).

(Step S5107) The GPS control section 660 receives the transmission request command C2 (first function query command) from the camera control section 170.

(Step S5108) The GPS control section 660 transmits the characteristic information of the extended function to the camera control section 170 in accordance with the transmission request command C2.

(Step S5109) The camera control section 170 receives the characteristic information of the extended function from the GPS control section 660.

(Step S5110) After reception of the characteristic information of the extended function is terminated, the camera control section 170 determines whether or not the accessory 600 has a GPS function, based on the function type information included in the initial state information received in step S5104. When it is determined that the accessory 600 has a GPS function (step S5110; Yes), the process proceeds to step S5111. When it is determined that the accessory 600 does not have a GPS function (step S5110; No), the process proceeds to step S5116.

(Step S5111) The camera control section 170 extracts the supply continuation information from the characteristic information of the extended function. The camera control section 170 sets a flag indicating that the accessory 600 has a supply continuation function (hereinafter, referred to as the power supply continuation flag) on the nonvolatile memory 160, based on the extracted supply continuation information. The power supply continuation flag is set, whereby the camera control section 170 continues the supply of power to the accessory 600 when the camera 10a transitions to the power OFF state or the sleep state.

In other words, when the power supply continuation flag is not set, the camera control section 170 does not continue the supply of power to the accessory in the power OFF state or the sleep state of the camera. or this reason, the camera control section 170 does not continue the supply of power to the accessory (illumination device) 400 of the above-mentioned embodiment in the power OFF state or the sleep state.

(Step S5112) After the flag is set, the camera control section 170 transmits a transmission request command C5001 for requesting transmission of GPS driving request information to the GPS control section 660.

(Step S5113) The GPS control section 660 receives the transmission request command C5001.

(Step S5114) The GPS control section 660 transmits response information, indicating that the transmission request command C5001 is received, to the camera control section 170. When the transmission request command C5001 is received, the GPS control section 660 outputs instructions to start positioning to the GPS module section 650. The GPS module section 650 starts to receive the GPS information (navigation message) from the positioning satellite, in accordance with the instructions to start positioning from the GPS control section 660. The GPS module section 650 starts a process of performing conversion from the received GPS information to the first GPS information (NMEA data).

(Step S5115) The camera control section 170 receives the response information from the GPS control section 660.

(Step S5116) The camera control section 170 determines whether or not the accessory 600 has an illumination light emitting function, based on the function type information included in the initial state information received in step S5104. When it is determined that the accessory has an illumination light emitting function (step S5116; Yes), processes of steps S5117 to S5120 are performed similarly to those of steps S211 to S214 (see FIG. 12). When it is determined that the accessory does not have an illumination light emitting function (step S5116; No), the process proceeds to step S5121.

(Step S5121) The camera control section 170 determines whether or not the accessory 600 has a flash light emitting function, based on the function type information received in step S5104.

(Step S5122) When it is determined that the accessory 600 does not have a flash light emitting function (step S5121; No), the camera control section 170 determines whether or not the accessory 600 has a function which does not correspond to both the illumination light emitting function and the flash light emitting function, for example, a multi-turn-on commander function or the like, based on the function type information received in step S5104 (step S5122). When it is determined that the accessory has a multi-turn-on commander function or the like, the process proceeds to step S217 (FIG. 12). When it is determined that the accessory does not have a multi-turn-on commander function, the initial communication sequence process is terminated.

Hereinafter, processes are performed similarly to those of steps S217 to S240 shown in FIG. 13.

As described in FIG. 40 mentioned above, in the initial communication after the accessory 600 is mounted to the camera 10a, even when the camera transitions to the power OFF state or the sleep state, the accessory 600 outputs a request (supply continuation information) for continuation of the supply of power from the camera, to the camera 10a, and the camera 10a side operates so as to respond to the supply power continuation request. For this reason, even when measurement intervals are empty to some extent, the camera system 1a is configured to be capable of executing the continuous GPS measurement. Therefore, even when the camera power is next turned on and is in a startup state, the position measurement can be completed relatively early.

In addition, when the “supply continuation information” from the mounted accessory side is present, the camera 10a continues the supply of power to the accessory even in the case where the camera transitions to the power OFF state or the sleep state. However, when the request (supply continuation information) is not received from the mounted accessory, the camera does not continue the supply of power to the accessory in the power OFF state or the sleep state. For this reason, since the accessory having no need for the power supply continuation dispenses with the supply of power, it is possible to prevent unnecessary power consumption from occurring.

In addition, in the present embodiment, when the accessory transmits the “supply continuation information” to the camera and the camera receives the information, the supply of power to the accessory is continued. However, when the accessory side transmits, to the camera, information for requesting “prohibition” of power supply continuation in the above-mentioned power OFF state or the above-mentioned sleep state, and the camera side receives the information, the supply of power to the accessory may be prohibited. For example, the “information for requesting prohibition of power supply continuation” may be caused to be transmitted from the accessory 400 of the above-mentioned embodiment at the time of the initial communication. In this case, any piece of information on power supply continuation may not be issued from the accessory 600 demanding for power supply continuation.

In addition, in the present embodiment, when the camera side transitions to the power OFF state and transitions to the sleep state, it is determined whether or not the supply of power is continued and power supply continuation/power supply prohibition are controlled. However, in only the case of the transition to any one of them, the power supply continuation/power supply prohibition may be controlled (for example, when the supply continuation information is received from the accessory, the camera control section 170 performs the power supply continuation in only the case of the transition to the sleep state, and performs the power supply prohibition in the case of the transition to the power OFF state).

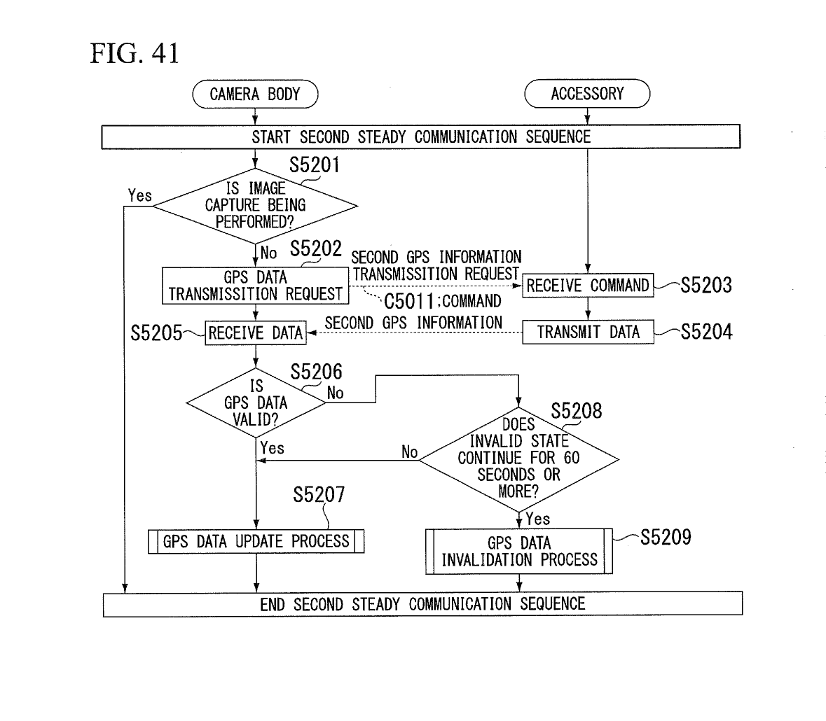

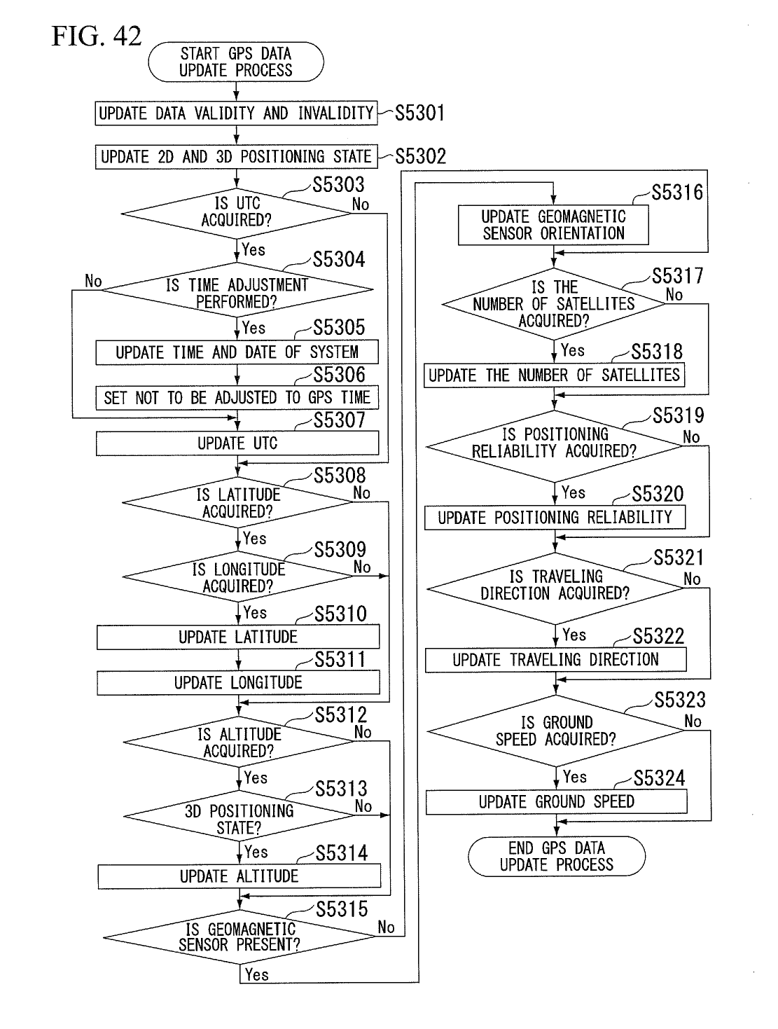

Next, reference will be made to FIGS. 41 and 42 to describe a procedure of processes in the second steady communication sequence performed in step S5004 (FIG. 39). FIG. 41 is a diagram illustrating a procedure of processes in the second steady communication sequence in the accessory 600. FIG. 42 is a diagram illustrating a procedure of processes in a GPS data update within the camera 10a.

The camera control section 170 determines whether or not the accessory 600 has a GPS function, based on the function type information included in the initial state information received in step S5104. When the accessory 600 has an extended function, the following second steady communication sequence is performed.

(Step S5201) The camera control section 170 determines whether or not imaging is being performed. When it is determined that imaging is being performed (step S5201; Yes), the second steady communication sequence is terminated. When it is determined that imaging is not being performed (step S5201; No), the process proceeds to step S5202.

(Step S5202) The camera control section 170 transmits a second GPS information transmission request command C5011 for requesting transmission of the second GPS information to the GPS control section 660.

(Step S5203) The GPS control section 660 receives the second GPS information transmission request command C5011 from the camera control section 170.

(Step S5204) The GPS control section 660 transmits the second GPS information to the camera control section 170 in accordance with the second GPS information transmission request command C5011.

(Step S5205) The camera control section 170 receives the second GPS information from the GPS control section 660.

(Step S5206) The camera control section 170 extracts the “GPS data valid/invalid” data from the second GPS information. The camera control section 170 extracts information indicating the second GPS information is valid or invalid from the “GPS data valid/invalid” data and determines whether or not the second GPS information is valid based on the extraction result. Next, the camera control section 170 writes the information indicating that the second GPS information is valid or invalid in the nonvolatile memory 160 or the buffer memory 165, based on the determination result, and updates the information.

When it is determined that the second GPS information is valid (step S5206; Yes), the process proceeds to step S5207. When it is determined that the second GPS information is not valid (step S5206; No), the process proceeds to step S5208.

(Step S5207) When it is determined that the second GPS information is valid (step S5206; Yes), the camera control section 170 performs a GPS data update process within the camera 10a. After the GPS data update process within the camera 10a is terminated, the second steady communication sequence is terminated.

(Step S5208) When it is determined that the second GPS information is not valid (step S5206; No), the camera control section 170 determines whether or not the invalid state of the second GPS information continues for 60 seconds or more. When it is determined that the invalid state of the second GPS information has continued for 60 seconds or more (step S5208; Yes), the process proceeds to step S5209. When the invalid state of the second GPS information does not continue for 60 seconds or more, that is, the second GPS information changes to validity within 60 seconds (step S5208; No), the process proceeds to step S5207.

(Step S5209) When it is determined that the invalid state of the second GPS information has continued for 60 seconds or more (step S5208; Yes), the camera control section 170 performs a process of invalidating GPS data within the camera 10a. After the process of invalidating the GPS data within the camera 10a is terminated, the second steady communication sequence is terminated.

Next, a process of invalidating the second GPS information performed in step S5209 (FIG. 41) will be described.

When it is determined that the invalid state of the second GPS information has continued for 60 seconds or more, the camera control section 170 does not write information based on the second GPS information with respect to an image file in which captured image data is stored. In addition, a display regarding position information displayed on a display portion 102 of the camera 10a is set to an invalid display. In addition, the invalid display is, for example, “- -” (hyphen).

Next, reference will be made to FIG. 42 to describe the update process of the GPS data within the camera 10a performed in step S5207 (FIG. 41). FIG. 42 is a diagram illustrating a procedure of update processes of the GPS data within the camera 10a in the second steady communication sequence according to the present embodiment.

(Step S5301) The camera control section 170 rewrites data valid or invalid state data stored in the nonvolatile memory 160 based on the “GPS data valid/invalid” data, and updates the data. For example, when the second GPS information is invalid, the camera control section 170 records “0” as the data valid or invalid state data. When the second GPS information is valid, the camera control section 170 records “1” as the data valid or invalid state data.

(Step S5302) The camera control section 170 extracts information indicating a 2D positioning state or a 3D positioning state from the “GPS data valid/invalid” data, and rewrites and updates 2D and 3D positioning state data stored in the nonvolatile memory 160 based on the extracted result. For example, when the information indicating a 2D positioning state or a 3D positioning state is information indicating a 2D positioning state, the camera control section 170 records “0” as the 2D and 3D positioning state data. When the information indicating a 2D positioning state or a 3D positioning state is information indicating a 3D positioning state, the camera control section 170 records “1” as the 2D and 3D positioning state data.

(Step S5303) The camera control section 170 extracts information indicating whether or not the UTC data can be acquired from the “GPS data acquisition information” data. When the UTC data can be acquired, the process proceeds to step S5304. When the UTC data cannot be acquired, the process proceeds to step S5308.

(Step S5304) The camera control section 170 determines whether or not the time generated in the clocking section 34 of the camera 10a is adjusted to the UTC time, based on information which is set by a user. In addition, the information which is set by a user is stored in the nonvolatile memory 160 or the buffer memory 165. When it is determined that the time generated in the clocking section 34 of the camera 10a is set to be adjusted to the UTC time (step S5304; Yes), the process proceeds to step S5305. When it is determined that the time of the camera 10a is not set to be adjusted to the UTC time (step S5304; No), the process proceeds to step S5307.

(Step S5305) The camera control section 170 extracts the “UTC” data from the second GPS information, and updates the time and date of clocking information generated in the clocking section 34 of the camera 10a to the time and date based on the extracted “UTC” data.

(Step S5306) The camera control section 170 rewrites setting in which the time generated in the clocking section 34 of the camera 10a is adjusted to the UTC time stored in the nonvolatile memory 160 or the buffer memory 165 to setting in which the time generated in the clocking section 34 of the camera 10a is not adjusted to the UTC time.

(Step S5307) After the process of step S5304 or S5306 is terminated, the camera control section 170 rewrites and updates the UTC data stored in the nonvolatile memory 160, based on the extracted “UTC” data.

(Step S5308) The camera control section 170 extracts information indicating whether or not the latitude data can be acquired from the “GPS data acquisition information” data, and determines whether or not the latitude data can be acquired based on the extracted information. When it is determined that the latitude data can be acquired (step S5308; Yes), the process proceeds to step S5309. When it is determined that the latitude data cannot be acquired (step S5308; No), the process proceeds to step S5312.

(Step S5309) The camera control section 170 extracts information indicating whether or not the longitude data can be acquired from the “GPS data acquisition information” data, and determines whether or not the longitude data can be acquired based on the extracted information. When it is determined that the longitude data can be acquired (step S5309; Yes), the process proceeds to step S5310. When it is determines that the longitude data cannot be acquired (step S5309; No), the process proceeds to step S5312.

(Step S5310) The camera control section 170 extracts the “latitude” data from the second GPS information, and rewrites and updates the latitude data stored in the nonvolatile memory 160 or the buffer memory 165 based on the extracted “latitude” data.

(Step S5311) The camera control section 170 extracts the “longitude” data from the second GPS information, and rewrites and updates the longitude data stored in the nonvolatile memory 160 or the buffer memory 165 based on the extracted “longitude” data.

(Step S5312) The camera control section 170 extracts information indicating whether or not the altitude data can be acquired from the “GPS data acquisition information” data, and determines whether or not the altitude data can be acquired based on the extracted information. When it is determined that the altitude data can be acquired (step S5312; Yes), the process proceeds to step S5313. When it is determined that the altitude data cannot be acquired (step S5312; No), the process proceeds to step S5315.

(Step S5313) The camera control section 170 reads out information indicating the 2D and 3D positioning state stored in the nonvolatile memory 160, and determines whether or not the information indicating the read-out 2D and 3D positioning state is information indicating the 3D positioning state. When it is determined that the information is information indicating the 3D positioning state (step S5313; Yes), the process proceeds to step S5314. When it is determined that the information is not information indicating the 3D positioning state, that is, the information is information indicating the 2D positioning state (step S5313; No), the process proceeds to step S5315.

(Step S5314) The camera control section 170 extracts the “altitude” data from the second GPS information, and rewrites and updates the altitude data stored in the nonvolatile memory 160 or the buffer memory 165, based on the extracted “altitude” data.

(Step S5315) The camera control section 170 extracts information indicating whether or not a geomagnetic sensor is mounted from the “GPS data valid/invalid” data, and determines whether or not the geomagnetic sensor is mounted based on the extracted information. When it is determined that the geomagnetic sensor is mounted (step S5315; Yes), the process proceeds to step S5316. When it is determined that the geomagnetic sensor is not mounted (step S5315; No), the process proceeds to step S5317.

(Step S5316) When it is determined that the geomagnetic sensor is mounted, the camera control section 170 extracts “orientation” data from the second GPS information, and rewrites and updates the orientation data stored in the nonvolatile memory 160 or the buffer memory 165, based on the extracted “orientation” data.

(Step S5317) The camera control section 170 extracts information indicating whether or not the number of positioning satellites can be acquired from the “GPS data acquisition information” data, and determines whether or not the number of positioning satellites can be acquired based on the extracted information. When it is determined that the number of positioning satellites can be acquired (step S5317; Yes), the process proceeds to step S5318. When it is determined that the number of positioning satellites cannot be acquired (step S5317; No), the process proceeds to step S5319.

(Step S5318) When it is determined that the number of positioning satellites can be acquired, the camera control section 170 extracts “satellite signal” data from the second GPS information, and rewrites and updates data of the number of positioning satellites used for positioning which is stored in the nonvolatile memory 160 or the buffer memory 165, based on the extracted “satellite signal” data.

(Step S5319) The camera control section 170 extracts information indicating whether or not positioning reliability data can be acquired from the “GPS data acquisition information” data, and determines whether or not the positioning reliability data can be acquired based on the extracted information. When it is determined that the positioning reliability data can be acquired (step S5319; Yes), the proceeds to step S5320. When it is determined that the positioning reliability data cannot be acquired (step S5319; No), the process proceeds to step S5321.

(Step S5320) When it is determined that the positioning reliability data can be acquired, the camera control section 170 extracts the “positioning reliability” data from the second GPS information, and rewrites and updates the positioning reliability data used for positioning which is stored in the nonvolatile memory 160 or the buffer memory 165, based on the extracted “positioning reliability” data.

(Step S5321) The camera control section 170 extracts information indicating whether or not traveling direction data can be acquired from the “GPS data acquisition information” data, and determines whether or not the traveling direction data can be acquired based on the extracted information. When it is determined that the traveling direction data can be acquired (step S5321; Yes), the process proceeds to step S5322. When it is determined that the traveling direction data cannot be acquired (step S5321; No), the process proceeds to step S5323.

(Step S5322) When it is determined that the traveling direction data can be acquired, the camera control section 170 extracts the “traveling direction” data from the second GPS information, and rewrites and updates the traveling direction data stored in the nonvolatile memory 160 or the buffer memory 165, based on the extracted “traveling direction” data.

(Step S5323) The camera control section 170 extracts information indicating whether or not ground speed data can be acquired from the “GPS data acquisition information” data, and determines whether or not the ground speed data can be acquired based on the extracted information. When it is determined that the ground speed data can be acquired (step S5323; Yes), the process proceeds to step S5324. When it is determined when the ground speed data cannot be acquired (step S5323; No), the GPS data update process is terminated.

(Step S5324) When it is determined that the ground speed data can be acquired, the camera control section 170 extracts the “ground speed” data from the second GPS information, and rewrites and updates the ground speed data stored in the nonvolatile memory 160 or the buffer memory 165, based on the extracted “ground speed” data.

As stated above, in the present embodiment, when setting is performed in which the time generated in the clocking section 34 of the camera 10a by a user is adjusted to the UTC time, the time generated in the clocking section 34 of the camera 10a is adjusted to the UTC time. After the time generated in the clocking section 34 of the camera 10a is adjusted to the UTC time, the setting is released in which the time generated in the clocking section 34 of the camera 10a is adjusted to the UTC time. This is because, for example, when the update of the second GPS information is performed every 400 msec and the time generated in the clocking section 34 is once adjusted to the UTC time, it is not necessary for the camera 10a to adjust the time generated in the clocking section 34 every 400 msec to the UTC time. Therefore, the process of adjusting the time generated in the clocking section 34 of the camera 10a to the UTC time is performed when the setting is performed in which the time generated in the clocking section 34 of the camera 10a by a user is adjusted to the UTC time once again. As a result, the load of the camera control section 170 can be reduced.

In addition, in the present embodiment, before each piece of data is read out from the second GPS information is updated, as in steps S5303, S5308, S5309, S5312, S5317, S5319, S5321, and S5323, it is determined whether or not each piece of data can be acquired. For this reason, only when each piece of data can be correctly acquired, the camera control section 170 can read out each piece of data from the second GPS information, and thus the update of the GPS data can be performed with correct data. In other words, it is possible to prevent the update using data which cannot be correctly acquired from being performed.

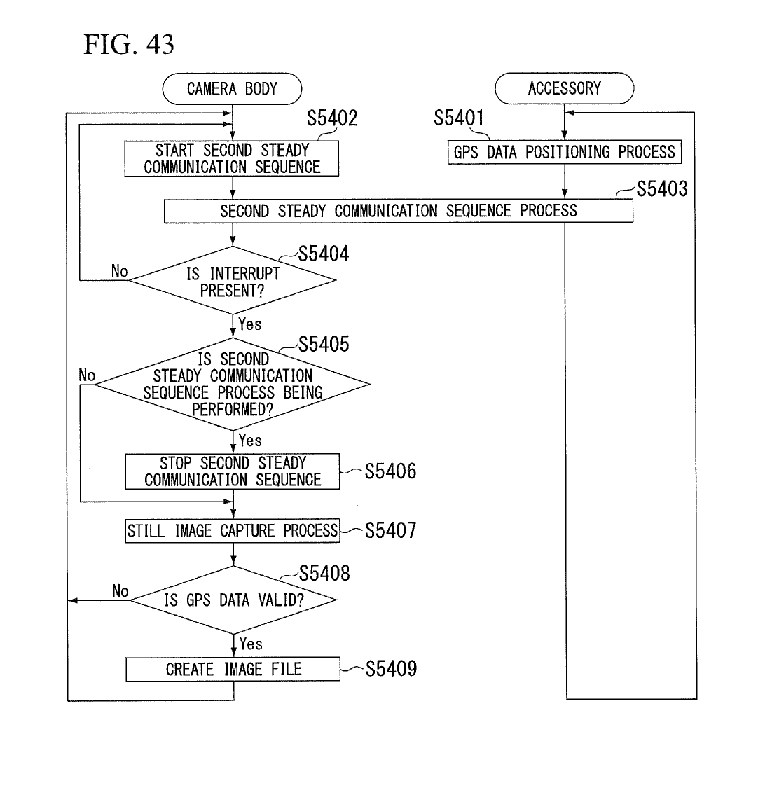

Next, processes in capture of a still image will be described with reference to FIG. 43. FIG. 43 is a diagram illustrating a procedure of processes of the camera 10a and the accessory 600 in the still image capture according to the present embodiment.

(Step S5401) The accessory 600 performs a GPS positioning process. In this case, the GPS control section 660 stores the generated second GPS information in the buffer memory 663.

(Step S5402) The camera control section 170 starts the second steady communication sequence every 2T time intervals. In addition, the period T is a period in which the accessory 400 and the camera 10 are performed.

(Step S5403) The camera control section 170 transmits the second GPS information transmission request command C5011 to the GPS control section 660.

Next, the GPS control section 660 transmits the second GPS information stored in the buffer memory 663 to the camera control section 170, in accordance with the second GPS information transmission request command C5011.

Next, the camera control section 170 performs the GPS data update process within the camera 10a based on the received second GPS information.

(Step S5404) The camera control section 170 determines whether or not an interrupt due to the image capturing sequence is present. The interrupt due to the image capturing sequence is generated, for example, when the release button 16 is pressed. When it is determined that the interrupt due to the image capturing sequence is present (step S5404; Yes), the process proceeds to step S5405. When it is determined that the interrupt due to the image capturing sequence is not present (step S5404; No), the process proceeds to step S5402.

(Step S5405) When it is determined that the interrupt due to the image capturing sequence is present, the camera control section 170 determines whether or not the second steady communication sequence process is being performed. When it is determined that the second steady communication sequence process is being performed (step S5405; Yes), the process proceeds to step S5406. When it is determined that the second steady communication sequence process is not being performed (step S5405; No), the process proceeds to step S5407.

(Step S5406) When it is determined that the second steady communication sequence process is being performed, the camera control section 170 stops the second steady communication sequence process.

(Step S5407) The camera control section 170 performs a capture process of a still image.

(Step S5408) The camera control section 170 reads out information indicating that the second GPS information is valid or invalid from the nonvolatile memory 160 or the buffer memory 165. The camera control section 170 determines whether or not the second GPS information is valid based on the read-out information. When the second GPS information is valid (step S5408; Yes), the process proceeds to step S5409. When it is determined that the second GPS information is not valid (step S5408; No), the process proceeds to step S5402.

(Step S5409) When the second GPS information is valid, the camera control section 170 reads out information necessary for an image file from the nonvolatile memory 160 or the buffer memory 165 to create the image file. The camera control section 170 displays, for example, the created image file on the display portion 102, and stores the image file in the memory 140 as an image file of captured image data. That is, the camera control section 170 creates the image file using the second GPS information stored in the nonvolatile memory 160 or the buffer memory 165 before the imaging start.

As stated above, when the image capturing sequence of a still image is generated, the camera control section 170 stops the second steady communication sequence with the GPS control section 660.

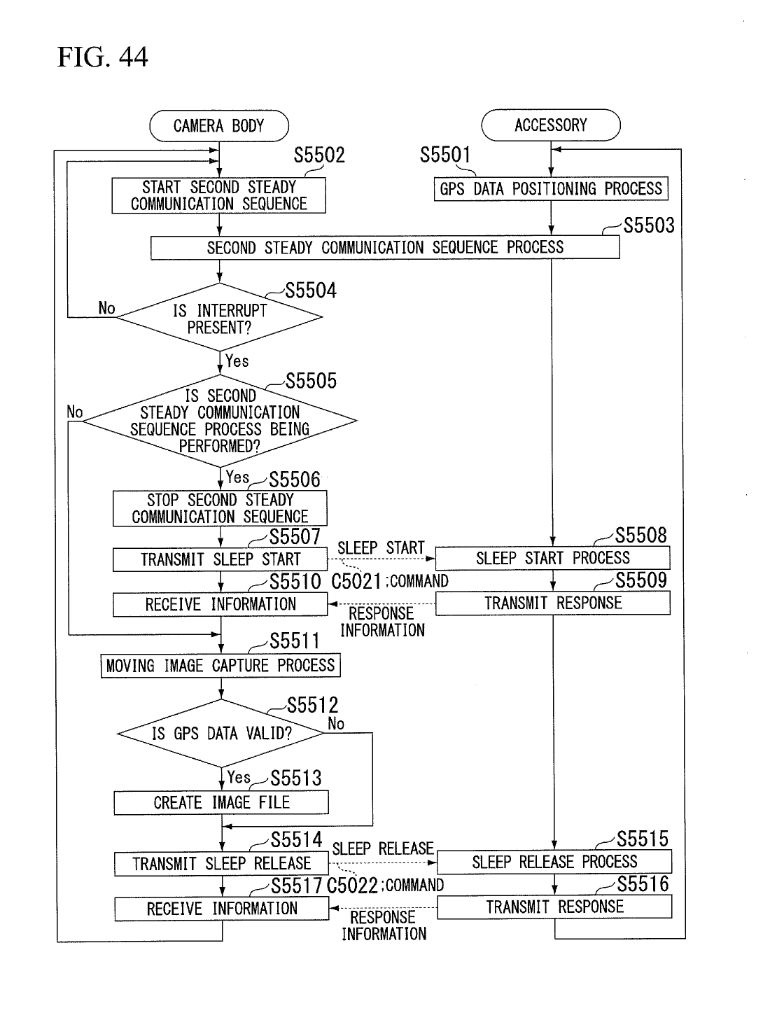

Next, processes in the capture of a moving image will be described with reference to FIG. 44. FIG. 44 is a diagram illustrating a procedure of processes of the camera 10a and the accessory 600 in the moving image capture according to the present embodiment.

Steps S5501 to S5504 are performed similarly to steps S5401 to S5404 (FIG. 43) in the capture process of a still image.

(Step S5505) When it is determined that the interrupt due to the image capturing sequence is present, the camera control section 170 determines whether or not the second steady communication sequence process is being performed. When it is determined that the second steady communication sequence process is being performed (step S5505; Yes), the process proceeds to step S5506. When it is determined that the second steady communication sequence process is not being performed (step S5505; No), the process proceeds to step S5511.

(Step S5506) When it is determined that the second steady communication sequence process is being performed, the camera control section 170 stops the second steady communication sequence process.

(Step S5507) The camera control section 170 transmits a sleep start command C5021 to the GPS control section 660.

(Step S5508) The GPS control section 660 receives the sleep start command C5021, and controls the accessory 600 to be in a sleep state (power saving mode) based on the received sleep start command C5021. In this case, the GPS control section 660 performs a control so as to stop the operation (positioning or generation of the first GPS information) of the GPS module section 650. In addition, the GPS control section 660 performs a control so as to perform only the generation of clocking information by the RTC 653 and retention of data stored in the storage section 652a within the GPS module section 650. In this case, power from the camera 10a to the module section 650 is supplied to only the RTC 653 and the storage section 652a.

(Step S5509) The GPS control section 660 transmits response information for the sleep start command C5021 to the camera control section 170.

(Step S5510) After the response information from the GPS control section 660 is received, the camera control section 170 switches the communication control signal Cs from an H level to an L level.

(Step S5511) The camera control section 170 performs a moving image capture process.

(Step S5512) The camera control section 170 reads out information indicating that the second GPS information is valid or invalid from the nonvolatile memory 160 or the buffer memory 165. The camera control section 170 determines whether or not the second GPS information is valid based on the read-out information. When the second GPS information is valid (step S5512; Yes), the process proceeds to step S5513. When it is determined that the second GPS information is not valid (step S5512; No), the process proceeds to step S5514.

(Step S5513) When the second GPS information is valid, the camera control section 170 reads out information necessary for an image file from the nonvolatile memory 160 or the buffer memory 165 to create the image file. The camera control section 170 displays, for example, the created image file on the display portion 102, and stores the image file in the memory 140 as an image file of captured image data. That is, the camera control section 170 creates the image file using the second GPS information stored in the nonvolatile memory 160 or the buffer memory 165 before the imaging start. In addition, the second GPS information (position information) recorded in the image file created in the present step is the position information acquired at the timing of step S5501, that is, the second GPS information (position information) acquired just before the moving image capture is started, as shown in the flow diagram of FIG. 44.

(Step S5514) When the image capture process is terminated, the camera control section 170 switches the communication control signal Cs from an L level to an H level.

Next, the camera control section 170 transmits a sleep release command C5022 to the GPS control section 660. In addition, the termination of the image capture process is a state where the release button 16 is pressed again and the moving image capture is terminated, a state where free space of the memory 140 becomes small and the moving image capture cannot be continued, or the like.

(Step S5515) The GPS control section 660 receives the sleep release command C5022 from the camera 10a, and performs a control so that the GPS module section 650 is returned from a sleep state, based on the received sleep release command C5022.

Next, the GPS control section 660 performs a control so as to cause the GPS module section 650 to restart the operation.

(Step S5516) The GPS control section 660 transmits response information for the sleep release command C5022 to the camera control section 170.

(Step S5517) After the response information from the GPS control section 660 is received, the camera control section 170 returns to step S5502.

As stated above, when the image capturing sequence of a moving image is generated, the camera control section 170 stops the second steady communication sequence with the GPS control section 660, and further transmits a command for starting the sleep process to the GPS control section 660. Thereby, the accessory 600 controls the operation state of the GPS module section 650 to be in a sleep state (power saving mode) during capturing a moving image. As a result, since power supplied from the camera 10a can be reduced, power consumption in the camera system 1a can be reduced. In addition, in the present embodiment, the GPS module section 650 to set to a sleep state to thereby suppress power consumption. However, a restriction (sleep process) on the operation of the GPS control section 660 may be performed, and the supply of power to the GPS control section 660 may be additionally reduced, to thereby further suppress power consumption. (Standby State Described Later)

In addition, transmission of a command for causing the GPS control section 660 to start the above-mentioned sleep process by the camera control section 170 (thereby, control of the GPS control section 660 to be in a sleep state) is not limited to the case where the camera enters the above-mentioned moving image capture sequence. Besides this, for example, even when the camera 10a operates in an image reproduction mode in which a captured image (still image and moving image) is reproduced, or performs the still image capture in which, however, the one-frame exposure time of the image capture is long (so-called long-time exposure image capture), the camera 10a may control the GPS control section 660 to be in a sleep state. In addition to this, even when the image capture lens mounted to the camera is not in a shootable state (when the image capture lens is in a contracted state where it contracts to a non-shootable state), or a photographer opens a menu screen on the liquid crystal display portion provided to the back side of the camera and performs a menu setting operation for setting the image capture conditions or the like, the camera 10a may control the GPS control section 660 to be in a sleep state (power saving mode). In such a case, the GPS control section 660 may receive state information indicating each state from the camera 10a, and may control the GPS control section 660 to be in a sleep state, based on the received state information.

In addition, in the present embodiment, an example is described in which the sleep process is performed on the accessory 600 at the time of the moving image capture, but the camera 10a may cause the accessory 600 to continue positioning without setting the accessory to be in a sleep state during the moving image capture. In addition, the camera 10a may cause the accessory 600 to perform positioning for each time interval which is set in advance, and may cause the accessory to be set to a sleep state only for a period in which positioning is not performed.

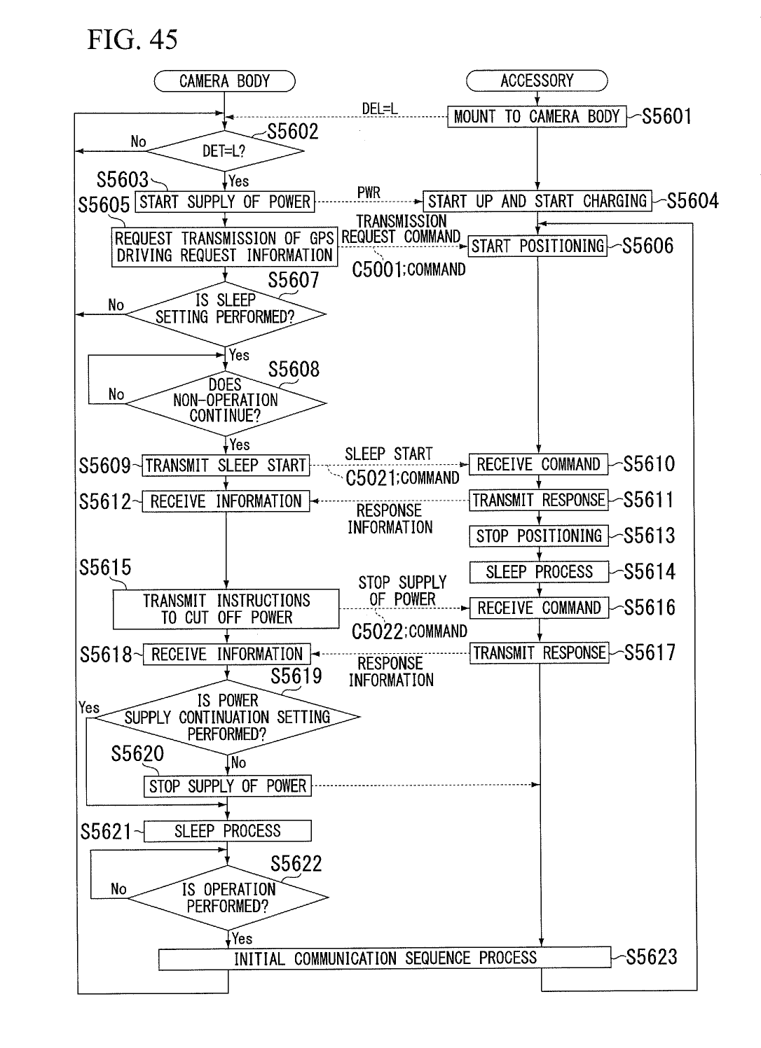

Next, a power source control of the accessory 600 by the camera 10a will be described with reference to FIG. 45. FIG. 45 is a diagram illustrating processes in the power source control of the accessory 600 by the camera 10a according to the present embodiment.

First, a case where the camera 10a is set to a sleep state will be described.

(Step S5601) When the accessory 600 is mounted to the shoe seat 15 of the camera body 100a by a user, the signal level of the startup detection level DET is changed to an L (low) level.

(Step S5602) The camera control section 170 performs a determination process of determining whether or not the signal level of the startup detection level DET is an L level. When it is determined that the signal level of the startup detection level DET is not an L level (step S5602; No), the camera control section 170 determines that the accessory 600 is in a state where it is not mounted to the camera 10a and performs the determination process of step S5602 again. When it is determined that the signal level of the startup detection level DET is an L level (step S5602; Yes), the process proceeds to step S5603.

(Step S5603) When it is determined that the signal level of the startup detection level DET is an L level, the camera control section 170 starts the supply of power to the accessory 600 through the terminal section 25 of the camera 10a and the terminal section 623 of the accessory 600.

(Step S5604) After the supply of power from the camera 10a is started, the GPS control section 660 starts a control of each section.

Next, the charging section 664 of the accessory 600 starts charging the secondary battery 665.

(Step S5605) After the power supply continuation flag is set, the camera control section 170 transmits the transmission request command C5001 for requesting transmission of the GPS driving request information to the GPS control section 660.

(Step S5606) The GPS control section 660 receives the transmission request command C5001. Next, the GPS control section 660 outputs instructions to start positioning to the GPS module section 650, in accordance with the transmission request command C5001. Next, the GPS module section 650 starts receiving the first GPS information (navigation message) from the positioning satellite, in accordance with the instructions to start positioning which are output by the GPS control section 660.

(Step S5607) After the accessory 600 starts positioning, the camera control section 170 determines whether or not setting in which the sleep process is performed on the camera 10a is made by a user. In addition, the sleep process is a process of causing the camera 10a and the accessory 600 to transition to a sleep state when the camera 10a is not operated within the time which is set in advance. When it is determined that the setting in which the sleep process is performed is not made (step S5607; No), the process returns to step S602. When it is determined that the setting in which the sleep process is performed is made (step S5607; Yes), the process proceeds to step S5608. In addition, the sleep state in the camera 10a is, for example, a process, different from the sleep process of the accessory 600, in which a display on the display portion 102 is set to a non-display and the operation of the camera control section 170 is restricted.

(Step S5608) When it is determined that the setting in which the sleep process is performed is made, the camera control section 170 determines whether or not a state where the operation is not performed (hereinafter, referred to as the non-operation state) continues for a predetermined period. The predetermined period is a period (for example, 5 minutes) which is set or selected through setting switches 104 by a user. When it is determined that the non-operation state has not continued for the predetermined period (step S5608; No), step S5608 is repeated. When it is determined that the non-operation state has continued for the predetermined period (step S5608; Yes), the process proceeds to step S5609.

(Step S5609) When it is determined that the non-operation state has continued for the predetermined period, the camera control section 170 transmits the sleep start command C5021 to the GPS control section 660.

(Step S5610) The GPS control section 660 receives the sleep start command C5021.

(Step S5611) The GPS control section 660 transmits response information for the received sleep start command C5021 to the camera control section 170.

(Step S5612) The camera control section 170 receives the response information from the GPS control section 660.

(Step S5613) The GPS control section 660 performs a control so as to stop the operation (positioning or generation of the first GPS information) of the GPS module section 650, based on the received sleep start command C5021.

(Step S5614) The GPS control section 660 performs a control so as to perform only the generation of clocking information by the RTC 653 and retention of data stored in the storage section 652a within the GPS module section 650.

(Step S5615) The camera control section 170 transmits the power supply stop command C5022, indicating the stop of the supply of power from the camera 10a to the accessory 600, to the GPS control section 660.

(Step S5616) The GPS control section 660 receives the power supply stop command C5022.

(Step S5617) The GPS control section 660 transmits response information for the received power supply stop command C5022 to the camera control section 170.

(Step S5618) The camera control section 170 receives the response information for the power supply stop command C5022.

(Step S5619) The camera control section 170 determines whether or not the power supply continuation flag is set in the nonvolatile memory 160. When it is determined that the power supply continuation flag is not set (step S5619; No), the process proceeds to step S5620. When it is determined that the power supply continuation flag is set (step S5619; Yes), the process proceeds to step S5621.

(Step S5620) After it is determined that the power supply continuation flag is not set and the response information for the power supply stop command C5022 is received, the camera control section 170 stops the supply of power to the accessory 600. That is, the camera control section 170 stops the supply of power PWR, supplied through the terminal section 25, to the accessory 600.

(Step S5621) The camera control section 170 performs a control so as to set the camera 10a to a sleep state. Herein, when it is determined in step S5619 that the power supply continuation flag is set (step S5619; Yes), the camera control section 170 sets the camera 10a to a sleep state without stopping the supply of power to the accessory 600.

(Step S5622) The camera control section 170 detects whether or not the setting switches 104, the release button 16 or the like is operated while maintaining a sleep state. In this case, for example, when the setting switches 104, the release button 16 or the like is operated, an interrupt signal is input to the camera control section 170. The camera control section 170 returns from a sleep state by detecting the interrupt signal. When it is determined that the setting switches 104, the release button 16 or the like is operated (step S5622; Yes), the process proceeds to step S5623. When it is determined that the setting switches 104, the release button 16 or the like is not operated (step S5622; No), step S5622 is repeated.

(Step S5623) When it is determined that the setting switches 104, the release button 16 or the like is operated, and the power supply continuation flag is set in the nonvolatile memory 160, the camera control section 170 determines whether or not the accessory 600 is mounted to the shoe seat 15 depending on whether or not the signal level of the startup detection level DET is an L level. When it is determined that the signal level of the startup detection level DET is an L level, the camera control section 170 performs the initial communication sequence with the accessory 600.

Next, in the initial communication sequence, the GPS control section 660 performs a control so as to cause the GPS module section 650 to start positioning, based on transmission information of the GPS driving request information transmitted from the camera control section 170.

As stated above, when the camera 10a transitions to a sleep state, the accessory 600 having a GPS function performs a control so that the GPS control section 660 stops positioning by the GPS module section 650. Thereafter, the GPS control section 660 performs a control so that the GPS module section 650 transitions to a sleep state. In addition, in the present embodiment, the GPS module section 650 to set to a sleep state to thereby suppress power consumption. However, a restriction (sleep process) on the operation of the GPS control section 660 may be performed, and the supply of power to the GPS control section 660 may be additionally reduced, to thereby further suppress power consumption. (Standby State Described Later)

For example, the GPS control section 660 controls only the GPS module section 650 to be in a sleep state, based on the sleep start command C5021. The GPS control section 660 may count a clock generated by the RTC 653, and may perform a control so as to set itself to a sleep state without using a command of the camera 10a after a predetermined time. Alternatively, after the power supply stop command C5022 is received from the camera 10a, the GPS control section 660 may count a clock generated by the RTC 653, and may perform a control so as to set itself to a sleep state after a predetermined time.

Next, a case where the power source of the camera 10a is turned off will be described with reference to FIG. 45.

The camera 10a is configured such that the power source is automatically turned off when the non-operation state has continued for a predetermined period, except when the power switch 31 is pressed by a user (hereinafter, automatic turn-off of the power source of the camera 10a is referred to as the automatic power-off). When the power source of the camera 10a is turned off, the accessory 600 transitions to a standby state. The standby state of the accessory 600 is an operating state in which the GPS module section 650 is set to a sleep (power saving mode) state, and the GPS control section 660 is additionally set to a sleep (power saving mode) state.

Steps S5601 to S5606 are the same as those in the case of the power source control (FIG. 45) of the accessory 600 transitioning to a sleep state. Only processes different from those in the case of the power source control of the accessory 600 transitioning to a sleep state will be described.

(Step S5607) After the accessory 600 starts positioning, the camera control section 170 determines whether or not setting in which an automatic power-off process is performed on the camera 10a is made by a user. In addition, the automatic power-off process is a process of performing a control in which the power sources of the camera 10a and the accessory 600 are automatically turned off when the camera 10a is not operated within the time which is set in advance. When it is determined that the setting in which the automatic power-off process is performed is not made (step S5607; No), the process returns to step S602. When it is determined that the setting in which the automatic power-off process is performed is made (step S5607; Yes), the process proceeds to step S5608.

Even when the automatic power-off process is performed, the camera 10a determines that the non-operation state has continued for a predetermined time, and then transmits the sleep start command C5021 to the GPS control section 660 (step S5609).

The GPS control section 660 transmits response information to the camera control section 170 in accordance with the sleep start command C5021. In addition, the GPS control section 660 performs a control so as to set the GPS module section 650 to a sleep state in accordance with the sleep start command C5021, and then performs a control so as to set itself to a sleep state (steps S5610 to S5614).

When the power supply continuation flag is set in the nonvolatile memory 160 (step S5619; Yes), the camera control section 170 continues the supply of power to the accessory 600 even after the automatic power-off of the camera 10a.

In this manner, even after the power source of the camera 10a is automatically turned off, the reason to continue the supply of power to the accessory 600 will be described.

The GPS module section 650 receives the GPS information (navigation message) from the positioning satellite, and generates the first GPS information (NMEA data) based on the received GPS information. In addition, the GPS control section 660 converts the first GPS information generated by the GPS module section 650 and generates the second GPS information.

The GPS information is a valid period as mentioned above. The valid period of the ephemeris data is 2 hours±2 hours. In addition, the valid period of the almanac data is ±3 days from time of epoch. After the valid period of the data elapses, the GPS module section 650 needs to receive the GPS information again, and thus the time until positioning is started becomes longer. Therefore, even when a user performs the image capture immediately after the power source of the camera 10a is turned on, the second GPS information is not obtained from the accessory 600.

In order to avoid such circumstances, even when the accessory 600 is in a standby state, it performs a count using clocking information of the RTC 653, is started up, for example, at 30-minute intervals, and acquires the GPS information. The GPS module section 650 stores the first GPS information based on the acquired GPS information in the storage section 652a within the GPS module section 650, and then transitions to a standby state again.

When the power source of the camera 10a is turned on, the GPS control section 660 can generate the second GPS information rapidly by using the first GPS information stored in the storage section 652a within the GPS module section 650. Therefore, when the image capture is performed immediately after the power source of the camera 10a is turned on, the camera 10a can obtain the second GPS information immediately from the accessory 600.

In order for the accessory 600 to be capable of performing such a control, the camera control section 170 continues the supply of power to the accessory 600 even after the power source of the camera 10a is turned off.

In addition, the automatic power-off is described above as an example, but even when the power source is turned off by the power switch 31, the camera control section 170 performs the processes of steps S5609 to S5619. That is, the sleep start command C5021 is transmitted to the GPS control section 660 (step S5609).

The GPS control section 660 transmits response information to the camera control section 170 in accordance with the sleep start command C5021. In addition, the GPS control section 660 performs a control so as to set the GPS module section 650 to a sleep state in accordance with the sleep start command C5021, and then performs a control so as to set itself to a sleep state (steps S5610 to S5613).

When the power supply continuation flag is set in the nonvolatile memory 160 (step S5619; Yes), the camera control section 170 then continues the supply of power to the accessory 600 even after the camera 10a is powered off.

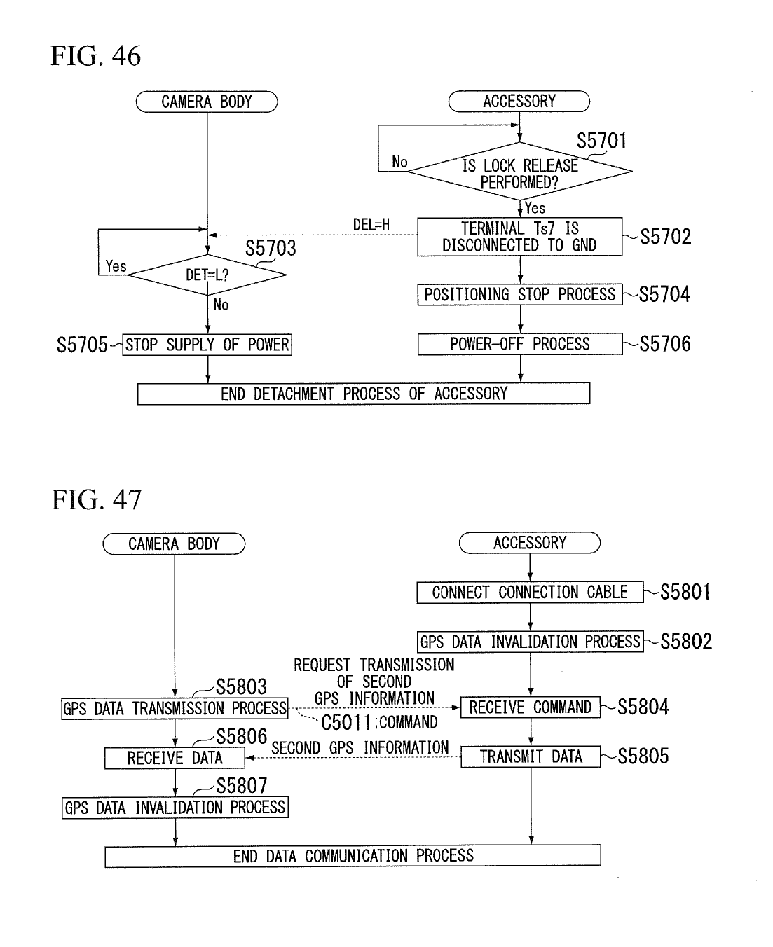

Next, a detachment process (power-off process) of the accessory 600 in the operating portion 630 will be described with reference to FIG. 46. FIG. 46 is a diagram illustrating a procedure of detachment processes (power-off processes) of the accessory 600 according to the present embodiment.

(Step S5701) The GPS control section 660 detects whether or not the operating portion 630 is operated (lock release operation is performed) by a user. When the operating portion 630 is not operated (step S5701; No), step S5701 is repeated. When the operating portion 630 is operated (step S5701; Yes), the process proceeds to step S5702.

(Step S5702) When it is detected that the operating portion 630 is operated (lock release operation is performed), the startup state providing terminal Ts7 of the accessory 600 is disconnected to the GND (reference potential), and the potential of the startup state providing terminal Ts7 is changed to an H (high) level.

(Step S5703) The camera control section 170 performs a determination process of determining whether or not the signal level of the startup detection level DET is an L level. When it is determined that the signal level of the startup detection level DET is an L level (step S5703; Yes), the camera control section 170 determines that the accessory 600 is mounted to the camera 10a, and performs the determination process of step S5703 again. When it is determined that the signal level of the startup detection level DET is not an L level (step S5703; No), the proceeds to step S5704.

(Step S5704) When the signal level of the startup detection level DET which is not an L level is detected, the GPS control section 660 performs a control so as to stop positioning by the GPS module section 650.

(Step S5705) When it is determined in step S5703 that the signal level of the startup detection level DET is not an L level, the camera control section 170 stops the supply of power to the accessory 600.

(Step S5706) The GPS control section 660 performs a power-off process. In the power-off process, the supply of power from the power source section 670 of the accessory 600 to each section is blocked. Power is supplied from the secondary battery 665 to the storage section 652a and the RTC 653 within the GPS module section 650.

Thereby, the GPS module section 650 performs only the generation of clocking information by the RTC 653 and retention of data stored in the storage section 652a within the GPS module section 650, using power of the secondary battery 665.

As stated above, when the accessory 600 is detached from the camera 10a by the operating portion 630 of the accessory 600, the supply of power from the camera 10a is stopped. After the supply of power from the camera 10a is stopped, the accessory 600 performs the generation of the clocking information by the RTC 653 and the retention of data stored in the storage section 652a within the GPS module section 650, using power of the secondary battery 665.

Next, reference will be made to FIG. 47 to describe an operation in the case where the accessory 600 and an external device such as a personal computer are connected to each other through the data terminal 640 by a connection cable. FIG. 47 is a diagram illustrating an operation example in the case where a connection cable is connected to the data terminal 640 according to the present embodiment. The connection cable is, for example, a USB cable.

When the accessory 600 is mounted to the camera 10a, and an external device is connected through the data terminal 640 by the connection cable, the accessory 600 is supplied with power from the camera 10a. On the other hand, when the accessory 600 is detached from the camera 10a, and the external device is connected to the data terminal 640 through the connection cable, the accessory 600 is supplied with power from the external device through the data terminal 640.

(Step S5801) A user connects the accessory 600 and the personal computer through the data terminal 640 by the connection cable.

(Step S5802) When a personal computer is connected, the GPS control section 660 detects that the personal computer is connected.

When it is detected that the personal computer is connected, the GPS control section 660 sets a flag indicating that data is invalid, in the “GPS data valid/invalid” data of the second GPS information. In addition, the GPS control section 660 performs a control so as to cause the GPS module section 650 to stop positioning.

(Step S5803) The camera control section 170 transmits the second GPS data transmission request command C5011 to the GPS control section 660.

(Step S5804) The GPS control section 660 receives the second GPS data transmission request command C5011 from the camera control section 170.

(Step S5805) The GPS control section 660 transmits the second GPS information to the camera 10a in accordance with the second GPS data transmission request command C5011.

(Step S5806) The camera control section 170 receives the second GPS information from the GPS control section 660.

(Step S5807) The camera control section 170 determines whether or not the flag indicating that data is invalid is set in the “GPS data valid/invalid” data of the received second GPS information. When it is determined that the flag indicating that data is invalid is set, the camera control section 170 performs a GPS data invalidation process of invalidating the received second GPS information.

Since the second GPS information is invalid, the camera control section 170 does not generate image file data making use of the received second GPS information. The GPS control section 660 performs transmission of the second GPS information including the flag indicating that data is invalid, until communication through the connection cable is terminated.

Alternatively, when various types of commands are transmitted from the camera 10a at the time of communication with the personal computer and the like, the GPS control section 660 regards a command transmitted by the camera control section 170 as invalid. A reply or transmission of data may not be performed on the command and the like transmitted by the camera 10a. In this case, even when the command is transmitted to the GPS control section 660, the camera control section 170 determines that the command to the GPS control section 660 is invalid in accordance with no response or data transmission from the GAS control section 660 within a period which is set in advance. In this case, the GPS control section 660 may store the received command in the buffer memory 663. After communication with the personal computer and the like is terminated, the GPS control section 660 may transmit data corresponding to the transmitted command.

In this case, the command which is stored and withheld is, for example, a sleep start command (FIGS. 44 and 45), a power supply stop command (FIG. 45) and the like. When the sleep start command is withheld, the GPS control section 660 releases the connection to the personal computer through the data terminal 640, and then reads out the stored sleep start command to perform a sleep process.

Next, a description will be made of an example of an operation between the accessory 600 and the personal computer in the case where the connection is performed by the connection cable.

The personal computer transmits instructions indicating a GPS data request to the accessory 600 through the connection cable. The GPS control section 660 transmits the first GPS information or the second GPS information to the personal computer in accordance with the instructions indicating the GPS data request.

In addition, assist data is transmitted from the personal computer through the connection cable to the accessory 600. The assist data is orbit information of the positioning satellite necessary for acquisition of position information, and is data which is capable of shortening the time until the GPS module section 650 acquires the position information by storing the data in the accessory 600. In this case, the personal computer acquires the assist data in advance through a network which is not shown. In addition, the valid period of the assist data is about 30 days.

As stated above, in the present embodiment, the GPS control section 660 extracts only information necessary for generating the image file (Exif file) from the first GPS information (NMEA data) which is output by the GPS module section 650, and deletes data unnecessary for image file creation to generate the second GPS information. In addition, the GPS control section 660 converts the data from the GPS module section 650 into data of 1-byte unit at the time of the generation of the second GPS information. Further, the GPS control section 660 determines information acquisition possibility, generates a flag for the GPS data acquisition information, and generates the second GPS information including the generated information acquisition possibility flag. In addition, the GPS control section 660 generates a flag indicating that the GPS data is valid or invalid, generates a flag indicating a 2D positioning state or a 3D positioning state, and generates the second GPS information including each flag for the generated GPS data acquisition information.

In this manner, the GPS control section 660 generates the second GPS information necessary for the camera 10a based on the first GPS information. Therefore, it is possible to reduce the amount of data transmitting from the accessory 600 to the camera 10a, as compared to the case where the first GPS information is output to the camera. As a result, the load of the camera control section 170 can be lessened. In addition, the GPS control section 660 determines a flag indicating whether or not each data necessary for generating the image file (information indicating the latitude, information indicating the longitude, information indicating the altitude, information indicating the Universal Time Coordinated, information indicating the number of satellites used for positioning, information indicating reliability of positioning, information indicating the direction of travel, and ground information) has been acquired, generates a flag, and generates the second GPS information including the generated flag.

As a result, the accessory 600 can transmit data to the camera 10a with information indicating whether or not each data is valid and has been acquired.

In addition, in the present embodiment, the camera 10a has no need of a process of extracting the data necessary for generating the image file from the second GPS information received from the accessory 600. Further, the camera 10a can determine whether or not each data necessary for generating the image file has been acquired and is error data by checking the flag indicating whether or not each data has been acquired, and thus can omit to determine whether or not the data is appropriate. Therefore, the camera 10a can determine validity of each data based on the information indicating whether or not each data is valid and has been acquired. As a result, the load of the camera control section 170 can be lessened. In addition, even when data including an error is received from the accessory 600, the camera 10a prevent generating the image file using the received data to display the image file on the display portion 102, and can prevent storing the generated image file in the memory 140 in association with captured image data.

In addition, when information indicating the UTC included in the second GPS information received from the accessory 600 can be acquired, the camera 10a adjusts clocking of the camera 10a using the information indicating the UTC based on setting of the camera 10a. For this reason, even when time adjustment by a user deviates, the battery of the camera 10a is consumed and thus the time which is once set deviates, or the like, the camera 10a can perform the time adjustment based on the information indicating the UTC acquired by the accessory 600.

In addition, in the present embodiment, before the camera 10a transitions to a sleep state, a power-off state, or an auto power-off state, a sleep start command is transmitted to the accessory 600. The accessory 600 transmits a response to the received sleep start command, and then stops the operation of the GPS module section 650.

In addition, in the present embodiment, the camera 10a receives the response to the sleep start command from the accessory 600, and then transmits a power supply stop command to the accessory 600. The accessory 600 transmits a response to the power supply stop command. When the camera 10a receives the response to the power supply stop command from the accessory 600, and then determines that the power supply continuation flag is set in the nonvolatile memory 160, the camera 10a is controlled to be in a sleep state, a power-off state, or an auto power-off state while continuing the supply of power from the camera 10a through the terminal section 25 to the accessory 600.

That is, before the camera 10a according to the present embodiment transitions to a sleep state, a power-off state, or an auto power-off state, the camera first transmits a sleep start command for stopping the operation of the GPS module section 650, receives a response to the command, and then performs a two-step process so as to transmit the power supply stop command.

As a result, after the operation is stopped, the accessory 600 can store the measured data in the storage section 652a by the sleep process and save the data in backup. In addition, the accessory 600 performs a count using clocking information of the RTC 653 during the sleep process, is started up, for example, at 30-minute intervals, and acquires the GPS information. The accessory 600 stores the first GPS information based on the acquired GPS information in the storage section 652a within the GPS module section 650. Therefore, when the power source of the camera 10a is turned on from a sleep state, the first GPS information stored in the storage section 652a within the GPS module section 650 is used, thereby allowing the GPS control section 660 to generate the second GPS information rapidly. Therefore, when the image capture is performed immediately after the power source of the camera 10a is turned on, the camera 10a can obtain the second GPS information immediately from the accessory 600.

In addition, in the present embodiment, when the lock of the operating portion 630 of the accessory 600 is released, the accessory 600 performs a control so as to stop positioning by the GPS module section 650. Thereafter, the accessory 600 causes the GPS control section 660 to perform a power-off process.

In addition, when the lock of the operating portion 630 of the accessory 600 is released, the camera 10a detects that the startup detection level (DET) is changed to an L level from an H level. After it is detected that the startup detection level is changed to an H level, the camera 10a stops the supply of power to the accessory 600 through the terminal section 25.

After the supply of power from the terminal section 25 of the camera 10a is stopped, the accessory 600 performs the supply of power from the secondary battery 665 to the storage section 652a and the RTC 653 within the GPS arithmetic operation section 652.

As a result, the accessory 600 can stop the operation normally, store the first GPS information in the storage section 652a through the sleep process and save the information in backup. After the lock release, the accessory 600 holds the first GPS information stored in the storage section 652a of the GPS module section 650 using power supplied from the secondary battery 665, and continues clocking of the RTC 653. As a result, even when the accessory 600 is mounted to the camera 10a again, it is possible to start positioning rapidly.

In addition, in the present embodiment, the GPS control section 660 of the accessory 600 detects that the communication control signal Cs from the camera 10a is changed to an L level to an H level during a standby state, and returns from the standby state. As a result, when the camera 10a returns from the standby state, the accessory 600 can also return from the standby state rapidly, and thus can communicate with the camera 10a.

In addition, in the present embodiment, the camera 10a stops the second steady communication with the accessory 600 at the time of capturing a still image. Further, the camera 10a stops the second steady communication with the accessory 600 at the time of capturing a moving image, and then transmits the sleep start command. As a result, since the camera 10a can cause the accessory 600 to transition to the sleep state at the time of capturing a moving image, power consumption of the accessory 600 can be reduced.

In addition, in the present embodiment, the accessory 600 transmits, to the camera 10a, characteristic information of an extended function including power supply continuation information indicating whether or not the supply of power to the camera 10a is required to be continued even when the camera 10a is in a sleep state. The camera 10a detects the supply continuation information even when the camera 10a is in a sleep state, based on the characteristic information of the extended function transmitted by the accessory 600. When the supply continuation information is detected, the camera 10a can continue the supply of power to the accessory 600 even after the camera 10a transitions to a sleep state. As a result, since the accessory 600 can continue positioning even when the camera 10a is in a sleep state, measured data can be transmitted to the camera 10a rapidly after the camera 10a returns from the sleep state.

In addition, in the present embodiment, the accessory 600 includes the data terminal 640. When the connection cable is connected to the data terminal 640 and communication with a personal computer is performed, the accessory 600 can transmit assist data from the personal computer to the accessory 600, or write the assist data therefrom. As a result, since the GPS control section 660 can receive the received data from the positioning satellite using the assist data, it is possible to shorten the time of positioning performed after the sleep release or after the start of the supply of power. In addition, since the time of positioning can be shortened, it is possible to reduce power consumption of the accessory 600. In addition, since the valid period of data of the satellite orbit can be set to up to about 7 days depending on the assist data acquired from a network, it is possible to increase the interval at which a navigation message is acquired from the positioning satellite and is updated.

In addition, when the connection cable is connected to the data terminal 640 and communication with the personal computer is performed, the accessory 600 sets a command transmitted from the camera 10a to be invalid. In addition, the accessory 600 withholds a process for the command transmitted from the camera 10a during communication with the personal computer through the connection cable, and performs the withheld process for the command after communication with the personal computer is terminated. As a result, the accessory 600 can also perform communication after communication with the personal computer is completed, with respect to the command which is not capable of being executed during communication with the personal computer.

In addition, in the present embodiment, a description has been made of an example in which the accessory 600 includes a GPS function. For example, the accessory 600 may further include other functions. In such a case, the camera 10a and the accessory 600 perform the first steady communication sequence every 200 msec similarly to the accessory 400, with respect to other functions. After the first steady communication sequence is terminated, the camera 10a and the accessory 600 performs the second steady communication sequence every 400 msec.

In addition, as in the case of the accessory 400 which does not include a GPS function shown in FIG. 7, the accessory control section 440 transmits the function extension type information indicating that the extended function is not included in the camera 10a (or 10) in the initial communication sequence. For this reason, the camera control section 170 determines that the extended function is not included in the initial communication sequence, and thus does not perform a transmission request of the characteristic information of the extended function with respect to the accessory 400. As a result, the accessory 400 does not perform a request for performing power supply continuation even in the sleep state or the standby state, with respect to the camera control section 170.

As stated above, in the present embodiment, in the initial communication sequence, the accessory 600 including the extended function transmits the power supply continuation information to the camera 10a even in the sleep state or the standby state. Alternatively, in the initial communication sequence, the accessory 400 which does not include the extended function does not transmit the power supply continuation information to the camera 10a even in the sleep state or the power-off state. The camera 10a controls whether or not the supply of power is continued even in the sleep state or the standby state, based on the supply continuation information.

For this reason, in the accessory 600 including the GPS function section that performs a process even in the sleep state or the standby state, the supply of power from the camera 10a to the accessory 600 is continued even in the sleep state or the standby state. As a result, after the sleep state release or after the standby state release, it is possible to start positioning rapidly.

On the other hand, in the accessory 400 including no GPS function section that does not perform a process even in the sleep state or the standby state, the supply of power from the camera 10a to the accessory 400 is not continued in the sleep state or the standby state. As a result, when the camera 10a is in the sleep state, the accessory 400 is also controlled to be in the sleep state, and thus power saving can be realized.

In addition, similarly to Modified Example 1 (FIG. 25) to Modified Example 3 (FIG. 27) in the accessory 400, the camera system 1a according to the present embodiment may determine whether or not information is normally received from the GPS control section 660 by the camera control section 170 in the initial communication sequence. For example, when the accessory initial state information cannot be received from the GPS control section 660, or the received accessory initial state information does not include information containing at least one item of items designated by the transmission request command C1, the camera control section 170 may determine that the information is not normally received. The camera control section 170 notifies the accessory 600 that the supply of power is stopped, and then may perform a process of stopping the supply of power to the accessory 600.

[Description about Camera Including GPS Function]

Next, an example will be described in which a GPS section having a GPS function is built in the camera body.

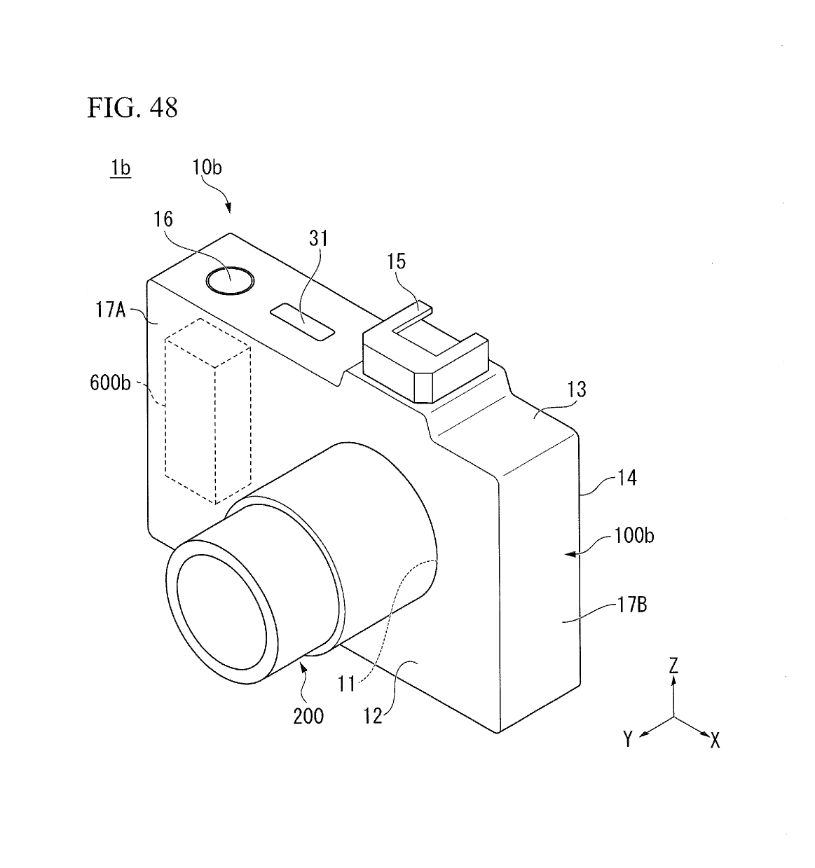

FIG. 48 is a diagram illustrating an appearance of a camera system 1b according to the present embodiment.

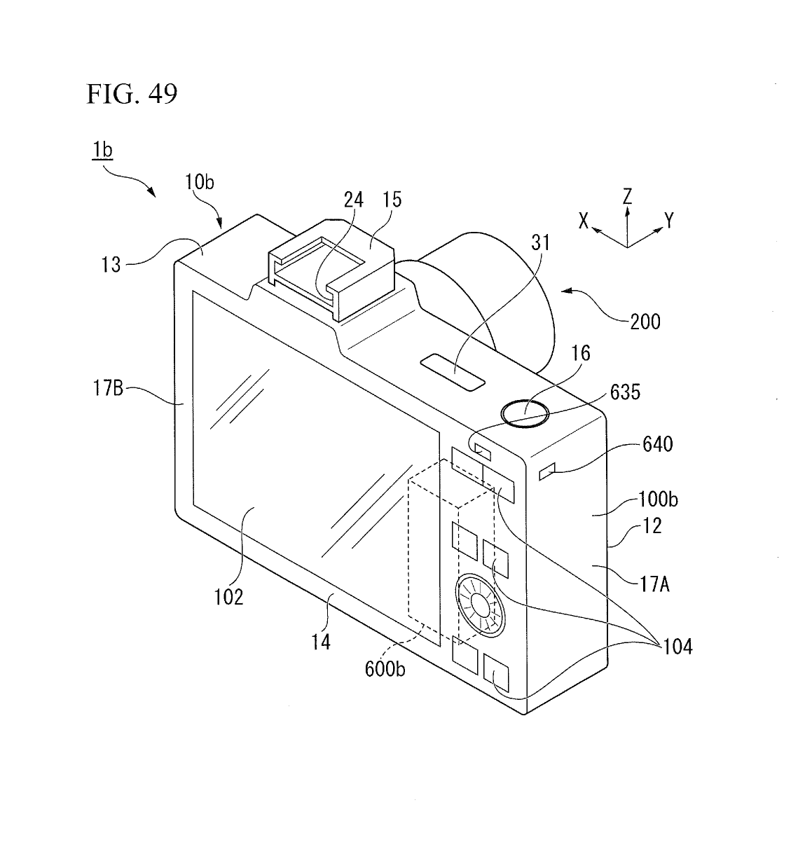

FIG. 49 is a diagram when the camera system 1b according to the present embodiment is viewed from the side opposite to FIG. 48. The camera system 1b shown in FIGS. 48 and 49 includes a GPS section 600b within the camera 10b. The appearance of the camera 10b is the same as the appearance of the camera 10 shown in FIGS. 1 and 2 and the appearance of the camera 10a shown in FIGS. 31 and 32, except for the LED 635 and the data terminal 640 (first information communication section). In addition, the lateral side 17A is a left side, viewed from the front surface 12, of the lateral sides directed laterally with respect to the front surface 12 on which the mount 11 is disposed. The lateral side 17B is a right side, viewed from the front surface 12, of the lateral sides directed laterally with respect to the front surface 12 on which the mount 11 is disposed.

As shown in FIG. 49, a camera body 100b includes a display portion 102 disposed on the back surface 14, setting switches 104 disposed on the back surface 14, an LED 635 disposed on the back surface 14, and a data terminal 640 disposed on the lateral side 17. The LED 635 and the data terminal 640 have the same function as that of the accessory 600 shown in FIG. 32. In addition, in the present embodiment, an example in which the LED 635 is disposed on the back surface 14 is illustrated, but the LED 635 and the data terminal 640 may not be included. In this case, for example, the camera 10b may display information indicated by turning off or turning on the LED 634 on the display portion 102. In addition, for example, the data terminal 640 may be disposed on the lateral side 17B or the back surface 14.

The GPS section 600b included in the camera 10b according to the present embodiment has a GPS function similarly to the accessory 600, and can perform positioning and the like. In addition, the camera 10b can control the GPS section 600b by communication with the GPS section 600b. The camera 10b can, for example, measure an image capture position by the GPS section 600b, and store image capture position information, measured in association with image data captured by the camera 10b, in the memory 140 (see FIG. 6).

The components inside the camera 10b are the same as those of the camera 10a shown in FIG. 35 except that the GPS section 600b is included. Therefore, in the following description, the same components are assigned the same names and reference symbols, and the description thereof may be simplified or omitted.

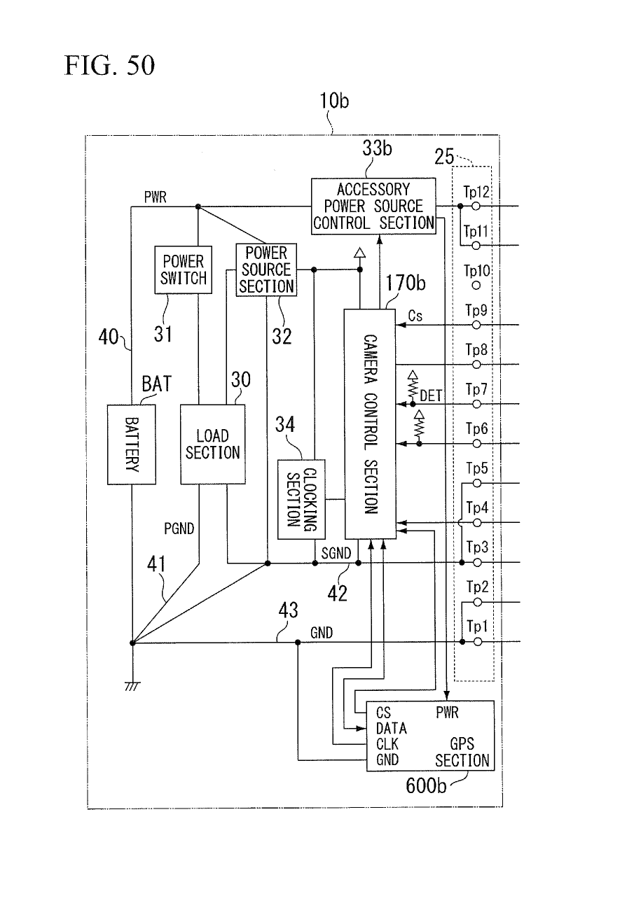

FIG. 50 is a configuration diagram illustrating a connection relationship between the camera 10b and the GPS section 600b according to the present embodiment. As shown in FIG. 50, the camera 10b includes a load section 30, a power switch 31, a power source section 32, an accessory power source control section 33b, a clocking section 34, and the GPS section 600b. The difference from the camera 10b is the accessory power source control section 33b, a camera control section 170b, and the GPS section 600b.

The accessory power source control section 33b includes a first terminal, a second terminal, a third terminal, and a control terminal. The third terminal of the accessory power source control section 33b is connected to a power (PWR) terminal of the GPS section 600b.

The camera control section 170b is configured such that a GPS control signal for controlling the GPS section 600b by communication with the GPS section 600b is connected to the GPS section 600b, in addition to a control signal for controlling the accessory 400 by communication with the accessory 400 through the terminal section 25. In the present embodiment, the GPS control signal is the communication signal DATA, the communication control signal Cs for setting a communication timing between the camera 10b and the GPS section 600b, and the synchronous signal (clock signal) CLK which is a clock signal for communication output by the GPS section 600b.

The GPS section 600b has the same function section as that of the accessory 600 shown in FIG. 34 except for the terminal section 623 (second information communication section) and the operating portion 630. Therefore, in the following description, the same components are assigned the same names and reference symbols, and the description thereof may be simplified or omitted.

A power source terminal of the GPS section 600b is connected to the third terminal of the accessory power source control section 33b. A GND terminal of the GPS section 600b is connected to the grounding line (SGND) 42 on the camera 10b side and the grounding line (GND) 43. In addition, the GPS section 600b is configured such that the communication control signal Cs, the communication signal DATA, and the synchronous signal CLK are connected to each other between the camera control section 170b and the GPS section.

In addition, in the example shown in FIG. 50, an example is illustrated in which the camera control section 170b and the GPS section 600b are connected to each other by serial communication, but the camera control section 170b and the GPS section 600b may be a connected to each other by parallel communication.

Next, processes performed by the camera control section 170b of the camera 10b and the GPS control section 660 (see FIG. 34) of the GPS section 600b will be described.

The camera system 1b performs processes in the camera system 1b, similarly to FIG. 39. In addition, the camera system 1b according to the present embodiment performs communication between the camera control section 170b of the camera 10b and the GPS control section 660 of the GPS section 600b, instead of communication performed by the camera control section 170 of the camera 10a and the GPS control section 660 of the accessory 600.

Therefore, in the camera system 1b according to the present embodiment, in the initial communication sequence (FIGS. 40, 12, and 13), the second steady communication sequence (FIG. 41), the GPS data update (FIG. 42), the process (FIG. 43) in capture of a still image, the process (FIG. 44) in capture of a moving image, the power source control (FIG. 45) by the camera, and the data communication process (FIG. 47) between the GPS section 600b and the external device, a left flow in the drawing is the process details in the camera control section 170b of the camera body 100b, and a right flow in the drawing is the process details in the GPS control section 660 of the GPS section 600b.

In addition, when the accessory 400 is, for example, installed to the shoe seat 15, the camera system 1b according to the present embodiment performs the initial communication sequence with the accessory 400 shown in FIGS. 12 and 13 and the steady communication sequence shown in FIGS. 15 and 16, in addition to the initial communication sequence with the GPS section 600b. In this case, the camera control section 170b performs steady communication with the accessory 400 at a period T, and performs first steady communication with the GPS function section 600b at a period 2T. In addition, the camera control section 170b performs second steady communication with only the GPS function section 600b.

Next, a power source control of the GPS section 600b by the camera 10b will be described.

Since the GPS section 600b is built in the camera body 100b, the camera system 1b according to the present embodiment does not perform the processes of step S5601 and S5602 in the processes shown in FIG. 45, and the process starts from step S5603. Thereafter, the camera control section 170b and the GPS control section 660 perform the processes of steps S5603 to S5622.

As state above, when the camera 10b transitions to a sleep state, the GPS function section 600b performs a control so that the GPS control section 660 stops the positioning by the GPS module section 650. Thereafter, the GPS control section 660 performs a control so that the GPS module section 650 transitions to a sleep state. In addition, in the present embodiment, the GPS module section 650 to set to a sleep state to thereby suppress power consumption. However, a restriction (sleep process) on the operation of the GPS control section 660 may be performed, and the supply of power to the GPS control section 660 may be additionally reduced, to thereby further suppress power consumption.

For example, the GPS control section 660 controls only the GPS module section 650 to be in a sleep state, based on the sleep start command C5021. The GPS control section 660 may count a clock generated by the RTC 653, and may perform a control so as to set itself to a sleep state without using a command of the camera 10b after a predetermined time. Alternatively, after the power supply stop command C5022 is received from the camera 10b, the GPS control section 660 may count a clock generated by the RTC 653, and may perform a control so as to set itself to a sleep state after a predetermined time.

In addition, when the accessory 400 is, for example, installed to the shoe seat 15, the camera system 1b according to the present embodiment may perform the power source control of the accessory 400, as shown in FIG. 11, in addition to the power source control of the GPS section 600b.

As mentioned above, in the camera system 1b according to the present embodiment, the same effect as that of the camera system 1a which includes the accessory 600 having a GPS function is obtained.

For example, in the camera system 1b according to the present embodiment, before the camera 10b transitions to a sleep state, a power-off state, or an auto power-off state, the camera control section 170b transmits a sleep start command to the GPS section 600b. The GPS section 600b transmits a response to the received sleep start command, and then stops the operation of the GPS module section 650.

In addition, in the camera system 1b according to the present embodiment, the camera control section 170b receives the response to the sleep start command from the GPS section 600b, and then transmits a power supply stop command to the GPS section 600b. The UPS control section 660 of the GPS section 600b transmits a response to the power supply stop command. When the camera control section 170b receives the response to the power supply stop command from the GPS section 600b, and then determines that the power supply continuation flag is set in the nonvolatile memory 160, the camera 10b is controlled to be in a sleep state, a power-off state, or an auto power-off state while continuing the supply of power to the GPS section 600b.

That is, before the camera 10b according to the present embodiment transitions to a sleep state, a power-off state, or an auto power-off state, the camera first transmits a sleep start command for stopping the operation of the GPS module section 650, receives an response to the command, and then performs a two-step process so as to transmit the power supply stop command.

As a result, after the operation is stopped, the GPS section 600b can store the measured data in the storage section 652a by the sleep process and save the data in backup. In addition, the GPS section 600b performs a count using clocking information of the RTC 653 during the sleep process, is started up, for example, at 30-minute intervals, and acquires the GPS information. The GPS section 600b stores the first GPS information based on the acquired GPS information in the storage section 652a within the GPS module section 650. Therefore, when the power source of the camera 10b is turned on from a sleep state, the first GPS information stored in the storage section 652a within the GPS module section 650 is used, thereby allowing the GPS control section 660 to generate the second GPS information rapidly. Therefore, when the image capture is performed immediately after the power source of the camera 10b is turned on, the camera 10b can obtain the second GPS information immediately from the GPS section 600b.

In addition, in the present embodiment, the camera 10a stops the second steady communication with the GPS section 600b at the time of capturing a still image. Further, the camera 10a stops the second steady communication with the GPS section 600b at the time of capturing a moving image, and then transmits the sleep start command. As a result, since the camera 10a can cause the GPS section 600b to transition to the sleep state at the time of capturing a moving image, power consumption of the GPS section 600b can be reduced.

In addition, in the camera system 1b according to the present embodiment, the GPS section 600b transmits, to the camera control section 170b, characteristic information of an extended function including power supply continuation information indicating whether or not the supply of power to the camera control section 170b is required to be continued even when the camera 10b is in a sleep state. The camera control section 170b detects the supply continuation information even when the camera 10b is in a sleep state, based on the characteristic information of the extended function transmitted by the GPS section 600b. When the supply continuation information is detected, the camera 10b can continue the supply of power to the GPS section 600b even after the camera 10b transitions to a sleep state. As a result, since the GPS section 600b can continue positioning even when the camera 10b is in a sleep state, measured data can be transmitted to the camera control section 170b rapidly after the camera 10b returns from the sleep state.

In addition, in the camera system 1b according to the present embodiment, an example in which the camera control section 170b and the GPS control section 660 are included is described, but the GPS control section 660 may not be included. In this case, the camera control section 170b may control the GPS section 600b.

In addition, similarly to Modified Example 1 (FIG. 25) to Modified Example 3 (FIG. 27) in the accessory 400, the camera system 1b according to the present embodiment may determine whether or not the camera control section 170b normally receives information from the GPS control section 660b in the initial communication sequence. For example, when the accessory initial state information cannot be received from the GPS control section 660b, or the received accessory initial state information does not include information of at least one item of items designated by the transmission request command C1, the camera control section 170b may determine that the information is not normally received. The camera control section 170b notifies the GPS section 600b that the supply of power is stopped, and then may perform a process of stopping the supply of power to the GPS section 600b.

In addition, the technical scope of the present invention is not limited to the above-mentioned embodiment. At least one of the requirements described in the above-mentioned embodiment may be omitted. The requirements described in the above-mentioned embodiment may be appropriately combined.

For example, in the present embodiment, the positioning information and the like are generated using the GPS, well-known positioning systems used in a cellular phone and the like may be used without being limited thereto.

In addition, the data terminal 640 connected to an external device may be configured to perform wireless communication.

### Second Embodiment

Hereinafter, a second embodiment of the present invention will be described in detail with reference to the accompanying drawings. In the following description, the same components as those in the above-mentioned embodiment are assigned the same reference numerals and signs, and the description thereof may be simplified or omitted.

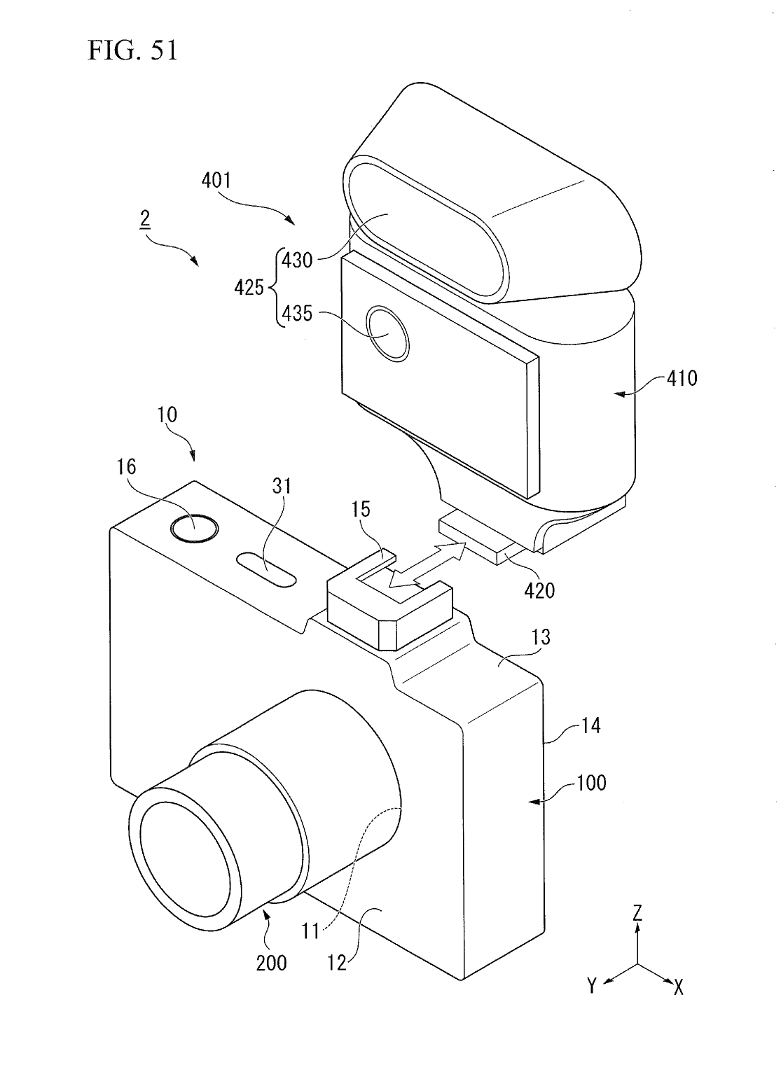

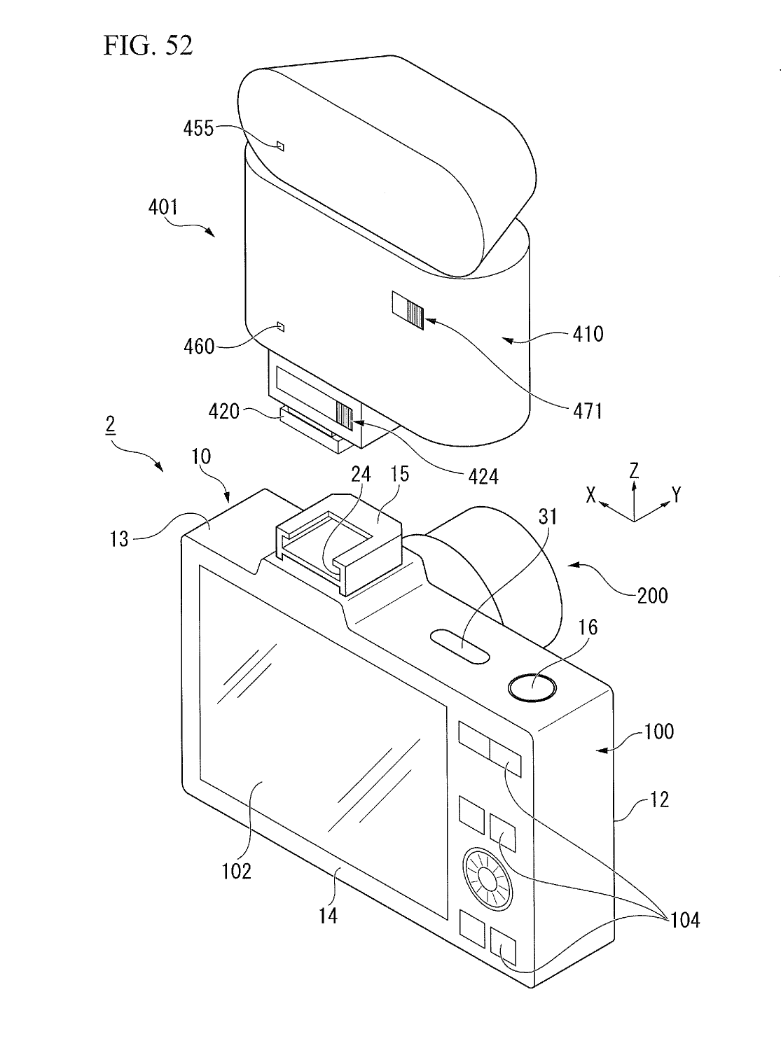

FIG. 51 is a diagram illustrating an appearance of a camera system 2 according to the present embodiment. FIG. 52 is a diagram when the camera system 2 according to the present embodiment is viewed from the opposite side from that of FIG. 51.

The camera system 2 shown in FIGS. 51 and 52 includes a camera 10 (camera body 100 and image capture lens 200) and an accessory 401. The accessory 401 according to the present embodiment has a light emitting function, and can illuminate a subject. The camera 10 communicates with the accessory 401, and can control the accessory 401. The camera system 2 can capture an image of a subject through the camera 10, for example, while illuminating the subject using the accessory 401.

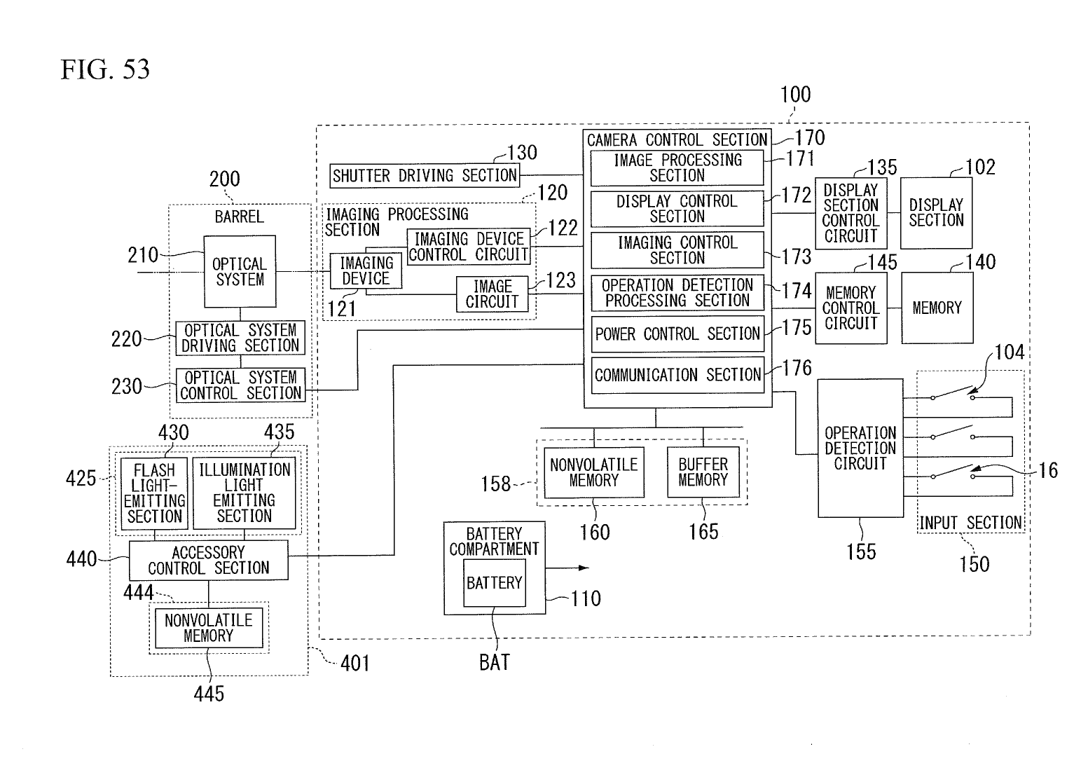

FIG. 53 is a block diagram illustrating a functional configuration of the camera system 2 according to the present embodiment. As shown in the same drawing, the image capture lens 200 includes an optical system 210, an optical system driving section 220, and an optical system control section 230. Light incident on the image capture lens 200 from a subject is incident on the light-receiving surface of an imaging device 121 of the camera body 100 through the optical system 210.

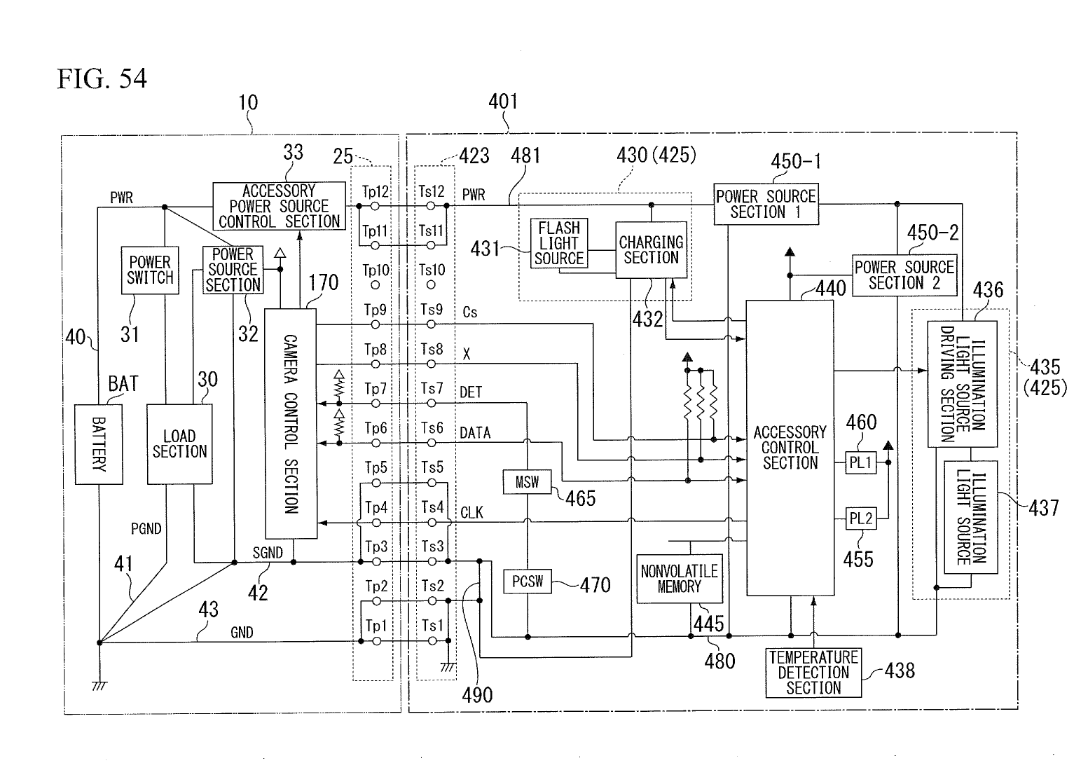

The accessory 401 includes a flash light-emitting section 430, an illumination light emitting section 435, an accessory control section 440, and a nonvolatile memory 445. The illumination light emitting section 435, the accessory control section 440, and the nonvolatile memory 445 are received in, for example, the accessory main body 410 shown in FIGS. 53 and 54. A detailed description of the accessory 401 will be made later.

FIG. 54 is a diagram illustrating a configuration of the accessory 401 according to the present embodiment and a connection relationship between the accessory 401 and the camera 10 (camera body 100 and image capture lens 200 mentioned above).

<Configuration of Accessory 401>

Next, the configuration of the accessory 401 will be described with reference to FIG. 54. The accessory 401 according to the present embodiment is operated by the power PWR supplied from the camera 10. When the power source that supplies power consumed in the accessory 401 is not mounted to the accessory 401, the accessory 401 causes each of the components of the accessory 401 to function by the power PWR supplied from the camera 10.

The accessory 401 includes the terminal section 423, the flash light-emitting section 430, the illumination light emitting section 435, a temperature detection section 438, the accessory control section 440, the storage section 444, the first power source section (power source section 1) 450-1, the second power source section (power source section 2) 450-2, the second pilot lamp (PL1) 460, the first pilot lamp (PL2) 455, the first switch section (MSW) 465, and the second switch section (PCSW) 470. The accessory 401 cannot have a built-in battery.

The terminal section 423 of the accessory 401 will be described below. As shown in FIG. 54, when the accessory 401 is mounted to the camera 10, the terminal section 423 is electrically connected to the terminal section 25 of the camera 10. The terminal section 423 includes a plurality of (twelve) terminals indicated by reference signs Ts1 to Ts12. Herein, the number indicating the arrangement order of the terminals described next is the number ascending from one side (+X side) in the array direction (X-axis direction) of the terminals toward the other side (−X side).

The function assigned to each of the terminals in the terminal section 423 is explained below. Each of the terminals Ts1 to Ts12 of the terminal section 423 is provided corresponding to each of the terminals (Tp1 to Tp12) of the terminal section 25 on the camera 10 side described in FIG. 54. The function of each of the terminals in the terminal section 423 is also associated with the function of each of the terminals in the terminal section 25. For this reason, in the description of the present embodiment, in order to avoid repeating the description mentioned above with respect to the terminal section 25, the terminal numbers 1 to 12 of each of the terminals are assigned the same numbers as the terminal numbers of the terminals corresponding to each of the terminals in the terminal section 25 on the camera side, and thus a repeated description regarding the function or the arrangement of each of the terminals will be simplified or omitted.

In the terminal section 423, a power terminal Ts11 and a power terminal Ts12, respectively, are terminals supplied with the power PWR from the camera 10. A ground terminal Ts1 and a ground terminal Ts2 are ground terminals corresponding to the power terminal Ts11 and the power terminal Ts12, and are terminals of which the potential serves as a reference potential (ground) of the power PWR.

A reference potential terminal Ts3 and a reference potential terminal Ts5 are respectively terminals of which the potential serves as a reference potential (ground signal) for performing transmission and reception of a signal.

A synchronous signal terminal Ts4 is a terminal for outputting a synchronous signal (clock signal) CLK which is a communication clock signal to the camera 10.

A communication signal terminal Ts6 is a terminal for inputting the communication signal DATA including communication data on the camera side as explained above from the camera 10 side, or outputting the communication signal DATA on the accessory side to the camera 10.

A startup state providing terminal Ts7 is a terminal for providing the startup detection level DET (reference potential based on L level/SGND) to the camera 10.

An emission control signal terminal Ts8 is a terminal to which the emission control signal (emission command signal) X is input from the camera 10.

A communication control signal terminal Ts9 is a terminal to which the communication control signal (communication startup signal) Cs is input from the camera 10.

An open terminal Ts10 is arranged between the power terminal Ts11 and the communication control signal terminal Ts9.

The temperature detection section 438 detects air temperature (hereinafter, called outside air temperature) outside the accessory 401 in accordance with the control of the accessory control section 440, and outputs outside air temperature information indicating the detected outside air temperature to the accessory control section 440.

The accessory control section 440 acquires the outside air temperature information which is output from the temperature detection section 438, at a predetermined time interval. Whenever the outside air temperature information is acquired, the accessory control section 440 creates light-emittable time information indicating the time for which the illumination light emitting section 435 is capable of continuously emitting the illumination light, based on the outside air temperature indicated by the acquired outside air temperature information. Here, the illumination light emitting section 435 creates the light-emittable time information so as to shorten the light-emittable time as the outside air temperature rises.

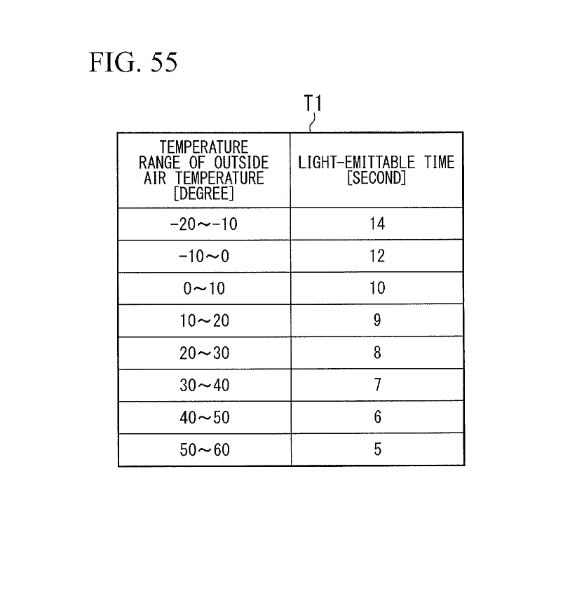

Specifically, for example, the outside air temperature information indicating the outside air temperature and the light-emittable time information indicating the light-emittable time are previously stored in the storage section 444 in association with each other. For example, the storage section 444 stores table T1 shown in FIG. 55.

FIG. 55 is an example of table T1 in which the outside air temperature information and the light-emittable time information which are stored in the storage section 444 are associated with each other. In table T1 of the same drawing, a set of the temperature ranges of the outside air temperature and the light-emittable times is shown. For example, in the temperature range of the outside air temperature from 20 degrees to 30 degrees, it is shown that the light-emittable time is 8 seconds.

When the accessory control section 440 receives the transmission request command C3 in initial communication which is an initial communication process executed between the accessory control section and the camera 10, the accessory control section creates the light-emittable time information by reading out the light-emittable time information, indicating the light-emittable time corresponding to the outside air temperature indicated by the outside air temperature information which is input from the temperature detection section 438, from the storage section 444. In the example of FIG. 55, the accessory control section 440 refers to a corresponding temperature range of the outside air temperature indicated by the outside air temperature information from table T1, and reads out the light-emittable time information associated with the referred temperature range.

Thereby, the temperature detection section 438 can create the light-emittable time according to the temperature of the illumination light emitting section 435.

The accessory control section 440 transmits the accessory initial state information including the light-emittable time information indicating the created light-emittable time to the camera control section 170 through the communication signal terminal Ts6 and the communication signal terminal Tp6 of the camera 10. Here, the initial communication means intercommunication of setting information, such as an initial state and a setting state, necessary for image capture after startup.

Thereby, the camera control section 170 can determine whether the image capture is capable of being completed within the light-emittable time, using the light-emittable time according to the outside air temperature. As a result, since the camera control section 170 can operate the illumination light emitting section 435 within a predetermined temperature range, it is possible to capture an image at the longest light-emitting time while preventing the damage of the illumination light emitting section 435 with a rise in temperature.

In addition, when the camera 10 returns from the sleep state and the initial communication is performed again by a command on the camera 10 side, and when the accessory control section 440 receives the transmission request command C3 from the camera 10 again, the accessory control section transmits the accessory initial state information including the light-emittable time information indicating the created light-emittable time to the camera control section 170 through the communication signal terminal Ts6 and the communication signal terminal Tp6 of the camera 10.

Thereby, the camera control section 170 performs the initial communication again, and thus can determine whether the image capture is capable of being completed within the light-emittable time, using the light-emittable time according to the outside air temperature at that time. As a result, since the camera control section 170 can operate the illumination light emitting section 435 within the predetermined temperature range, it is possible to capture an image at the longest light-emitting time while preventing the damage of the illumination light emitting section 435 with a rise in temperature.

In addition, not only in the initial communication, but in the steady communication executed in the predetermined time interval, the accessory control section 440 may transmit the accessory initial state information including the created light-emittable time information to the camera control section 170 through the communication signal terminal Ts6 and the communication signal terminal Tp6 of the camera 10, in accordance with the transmission request command (C11, C12, C13 or C14).

Thereby, the camera control section 170 can always determine whether the image capture is capable of being completed within the light-emittable time, using the light-emittable time according to the current outside air temperature. As a result, since the camera control section 170 can always operate the illumination light emitting section 435 within the predetermined temperature range, it is possible to capture an image at the longest light-emitting time while preventing the damage of the illumination light emitting section 435 with a rise in temperature.

In addition, the accessory control section 440 may calculate the light-emittable time in accordance with a function of the outside air temperature T regarding the light-emittable time. Here, the function of the outside air temperature T is a function in which the light-emittable time decreases as the outside air temperature T increases. In that case, function information indicating the function of the outside air temperature T is stored in the storage section 444 in advance. The accessory control section 440 may calculate the light-emittable time by reading out the function information from the storage section 444 and substituting the outside air temperature T into the function of the outside air temperature T indicated by the function information.

Here, the function information may be a function of temperature of a member within the accessory or air temperature within the accessory without being limited to the function of the outside air temperature T, and may be a function indicating the correlation between the light-emittable time and the temperature.

That is, the function information indicating the correlation between the light-emittable time and the temperature is stored in the storage section 444, and the accessory control section 440 may create the light-emittable time information by reading out the function information from the storage section and applying the temperature detected by the temperature detection section to the readout function information.

In addition, the accessory control section 440 may correct a reference value St of the light-emittable time at predetermined reference temperature Ts so as to shorten the time according to the amount of the temperature rise, or the light-emittable time, when the outside air temperature rises from the reference temperature Ts. In addition, when the outside air temperature drops from the reference temperature Ts, the accessory control section 440 may perform the correction so as to lengthen the time according to the amount of the temperature drop, or the light-emittable time.

As an example, the function of the outside air temperature T will be described using a case where the function is set to a monotonically decreasing function. Specifically, for example, the predetermined reference temperature Ts (for example, 25 degrees), the reference value St (for example, 8 seconds) of the light-emittable time at the reference temperature, and the correction amount Ca (for example, 0.1 sec/temperature) of the light-emittable time per unit temperature are stored in the storage section 444.

The accessory control section 440 reads out the reference temperature Ts, the reference value St of the light-emittable time, and the correction amount Ca of the light-emittable time per unit temperature, from the storage section 444. The accessory control section 440 then subtracts the reference temperature Ts from the temperature T indicated by the temperature information and multiplies a value (T−Ts) obtained by the subtraction by the correction amount Ca of the light-emittable time per unit temperature, to thereby calculate a correction value H (=(T−Ts)×Ca).

The accessory control section 440 then calculates the light-emittable time by subtracting the calculated correction value H from the reference value St of the light-emittable time. For example, when the reference temperature Ts is 25 degrees, the reference value St of the light-emittable time at the reference temperature (in this case, 25 degrees) is 8 seconds, and the correction amount Ca is 0.1 sec/temperature, the time is 7.9 seconds in a case where the temperature is 26 degrees, and the time is 8.1 seconds in a case where the temperature is 24 degrees.

That is, the accessory control section 440 may create the light-emittable time by calculating a correction value of the light-emittable time based on the outside air temperature indicated by the outside air temperature information, the reference value St of the light-emittable time in the predetermined reference temperature Ts, and the correction amount Ca of the light-emittable time per unit temperature and correcting the reference value St of the light-emittable time using the calculated correction value.

Thereby, since the amount of radiation from the accessory 401 to the outside is reduced as the temperature rises, the accessory control section 440 shortens the light-emittable time further than the reference value of the light-emittable time when the temperature is higher than the reference temperature.

In addition, in consideration of an increase in the amount of radiation from the accessory 401 to the outside as the temperature drops, the accessory control section 440 lengthens the light-emittable time further than the reference value of the light-emittable time when the temperature is lower than the reference temperature.

In addition, the accessory control section 440 linearly varies the correction value depending on the temperature, but may non-linearly vary the correction value depending on the temperature, without being limited thereto.

In addition, in the present embodiment, the temperature detection section 438 detects the outside air temperature, but may detect the temperature (for example, temperature of the package of electronic parts) of the member within the accessory 401 or the air temperature within the accessory 401.

In that case, the accessory control section 440 may create the light-emittable time by applying the temperature (for example, temperature of the package of electronic parts) of the member within the accessory 401 detected by the temperature detection section 438 or the air temperature within the accessory 401 to one process of the above-mentioned creation processes.

Thereby, the camera control section 170 can determine whether the image capture is capable of being completed within the light-emittable time, using the light-emittable time according to the temperature of the member within the accessory 401 or the air temperature within the accessory 401. As a result, since the camera control section 170 can operate the illumination light emitting section 435 within the predetermined temperature range, it is possible to capture an image at the longest light-emitting time while preventing the damage of the illumination light emitting section 435 with a rise in temperature.

In addition, in the present embodiment, the temperature detection section 438 detects the outside air temperature, but without being limited thereto, the accessory 401 includes a plurality of thermometers, and thus the temperature detection section may detect two or more temperatures of the outside air temperature, the temperature of the member within the accessory 401, and the air temperature within the accessory 401.

In that case, the accessory control section 440 may create the light-emittable time information based on the combination of two or more temperatures of the outside air temperature, the temperature of the member within the accessory 401, and the air temperature within the accessory 401. Specifically, for example, the combination of two or more temperatures of the outside air temperature, the temperature of the member within the accessory 401, and the air temperature within the accessory 401 and the light-emittable time information are previously stored in the storage section 444 in association with each other. The accessory control section 440 creates the light-emittable time information by reading out the light-emittable time information corresponding to the combination of two or more temperatures of the outside air temperature, the temperature of the member within the accessory 401, and the air temperature within the accessory 401.

Thereby, the accessory control section 440 can create more accurate light-emittable time information.

Thereby, the camera control section 170 can determine whether the image capture is capable of being completed within the light-emittable time, using the light-emittable time according to the combination of two or more temperatures of the outside air temperature, the temperature of the member within the accessory 401 and the air temperature within the accessory 401. As a result, since the camera control section 170 can operate the illumination light emitting section 435, more reliably, within the predetermined temperature range, it is possible to capture an image at the longest light-emitting time while preventing the damage of the illumination light emitting section 435 with a rise in temperature.

In addition, the camera control section 170 may create the light-emittable time in accordance with the total light-emitting time during which the illumination light emitting section 435 has emitted light so far or the elapsed time from the time when the illumination light emitting section 435 is started to be used.

Thereby, the camera control section 170 can determine whether the image capture is capable of being completed within the light-emittable time, using the light-emittable time according to the total light-emitting time during which the illumination light emitting section 435 has emitted light so far or the elapsed time from the time when the illumination light emitting section 435 is started to be used. As a result, since the camera control section 170 can operate the illumination light emitting section 435 within the temperature range considering aging degradation, it is possible to capture an image at the longest light-emitting time while preventing the damage of the illumination light emitting section 435 with a rise in temperature.

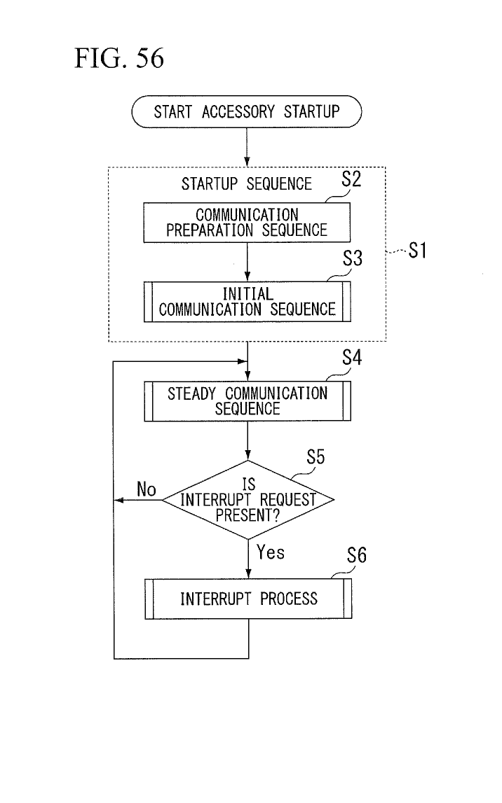

FIG. 56 is a flow diagram illustrating a procedure of processes in the camera system 2 according to the present embodiment. The camera system 2 performs a series of processes (startup sequence) for starting up the accessory 401. In the startup sequence (step S1), the camera system 2 performs a series of processes (communication preparation sequence) for preparing so as to be capable of communicating between the camera 10 and the accessory 401 (step S2).

After the communication preparation sequence is terminated in the startup sequence, the camera system 2 performs a series of processes (initial communication sequence) for mutually communicating information necessary for image capture between the camera control section 170 and the accessory control section 440 (step S3). After the initial communication sequence is terminated, the camera system 2 performs a series of processes (steady communication sequence) for mutually communicating between the camera control section 170 and the accessory control section 440 so that information varied by a setting change or the like can be updated (step S4).

After the steady communication sequence is terminated, the camera control section 170 performs a determination process of determining whether an interrupt request is present (step S5). When it is determined in step S5 that the interrupt request is not present (step S5; No), the camera system 2 performs the process of the steady communication sequence once again.

When it is determined in step S5 that the interrupt request is present (step S5; Yes), the camera system 2 performs an interrupt process (step S6). The interrupt process is, for example, a series of processes included in an image capturing sequence. After the interrupt process is terminated, the camera system 2 performs the process of the steady communication sequence once again. That is, the camera system 2 does not perform the process of the steady communication sequence in the image capturing sequence.

Next, processes in the initial communication sequence will be described. In the initial communication sequence, the camera system 2 mutually sends information required for image capture between the camera 10 and the accessory 401. In the initial communication sequence, the camera 10 and the accessory 401 transmit and receive a plurality of information items in accordance with a predetermined order. As the initial conditions of processes in the initial communication sequence, information (first response information) including accessory type information indicating an accessory type is previously stored in the storage section 444 of the accessory 401. The accessory type information includes function type information and battery presence or absence information.

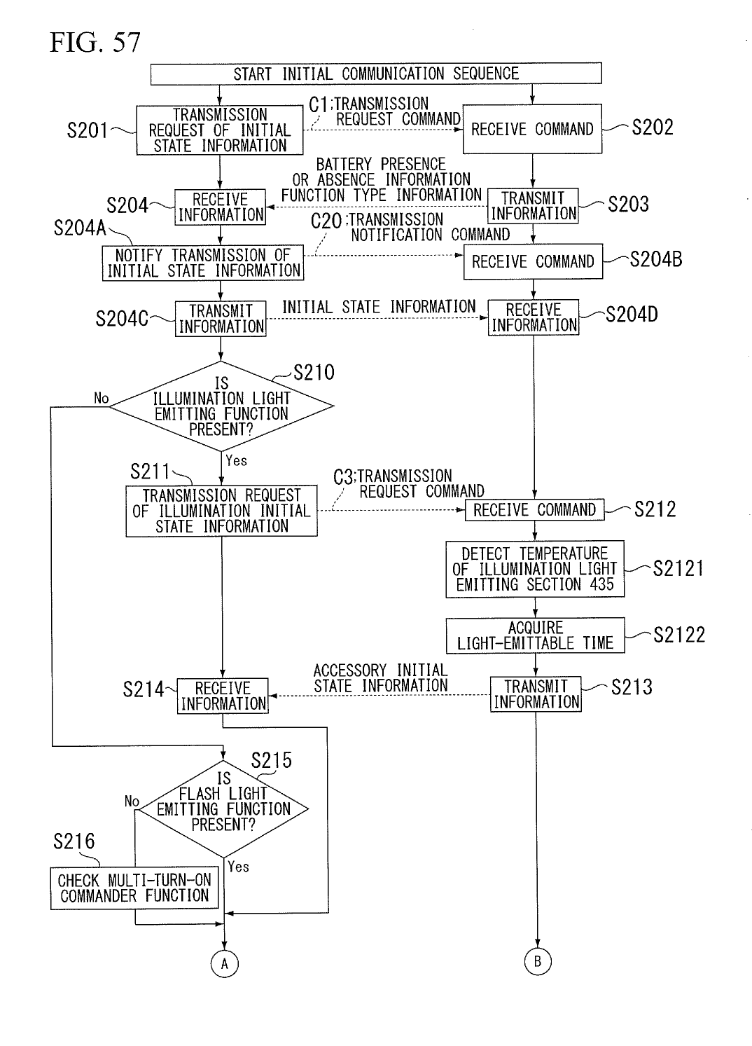

FIG. 57 is a flow diagram illustrating a procedure of processes in the initial communication sequence. In the following description, the same steps as those in the above-mentioned embodiment are assigned the same reference numerals and signs, and the description thereof may be simplified or omitted.

The drawing is a flow diagram illustrating a procedure of processes subsequent to FIG. 57. In FIG. 57, a left flow in the drawing is the processing details in the camera control section 170 of the camera body 100, and a right flow in the drawing is the processing details in the accessory control section 440 of the accessory 401.

After the accessory control section 440 receives the camera initial state information in step S204D, the camera control section 170 determines whether the accessory 401 has the illumination light emitting function, based on the function type information received in step S204 (step S210). When it is determined in step S210 that the accessory 401 has the illumination light emitting function (step S210; Yes), the camera control section 170 transmits a transmission request command C3 for requesting the transmission of initial state information (third response information) of the illumination light emitting function to the accessory control section 440 (step S211).

When the transmission request command C3 is received (step S212), the accessory control section 440 reads out the light-emittable time information, indicating the light-emittable time corresponding to the outside air temperature indicated by the outside air temperature information which is input from the temperature detection section 438, from the storage section 444 (step S2121 and step S2121). The accessory control section 440 transmits the accessory initial state information including the readout light-emittable time information to the camera control section 170 (step S213). The camera control section 170 receives the accessory initial state information including the light-emittable time information (step S214).

Each of the steps after step S215 in the camera control section 170 and the accessory control section 440 is the same as each of the steps after step S215 in FIGS. 12 and 13.

When the transmission request command C3 is received in accordance with the procedure of the initial communication sequence shown above, the accessory control section 440 reads out the light-emittable time information, indicating the light-emittable time corresponding to the outside air temperature indicated by the outside air temperature information which is input from the temperature detection section 438, from the storage section 444. The accessory control section 440 then transmits the accessory initial state information including the readout light-emittable time information to the camera control section 170.

Thereby, the accessory control section 440 can transmit the light-emittable time information created based on the temperature to the camera control section 170.

As a result, since the accessory control section 440 can cause the illumination light emitting section 435 to emit light within the created light-emittable time, it is possible to operate the illumination light emitting section 435 within the predetermined temperature range, and to capture an image within the longest light-emitting time while preventing the damage of the illumination light emitting section 435 with a rise in temperature of the illumination light emitting section 435.

As mentioned above, when it is determined that the image capture is not able to be completed within the normal turn-on time using the light-emittable time acquired from the accessory control section 440 in the initial communication sequence, the camera control section 170 according to the present embodiment extends the turn-on time from the normal turn-on time to the time equal to or less than the light-emittable time, and further determines whether the image capture is able to be completed within the light-emittable time. When the image capture is able to be completed within the light-emittable time, the camera control section 170 then notifies the accessory control section 440 of the turn-on time extension. Thereby, the accessory control section 440 extends the turn-on time of the illumination light emitting section 435.

Thereby, since the accessory control section 440 can determine whether the image capture is able to be completed within the light-emittable time using the light-emittable time according to the temperature, it is possible to prevent the temperature of the illumination light emitting section 435 from rising in excess of the predetermined temperature range, and to capture an image at the longest light-emitting time while preventing the damage of the illumination light emitting section 435 with a rise in temperature.

A program for executing each of the processes of the camera control section 170 or the accessory control section 440 according to the present embodiment is recorded in a computer readable recording medium, and the program recorded in the recording medium is read by a computer system and is executed, so that the above-mentioned various processes of the camera control section 170 or the accessory control section 440 may be performed.

In addition, the camera body 100 (or 100a, 100b) and the accessory 400 (or 600, GPS section 600b) mentioned above include a computer system therein. The sequences of the operations of the function sections are stored in a program form in a computer-readable recording medium and the processes are performed by causing a computer system to read out and execute the program. The term “computer system” herein includes a CPU, various types of memory or OS, and hardware such as peripheral devices.

In addition, the “computer system” may also include a homepage providing environment (or a display environment) when a WWW system is used. In addition, the “computer readable recording medium” means writable nonvolatile memories such as a flexible disk, a magnetooptic disc, a ROM, and a flash memory, portable mediums such as a CD-ROM, and storage devices such as a hard disk built in the computer system.

Further, the “computer readable recording medium” means including mediums that dynamically hold a program during a short period of time like networks such as the Internet or communication lines when a program is transmitted through communication lines such as a telephone line, and mediums that hold a program for a certain period of time like a volatile memory (for example, DRAM (Dynamic Random Access Memory)) inside a computer system serving as a server or a client in that case.

In addition, the above-mentioned program may be transmitted from a computer system having the program stored in a storage device or the like through a transmission medium, or through transmitted waves in the transmission medium, to another computer system. Here, the “transmission medium” that transmits a program means mediums having a function of transmitting information like networks (communication networks) such as the Internet or communication lines (communication lines) such as a telephone line. In addition, the above-mentioned program may be a program for realizing a portion of the above-mentioned functions.

In addition, the above-mentioned program may be a program for realizing a portion of the above-mentioned functions, and may be a so-called difference file (difference program) capable of realizing the above-mentioned functions by a combination with a program which is already recorded in a computer system.

In addition, the technical scope of the present invention is not limited to the above-mentioned embodiment. At least one of the constituent elements described in the above-mentioned embodiment may be omitted. Each of the constituent elements described in the above-mentioned embodiment may be appropriately combined.

1. An accessory which is capable of communicating with a camera, comprising:
a light-emitting section that emits illumination light;
a nonvolatile storage section that stores light-emittable time information which is a time for which the light-emitting section is capable of continuously emitting the illumination light and a predetermined time indicating an upper limit of the continuous light-emitting time; and
an accessory control section that transmits the light-emittable time information stored in the storage section to the camera.

2. The accessory according to claim 1, further comprising an accessory terminal section which is capable of being electrically connected to a camera terminal section provided in the camera,
wherein the accessory control section receives a transmission request command, transmitted from the camera, for requesting transmission of the light-emittable time information through the camera terminal section and the accessory terminal section, and then transmits the light-emittable time information to the camera through the accessory terminal section and the camera terminal section.

3. The accessory according to claim 1, wherein the accessory control section transmits the light-emittable time information to the camera in an initial communication sequence executed between the camera and the accessory control section.

4. A camera which is capable of communicating with an accessory including a light-emitting section that emits illumination light and a nonvolatile storage section that stores light-emittable time information which is a time for which the light-emitting section is capable of continuously emitting the illumination light and a predetermined time indicating an upper limit of the continuous light-emitting time, the camera comprising:
a camera control section that receives the light-emittable time information transmitted from the accessory.

5. The camera according to claim 4, further comprising a camera terminal section which is capable of being electrically connected to an accessory terminal section provided in the accessory,
wherein the camera control section transmits a transmission request command for requesting transmission of the light-emittable time information to the accessory through the camera terminal section and the accessory terminal section, and
the camera control section transmits the transmission request command, and then receives the light-emittable time information through the accessory terminal section and the camera terminal section.

6. The camera according to claim 4, wherein the camera control section receives the light-emittable time information from the accessory in an initial communication sequence executed between the accessory and the camera control section.

7. The camera according to claim 5, wherein the camera control section sets the longest time for which the light-emitting section is capable of continuously emitting the illumination light as a predetermined time, when the camera control section does not receive the light-emittable time information from the accessory, regardless of transmission of the transmission request command to the accessory.

8. An accessory control program for controlling an operation of an accessory control section included in an accessory, capable of communicating with a camera, which includes a light-emitting section that emits illumination light and a nonvolatile storage section that stores light-emittable time information which is a time for which the light-emitting section is capable of continuously emitting the illumination light and a predetermined time indicating an upper limit of the continuous light-emitting time, the program comprising:
a step of transmitting the light-emittable time information stored in the storage section to the camera.

9. A camera control program for controlling an operation of a camera control section included in a camera which is capable of communicating with an accessory including a light-emitting section that emits illumination light and a nonvolatile storage section that stores light-emittable time information which is a time for which the light-emitting section is capable of continuously emitting the illumination light and a predetermined time indicating an upper limit of the continuous light-emitting time, the program comprising:
a step of receiving the light-emittable time information transmitted from the accessory.

10. An accessory which is capable of communicating with a camera, comprising:
an accessory terminal section which is capable of being electrically connected to a camera terminal section provided in the camera; and
a nonvolatile storage section that stores type information on the accessory side indicating a type of the accessory terminal section.

11. The accessory according to claim 10, further comprising an accessory control section that transmits the type information on the accessory side stored in the storage section to the camera through the accessory terminal section and the camera terminal section.

12. The accessory according to claim 10, wherein the accessory control section receives the type information on the camera side indicating a type of the camera terminal section through the accessory terminal section.

13. The accessory according to claim 12, wherein the accessory control section compares the type information on the camera side with the type information on the accessory side stored in the storage section.

14. The accessory according to claim 13, wherein the accessory control section prohibits an update process of firmware for the accessory when comparison results of the type information on the camera side and the type information on the accessory side do not match each other.

15. A camera which is capable of communicating with an accessory, comprising:
a camera terminal section which is capable of being electrically connected to an accessory terminal section provided in the accessory; and
a nonvolatile storage section that stores type information on the camera side indicating a type of the camera terminal section.

16. The camera according to claim 15, further comprising a camera control section that transmits the type information on the camera side stored in the storage section to the accessory through the camera terminal section.

17. The camera according to claim 15, wherein the camera control section receives type information on the accessory side indicating a type of the accessory terminal section through the camera terminal section.

18. The camera according to claim 17, wherein the camera control section compares the type information on the accessory side with the type information on the camera side stored in the storage section.

19. The camera according to claim 18, wherein the camera control section prohibits an update process of firmware for the accessory when comparison results of the type information on the accessory side and the type information on the camera side do not match each other.

20. An accessory control program for controlling an operation of an accessory control section included in an accessory, capable of communicating with a camera, which includes an accessory terminal section which is capable of being electrically connected to a camera terminal section provided in the camera and a nonvolatile storage section that stores type information on the accessory side indicating a type of the accessory terminal section, the program comprising:
a step of reading out the type information on the accessory side stored in the storage section; and
a step of transmitting the type information on the accessory side which is read out in the step to the camera.

21. A camera control program for controlling an operation of a camera control section included in a camera, capable of communicating with an accessory, which includes a camera terminal section capable of being electrically connected to an accessory terminal section provided in the accessory and a nonvolatile storage section that stores type information on the camera side indicating a type of the camera terminal section, the program comprising:
a step of reading out the type information on the camera side stored in the storage section; and
a step of transmitting the type information on the camera side which is read out in the step to the accessory.

22. An accessory which is capable of being attached and detached to and from a camera, comprising:
a terminal section that receives a supply of power from the camera; and
an accessory control section that outputs power supply continuation information, to the camera, which requests, from the camera, the continuation of the supply of power even when the camera is set to be in a predetermined state different from a startup state in which the camera is capable of being operated.

23. The accessory according to claim 22, wherein the accessory control section outputs the power supply continuation information to the camera, in initial communication executed immediately after the supply of power from the camera is started.

24. The accessory according to claim 22, wherein the accessory control section transmits a function included in the accessory to the camera, and transmits the power supply continuation information to the camera at a timing subsequent to the transmission of the function.

25. The accessory according to claim 22, wherein the predetermined state includes at least one of a power source off state in which a power source of the camera is turned off and a state of power consumption lower than power consumption when power consumption of the camera is in the startup state.

26. The accessory according to claim 22, wherein the accessory control section transmits the power supply continuation information to the camera through a separate communication terminal section from the terminal section.

27. A camera to and from which an accessory is capable of being attached and detached, comprising:
a communication terminal section which communicates with the attached accessory;
a power supply terminal section that supplies power to the attached accessory; and
a camera control section that controls the camera,
wherein the camera control section is able to receive power supply continuation information, from the accessory through the communication terminal section, which requests, from the camera, the continuation of the supply of power even when the camera is set to be in a predetermined state different from a startup state in which the camera is capable of being operated, and
continues a supply of power to the accessory through the power supply terminal section even when the camera is set to be in the predetermined state at the time of receiving the power supply continuation information.

28. The camera according to claim 27, wherein the camera control section receives the power supply continuation information from the accessory, in initial communication executed immediately after the supply of power to the accessory is started.

29. The camera according to claim 27, wherein the predetermined state includes at least one of a power source off state in which a power source of the camera is turned off and a state of power consumption lower than power consumption when power consumption of the camera is in the startup state.

30. The camera according to claim 27, wherein the camera control section transmits a first command for inquiring a function included in the accessory to the accessory, in initial communication executed immediately after the supply of power to the accessory is started,
receives a response from the accessory with respect to the first command, and determines whether the accessory has a predetermined function based on the response,
transmits a second command to the accessory in order to inquire the predetermined function, when it is determined that the accessory has the predetermined function, and
receives a response from the accessory with respect to the second command, and continues the supply of power to the accessory when the power supply continuation information is included in the response and the camera is set to be in the predetermined state.

31. An accessory control program causing a computer to execute control of an operation of an accessory control section provided in an accessory which is capable of being attached and detached to and from a camera, the program causing the computer to execute:
a procedure of outputting power supply continuation information, to the camera, which requests, from the camera, the continuation of the supply of power even when the camera is set to be in a predetermined state different from a startup state in which the camera is capable of being operated.

32. A camera control program causing a computer to execute control of an operation of a camera control section provided in a camera to and from which an accessory is capable of being attached and detached, the program causing the computer to execute:
a procedure of receiving power supply continuation information, from the accessory, which requests, from the camera, the continuation of the supply of power even when the camera is set to be in a predetermined state different from a startup state in which the camera is capable of being operated; and
a procedure of continuing a supply of power to the accessory even when the camera is set to be in the predetermined state at the time of receiving the power supply continuation information.

33. An accessory which is capable of communicating with a camera, comprising:
a light-emitting section that emits illumination light;
a temperature detection section that detects a temperature; and
an accessory control section that creates light-emittable time information indicating a time for which the light-emitting section is capable of continuously emitting the illumination light, based on the temperature detected by the temperature detection section, and transmits the created light-emittable time information to the camera.

34. The accessory according to claim 33, wherein the light-emittable time indicated by the light-emittable time information becomes shorter as the temperature rises.

35. The accessory according to claim 33, wherein the temperature is air temperature outside the accessory, temperature of a member within the accessory or air temperature within the accessory.

36. The accessory according to claim 33, further comprising a storage section in which temperature information indicating the temperature and the light-emittable time information are stored in association with each other,
wherein the accessory control section creates the light-emittable time information by reading out the light-emittable time information, corresponding to the temperature detected by the temperature detection section, from the storage section.

37. The accessory according to claim 33, wherein the temperature detection section detects at least two or more temperatures of air temperature outside the accessory, temperature of a member within the accessory, and air temperature within the accessory, and
the accessory control section creates the light-emittable time information based on a combination of at least two or more temperatures of the air temperature outside the accessory, the temperature of the member within the accessory, and the air temperature within the accessory which are detected by the temperature detection section.

38. The accessory according to claim 33, further comprising a storage section in which function information indicating a correlation between the light-emittable time and the temperature is stored,
wherein the accessory control section reads out the function information from the storage section, and creates the light-emittable time information by applying the temperature detected by the temperature detection section to the readout function information.

39. The accessory according to claim 33, further comprising a storage section in which a predetermined reference temperature, a reference value of the light-emittable time at the reference temperature, and a correction amount of the light-emittable time per unit temperature are stored,
wherein the accessory control section reads out the reference temperature, the reference value, and the correction amount from the storage section, and creates the light-emittable time information based on the reference temperature, the reference value, and the correction amount which are read out, and the temperature detected by the temperature detection section.

40. The accessory according to claim 33, further comprising an accessory terminal section which is capable of being electrically connected to a camera terminal section provided in the camera,
wherein the accessory control section receives a transmission request command, transmitted from the camera, for requesting transmission of the light-emittable time information through the camera terminal section and the accessory terminal section, and then transmits the light-emittable time information to the camera through the accessory terminal section and the camera terminal section.

41. The accessory according to claim 33, wherein the accessory control section transmits the light-emittable time information to the camera in communication executed between the camera and the accessory control section.

42. An accessory control method of controlling an operation of an accessory, capable of communicating with a camera, which includes a light-emitting section that emits illumination light and a temperature detection section that detects a temperature, the method comprising:
executing a procedure of creating a light-emittable time indicating a time for which the light-emitting section is capable of continuously emitting the illumination light, based on the temperature detected by the temperature detection section, and transmitting light-emittable time information indicating the created light-emittable time to the camera.

43. An accessory control program for controlling an operation of an accessory, capable of communicating with a camera, which includes a light-emitting section that emits illumination light and a temperature detection section that detects a temperature, the program causing a computer to execute,
a step of creating light-emittable time information indicating a time for which the light-emitting section is capable of continuously emitting the illumination light, based on the temperature detected by the temperature detection section, and transmitting the created light-emittable time information to the camera.

44. An accessory which is capable of communicating with a camera, comprising:
an accessory terminal section which is capable of being electrically connected to a camera terminal section provided in the camera;
a nonvolatile storage section that stores accessory initial state information including accessory type information; and
an accessory control section that transmits the accessory initial state information stored in the storage section to the camera, at the time of initial communication with the camera,
wherein the accessory type information includes
battery presence or absence information indicating whether a battery is mounted in the accessory,
function type information including information indicating the presence or absence of the flash light emitting function, information indicating the presence or absence of an illumination light emitting function, and information indicating the presence or absence of an extended function, different from the flash light emitting function and the illumination light emitting function, in the accessory,
characteristic information indicating a characteristic of each of the functions included in the accessory, and
type information on the accessory side indicating a type of the accessory terminal section.

45. The accessory according to claim 44, further comprising a flash light-emitting section and an illumination light emitting section,
wherein the characteristic information of the flash light emitting function includes profile information indicating emission characteristics of the flash light-emitting section, and
the characteristic information of the illumination light emitting function includes illumination profile information indicating emission characteristics of the illumination light emitting section and light-emittable time information which is a time for which the illumination light emitting section is capable of continuously emitting the illumination light and a predetermined time indicating an upper limit of the continuous light-emitting time.

46. The accessory according to claim 44, wherein the storage section further stores accessory setting state information,
the accessory control section further transmits the accessory setting state information at the time of initial communication with the camera, and
the accessory setting state information includes information indicating whether the flash light emitting function is valid or invalid and information indicating whether the illumination light emitting function is valid or invalid.

47. The accessory according to claim 44, further comprising a positioning section that performs positioning,
wherein the characteristic information of the extended function includes information indicating a type of an object to be positioned by the positioning section.
